(19) United States
(12) Patent Application Publication
(10) Pub. No.: US 2026/0218661 A1
(43) Pub. Date: Jul. 30, 2026

(54) GAS TURBINE ENGINE HAVING COMPOSITE FAN BLADES

(71) Applicant: General Electric Company, Evendale, OH (US)

(72) Inventors: Arthur William Sibbach, Boxford, MA (US); Gary Willard Bryant, JR., Loveland, OH (US)

(21) Appl. No.: 19/573,039

(22) Filed: Mar. 20, 2026

Related U.S. Application Data
(63) Continuation-in-part of application No. 19/362,542, filed on Oct. 20, 2025.
Application No. 19/362,542 is a continuation of application No. 18/909,259, filed on Oct. 8, 2024, now Pat. No. 12,473,863.
Application No. 18/909,259 is a continuation-in-part of application No. 18/603,773, filed on Mar. 13, 2024, now Pat. No. 12,473,832.
(60) Provisional application No. 63/820,482, filed on Jun. 9, 2025.
(60) Provisional application No. 63/837,313, filed on Jul. 2, 2025.

(51) Int. Cl. F02C 7/36

(52) U.S. Cl. CPC F02C 7/36; F05D 2220/36; F05D 2260/4031

(57) ABSTRACT

A gas turbine engine includes: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio during operation of the gas turbine engine in a cruise operating mode; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8.

### CROSS-REFERENCE TO RELATED APPLICATIONS

This application is a continuation of U.S. patent application Ser. No. 19/362,542, filed Oct. 20, 2025, which is a continuation-in-part application of U.S. application Ser. No. 18/909,259 filed on Oct. 8, 2024, granted as U.S. Pat. No. 12,473,863 on Nov. 18, 2025, which is a continuation-in-part of U.S. application Ser. No. 18/603,773 filed on Mar. 13, 2024, granted as U.S. Pat. No. 12,473,832 on Nov. 18, 2025, each of which are hereby incorporated by reference in their entireties. This application claims the benefit of U.S. Provisional Application No. 63/820,482, filed on Jun. 9, 2025, and U.S. Provisional Application No. 63/837,313, filed on Jul. 2, 2025, the entire contents of which are hereby incorporated by reference in their entireties.

### FIELD

The present disclosure relates to a gas turbine engine having composite fan blades.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extract energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up view of a blade of the gas turbine engine of FIG. 1 in accordance with an exemplary aspect of the present disclosure.

FIG. 3 is a table of example engines of the present disclosure.

FIG. 4 is a cross-sectional view of a gas turbine engine in accordance with another exemplary aspect of the present disclosure

FIG. 5 is a close-up, schematic view of the gas turbine engine of FIG. 4 with a cooled cooling air system in accordance with an exemplary embodiment of the present disclosure.

FIG. 6 is a close-up view of an aft-most stage of high-pressure compressor rotor blades within the gas turbine engine of FIG. 4.

FIG. 7 is a close-up, schematic view of the gas turbine engine of FIG. 4 showing the cooled cooling air system of FIG. 5.

FIG. 8 is a schematic view of a thermal transport bus of the present disclosure.

FIG. 9 is a table depicting numerical values showing the relationships between various parameters in accordance with various example embodiments of the present disclosure.

FIG. 10 is a graph depicting a range of corrected specific thrust values and redline exhaust gas temperature values of gas turbine engines in accordance with various example embodiments of the present disclosure.

FIG. 11 is a schematic, cross-sectional view of a gas turbine engine with an intercooler in accordance with an exemplary aspect of the present disclosure.

FIG. 12 is a schematic, close-up view of a gas turbine engine having a cooled cooling air system in accordance with another exemplary aspect of the present disclosure.

FIG. 13 is a schematic, close-up view of a gas turbine engine having a cooled cooling air system in accordance with yet another exemplary aspect of the present disclosure.

FIG. 14 is a schematic, close-up view of a gas turbine engine having a cooled cooling air system in accordance with still another exemplary aspect of the present disclosure.

FIG. 15 is a schematic view of a gas turbine engine in accordance with another exemplary aspect of the present disclosure.

FIG. 16 shows a schematic, cross-sectional view of a ducted, direct-drive gas turbine engine, taken along a longitudinal centerline axis of the gas turbine engine.

FIG. 17 shows an enlarged, cross-sectional view of a portion of the cross-sectional view of FIG. 16.

FIG. 18A shows a cross-sectional view of a steel shaft.

FIG. 18B shows a cross-sectional view of a composite shaft.

FIG. 19A shows a cross-sectional view of a uniform shaft with a constant diameter and thickness, taken along a longitudinal centerline axis of the shaft.

FIG. 19B shows a cross-sectional view of a concave shaft with a constant diameter and a variable thickness, taken along a longitudinal centerline axis of the shaft.

FIG. 19C shows a cross-sectional view of a convex shaft with a variable diameter and a variable thickness, taken along a longitudinal centerline axis of the shaft.

FIG. 20A shows a schematic view of a shaft using a four-bearing straddle configuration.

FIG. 20B shows a schematic view of a shaft using a four-bearing outbound configuration.

FIG. 20C shows a schematic view of a shaft using an inbound duplex configuration.

FIG. 20D shows a schematic view of a shaft using an outbound duplex configuration.

FIG. 20E shows a schematic view of a shaft using a two-bearing configuration.

FIG. 21 shows a schematic, cross-sectional view, taken along a longitudinal centerline axis, of a ducted gas turbine engine, according to the present disclosure.

FIG. 22 shows a schematic, cross-sectional view, taken along a longitudinal centerline axis, of a ducted gas turbine engine, according to the present disclosure.

FIG. 23 shows a schematic, cross-sectional view, taken along a longitudinal centerline axis, of a ducted gas turbine engine, according to the present disclosure.

FIG. 24 shows a schematic, cross-sectional view, taken along a longitudinal centerline axis, of ducted a gas turbine engine, according to the present disclosure.

FIG. 25 shows a schematic view, taken along a longitudinal centerline axis, of an unducted gas turbine engine, according to the present disclosure.

FIG. 26 shows a schematic, partial cross-sectional view, taken along a longitudinal centerline axis, of a gas turbine engine, according to the present disclosure.

FIG. 27 shows an enlarged cross-sectional view of a portion of the gas turbine engine of FIG. 26, according to the present disclosure.

FIG. 28 shows an exemplary blade for a gas turbine engine, according to the present disclosure.

FIG. 29 shows a table of material properties.

FIG. 30 shows a plot depicting disk bore radius change as a factor of airfoil weight change.

FIG. 31 shows a plot depicting disk bore width change as a factor of airfoil weight change.

FIG. 32 shows a schematic, partial cross-sectional view, taken along a centerline axis, of a gearbox for a gas turbine engine, according to the present disclosure.

FIG. 33A shows a first order bending mode of a shaft.

FIG. 33B shows a second order bending mode of a shaft.

FIG. 33C shows a third order bending mode of a shaft.

FIG. 34 shows a schematic view of a gas turbine engine, according to the present disclosure.

FIG. 35 is a schematic view of an exemplary bearing damper assembly of a gas turbine engine, taken along a longitudinal centerline axis of the gas turbine engine, according to the present disclosure.

FIGS. 36A to 36I show a table of embodiments, according to the present disclosure.

FIG. 37A shows a plot depicting a range of a midshaft rating relative to a range of outer diameter redline speeds.

FIG. 37B shows a plot depicting a range of a midshaft rating relative to a range of length-diameter ratios.

FIG. 37C shows a plot depicting a range of a midshaft rating relative to a range of length-diameter ratios.

FIG. 38 represents, in graph form, a Midshaft Effective Flexural Rigidity (MEFR) as a function of a midshaft thickness of a low-pressure shaft of the gas turbine engine, according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine. Alternatively, unless otherwise specified, the aforementioned terms may be understood in their superlative degree. For example, a “low-pressure turbine” may refer to the lowest maximum pressure within a turbine section, and a “high-pressure turbine” may refer to the highest maximum pressure within the turbine section. The terms “low” or “high” in such aforementioned regards may additionally, or alternatively, be understood as relative to minimum allowable speeds and/or pressures, or minimum or maximum allowable speeds and/or pressures relative to normal, desired, steady state, etc., operation of the engine.

The term “disk loading” refers to an average pressure change across a plurality of rotor blades of a rotor assembly, such as the average pressure change across a plurality of fan blades of a fan.

As used herein, the term “rated speed” (also referred to herein as “redline speed”) with reference to a gas turbine engine refers to a maximum rated speed of the gas turbine engine. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation. The rated speed, or the redline speed, may be expressed in terms of rotations per second in Hertz (Hz), rotations per minute (RPM), or as a linear velocity of the outer diameter of the shaft in terms of feet per second. For a gas turbine engine that has a high-pressure shaft and a low-pressure shaft, both the high-pressure shaft and the low-pressure shaft have redline speeds.

The term “cruise operating mode” refers to a specific configuration or setting of the gas turbine engine that controls for, e.g., performance and fuel efficiency during a cruise phase of flight.

The term “thrust rating” for a gas turbine engine refers to a maximum amount of thrust the gas turbine engine can generate when operating at the rated speed during standard day operating conditions (i.e., sea level under standard temperature and pressure conditions).

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

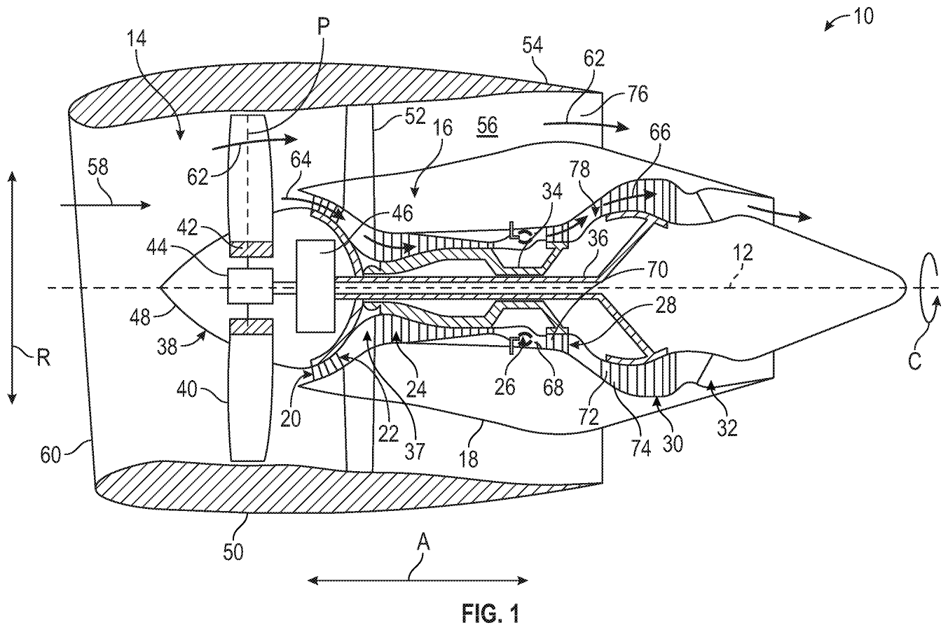

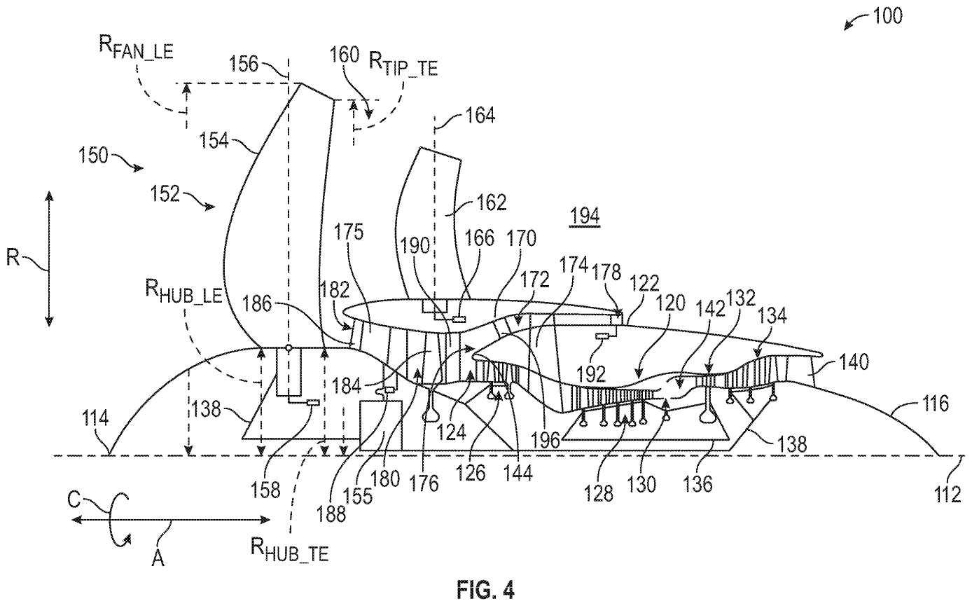

The term “bypass ratio” refers to a ratio in a gas turbine engine of a mass flowrate of an airflow from a primary fan that is bypassed around the engine's upstream-most ducted inlet (downstream of the primary fan of the engine) to a mass flowrate of an airflow that passes through the engine's ducted inlet. For example, in the embodiment of FIGS. 1, and 4 discussed below, the bypass ratio refers to a mass flowrate of an airflow from a fan 38, 152 that flows over an outer casing 18 or a fan cowl 170 to a mass flowrate of an airflow from the fan 38, 152 that flows through the engine inlet 20, 182. The bypass ratio may be defined during operation of the gas turbine engine in a cruise operating mode.

As used herein, the term “composite material” refers to a material produced from two or more constituent materials. Example composite materials include polymer matrix composites (PMC), ceramic matrix composites (CMC), or metal matrix composites (MMC)-.

For example, the term “composite material” can be a material made by combining two or more distinct materials with different chemical properties and physical properties and having a finite interface between the two or more distinct materials. One of the distinct materials can be a reinforcement, or reinforcing phase, while the other can be a matrix phase.

As used herein, a “composite” component refers to a structure or a component including any suitable composite material. Composite components, such as a composite airfoil, can include several layers or plies of composite material. The layers or the plies can vary in stiffness, material, and dimension to achieve the desired composite component or the desired composite portion of a component having a predetermined weight, size, stiffness, and strength.

One or more layers of adhesive can be used in forming or coupling composite components. Adhesives can include resin and phenolics, wherein the adhesive can require curing at elevated temperatures or other hardening techniques.

As used herein, PMC refers to a class of materials. By way of example, the PMC material is defined in part by a prepreg, which is a reinforcement material pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of non-limiting example electrostatically, and then adhered to the fiber, by way of non-limiting example, in an oven or with the assistance of heated rollers. The prepregs can be in the form of unidirectional tapes or woven fabrics, which are then stacked on top of one another to create the number of stacked plies desired for the part.

Multiple layers of prepreg are stacked to the proper thickness and orientation for the composite component and then the resin is cured and solidified to render a fiber reinforced composite part. Resins for matrix materials of PMCs can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific example of high performance thermoplastic resins that have been contemplated for use in aerospace applications include, polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy, bismaleimide (BMI), and polyimide resins.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cure to the make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure. As will be appreciated, these are all examples and non-limiting.

Instead of using a prepreg, in another non-limiting example, with the use of thermoplastic polymers, it is possible to utilize a woven fabric. Woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers or matrix material to a mold or cavity. The dry fibers or matrix material can include prepreg, braided material, woven material, or any combination thereof.

Resin can be pumped into or otherwise provided to the mold or cavity to impregnate the dry fibers or matrix material. The combination of the impregnated fibers or matrix material and the resin are then cured and removed from the mold. When removed from the mold, the composite component can require post-curing processing.

RTM can be a vacuum assisted process. That is, the air from the cavity or mold can be removed and replaced by the resin prior to heating or curing. The placement of the dry fibers or matrix material can be manual or automated.

The dry fibers or matrix material can be contoured to shape the composite component or direct the resin. Optionally, additional layers or reinforcing layers of material differing from the dry fiber or matrix material can also be included or added prior to heating or curing.

As used herein, the term “ceramic matrix composite” (“CMC”) refers to a subgroup of composite materials and a subgroup of ceramics. The terms “CMC” and “CMC material” are used interchangeably herein. When the engine component (e.g., the higher pressure turbine module, nozzle, or blade thereof) comprises or includes “CMC” or “CMC material,” it is understood that the engine component may include one of, or combinations of one or more of the ceramic matrix composite materials described herein. Such engine component may also include non-ceramic matrix composite materials, such as a metal alloy (e.g., a CMC material for an airfoil and separate disk with dovetail slot made from a metal alloy). Reference to a “first” or “second” or “third” CMC material does not preclude the materials from including multiple CMC materials, different CMC materials, or the same CMC materials.

More specifically, CMC refers to a class of materials that includes a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3 Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration (“MI”) with silicon, or a cure or pyrolysis to yield a silicon carbide matrix in the preform, and subsequent chemical vapor infiltration (“CVI”) with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known methods or hereinafter developed including but not limited to melt infiltration, chemical vapor infiltration, polymer impregnation pyrolysis (PIP) and any combination thereof.

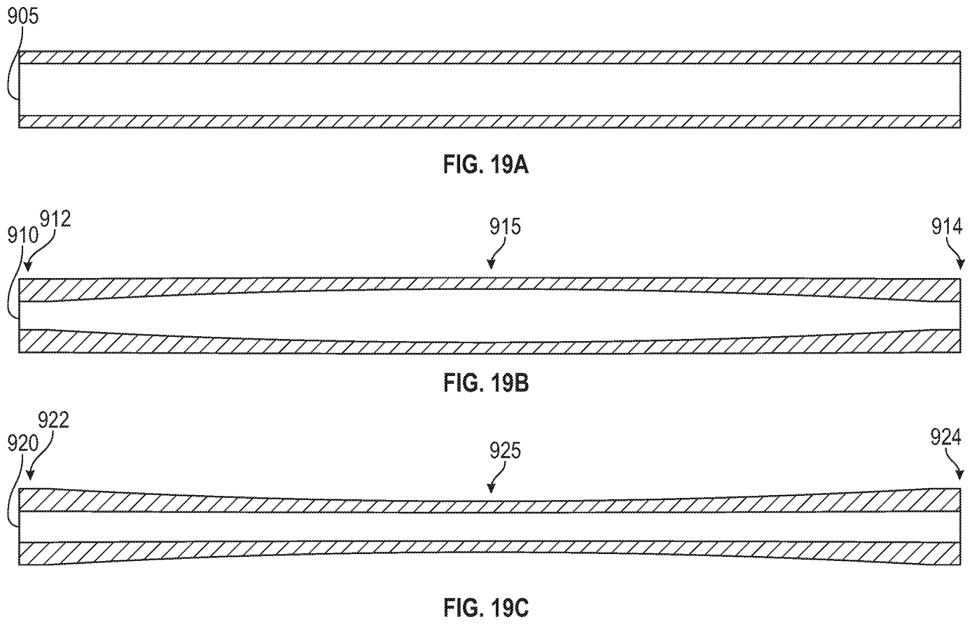

Such materials, along with certain monolithic ceramics (i.e., ceramic materials without a reinforcing material), are particularly suitable for higher temperature applications. Additionally, these ceramic materials are lightweight compared to metal alloys (e.g., superalloys), yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer. FIG. 19 compares properties of CVI type and MI type CMC materials to metal alloys.

The term “metallic” as used herein is indicative of a material that includes metal such as, but not limited to, titanium, iron, aluminum, stainless steel, and nickel alloys. A metallic material or an alloy can be a combination of at least two or more elements or materials, where at least one is a metal.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy. In some embodiments, the metal alloy detailed herein is chosen from iron-based alloys, titanium-based alloys, nickel-based alloys, cobalt-based alloys, and aluminum-based alloys. In some embodiments, the iron-based alloy is a steel. In some embodiments, the alloy includes at least one alloy chosen from high strength steel, titanium-based alloys, and nickel-based alloys. In some embodiments, the high strength steel, titanium-based alloys, and nickel-based alloys are chosen from Special Metals Corporation's Inconel® 600, Special Metals Corporation's Inconel® 722 and Special Metals Corporation's Inconel® 718, Special Metals Corporation's Nimonic®, Teledyne Allvac's Rene® 88DT, Teledyne Allvac's Rene® 104, Teledyne Allvac's Rene® 95, Teledyne Allvac's Rene® 100, Teledyne Allvac's Rene® 80, Teledyne Allvac's Rene® 77, Special Metals Corporation's Udimet® 500, Haynes International's Hastelloy X, and Haynes International's Haynes® 188. In some embodiments, the metal alloy is Rene® 65.

Here and throughout the specification and claims, range limitations are combined, and interchanged, such ranges are identified and include all the sub-ranges contained therein unless context or language indicates otherwise. For example, all ranges disclosed herein are inclusive of the endpoints, and the endpoints are independently combinable with each other. For example, the phrases “from X to Y” and “between X and Y” each refers to a range of values inclusive of the endpoints (i.e., refers to a range of values that includes both X and Y).

The term “cooled cooling air system” is used herein to mean a system configured to provide a cooling airflow to one or more components exposed to a working gas flowpath of a turbomachine of a gas turbine engine at a location downstream of a combustor of the turbomachine and upstream of an exhaust nozzle of the turbomachine, the cooling airflow being in thermal communication with a heat exchanger for reducing a temperature of the cooling airflow at a location upstream of the one or more components.

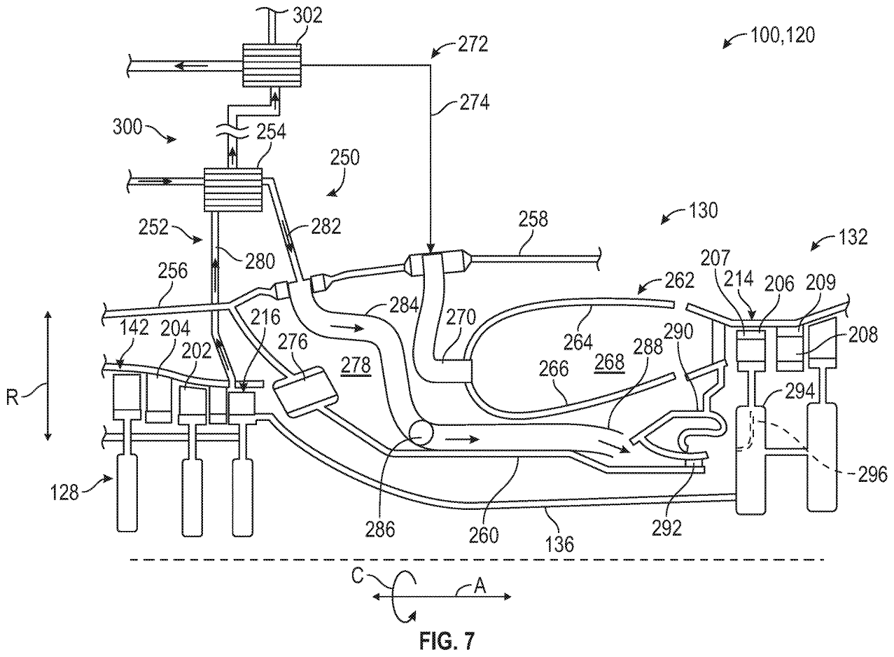

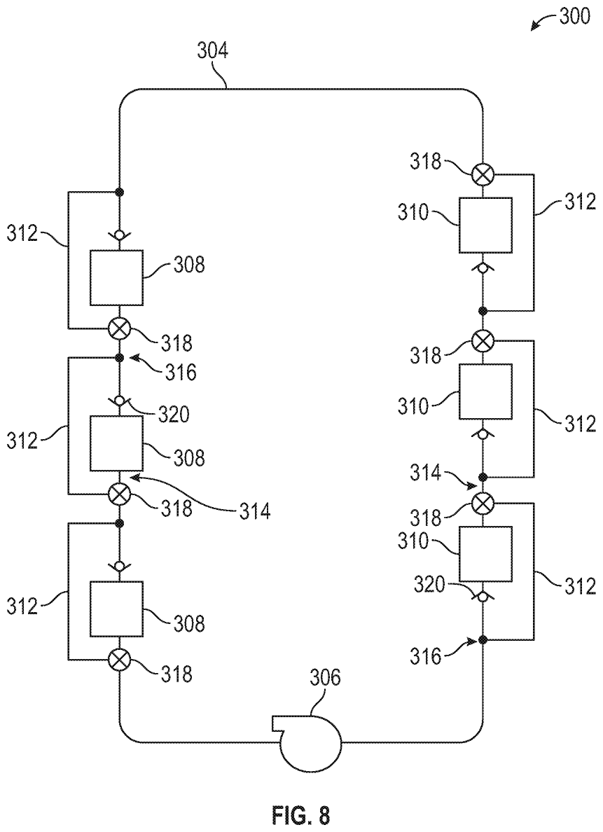

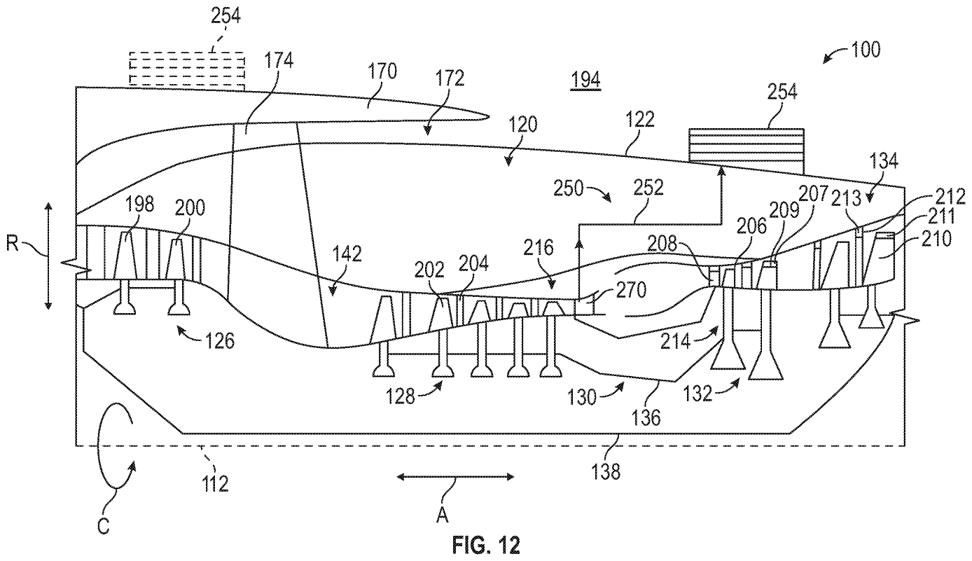

The cooled cooling air systems contemplated by the present disclosure may include a thermal bus cooled cooling air system (see, e.g., FIGS. 7 and 8) or a dedicated heat exchanger cooled cooling air system (i.e., a cooled cooling air system including a heat sink heat exchanger dedicated to the cooled cooling air system); a bypass heat exchanger cooled cooling air system having a heat sink heat exchanger thermally coupled to an airflow through a bypass passage (see, e.g., FIG. 12); an air-to-air cooled cooling air system (i.e., a cooled cooling air system having a heat sink heat exchanger configured to transfer heat to an airflow; see, e.g., FIG. 12); an oil-to-air cooled cooling air system (i.e., a cooled cooling air system having a heat sink heat exchanger configured to transfer heat to an oil flow); a fuel-to-air cooled cooling air system (i.e., a cooled cooling air system having a heat sink heat exchanger configured to transfer heat to a fuel flow, such as a Jet A fuel flow, a liquid hydrogen or hydrogen gas fuel flow, etc.; see, e.g., FIG. 7); or a combination thereof.

In one or more of the exemplary cooled cooling air systems described herein, the cooled cooling air system may receive the cooling air from a downstream end of a high-pressure compressor (i.e., a location closer to a last stage of the high-pressure compressor), an upstream end of the high-pressure compressor (i.e., a location closer to a first stage of the high-pressure compressor), a downstream end of a low-pressure compressor (i.e., a location closer to a last stage of the low-pressure compressor), an upstream end of the low-pressure compressor (i.e., a location closer to a first stage of the low-pressure compressor), a location between compressors, a bypass passage, a combination thereof, or any other suitable airflow source.

A “third stream” as used herein means a non-primary air stream capable of increasing fluid energy to produce a minority of total propulsion system thrust. A pressure ratio of the third stream may be higher than that of the primary propulsion stream (e.g., a bypass or a propeller driven propulsion stream). The thrust may be produced through a dedicated nozzle or through mixing of an airflow through the third stream with a primary propulsion stream or a core air stream, e.g., into a common nozzle.

In certain exemplary embodiments, an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments, these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or, more particularly, while operating at a rated takeoff power at sea level, static flight speed, 86 degrees Fahrenheit ambient temperature operating conditions.

Furthermore, in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “takeoff power level” refers to a power level of a gas turbine engine used during a takeoff operating mode of the gas turbine engine during a standard day operating condition.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate the engine, or to replace losses due to aerodynamic drag or gravity.

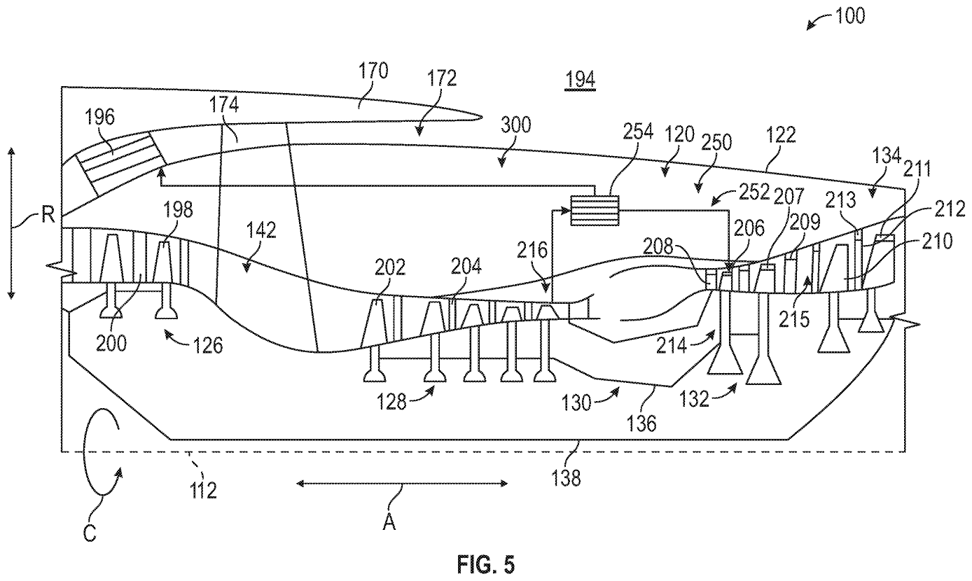

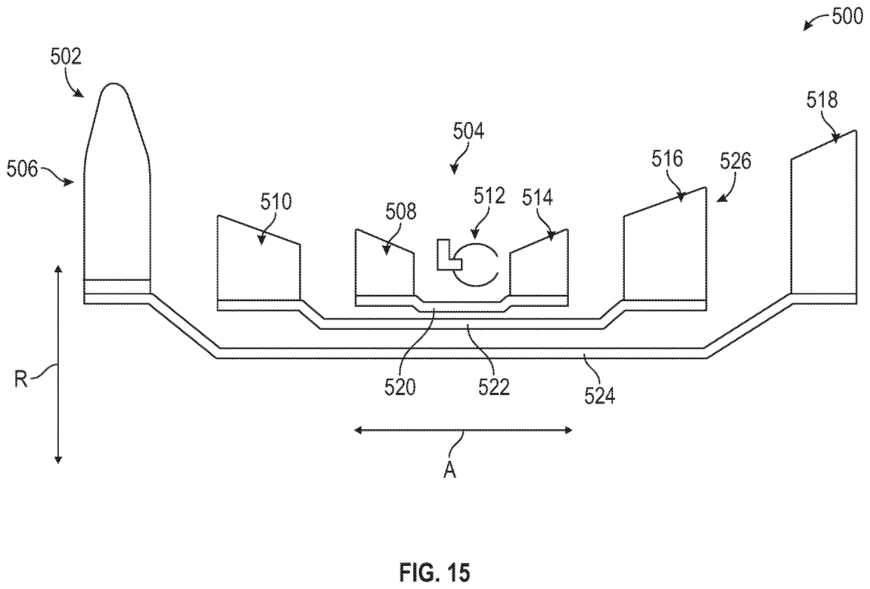

The term redline exhaust gas temperature (referred to herein as “redline EGT”) refers to a maximum permitted takeoff temperature documented in a Federal Aviation Administration (“FAA”)-type certificate data sheet. For example, in certain exemplary embodiments, the term redline EGT may refer to a maximum permitted takeoff temperature of an airflow after a first stage stator downstream of an HP turbine of an engine that the engine is rated to withstand. For example, with reference to the exemplary gas turbine engine 100 discussed below with reference to FIG. 5, the term redline EGT refers to a maximum permitted takeoff temperature of an airflow after the first HP turbine stator vane 208 downstream of the last stage of rotor blades 206 of the HP turbine 132 (at location 215 into the first of the plurality of LP turbine rotor blades 210). In embodiments wherein the engine is configured as a three-spool engine (as compared to the two-spool engine of FIG. 1; see FIG. 15), the term redline EGT refers to a maximum permitted takeoff temperature of an airflow after the first stator downstream of the last stage of rotor blades of the intermediate speed turbine (see the second turbine 516 of the gas turbine engine 500 of FIG. 15). The term redline EGT is sometimes also referred to as an indicated turbine exhaust gas temperature or indicated turbine temperature.

The term “propulsive system” refers generally to a thrust-producing system, which thrust is produced by a propulsor, and the propulsor provides the thrust using an electrically-powered motor(s), a heat engine such as a turbomachine, or a combination of electrical motor(s) and a turbomachine.

As used herein, the terms “axial” and “axially” refer to directions and orientations that extend substantially parallel to a longitudinal centerline axis of the gas turbine engine. Moreover, the terms “radial” and “radially” refer to directions and orientations that extend substantially perpendicular to the longitudinal centerline axis of the gas turbine engine. In addition, as used herein, the terms “circumferential” and “circumferentially” refer to directions and orientations that extend arcuately about the longitudinal centerline axis of the gas turbine engine.

As used herein, “maximum operating speed” is a minimum rotational speed of the shaft to achieve a maximum thrust of the gas turbine engine and is less than the redline speed for the gas turbine engine. In one embodiment, the maximum operating speed of the shaft is 1% to 5% less than the redline speed. For example, the redline speed of the shaft can be 10,000 RPM and the maximum operating speed is 9,500 RPM to achieve the maximum thrust (e.g., during takeoff of the aircraft). In some embodiments, the maximum operating speed of the shaft is 1.5% to 2% less than the redline speed.

As used herein, “critical speed” means a rotational speed of the shaft that is about the same as the fundamental, or natural frequency of a first order bending mode of the shaft (e.g., the shaft rotates at eighty Hz and the first-order modal frequency is eighty Hertz). When the shaft rotates at the critical speed, the shaft is expected to have a maximum amount of deflection, hence instability, due to excitation of the first order bending mode of the shaft. The critical speed may be expressed in terms of rotations per second in Hertz (Hz), rotations per minute (RPM), or as a linear velocity of the outer diameter of the shaft in terms of feet per second.

As used herein, “critical frequency” and “fundamental frequency” are referred to interchangeably and refer to the fundamental, or natural frequency, of the first order bending mode of a low-pressure or high-pressure shaft supported at their ends by bearings.

The term “subcritical speed” refers to a shaft redline speed that is less than the fundamental, or natural frequency of the first order bending mode of the shaft (e.g., the shaft rotates at a redline speed of 70 Hz while the first-order modal frequency is about 80 Hertz). When the rotational speed is subcritical the shaft is more stable than when rotating at a critical speed. A “subcritical shaft” is a shaft that has a redline speed below the critical speed of the shaft.

The term “supercritical speed” refers to a shaft rotational speed that is above the fundamental, or natural frequency of the first order bending mode of the shaft (e.g., the shaft rotates at eighty Hz while the first-order modal frequency is about seventy Hertz). A supercritical shaft is less stable than a subcritical shaft because the shaft speed can pass through the critical speed since its fundamental mode is below the redline speed. A “supercritical shaft” is a shaft that has a redline speed above the critical speed of the shaft.

The term “critical modal frequency” for a gearbox or F_{GBX} is a natural frequency of vibration for a gearbox assembly, characterized by modal properties (mode shape, strain energy in various supporting structural, etc.) producing lateral inertial bending or displacement reaction forces through a gearbox sun-gear—midshaft coupling when the gearbox assembly. The gearbox assembly can produce a significant dynamic response characterized by these modal properties when there is an external force applied with an excitation frequency at or near F_{GBX} through the sun gear-midshaft coupling (e.g. by motion of the midshaft) or when the gearbox assembly undergoes a periodic acceleration at or near F_{GBX}.

The term “casing” herein refers to the structure that defines an airflow path (e.g., wall of duct, or casing). A mounting to the casing may be a direct bolted connection or through a load bearing frame.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. With a gas turbine engine, and in particular with a high-bypass gas turbine engine, the gas turbine engine further defines a bypass ratio characterizing a ratio of a mass flowrate of airflow over the turbomachine to a mass flowrate of airflow through the working gas flowpath (more particularly defined above).

In order to provide high levels of thrust in a relatively efficient manner, certain gas turbine engines includes a relatively large fan. The inventors of the present disclosure sought out to design a gas turbine engine with a fan having an increased efficiency for a desired overall thrust output of the gas turbine engine.

Conventionally, fan blades are formed of a metal material, which generally provides for desirably thin and light fan blades. In some designs, the thickness of the fan blades drives a hub radius for the fan, which in turn affects an overall size of the fan, as a larger hub radius leads to a larger fan radius for a given thrust design point. While forming the fan blades out of metal is a cost-effective manufacturing method that is widely used, the inventors found that a size of the fan blades may be limited with such construction due to the mechanical properties of the metal being used.

In particular, the inventors found that by forming fan blades of the fan out of a composite material, a size of the fan blades could be increased (both in radial length and chord length), as the composite material provides improved strength characteristics over certain metal materials traditionally used for fan blade design. This increase in size, the inventors found, allowed for a reduced fan pressure ratio for a given thrust design point of the gas turbine engine. More specifically, by forming the fan blades out of the composite material, the inventors designed the fan to have a lower solidity and lower fan blade count for the given thrust design point of the gas turbine engine as a result of the increased size of the fan blades.

Conventional design has indicated against such a change in fan blade composition, as forming the fan blades out of composite materials generally results in thicker fan blades, which can be challenging at the hub. However, the inventors found that the lower solidity and lower fan blade count allowed for the fan designed by the inventors to unexpectedly have a lower hub radius (particularly at the leading edge of the fan blades), improving efficiency of the fan at the hub, and allowing for overall shorter fan blades as the fan blades can “start” at a closer radial distance to a centerline of the gas turbine engine.

Further, the inventors of the present disclosure found that by including a reduction gearbox, a rotational speed of the fan may be reduced, further reducing the fan pressure ratio of the fan. While slowing the fan blades down too much can result in a stall at the fan during certain operations, by increasing the size of the fan blades, as is allowed through use of the composite fan blades, the inventors found that the fan may still provide for the desired mass flowrate of airflow thereacross to provide the desired thrust output.

In particular, the inventors discovered, unexpectedly, in the course of designing a gas turbine engine having a fan with composite fan blades, that the costs associated with inclusion of a fan with composite fan blades can be overcome by the aeronautical efficiency benefits to the fan in at least certain designs, contrary to previous thinking and expectations. In particular, the inventors discovered during the course of designing several gas turbine engines having fans with composite fan blades of varying thrust classes and aeronautical efficiency requirements (including the configurations illustrated and described in detail herein), a relationship exists among a leading edge tip radius of a fan blade of the fan, a leading edge hub radius of the fan, a trailing edge tip radius of the fan blade of the fan, and a trailing edge hub radius of the fan, whereby including a fan with composite fan blades in accordance with one or more of the exemplary aspects described herein may result in a net benefit to the overall gas turbine engine design. Notably, the leading edge and trailing edge hub radii (for given leading edge and trailing edge tip radii) are driven by, and correlate to, a solidity and fan blade count of the fan, as lower leading edge and trailing edge hub radii (for given leading edge and trailing edge tip radii) require a fan with a lower solidity and a lower fan blade count.

As briefly noted above, previous thinking was to form fan blades out of metal which avoids the costly process of manufacturing components using composite materials. Manufacturing components out of composite materials is either very labor intensive or requires significant upfront automation design costs. The inventors unexpectedly found that by forming the fan blades out of a composite material, the updated designs of the fan that are enabled result in gas turbine engines with aeronautical efficiency improvements that outweighed the challenges associated with manufacturing the fan blades using composite materials.

In particular, with a goal of arriving at an improved gas turbine engine capable of providing an improved aeronautical efficiency, the inventors proceeded in the manner of designing gas turbine engines having a fan (with composite fan blades) with various leading edge tip radii, leading edge hub radii, trailing edge tip radii, and trailing edge hub radii; checking an operability and aeronautical efficiency characteristics of the designed gas turbine engines; redesigning the gas turbine engines to vary the noted parameters based on the impact on other aspects of the gas turbine engines; rechecking the operability and aeronautical efficiency characteristics of the redesigned gas turbine engines; etc. during the design of several different types of fans with composite fan blades, including the fans with composite fan blades described herein, which are described below in greater detail.

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline axis 12 provided for reference), a radial direction R, and a circumferential direction C extending about the longitudinal centerline axis 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low-pressure (LP) compressor 22 and a high-pressure (HP) compressor 24; a combustion section 26; a turbine section including a high-pressure (HP) turbine 28 and a low-pressure (LP) turbine 30; and a jet exhaust nozzle section 32. A high-pressure (HP) shaft 34 (which may additionally or alternatively be a spool) drivingly connects the HP turbine 28 to the HP compressor 24. A low-pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a gearbox assembly, also referred to as a power gear box 46, and the fan blades 40, disk 42, and pitch change mechanism 44 are together rotatable about the longitudinal centerline axis 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have other configurations. For example, although the gas turbine engine 10 depicted is configured as a ducted gas turbine engine (i.e., including the outer nacelle 50, also referred to herein as a turbofan engine), in other embodiments, the gas turbine engine 10 may be an unducted gas turbine engine (such that the fan 38 is an unducted fan, and the outlet guide vanes 52 are cantilevered from the outer casing 18; see, e.g., FIG. 4; also referred to herein as an open rotor engine). Additionally, or alternatively, although the gas turbine engine 10 depicted is configured as a variable pitch gas turbine engine (i.e., including a fan 38 configured as a variable pitch fan), in other embodiments, the gas turbine engine 10 may alternatively be configured as a fixed pitch gas turbine engine (such that the fan 38 includes fan blades 40 that are not rotatable about a pitch axis P).

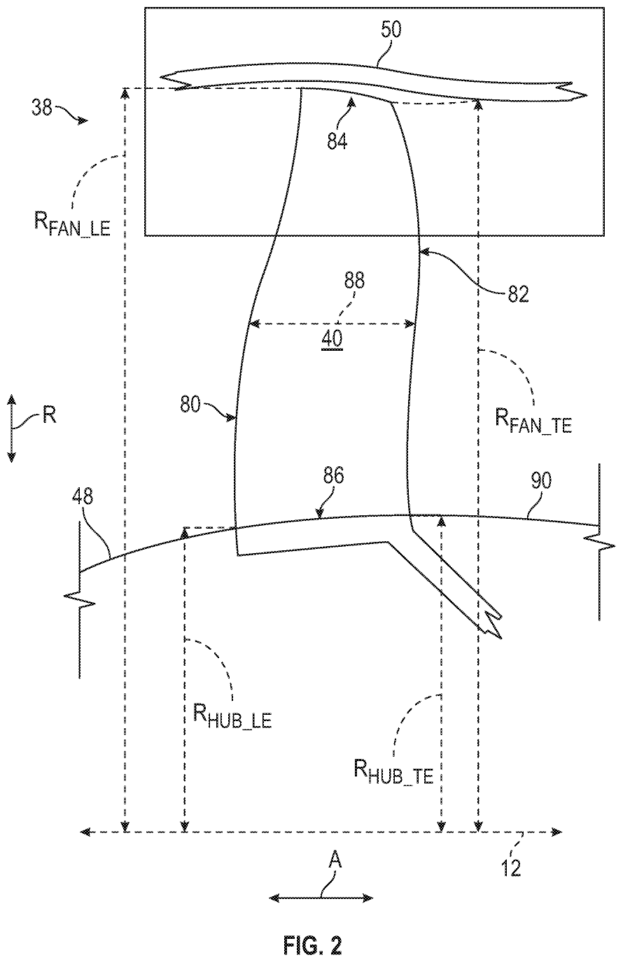

Referring now to FIG. 2, a close-up view is provided of the fan 38 of the gas turbine engine 10 of FIG. 1, and in particular of a fan blade 40 of the fan 38 of the gas turbine engine 10 of FIG. 1. The fan blade 40 generally defines a leading edge 80, a trailing edge 82, an outer tip 84 along the radial direction R, a base 86 along the radial direction R, and a chord 88 from the leading edge 80 to the trailing edge 82.

Further, it will be appreciated that the fan 38 defines a leading edge (LE) fan radius R_{Fan_LE} of the fan blade 40, a trailing edge (T_{E}) fan radius R_{Fan_TE} of the fan blade 40, a leading edge hub radius R_{Hub_LE} of the fan 38, and a trailing edge hub radius R_{Hub_TE} of the fan 38. The leading edge fan radius R_{Fan_LE} of the fan blade 40 is a measure along the radial direction R from the longitudinal centerline axis 12 of the gas turbine engine 10 to the outer tip 84 of the fan blade 40 at the leading edge 80. The trailing edge fan radius R_{Fan_TE} of the fan blade 40 is a measure along the radial direction R from the longitudinal centerline axis 12 of the gas turbine engine 10 to the outer tip 84 of the fan blade 40 at the trailing edge 82. The leading edge hub radius R_{Hub_LE} of the fan 38 is a measure along the radial direction R from the longitudinal centerline axis 12 of the gas turbine engine 10 to the base 86 of the fan blade 40 at the leading edge 80 (where the leading edge 80 meets the spinner/front hub 48). The trailing edge hub radius R_{Hub_TE} of the fan 38 is a measure along the radial direction R from the longitudinal centerline axis 12 of the gas turbine engine 10 to the base 86 of the fan blade 40 at the trailing edge 82 (where the trailing edge 82 meets a casing 90 defining in part an airflow path to receive airflow from the fan 38).

Further, it will be appreciated that the fan blade 40 (and each of the fan blades 40 of the fan 38) are formed of a composite material. It will be appreciated that as used herein, the phrase “formed of a composite material,” with reference to the fan blades 40, refers to at least 80% by weight of the fan blades 40, between the base 86 and the outer tip 84, being formed of one or more composite materials.

As alluded to earlier, the inventors discovered, unexpectedly during the course of designing gas turbine engines having a fan with composite fan blades—i.e., designing gas turbine engines having a fan (with composite fan blades) with various leading edge tip radii, leading edge hub radii, trailing edge tip radii, and trailing edge hub radii, and evaluating an overall engine and aeronautical efficiency performance—a significant relationship between the leading edge tip radii, leading edge hub radii, trailing edge tip radii, and trailing edge hub radii. The relationship can be thought of as an indicator of the ability of a gas turbine engine having a fan with composite fan blades to be able to provide a desired aeronautical efficiency for a given level of desired thrust output for the gas turbine engine. As will be appreciated, and as discussed above, the leading edge and trailing edge hub radii (for given leading edge and trailing edge tip radii) are driven by, and correlate to, a solidity and fan blade count of the fan, enabled by the formation of the fan blades out of composite materials, as lower leading edge and trailing edge hub radii (for given leading edge and trailing edge tip radii) require a fan with a lower solidity and a lower fan blade count.

The relationship applies to a gas turbine engine having a reduction gearbox to reduce a rotational speed of the fan relative to a driving turbine of a turbomachine of the gas turbine engine, a fan having fan blades formed of a composite material, and a high bypass ratio (i.e., a bypass ratio greater than or equal to 10). The relationship ties together a leading edge tip radius of a fan blade of the fan, a leading edge hub radius of the fan, a trailing edge tip radius of the fan blade of the fan, and a trailing edge hub radius of the fan, as described in more detail herein.

In particular, the inventors discovered that when designing a gas turbine engine, inclusion of a fan having fan blades with a large leading edge tip radius, the fan pressure ratio and rotational speed of the fan may be decreased, resulting generally in more efficiency. However, to avoid stall and generate a desired thrust output, a chord of the fan blades needs to be increased to ensure a sufficient airflow is provided through the fan. As the chord of the fan blade increases, the trailing edge tip radius of the fan blades may also increase to achieve a desired fan pressure ratio. Notably, however, the inventors found that increasing the leading edge tip radius too much resulted in increased weight and drag, offsetting the aerodynamic benefits otherwise achieved.

Further, with the chords of the fan blades increasing, the inventors of the present disclosure found that the solidity and fan blade count of the fan may be reduced, which may in turn result in lower leading edge and trailing edge hub radii (despite an increase in individual fan blade thickness as a result of forming the fan blades with composite materials). However, the inventors of the present disclosure found that the trailing edge hub radii could not be reduced too much without negatively affecting aerodynamics of an airflow into an inlet to the turbomachine, and the leading edge hub radii could not deviate too much from the trailing edge hub radii without negatively affecting a fan pressure ratio of the fan.

The relationship discovered, infra, can therefore identify a gas turbine engine having a fan having fan blades formed of a composite material, a reduction gearbox, and a high bypass ratio capable of achieving a desired aeronautical efficiency, while avoiding a prohibitive drag and weight increases, aerodynamic penalties, or combinations thereof and suited for particular mission requirements, one that takes into account efficiency, weight, structural needs for the fan blades, complexity, reliability, and other factors influencing the optimal choice for a gas turbine engine having a fan having fan blades formed of a composite material, a reduction gearbox, and a high bypass ratio.

In addition to yielding an improved gas turbine engine as noted above, utilizing this relationship, the inventors found that the number of suitable or feasible gas turbine engine designs capable of meeting the above design requirements could be greatly diminished, which facilitates a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

One such relationship providing for improved gas turbine engines, discovered by the inventors, is a Fan Leading Edge to Trailing Edge Compression Factor (FLTCF), expressed as:

$$FLTCF = \frac{{R}_{Fan\_LE} \times {R}_{Hub\_TE}}{{R}_{Fan\_TE} \times {R}_{Hub\_LE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

Another such relationship providing for the improved gas turbine engines, discovered by the inventors, is a Fan Leading Edge to Trailing Edge Opening Ratio (FLTOR), expressed as:

$$FLTOR = \frac{{R}_{Fan\_LE} - {R}_{Hub\_LE}}{{R}_{Fan\_TE} - {R}_{Hub\_TE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

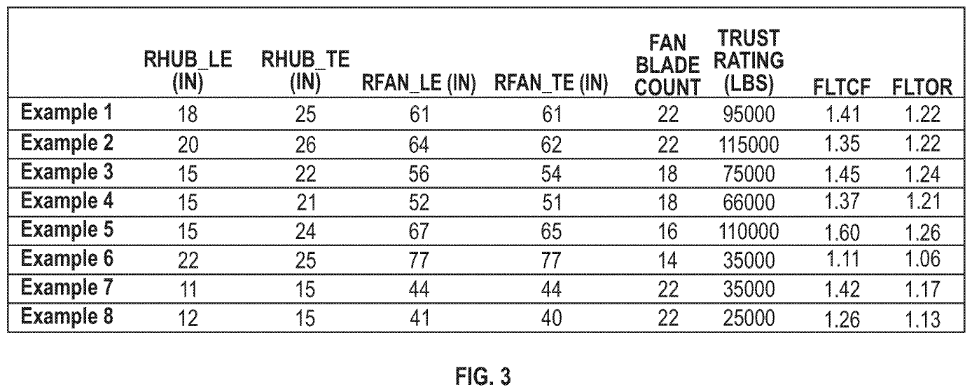

Example engines in accordance with one or more exemplary embodiments of the present disclosure are provided in the table of FIG. 3. The FLTCF is valid only when it is greater than or equal to 1.05 and less than or equal to 1.8. For example, in certain exemplary embodiments, the FLTCF is greater than or equal to 1.07 and less than or equal to 1.65. Further, the FLTOR is valid only when it is greater than or equal to 1.03 and less than or equal to 1.5. For example, in certain exemplary embodiments, the FLTOR is greater than or equal to 1.05 and less than or equal to 1.3.

Notably, each of gas turbine engines noted in FIG. 3 defines a bypass ratio greater than or equal to 10 and less than or equal to 30, such as greater than or equal to 13 and less than or equal to 25. Further, each of the gas turbine engines noted in FIG. 3 includes a reduction gearbox (and thus may be referred to as a geared gas turbine engine) defining a gear ratio greater than or equal to 2 and less than or equal to 14.

For example, in one exemplary embodiment, the gas turbine engine may be an unducted gas turbine engine (also referred to as an “open rotor engine”) including an unducted fan having fan blades formed of a composite material (see, e.g., the embodiment of FIG. 4, described below). In such an exemplary embodiment, a leading edge fan radius R_{Fan_LE} of a fan blade of the fan is greater than or equal to 65 inches and less than or equal to 85 inches, the fan defines a fan blade count greater than or equal to 5 and less than or equal to 15, a reduction gearbox defines a gear ratio greater than 4 and less than 12, and a thrust rating for the engine is between 20,000 pounds and 45,000 pounds. With such an exemplary embodiment the FLTCF is greater than or equal to 1.07 and less than or equal to 1.25, and the FLTOR is greater than or equal to 1.03 and less than or equal to 1.12. In such a manner, it will be appreciated that forming the fan blades of a composite material with this exemplary gas turbine engine enabled a size of the fan (both radially and in a chordwise direction) to be increased, allowing for a desired thrust output, despite a reduction in the fan blade count of the fan and solidity of the fan blades. Example 6 in FIG. 3 is an exemplary embodiment of such a gas turbine engine.

Further for example, in another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 35 inches and less than or equal to 50 inches, the fan defines a fan blade count greater than or equal to 12 and less than or equal to 23, a reduction gearbox defines a gear ratio greater than 2 and less than 4, and a thrust rating for the engine is between 20,000 pounds and 45,000 pounds. With such an exemplary embodiment the FLTCF is greater than or equal to 1.12 and less than or equal to 1.35, and the FLTOR is greater than or equal to 1.06 and less than or equal to 1.19. In such a manner, it will be appreciated that forming the fan blades of a composite material with this exemplary gas turbine engine enabled a size of the fan (e.g., in a chordwise direction) to be increased, allowing for a desired thrust output, despite a potential reduction in the fan blade count of the fan and solidity of the fan blades. Example 8 in FIG. 3 is an exemplary embodiment of such a gas turbine engine.

For example, in yet another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 51 inches and less than or equal to 66 inches, the fan defines a fan blade count greater than or equal to 17 and less than or equal to 23, a reduction gearbox defines a gear ratio greater than 1 and less than 4, and a thrust rating for the engine is between 60,000 pounds and 118,000 pounds. With such an exemplary embodiment the FLTCF is greater than or equal to 1.27 and less than or equal to 1.5, and the FLTOR is greater than or equal to 1.18 and less than or equal to 1.25. In such a manner, it will be appreciated that forming the fan blades of a composite material with this exemplary gas turbine engine enabled a size of the fan (e.g., in a radial direction and in a chordwise direction) to be increased, allowing for a desired thrust output, despite a potential reduction in the fan blade count of the fan and solidity of the fan blades. Examples 1 through 4 in FIG. 3 are exemplary embodiments of such a gas turbine engine.

Further for example, in still another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 55 inches and less than or equal to 70 inches, the fan defines a fan blade count greater than or equal to 12 and less than or equal to 22 (e.g., less than or equal to 19), a reduction gearbox defines a gear ratio greater than 1 and less than 4, and a thrust rating for the engine is between 100,000 pounds and 150,000 pounds (such as greater than 118,000 pounds and less than 150,000 pounds). With such an exemplary embodiment the FLTCF is greater than or equal to 1.46 and less than or equal to 1.65, and the FLTOR is greater than or equal to 1.2 and less than or equal to 1.5 (such as greater than or equal to 1.25 and less than 1.5). In such a manner, it will be appreciated that forming the fan blades of a composite material have enabled a size of the fan (e.g., in a radial direction and in a chordwise direction) to be increased, allowing for a desired thrust output, despite a potential reduction in the fan blade count of the fan and solidity of the fan blades. Example 5 in FIG. 3 is an exemplary embodiments of such a gas turbine engine.

Referring now to FIG. 4, a schematic cross-sectional view of a gas turbine engine 100 is provided according to another example embodiment of the present disclosure. The exemplary gas turbine engine 100 of FIG. 4 may be configured in substantially the same manner as the exemplary gas turbine engine 100 described above with reference to FIGS. 1 and 2.

For example, the exemplary gas turbine engine 100 defines an axial direction A, a radial direction R, and a circumferential direction C. Moreover, the gas turbine engine 100 defines an axial centerline or longitudinal centerline axis 112 that extends along the axial direction A. In general, the axial direction A extends parallel to the longitudinal centerline axis 112, the radial direction R extends outward from and inward to the longitudinal centerline axis 112 in a direction orthogonal to the axial direction A, and the circumferential direction extends three hundred sixty degrees (360°) around the longitudinal centerline axis 112. The gas turbine engine 100 extends between a forward end 114 and an aft end 116, e.g., along the axial direction A.

Further, the exemplary gas turbine engine 100 generally includes a fan section 150 and a turbomachine 120. Generally, the turbomachine 120 includes, in serial flow order, a compressor section, a combustion section, a turbine section, and an exhaust section. Particularly, as shown in FIG. 4, the turbomachine 120 includes a core cowl 122 that defines a core inlet 124 that is annular. The core cowl 122 further encloses at least in part a low-pressure system and a high-pressure system. For example, the core cowl 122 depicted encloses and supports at least in part a booster or low-pressure (“LP”) compressor 126; a high-pressure (“HP”) compressor 128; a combustion section 130; a high-pressure turbine 132; and a low-pressure turbine 134. The high-pressure turbine 132 drives the high-pressure compressor 128 through a high-pressure shaft 136. The low-pressure turbine 134 drives the low-pressure compressor 126 and components of the fan section 150 through a low-pressure shaft 138, and as such may be referred to as a drive turbine. After driving each of the turbines 132, 134, combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. By contrast to the embodiment of FIG. 1, for the depicted embodiment of FIG. 4, the fan 152 is an open rotor or unducted fan. In such a manner, the gas turbine engine 100 may be referred to as an open rotor engine.

As depicted, the fan 152 includes an array of fan blades 154 (only one shown in FIG. 4). The fan blades 154 are rotatable, e.g., about the longitudinal centerline axis 112. As noted above, the fan 152 is drivingly coupled with the low-pressure turbine 134 via the LP shaft 138. As with the exemplary embodiments discussed above, the fan blades 154 are formed of a composite material.

Further for the embodiments shown in FIG. 4, the fan 152 is coupled with the LP shaft 138 via a speed reduction gearbox, also referred to as a gearbox assembly 155, e.g., in an indirect-drive or geared-drive configuration.

Moreover, the array of fan blades 154 can be arranged in equal spacing around the longitudinal centerline axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal centerline axis 112. For this embodiment, the fan guide vanes 162 are not rotatable about the longitudinal centerline axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170. Notably, the gas turbine engine 100 defines a bypass passage 194 over the fan cowl 170 and core cowl 122.

In some embodiments, the fan guide vanes 162 are composite fan guide vanes that each include a composite portion. The composite portion can encompass a portion a respective fan guide vanes 162 or can encompass an entirety of the respective fan guide vane 162. The composite portion can be made of one or more layers of material. The one or more layers of material can be applied during the same stage or different stages of the manufacturing of the composite fan blades. By way of non-limiting example, the composite portion can include at least a polymer matrix composite (PMC) portion or a polymeric portion. The polymer matrix composite can include, but is not limited to, a matrix of thermoset (epoxies, phenolics) or thermoplastic (polycarbonate, polyvinylchloride, nylon, acrylics) and embedded glass, carbon, steel, or Kevlar fibers. In some embodiments, the composite portion can include a ceramic matrix composite (CMC) portion.

By contrast to the embodiment of FIG. 1, as shown in FIG. 4, in addition to the fan 152 that is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal centerline axis 112) as the fan blade 154. The ducted fan 184 is, for the embodiment depicted, driven by the low-pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal spacing around the longitudinal centerline axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the gas turbine engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 4). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The gas turbine engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

As will be appreciated from the description herein, various other embodiments of a gas turbine engine are provided. Certain of these embodiments may be an unducted, single rotor gas turbine engine, or a ducted gas turbine engine. Various additional aspects of one or more of these embodiments are discussed below. These exemplary aspects may be combined with one or more of the exemplary gas turbine engine(s) discussed above with respect to the figures.

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 pounds per square inch absolute (psia) and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics and provide the benefits noted herein associated with forming the fan blades from a composite material, a gear assembly may be provided to reduce a rotational speed of the fan assembly relative to a driving shaft (such as a low-pressure shaft coupled to a low-pressure turbine). In some embodiments, a gear ratio of the input rotational speed to the output rotational speed is greater than or equal to 2. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low-pressure compressor may include 1 to 8 stages, a high-pressure compressor may include 8 to 15 stages, a high-pressure turbine may include 1 to 2 stages, and/or a low-pressure turbine (LPT) may include 3 to 7 stages. In particular, the LPT may have 4 stages, or between 4 and 7 stages. For example, in certain embodiments, an engine may include a one stage low-pressure compressor, an 11 stage high-pressure compressor, a two stage high-pressure turbine, and 4 stages, or between 4 and 7 stages for the LPT. As another example, an engine can include a three stage low-pressure compressor, a 10 stage high-pressure compressor, a two stage high-pressure turbine, and a 7 stage low-pressure turbine.

Moreover, it will be appreciated that in addition to a gas turbine engine that integrates composite fan blades in a fan of a high-bypass gas turbine engine, leveraging the increased strength to weight ratio of composite materials to facilitate an increase in a diameter of the fan blades of the gas turbine engine, which, e.g., can further facilitate a reduction in a fan pressure ratio of the fan to improve overall engine efficiency, the engine core properties can be matched correspondingly by adopting the relationship defined by a corrected specific thrust (“CST”).

Referring to the description hereinabove, as will be appreciated, with the lower fan pressure ratio comes an increase in propulsion efficiency. When such a fan configuration is combined with a gas turbine engine in accordance with the description hereinabove, e.g., a gas turbine engine having a high total sea level static thrust output and redline exhaust gas temperature for a given high-pressure compressor exit area, a compounded improvement in gas turbine engine efficiency is realized.

In particular, in the description hereinabove, the emphasis was on fan design parameters, particularly how changes in, e.g., fan blade radius and hub radius (embodied in the FLTCF and FLTOR relationships) improve thrust, aerodynamic efficiency, fan compression and aero-mechanics generally. Engines satisfying CST (e.g., cooled cooling air, advanced cooling circuits, heat exchanger arrangements, advanced materials, etc.) as provided in the examples herein, the engine can simultaneously benefit from increased CST while also capable of operating at reduced fan pressure ratios for a high bypass ratios. This pairing allows the engine architecture to take advantage of lower fan rotor speeds-thereby supporting the lower solidity fan designs-without surpassing material temperature limits in a hot section of the engine.

Moreover, it will be appreciated that incorporating one or more of these advanced technologies permits more aggressive high-pressure compressor configurations, complementing the larger-diameter fan or fewer blades described hereinabove. In other words, once the core can handle higher compression ratios because the hot-section components are capable of handling the higher EGT.

Conventional scaling methodologies for direct-drive gas turbine engines i.e., engines lacking a reduction gearbox between a drive turbine and an associated fan-do not adequately account for the decoupling of rotational speeds between the fan and the drive turbine (e.g., a low-pressure turbine (LPT)) introduced by a reduction gearbox. Such methodologies further fail to fully consider operation at relatively low fan pressure ratios (FPR), for example, FPR values below approximately 1.4. If the engine core that generates energy to drive the fan is improperly matched to both the reduction gearbox and the reduced FPR, suboptimal turbine sizing can result. Specifically, a high-pressure turbine (HPT) and/or the LPT may be undersized, such that available energy capacity and extraction are insufficient to drive the fan under peak demand conditions, or oversized, thereby incurring unnecessary weight, drag, and efficiency penalties. Moreover, the combination of increased bypass ratios and fan compression associated with fans incorporating the advantages of FLTCF or FLTOR, when further combined with CST, defines a design space that uniquely identifies an improved power density in gas turbine engines operating at lower fan pressure ratios.

Additionally, the description below regarding alternative spool and turbine arrangements—e.g., bearing placements, variable thickness shaft sections, and advanced materials—enhances the benefits of reduced fan speed from the above approach. Reduced spool vibrations, higher safe rotational speeds, and improved heat-transfer capacity all contribute to allowing for broad fan geometries and relationships described hereinabove, without creating unreasonable structural or thermal tradeoffs.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. A relatively small amount of thrust may also be generated by an airflow exiting the working gas flowpath of the turbomachine through the exhaust section. In addition, certain gas turbine engines may further include a third stream that contributes to a total thrust output of the gas turbine engine, potentially allowing for a reduction in size of a core of the turbomachine for a given total gas turbine engine thrust output.

Conventional gas turbine engine design practice has limited a compressor pressure ratio based at least in part on the gas temperatures at the exit stage of a high-pressure compressor. These relatively high temperatures at the exit of the high-pressure compressor may also be avoided when they result in prohibitively high temperatures at an inlet to the turbine section, as well as when they result in prohibitively high exhaust gas temperatures through the exhaust section. For a desired gas turbine engine thrust output produced from an increased pressure ratio across the high-pressure compressor, there is an increase in the gas temperature at the compressor exit, at a combustor inlet, at the turbine section inlet, and through an exhaust section of the gas turbine engine.

There are generally three approaches to making a gas turbine engine capable of operating at higher temperatures while providing a net benefit to engine performance: reducing the temperature of a gas used to cool core components, utilizing materials capable of withstanding higher operating temperature conditions, or a combination thereof.

Referring to the case of an engine that utilizes cooled cooling air for operating at higher temperatures, the costs associated with achieving a higher compression by reducing gas temperatures used to cool core components to accommodate higher core gas temperatures may indeed produce a net benefit, contrary to prior expectations in the art. The present disclosure provides for several engine architectures of varying thrust classes and mission requirements (including the engines illustrated and described in detail herein) and a relationship exists among the exhaust gas passing through the exhaust section, the desired maximum thrust for the engine, and the size of the exit stage of the high-pressure compressor, whereby including this technology produces a net benefit. Previously, it was thought that the cost for including a technology to reduce the temperature of gas intended for cooling compressor and turbine components was too prohibitive, as compared to the benefits of increasing the core temperatures.

For example, the present disclosure found that a cooled cooling air system may be included while maintaining or even increasing the maximum gas turbine engine thrust output, based on this discovery. The cooled cooling air system may receive an airflow from the compressor section, reduce a temperature of the airflow using a heat exchanger, and provide the cooled airflow to one or more components of the turbine section, such as a first stage of high-pressure turbine rotor blades. In such a manner, a first stage of high-pressure turbine rotor blades may be capable of withstanding increased temperatures by using the cooled cooling air, while providing a net benefit to the gas turbine engine, i.e., while taking into consideration the costs associated with accommodations made for the system used to cool the cooling air.

The present disclosure provides for evaluating potentially negative impacts to engine performance brought on by introduction of a cooled cooling air system. For example, a cooled cooling air system may generally include a duct extending through a diffusion cavity between a compressor exit and a combustor within the combustion section, such that increasing the cooling capacity may concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system may be positioned in a bypass passage of the gas turbine engine, which may create an aerodynamic drag or may increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

With a goal of arriving at an improved gas turbine engine capable of operating at higher temperatures at the compressor exit and turbine inlet, the present disclosure provides for gas turbine engines having an overall pressure ratio, total thrust output, redline exhaust gas temperature, and the supporting technology characteristics, checking the propulsive efficiency and qualitative gas turbine engine characteristics of the designed gas turbine engine, redesigning the gas turbine engine to have higher or lower compression ratios based on the impact on other aspects of the architecture, total thrust output, redline exhaust gas temperature, and supporting technology characteristics, rechecking the propulsive efficiency and qualitative gas turbine engine characteristics of the redesigned gas turbine engine, etc., during the design of several different types of gas turbine engines, including the gas turbine engines described below with reference to FIGS. 5 and 8 through 12 through 15, which will now be discussed in greater detail.

One or more components of the engine described herein below may be manufactured or formed using any suitable process, such as an additive manufacturing process, such as a three-dimensional (3D) printing process. The use of such a process may allow such a component to be formed integrally, as a single monolithic component, or as any suitable number of sub-components. In particular, the additive manufacturing process may allow such a component to be integrally formed and include a variety of features not possible when using prior manufacturing methods. For example, the additive manufacturing methods described herein enable the manufacture of shafts having unique features, configurations, thicknesses, materials, densities, passageways, headers, and mounting structures that may not have been possible or practical using prior manufacturing methods. Some of these features are described herein.

Referring again to FIG. 4, notably, for the embodiment depicted, the gas turbine engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the gas turbine engine 100 further includes an array of inlet guide vanes 186 positioned in the inlet duct 180 upstream of the ducted fan 184 and downstream of the engine inlet 182. The array of inlet guide vanes 186 are arranged around the longitudinal centerline axis 112. For this embodiment, the inlet guide vanes 186 are not rotatable about the longitudinal centerline axis 112. Each inlet guide vane 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vane 186 may be fixed or unable to be pitched about its central blade axis.

Further, located downstream of the ducted fan 184 and upstream of the fan duct inlet 176, the gas turbine engine 100 includes an array of outlet guide vanes 190. As with the array of inlet guide vanes 186, the array of outlet guide vanes 190 are not rotatable about the longitudinal centerline axis 112. However, for the embodiment depicted, unlike the array of inlet guide vanes 186, the array of outlet guide vanes 190 are configured as fixed-pitch outlet guide vanes.

Further, for the embodiment depicted, the fan exhaust nozzle 178 of the fan duct 172 is further configured as a variable geometry exhaust nozzle. In such a manner, the gas turbine engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal centerline axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the gas turbine engine 100 may be capable of generating more efficient third stream thrust, Fn_{3S}, across a relatively wide array of engine operating conditions, including takeoff and climb as well as cruise.

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 196 may be positioned in thermal communication with the fan duct 172. For example, one or more heat exchangers 196 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 196 may be an annular heat exchanger extending substantially 360 degrees in the fan duct 172 (e.g., at least 300 degrees, such as at least 330 degrees). In such a manner, the heat exchanger 196 may effectively utilize the air passing through the fan duct 172 to cool one or more systems of the gas turbine engine 100 (e.g., a cooled cooling air system (described below), lubrication oil systems, compressor bleed air, electrical components, etc.). The heat exchanger 196 uses the air passing through the fan duct 172 as a heat sink and correspondingly increases the temperature of the air downstream of the heat exchanger 196 and exiting the fan exhaust nozzle 178.

As will be appreciated, the gas turbine engine 100 defines a total sea level static thrust output Fn_{Total}, corrected to standard day conditions, which is generally equal to a maximum total engine thrust. As used herein, “sea level static thrust corrected to standard day conditions” refers to an amount of thrust an engine is capable of producing while at rest relative to the earth and the surrounding air during standard day operating conditions.

The total sea level static thrust output Fn_{Total} may generally be equal to a sum of: a fan stream thrust Fn_{Fan} (i.e., an amount of thrust generated by the fan 152 through the bypass passage 194), the third stream thrust Fn_{3S} (i.e., an amount of thrust generated through the fan duct 172), and a turbomachine thrust Fn_{TM} (i.e., an amount of thrust generated by an airflow through the turbomachine exhaust nozzle 140), each during the static, sea level, standard day conditions. The gas turbine engine 100 may define a total sea level static thrust output Fn_{Total} greater than or equal to fifteen thousand pounds (15,000 pounds). For example, it will be appreciated that the gas turbine engine 100 may be configured to generate at least twenty-five thousand pounds (25,000 pounds) and less than eighty thousand pounds (80,000 pounds), such as between twenty-five thousand pounds and fifty thousand pounds (25,000 pounds and 50,000 pounds), such as between thirty-five thousand pounds and forty-five thousand pounds (35,000 pounds and 45,000 pounds) of thrust during a takeoff operating power, corrected to standard day sea level conditions.

As will be appreciated, the gas turbine engine 100 defines a redline exhaust gas temperature (referred to herein as “EGT”), which is defined above, and for the embodiment of FIG. 4 refers to a maximum permitted takeoff temperature of an airflow after the first HP turbine stator vane 208 downstream of the last stage of rotor blades 206 of the HP turbine 132 (at location 215 into the first of the plurality of LP turbine rotor blades 210. See FIG. 5).

FIG. 5 is a close-up, simplified, schematic view of a portion of the gas turbine engine 100 of FIG. 4. The gas turbine engine 100, as noted above includes the turbomachine 120 having the LP compressor 126, the HP compressor 128, the combustion section 130, the HP turbine 132, and the LP turbine 134. The LP compressor 126 includes a plurality of stages of LP compressor rotor blades 198 and a plurality of stages of LP compressor stator vanes 200 alternatingly spaced with the plurality of stages of LP compressor rotor blades 198. Similarly, the HP compressor 128 includes a plurality of stages of HP compressor rotor blades 202 and a plurality of stages of HP compressor stator vanes 204 alternatingly spaced with the plurality of stages of HP compressor rotor blades 202. Moreover, within the turbine section, the HP turbine 132 includes at least one stage of HP turbine rotor blades 206 and at least one stage of HP turbine stator vanes 208, and the LP turbine 134 includes a plurality of stages of LP turbine rotor blades 210 and a plurality of stages of LP turbine stator vanes 212 alternatingly spaced with the plurality of stages of LP turbine rotor blades 210. With reference to the HP turbine 132, the HP turbine 132 includes at least a first stage 214 of HP turbine rotor blades 206.

Each of the HP turbine rotor blades 206 includes a shroud 207 integral with the HP turbine rotor blades 206. The shroud 207 is positioned on at least one of the outer end or the inner end of the HP turbine rotor blades 206. The shroud 207 acts as a barrier, preventing air from bypass the HP turbine rotor blades 206 at the tips, as well as help to provide a secure connection between adjacent HP turbine rotor blades 206 to help maintain structural integrity of the stage of HP turbine rotor blades 206 and reduce vibration during operation.

Each of the HP turbine stator vanes 208 includes a shroud 209 integral with the HP turbine stator vane 208. The shroud 209 is positioned on at least one of the outer end or the inner end of the HP turbine stator vane 208. The shroud 209 can include hooks that hook into respective openings in the outer casing or the inner casing of the HP turbine 132 such that the outer casing or the inner casing support the HP turbine stator vanes 208. The shroud 209 acts as a barrier, preventing air from bypass the HP turbine stator vanes 208 at the tips or at the roots, as well as help to provide a secure connection between adjacent HP turbine stator vanes 208 to help maintain structural integrity of the stage of HP turbine stator vanes 208 and reduce vibration during operation.

Each of the LP turbine rotor blades 210 includes a shroud 211 integral with the LP turbine rotor blades 210. The shroud 211 is positioned on at least one of the outer end or the inner end of the LP turbine rotor blades 210. The shroud 211 acts as a barrier, preventing air from bypass the LP turbine rotor blades 210 at the tips, as well as help to provide a secure connection between adjacent LP turbine rotor blades 210 to help maintain structural integrity of the stage of LP turbine rotor blades 210 and reduce vibration during operation.

Each of the LP turbine stator vanes 212 includes a shroud 213 integral with the LP turbine stator vane 212. The shroud 213 is positioned on at least one of the outer end or the inner end of the LP turbine stator vane 212. The shroud 213 can include hooks that hook into respective openings in the outer casing or the inner casing of the LP turbine 134 such that the outer casing or the inner casing support the LP turbine stator vanes 212. The shroud 213 acts as a barrier, preventing air from bypass the LP turbine stator vanes 212 at the tips or at the roots, as well as help to provide a secure connection between adjacent LP turbine stator vanes 212 to help maintain structural integrity of the stage of LP turbine stator vanes 212 and reduce vibration during operation.

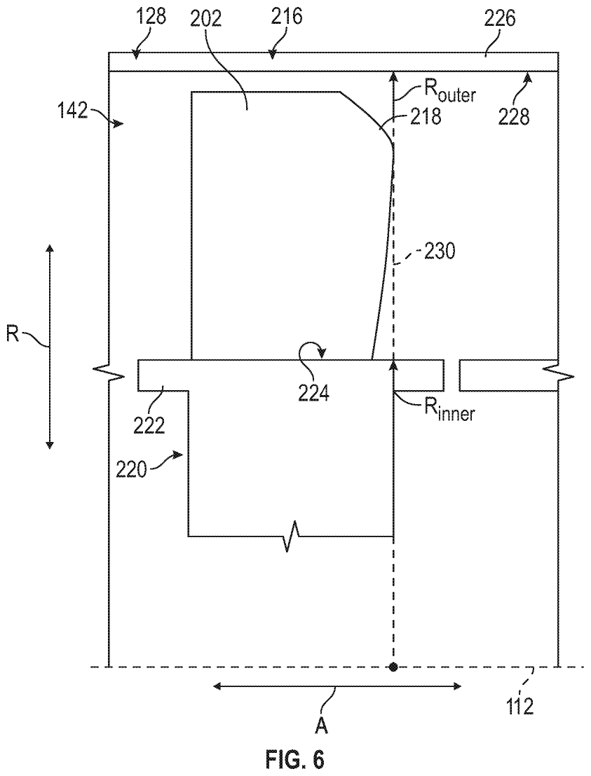

Referring particularly to the HP compressor 128, the plurality of stages of HP compressor rotor blades 202 includes an aftmost stage 216 of HP compressor rotor blades 202. Referring briefly to FIG. 6, a close-up view of an HP compressor rotor blade 202 in the aftmost stage 216 of HP compressor rotor blades 202 is provided. As will be appreciated, the HP compressor rotor blade 202 includes a trailing edge 218 and the aftmost stage 216 of HP compressor rotor blades 202 includes a rotor 220 having a base 222 to which the HP compressor rotor blade 202 is coupled. The base 222 includes a flowpath surface 224 defining in part the core duct 142 through the HP compressor 128. Moreover, the HP compressor 128 includes a shroud or liner 226 located outward of the HP compressor rotor blade 202 along the radial direction R. The shroud or liner 226 also includes a flowpath surface 228 defining in part the core duct 142 through the HP compressor 128.

The gas turbine engine 100 (FIG. 6) defines a reference plane 230 intersecting with an aft-most point of the trailing edge 218 of the HP compressor rotor blade 202 depicted, the reference plane 230 being orthogonal to the axial direction A. Further, the HP compressor 128 defines a high-pressure compressor exit area (A_{HPCExit}) within the reference plane 230. More specifically, the HP compressor 128 defines an inner radius (R_{INNER}) extending along the radial direction R within the reference plane 230 from the longitudinal centerline axis 112 to the flowpath surface 224 of the base 222 of the rotor 220 of the aftmost stage 216 of HP compressor rotor blades 202, as well as an outer radius (R_{OUTER}) extending along the radial direction R within the reference plane 230 from the longitudinal centerline axis 112 to the flowpath surface 228 of the shroud or liner 226. The HP compressor 128 exit area is defined according to Expression (1):

$${A}_{HPCExit} = π ( {R}_{OUTER}^{2} - {R}_{INNER}^{2} ) . \qquad Expression ( 1 )$$

The present disclosure contemplates that for a given total thrust output (Fn_{Total}), a decrease in size of the high-pressure compressor exit area (A_{HPCExit}) may generally relate in an increase in a compressor exit temperature (i.e., a temperature of the airflow through the core duct 142 at the reference plane 230), a turbine inlet temperature (i.e., a temperature of the airflow through the core duct 142 provided to the first stage 214 of HP turbine rotor blades 206. See FIG. 2), and the redline exhaust gas temperature (EGT). In particular, the present disclosure finds that the high-pressure compressor exit area (A_{HPCExit}) may generally be used as an indicator of the above temperatures to be achieved by the gas turbine engine 100 during operation for a given total thrust output (Fn_{Total}) of the gas turbine engine 100.

Referring back to FIG. 5, the gas turbine engine 100 depicted includes one or more technologies to accommodate the relatively small high-pressure compressor exit area (A_{HPCExit}) for the total thrust output (Fn_{Total}) of the gas turbine engine 100. In particular, for the embodiment depicted, the gas turbine engine 100 includes a cooled cooling air system 250. The exemplary cooled cooling air system 250 is in fluid communication with the HP compressor 128 and the first stage 214 of HP turbine rotor blades 206. More specifically, for the embodiment depicted, the cooled cooling air system 250 includes a duct assembly 252 and a cooled cooling air (CCA) heat exchanger 254. The duct assembly 252 is in fluid communication with the HP compressor 128 for receiving an airflow from the HP compressor 128 and providing such airflow to the first stage 214 of HP turbine rotor blades 206 during operation of the gas turbine engine 100. The CCA heat exchanger 254 is in thermal communication with the airflow through the duct assembly 252 for reducing a temperature of the airflow through the duct assembly 252 upstream of the first stage 214 of HP turbine rotor blades 206.

Briefly, as will be explained in more detail below, the gas turbine engine 100 depicted further includes a thermal transport bus 300, with the CCA heat exchanger 254 of the cooled cooling air system 250 in thermal communication with, or integrated into, the thermal transport bus 300. For the embodiment depicted, the gas turbine engine 100 further includes the heat exchanger 196 in the fan duct 172 in thermal communication with, or integrated into, the thermal transport bus 300, such that heat from the CCA heat exchanger 254 of the cooled cooling air system 250 may be transferred to the heat exchanger 196 in the fan duct 172 using the thermal transport bus 300.

FIG. 7 is a close-up, schematic view of the turbomachine 120 of the gas turbine engine 100 of FIG. 5, including the cooled cooling air system 250.

As is shown, the turbine section includes a compressor casing 256, and the combustion section 130 of the turbomachine 120 generally includes an outer combustor casing 258, an inner combustor casing 260, and a combustor 262. The combustor 262 generally includes an outer combustion chamber liner 264 and an inner combustion chamber liner 266, together defining at least in part a combustion chamber 268. The combustor 262 further includes a fuel nozzle 270 configured to provide a mixture of fuel and air to the combustion chamber 268 to generate combustion gases.

The gas turbine engine 100 further includes a fuel delivery system 272 including at least a fuel line 274 in fluid communication with the fuel nozzle 270 for providing fuel to the fuel nozzle 270.

The turbomachine 120 includes a diffuser nozzle 276 located downstream of the aftmost stage 216 of HP compressor rotor blades 202 of the HP compressor 128, within the core duct 142. In the embodiment depicted, the diffuser nozzle 276 is coupled to, or integrated with the inner combustor casing 260, the outer combustor casing 258, or both. The diffuser nozzle 276 is configured to receive compressed airflow from the HP compressor 128 and straighten such compressed air prior to such compressed air being provided to the combustion section 130. The combustion section 130 defines a diffusion cavity 278 downstream of the diffuser nozzle 276 and upstream of the combustion chamber 268.

As noted above, the gas turbine engine 100 further includes the cooled cooling air system 250. The cooled cooling air system 250 includes the duct assembly 252 and the CCA heat exchanger 254. More specifically, the duct assembly 252 includes a first duct 280 in fluid communication with the HP compressor 128 and the CCA heat exchanger 254. The first duct 280 more specifically extends from the HP compressor 128, through the compressor casing 256, to the CCA heat exchanger 254. For the embodiment depicted, the first duct 280 is in fluid communication with the HP compressor 128 at a location in between the last two stages of HP compressor rotor blades 202. In such a manner, the first duct 280 is configured to receive a cooling airflow from the HP compressor 128 and to provide the cooling airflow to the CCA heat exchanger 254.

In other embodiments, the first duct 280 may additionally, or alternatively, be in fluid communication with the HP compressor 128 at any other suitable location, such as at any other location closer to a downstream end of the HP compressor 128 than an upstream end of the HP compressor 128, or alternatively at a location closer to the upstream end of the HP compressor 128 than the downstream end of the HP compressor 128.

The duct assembly 252 further includes a second duct 282 extending from the CCA heat exchanger 254 to the outer combustor casing 258 and a third duct 284 extending from the outer combustor casing 258 inwardly generally along the radial direction R. The CCA heat exchanger 254 may be configured to receive the cooling airflow and to extract heat from the cooling airflow to reduce a temperature of the cooling airflow. The second duct 282 may be configured to receive cooling airflow from the CCA heat exchanger 254 and provide the cooling airflow to the third duct 284. The third duct 284 extends through the diffusion cavity generally along the radial direction R.

Moreover, for the embodiment depicted, the duct assembly 252 further includes a manifold 286 in fluid communication with the third duct 284 and a fourth duct 288. The manifold 286 extends generally along the circumferential direction C of the gas turbine engine 100, and the fourth duct 288 is more specifically a plurality of fourth ducts 288 extending from the manifold 286 at various locations along the circumferential direction C forward generally along the axial direction A towards the turbine section. In such a manner, the duct assembly 252 of the cooled cooling air system 250 may be configured to provide cooling airflow to the turbine section at a variety of locations along the circumferential direction C.

Notably, referring still to FIG. 7, the combustion section 130 includes an inner stator assembly 290 located at a downstream end of the inner combustion chamber liner 266, and coupled to the inner combustor casing 260. The inner stator assembly 290 includes a nozzle 292. The fourth duct 288, or rather, the plurality of fourth ducts 288, are configured to provide the cooling airflow to the nozzle 292. The nozzle 292 may include a plurality of vanes spaced along the circumferential direction C configured to impart a circumferential swirl to the cooling airflow provided through the plurality of fourth ducts 288 to assist with such airflow being provided to the first stage 214 of HP turbine rotor blades 206.

In particular, for the embodiment depicted, the HP turbine 132 further includes a first stage HP turbine rotor 294, with the plurality of HP turbine rotor blades 206 of the first stage 214 coupled to the first stage HP turbine rotor 294. The first stage HP turbine rotor 294 defines an internal cavity 296 configured to receive the cooling airflow from the nozzle 292 and provide the cooling airflow to the plurality of HP turbine rotor blades 206 of the first stage 214. In such a manner, the cooled cooling air system 250 may provide cooling airflow to the HP turbine rotor blades 206 to reduce a temperature of the plurality HP turbine rotor blades 206 at the first stage 214 during operation of the gas turbine engine 100.

For example, in certain exemplary aspects, the cooled cooling air system 250 may be configured to provide a temperature reduction of the cooling airflow equal to at least fifteen percent (15%) of the EGT and up to forty-five percent (45%) of the EGT. Further, in certain exemplary aspects, the cooled cooling air system 250 may be configured to receive between two and a half percent (2.5%) and thirty-five percent (35%) of an airflow through the core duct 142 at an inlet to the HP compressor 128, such as between three percent (3%) and twenty percent (20%), such as between four percent (4%) and fifteen percent (15%).

In addition, as briefly mentioned above, the cooled cooling air system 250 may utilize the thermal transport bus 300 to reject heat from the cooling air extracted from the compressor section of the turbomachine 120. In particular, for the embodiment shown the CCA heat exchanger 254 is in thermal communication with or integrated into the thermal transport bus 300. Notably, the thermal transport bus 300 further includes a fuel heat exchanger 302 in thermal communication with the fuel line 274. In such a manner, the thermal transport bus 300 may extract heat from the cooling air extracted from the compressor section through the cooled cooling air system 250 and provide such heat to a fuel flow through the fuel line 274 upstream of the fuel nozzle 270.

For the embodiment depicted, the thermal transport bus 300 includes a conduit having a flow of thermal transport fluid therethrough. More specifically, referring now briefly to FIG. 8, a schematic view of a thermal transport bus 300 as may be utilized with the gas turbine engine 100 described above with reference to FIGS. 4 through 7 is provided.

The thermal transport bus 300 includes an intermediary heat exchange fluid flowing therethrough and is formed of one or more suitable fluid conduits 304. The heat exchange fluid may be an incompressible fluid having a high temperature operating range. Additionally, or alternatively, the heat exchange fluid may be a single phase fluid, or alternatively, may be a phase change fluid. In certain exemplary embodiments, the heat exchange fluid may be a supercritical fluid, such as a supercritical CO₂.

The exemplary thermal transport bus 300 includes a pump 306 in fluid communication with the heat exchange fluid in the thermal transport bus 300 for generating a flow of the heat exchange fluid in/through the thermal transport bus 300.

Moreover, the exemplary thermal transport bus 300 includes one or more heat source exchangers 308 in thermal communication with the heat exchange fluid in the thermal transport bus 300. Specifically, the thermal transport bus 300 depicted includes a plurality of heat source exchangers 308. The plurality of heat source exchangers 308 are configured to transfer heat from one or more of the accessory systems of an engine within which the thermal transport bus 300 is installed (e.g., engine 100 of FIGS. 4 through 7) to the heat exchange fluid in the thermal transport bus 300. For example, in certain exemplary embodiments, the plurality of heat source exchangers 308 may include one or more of: a CCA heat source exchanger (such as CCA heat exchanger 254 in FIGS. 5 and 7), a main lubrication system heat source exchanger for transferring heat from a main lubrication system, an advanced clearance control (ACC) system heat source exchanger for transferring heat from an ACC system, a generator lubrication system heat source exchanger for transferring heat from the generator lubrication system; an environmental control system (ECS) heat exchanger for transferring heat from an ECS, an electronics cooling system heat exchanger for transferring heat from the electronics cooling system, a vapor compression system heat source exchanger, an air cycle system heat source exchanger, and an auxiliary system(s) heat source exchanger.

For the embodiment depicted, there are three heat source exchangers 308. The heat source exchangers 308 are each arranged in series flow along the thermal transport bus 300. However, in other exemplary embodiments, any other suitable number of heat source exchangers 308 may be included and one or more of the heat source exchangers 308 may be arranged in parallel flow along the thermal transport bus 300 (in addition to, or in the alternative to the serial flow arrangement depicted). For example, in other embodiments there may be a single heat source exchanger 308 in thermal communication with the heat exchange fluid in the thermal transport bus 300, or alternatively, there may be at least two heat source exchangers 308, at least four heat source exchangers 308, at least five heat source exchangers 308, or at least six heat source exchangers 308, and up to twenty heat source exchangers 308 in thermal communication with heat exchange fluid in the thermal transport bus 300.

Additionally, the exemplary thermal transport bus 300 of FIG. 8 further includes one or more heat sink exchangers 310 permanently or selectively in thermal communication with the heat exchange fluid in the thermal transport bus 300. The one or more heat sink exchangers 310 are located downstream of the plurality of heat source exchangers 308 and are configured for transferring heat from the heat exchange fluid in the thermal transport bus 300, e.g., to atmosphere, to fuel, to a fan stream, etc. For example, in certain embodiments the one or more heat sink exchangers 310 may include at least one of a RAM heat sink exchanger, a fuel heat sink exchanger, a fan stream heat sink exchanger, a bleed air heat sink exchanger, an engine intercooler heat sink exchanger, a bypass passage heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel (see, e.g., fuel heat exchanger 302 of the gas turbine engine 100 of FIG. 7). Moreover, the fan stream heat sink exchanger is generally an “air to heat exchange fluid” heat exchanger which transfers heat from the heat exchange fluid to an airflow through the fan stream (see, e.g., heat exchanger 196 of FIGS. 4 and 5). Further, the bleed air heat sink exchanger is generally an “air to heat exchange fluid” heat exchanger which flows, e.g., bleed air from the LP compressor 126 over the heat exchange fluid to remove heat from the heat exchange fluid.

For the embodiment of FIG. 8, the one or more heat sink exchangers 310 of the thermal transport bus 300 depicted includes a plurality of individual heat sink exchangers 310. More particularly, for the embodiment of FIG. 8, the one or more heat sink exchangers 310 include three heat sink exchangers 310 arranged in series. The three heat sink exchangers 310 are configured as a bypass passage heat sink exchanger, a fuel heat sink exchanger, and a fan stream heat sink exchanger. However, in other exemplary embodiments, the one or more heat sink exchangers 310 may include any other suitable number and/or type of heat sink exchangers 310. For example, in other exemplary embodiments, a single heat sink exchanger 310 may be provided, at least two heat sink exchangers 310 may be provided, at least four heat sink exchangers 310 may be provided, at least five heat sink exchangers 310 may be provided, or up to twenty heat sink exchangers 310 may be provided. Additionally, in still other exemplary embodiments, two or more of the one or more heat sink exchangers 310 may alternatively be arranged in parallel flow with one another.

Referring still to the exemplary embodiment depicted in FIG. 8, one or more of the plurality of heat sink exchangers 310 and one or more of the plurality of heat source exchangers 308 are selectively in thermal communication with the heat exchange fluid in the thermal transport bus 300. More particularly, the thermal transport bus 300 depicted includes a plurality of bypass lines 312 for selectively bypassing each heat source exchanger 308 and each heat sink exchanger 310 in the plurality of heat sink exchangers 310. Each bypass line 312 extends between an upstream juncture 314 and a downstream juncture 316—the upstream juncture 314 located just upstream of a respective heat source exchanger 308 or heat sink exchanger 310, and the downstream juncture 316 located just downstream of the respective heat source exchanger 308 or heat sink exchanger 310.

Additionally, each bypass line 312 meets at the respective upstream juncture 314 with the thermal transport bus 300 via a three-way valve 318. The three-way valves 318 each include an inlet fluidly connected with the thermal transport bus 300, a first outlet fluidly connected with the thermal transport bus 300, and a second outlet fluidly connected with the bypass line 312. The three-way valves 318 may each be a variable throughput three-way valve, such that the three-way valves 318 may vary a throughput from the inlet to the first and/or second outlets. For example, the three-way valves 318 may be configured for providing anywhere between zero percent (0%) and one hundred percent (100%) of the heat exchange fluid from the inlet to the first outlet, and similarly, the three-way valves 318 may be configured for providing anywhere between zero percent (0%) and one hundred percent (100%) of the heat exchange fluid from the inlet to the second outlet.

Notably, the three-way valves 318 may be in operable communication with a controller of an engine including the thermal transport bus 300 (e.g., engine 100 of FIGS. 5 through 8).

Further, each bypass line 312 also meets at the respective downstream juncture 316 with the thermal transport bus 300. Between each heat source exchanger 308 or heat sink exchanger 310 and downstream juncture 316, the thermal transport bus 300 includes a check valve 320 for ensuring a proper flow direction of the heat exchange fluid. More particularly, the check valve 320 prevents a flow of heat exchange fluid from the downstream juncture 316 towards the respective heat source exchanger 308 or heat sink exchanger 310.

Gas turbine engine design includes, i.e., designing gas turbine engines having a variety of different high-pressure compressor exit areas, total thrust outputs, redline exhaust gas temperatures, and supporting technology characteristics and evaluating an overall engine performance and other qualitative gas turbine engine characteristics. As alluded to earlier, the present disclosure provides a significant relationship between a total sea level static thrust output, a compressor exit area, and a redline exhaust gas temperature that enables increased engine core operating temperatures and overall engine propulsive efficiency. The relationship can be thought of as an indicator of the ability of a gas turbine engine to have a reduced weight or volume as represented by a high-pressure compressor exit area, while maintaining or even improving upon an overall thrust output, and without overly detrimentally affecting overall engine performance and other qualitative gas turbine engine characteristics. The relationship applies to an engine that incorporates a cooled cooling air system, builds portions of the core using material capable of operating at higher temperatures, or a combination of the two. Significantly, the relationship ties the core size (as represented by the exit area of the higher pressure compressor) to the desired thrust and exhaust gas temperature associated with the desired propulsive efficiency and practical limitations of the engine design, as described below.

Referring to the case of an engine that utilizes cooled cooling air for operating at higher temperatures, the costs associated with achieving a higher compression, enabled by reducing gas temperatures used to cool core components to accommodate higher core gas temperatures, may indeed produce a net benefit, contrary to expectations in the art. Referring to the case of utilizing more temperature-resistant material, such as a Carbon Matrix Composite (CMC), certain aspects of the engine size, weight and operating characteristics can be positively affected while taking into account the complexities and/or drawbacks associated with such material. In either case, the relationship now described can apply to identify the interrelated operating conditions and core size—i.e., total sea level static thrust, redline exhaust gas temperature, and compressor exit area, respectively.

Further, bounding the relationship between a product of total thrust output and redline exhaust gas temperature at a takeoff power level and the high-pressure compressor exit area squared (corrected specific thrust) can result in a higher power density core. This bounded relationship, as described herein, takes into due account the amount of overall complexity and cost, and/or a low amount of reliability associated with implementing the technologies required to achieve the operating temperatures and exhaust gas temperature associated with the desired thrust levels. The amount of overall complexity and cost may be prohibitively high for gas turbine engines outside the bounds of the relationship as described herein, and/or the reliability may prohibitively low outside the bounds of the relationship as described herein. The relationship provided, infra, can therefore identify an improved engine configuration suited for a particular mission requirement, one that takes into account efficiency, weight, cost, complexity, reliability, and other factors influencing the optimal choice for an engine configuration.

In addition to yielding an improved gas turbine engine, as explained in detail above, utilizing this relationship, the number of suitable or feasible gas turbine engine designs capable of meeting the above design requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationship providing for the improved gas turbine engine is expressed as:

$$CST = {Fn}_{Total} \times EGT / ( {A}_{HPCExit}^{2} \times 1000 ) , \qquad Expression ( 2 )$$

where CST is corrected specific thrust; Fn_{Total} is a total sea level static thrust output of the gas turbine engine in pounds; EGT is redline exhaust gas temperature in degrees Celsius; and A_{HPCExit} is a high-pressure compressor exit area in square inches.

CST values of an engine defined by Expression (2) in accordance with various embodiments of the present disclosure are from forty-two to ninety (42 to 90), such as from forty-five to eighty (45 to 80), such as from fifty to eighty (50 to 80). The units of the CST values may be pounds-degrees Celsius over square inches.

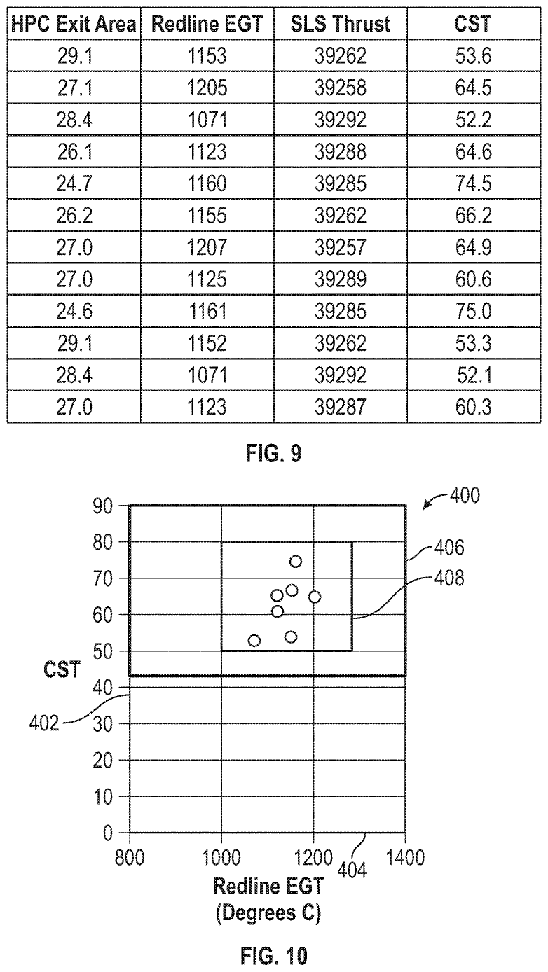

Referring now to FIGS. 9 and 10, various exemplary gas turbine engines are illustrated in accordance with one or more exemplary embodiments of the present disclosure. In particular, FIG. 9 provides a table including numerical values corresponding to several of the plotted gas turbine engines in FIG. 10. FIG. 10 is a plot 400 of gas turbine engines in accordance with one or more exemplary embodiments of the present disclosure, showing the CST on a Y-axis 402 and the EGT on an X-axis 404.

As shown, the plot 400 in FIG. 10 depicts a first range 406, with the CST values between forty-two and ninety (42 and 90) and EGT values from eight hundred degrees Celsius to one thousand four hundred degrees Celsius (800° C. to 1400° C.). FIG. 10 additionally depicts a second range 408, with the CST values between fifty and eighty (50 and 80) and EGT values from one thousand degrees Celsius to one thousand three hundred degrees Celsius (1000° C. to 1300° C.). In other embodiments, the EGT value may be greater than one thousand one hundred degrees Celsius (1100° C.) and less than one thousand two hundred fifty degrees Celsius (1250° C.), such as greater than one thousand one hundred fifty degrees Celsius (1150° C.) and less than one thousand two hundred fifty degrees Celsius (1250° C.), such as greater than one thousand degrees Celsius (1000° C.) and less than one thousand three hundred degrees Celsius (1300° C.).

Although the discussion above is generally related to an open rotor engine having a particular cooled cooling air system 250 (FIG. 5), in various embodiments of the present disclosure, the relationship outlined above with respect to Expression (2) may be applied to any other suitable engine architecture, including any other suitable technology(ies) to allow the gas turbine engine to accommodate higher temperatures to allow for a reduction in the high-pressure compressor exit area, while maintaining or even increasing the maximum gas turbine engine thrust output without, e.g., prematurely wearing various components within the turbomachine exposed the working gas flowpath.

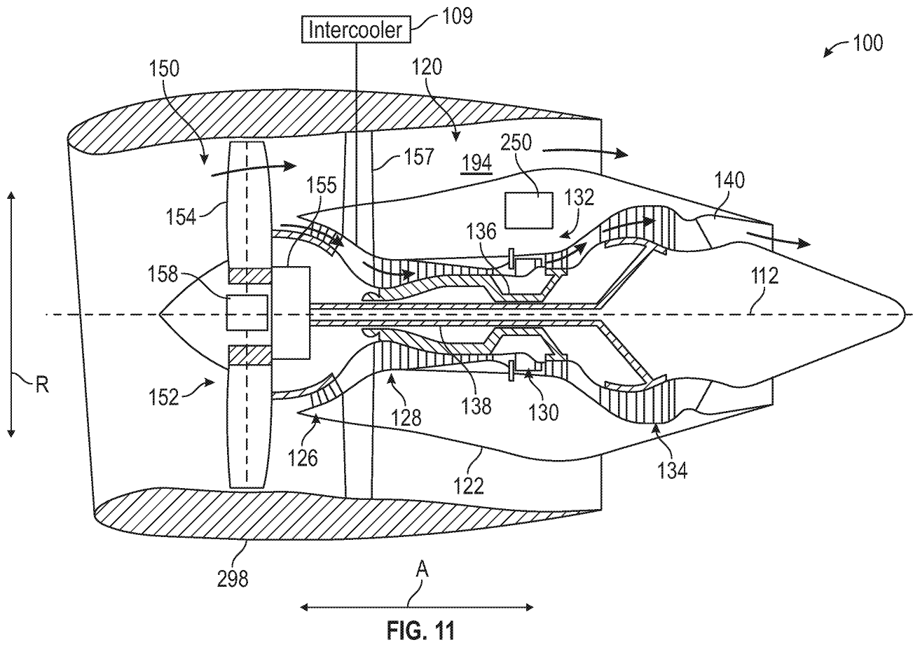

For example, reference will now be made to FIG. 11, which shows a schematic view of a gas turbine engine 100 in accordance with another exemplary embodiment of the present disclosure. The exemplary embodiment of FIG. 11 may be configured in substantially the same manner as the gas turbine engine 100 described above with respect to FIGS. 4 through 7, and the same or similar reference numerals may refer to the same or similar parts. However, for the embodiment shown, the gas turbine engine 100 further includes an outer housing or nacelle 298 circumferentially surrounding at least in part the fan section 150 and the turbomachine 120. The nacelle 298 defines a bypass passage 194 between the nacelle 298 and the turbomachine 120.

In some embodiments, the gas turbine engine 100 includes an intercooler 109. The intercooler 109 cools the engine flow path air downstream of the low-pressure compressor 126 before the engine flow path air enters the high-pressure compressor 128 during flight conditions (e.g., takeoff or maximum thrust). The intercooler 109 can include any type of intercooler. For example, the intercooler 109 can include a heat exchanger in an inter-compressor frame 157 or an inter-compressor casing (e.g., in the core cowl 122) in which cooling fluid is used to absorb heat with the flow path air. The cooling fluid can include a thermal bus or fuel. The thermal bus can absorb heat from the core air and reject the heat into a heat sink, such as, for example, fuel and/or bypass air. In some embodiments, the intercooler 109 can include a heat exchanger between the core air and the bypass air. In some embodiments, the intercooler 109 includes water or steam that is injected into the core flow path at the inter-compressor frame. While the intercooler 109 is described in relation to FIG. 11, any of the engines detailed herein can include an intercooler 109.

Briefly, the gas turbine engine 100 of FIG. 11 is configured as a two-stream engine, i.e., an engine without a third stream (e.g., the fan duct 172 in the gas turbine engine 100 of FIG. 4). With such a configuration, a total sea level static thrust output Fn_{Total} of the gas turbine engine 100 may generally be equal to a sum of: a fan stream thrust Fn_{Fan} (i.e., an amount of thrust generated by a fan 152 through a bypass passage 194) and a turbomachine thrust Fn_{TM} (i.e., an amount of thrust generated by an airflow through a turbomachine exhaust nozzle 140), each during the static, sea level, standard day conditions.

Further, for the exemplary embodiment of FIG. 11, the gas turbine engine 100 additionally includes a cooled cooling air system 250 configured to provide a turbine section with cooled cooling air during operation of the gas turbine engine 100, to allow the gas turbine engine 100 to accommodate higher temperatures to allow for a reduction in a high-pressure compressor exit area, while maintaining or even increasing a maximum gas turbine engine thrust output.

In other exemplary embodiments of the present disclosure, the cooled cooling air system 250 of the gas turbine engine 100 may be configured in any other suitable manner. For example, the exemplary cooled cooling air system 250 described above with reference to FIGS. 5 and 6 is generally configured as a thermal bus cooled cooling air system. However, in other embodiments, the cooled cooling air system 250 may instead be a dedicated heat exchanger cooled cooling air system (i.e., a cooled cooling air system including a heat exchanger that transfers heat directly to a cooling medium). Additionally, in other embodiments, the cooled cooling air system 250 may be a bypass heat exchanger cooled cooling air system having a heat sink heat exchanger thermally coupled to an airflow through a bypass passage (see, e.g., FIG. 12, discussed below). Additionally, or alternatively, in other embodiments, the cooled cooling air system 250 may be one of an air-to-air cooled cooling air system (a cooled cooling air system having a heat sink heat exchanger configured to transfer heat to an airflow. See, e.g., FIG. 12, discussed below), an oil-to-air cooled cooling air system (a cooled cooling air system having a heat sink heat exchanger configured to transfer heat to an oil flow), or a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc. See, e.g., FIG. 7).

More particularly, referring generally to FIGS. 12 through 14, in other exemplary embodiments, the cooled cooling air system 250 of the gas turbine engine 100 may be configured in any other suitable manner. The gas turbine engines 100 depicted in FIGS. 12 through 14 may be configured in a similar manner as gas turbine engine 100 described above with reference to FIGS. 4 through 7, and the same or similar numbers may refer to the same or similar parts.

For example, each of the gas turbine engines 100 depicted in FIGS. 12 through 14 generally includes a turbomachine 120 having an LP compressor 126, an HP compressor 128, a combustion section 130, an HP turbine 132, and an LP turbine 134 collectively defining at least in part a working gas flowpath, also referred to as a core duct 142, and arranged in serial flow order. The exemplary turbomachine 120 depicted additionally includes a core cowl 122, and the gas turbine engine 100 includes a fan cowl 170. The gas turbine engine 100 includes or defines a fan duct 172 positioned partially between the core cowl 122 and the fan cowl 170. Moreover, a bypass passage 194 is defined at least in part by the core cowl 122, the fan cowl 170, or both and extends over the turbomachine 120.

Moreover, the gas turbine engines 100 depicted in FIGS. 12 to 14 additionally include a cooled cooling air system 250. The cooled cooling air system 250 generally includes a duct assembly 252 and a CCA heat exchanger 254.

However, referring particular to FIG. 12, for the exemplary embodiment depicted, the CCA heat exchanger 254 is positioned in thermal communication with the bypass passage 194, and more specifically, it is exposed to an airflow through or over the bypass passage 194. For the embodiment of FIG. 12, the CCA heat exchanger 254 is positioned on the core cowl 122. In such a manner, the CCA heat exchanger 254 may be an air-to-air CCA heat exchanger configured to exchange heat between an airflow extracted from the HP compressor 128 and the airflow through the bypass passage 194.

As is depicted in phantom, the cooled cooling air system 250 may additionally or alternatively be positioned at any other suitable location along the bypass passage 194, such as on the fan cowl 170. Further, although depicted in FIG. 12 as being positioned on the core cowl 122, in other embodiments, the CCA heat exchanger 254 may be embedded into the core cowl 122, and airflow through the bypass passage 194 may be redirected from the bypass passage 194 to the CCA heat exchanger 254.

As will be appreciated, a size of the CCA heat exchanger 254 may affect the amount of drag generated by the CCA heat exchanger 254 being positioned within or exposed to the bypass passage 194. Accordingly, sizing the cooled cooling air system 250 in accordance with the present disclosure may allow for a desired reduction in a HP compressor 128 exit area, while maintaining or even increasing a total thrust output for the gas turbine engine 100, without creating an excess amount of drag on the gas turbine engine 100 in the process.

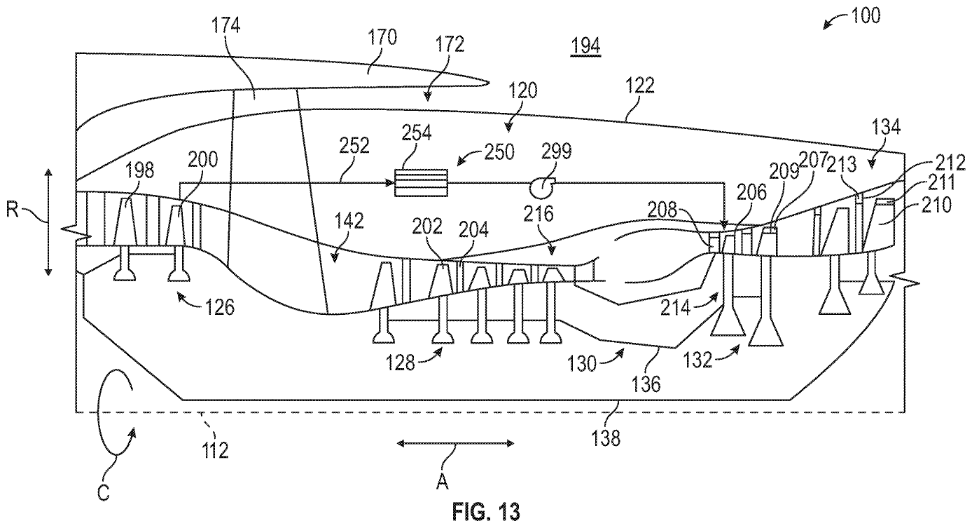

Referring now particularly to FIG. 13, for the exemplary embodiment depicted, the cooled cooling air system 250 is configured to receive the cooling airflow from an air source upstream of a downstream half of the HP compressor 128. In particular, for the exemplary embodiment of FIG. 13, the exemplary cooled cooling air system 250 is configured to receive the cooling airflow from a location upstream of the HP compressor 128, and, more specifically, still, from the LP compressor 126. In order to allow for a relatively low-pressure cooling airflow to be provided to a first stage 214 of HP turbine rotor blades 206 of the HP turbine 132, the cooled cooling air system 250 further includes a pump 299 in airflow communication with the duct assembly 252 to increase a pressure of the cooling airflow through the duct assembly 252. For the exemplary aspect depicted, the pump 299 is positioned downstream of the CCA heat exchanger 254. In such a manner, the pump 299 may be configured to increase the pressure of the cooling airflow through the duct assembly 252 after the cooling airflow has been reduced in temperature by the CCA heat exchanger 254. Such may allow for a reduction in wear on the pump 299.

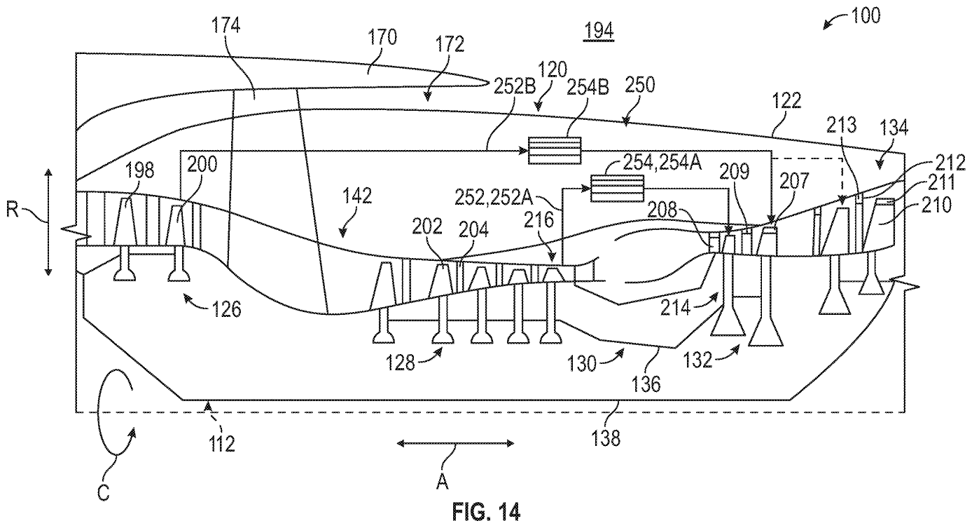

Referring now particularly to FIG. 14, the cooled cooling air system 250 includes a high-pressure portion and a low-pressure portion operable in parallel. In particular, the duct assembly 252 includes a high-pressure duct assembly 252A and a low-pressure duct assembly 252B, and the CCA heat exchanger 254 includes a high-pressure CCA heat exchanger 254A and a low-pressure CCA heat exchanger 254B.

The high-pressure duct assembly 252A is in fluid communication with the HP compressor 128 at a downstream half of the high-pressure compressor and is further in fluid communication with a first stage 214 of HP turbine rotor blades 206. The high-pressure duct assembly 252A may be configured to receive a high-pressure cooling airflow from the HP compressor 128 through the high-pressure duct assembly 252A and provide such high-pressure cooling airflow to the first stage 214 of HP turbine rotor blades 206. The high-pressure CCA heat exchanger 254A may be configured to reduce a temperature of the high-pressure cooling airflow through the high-pressure duct assembly 252A at a location upstream of the first stage 214 of HP turbine rotor blades 206.

The low-pressure duct assembly 252B is in fluid communication with a location upstream of the downstream half of the high-pressure compressor 128 and is further in fluid communication with the HP turbine 132 and a location downstream of the first stage 214 of HP turbine rotor blades 206. In particular, for the embodiment depicted, the low-pressure duct assembly 252B is in fluid communication with the LP compressor 126 and a second stage (not labeled) of HP turbine rotor blades 206. The low-pressure duct assembly 252B may be configured to receive a low-pressure cooling airflow from the LP compressor 126 through the low-pressure duct assembly 252B and provide such low-pressure cooling airflow to the second stage of HP turbine rotor blades 206. The low-pressure CCA heat exchanger 254B may be configured to reduce a temperature of the low-pressure cooling airflow through the low-pressure duct assembly 252B upstream of the second stage of HP turbine rotor blades 206.

Inclusion of the exemplary cooled cooling air system 250 of FIG. 14 may reduce an amount of resources utilized by the cooled cooling air system 250 to provide a desired amount of cooling for the turbomachine 120.

Further, for the exemplary embodiment of FIG. 14, the cooled cooling air system 250 may further be configured to provide cooling to one or more stages of LP turbine rotor blades 210, and in particular to a first stage (i.e., upstream-most stage) of LP turbine rotor blades 210. Such may further allow for, e.g., the higher operating temperatures described herein.

Reference will now be made briefly to FIG. 15. FIG. 15 provides a schematic view of a gas turbine engine 500 in accordance with another exemplary embodiment of the present disclosure. The exemplary embodiment of FIG. 15 may be configured in substantially the same manner as the exemplary gas turbine engine 100 described above with respect to FIGS. 4 through 7, and the same or similar reference numerals may refer to the same or similar parts. However, as will be appreciated, for the embodiment shown, the gas turbine engine 500 is configured as a three-spool engine, instead of a two-spool engine.

For example, the gas turbine engine 500 includes a fan section 502 and a turbomachine 504. The fan section includes a fan 506. The turbomachine includes a first compressor 508, a second compressor 510, a combustion section 512, a first turbine 514, a second turbine 516, and a third turbine 518. The first compressor 508 may be a high-pressure compressor, the second compressor 510 may be a medium pressure compressor (or intermediate pressure compressor), the first turbine 514 may be a high-pressure turbine, the second turbine 516 may be a medium pressure turbine (or intermediate pressure turbine), and the third turbine 518 may be a low-pressure turbine. Further, the gas turbine engine 500 includes a first shaft 520 extending between, and rotatable with both of, the first compressor 508 and first turbine 514; a second shaft 522 extending between, and rotatable with both of, the second compressor 510 and second turbine 516; and a third shaft 524 extending between, and rotatable with both of, the third turbine 518 and fan 506. In such a manner, it will be appreciated that the gas turbine engine 500 may be referred to as a three-spool engine.

For the embodiment of FIG. 15, the term redline EGT refers to a maximum temperature of an airflow after the first stator downstream of the last stage of rotor blades of the intermediate speed turbine, e.g., at location 526 in FIG. 15 (assuming the intermediate speed turbine (the second turbine 516) includes a stage of stator vanes downstream of the last stage of rotor blades).

The exemplary cooled cooling air systems 250 described hereinabove are provided by way of example only. In other exemplary embodiments, aspects of one or more of the exemplary cooled cooling air systems 250 depicted may be combined to generate still other exemplary embodiments. For example, in still other exemplary embodiments, the exemplary cooled cooling air system 250 of FIGS. 5 through 7 may not be utilized with a thermal transport bus (e.g., thermal transport bus 300), and instead may directly utilize a CCA heat exchanger 254 positioned within the fan duct 172. Similarly, in other example embodiment, the exemplary cooled cooling air systems 250 of FIGS. 12 through 14 may be utilized with a thermal transport bus (e.g., thermal transport bus 300 of FIG. 5, 7, or 8) to reject heat for the CCA heat exchanger 254. Additionally, although the exemplary cooled cooling air systems 250 depicted schematically in FIGS. 12 through 14 depict the duct assembly 252 as positioned outward of the core duct 142 along the radial direction R, in other exemplary embodiments, the duct assemblies 252 may extend at least partially inward of the core duct 142 along the radial direction R (see, e.g., FIG. 7). In still other exemplary embodiments, the cooled cooling air system 250 may include duct assemblies 252 positioned outward of the core duct 142 along the radial direction R and inward of the core duct 142 along the radial direction R (e.g., in FIG. 14, the high-pressure duct assembly 252A may be positioned inwardly of the core duct 142 along the radial direction R and the low-pressure duct assembly 252B may be positioned outwardly of the core duct 142 along the radial direction R).

Moreover, in still other exemplary aspects, the gas turbine engine may include additional or alternative technologies to allow the gas turbine engine to accommodate higher temperatures while maintaining or even increasing the maximum gas turbine engine thrust output, as may be indicated by a reduction in the high-pressure compressor exit area, without, e.g., prematurely wearing on various components within the turbomachine exposed to the working gas flowpath.

For example, in additional or alternative embodiments, a gas turbine engine may incorporate advanced materials capable of withstanding the relatively high temperatures at downstream stages of a high-pressure compressor exit (e.g., at a last stage of high-pressure compressor rotor blades), and downstream of the high-pressure compressor (e.g., a first stage of an HP turbine, downstream stages of the HP turbine, an LP turbine, an exhaust section, etc.).

In particular, in at least certain exemplary embodiments, a gas turbine engine of the present disclosure may include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite (CMC).

Additionally, or alternatively still, in other exemplary embodiments, a gas turbine engine of the present disclosure may include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, and/or cobalt based superalloys (e.g., those available under the name Inconel® available from Special Metals Corporation). One or more of these materials are examples of materials suitable for use in additive manufacturing processes.

Further, in at least certain exemplary embodiments of the present disclosure, a method of operating a gas turbine engine is provided. The method may be utilized with one or more of the exemplary gas turbine engines discussed herein, such as in FIGS. 1 through 4 and 7 through 10. The method includes operating the gas turbine engine at a takeoff power level, the gas turbine engine having a turbomachine with a high-pressure compressor defining a high-pressure compressor exit area (A_{HPCExit}) in square inches. The gas turbine engine further defines a redline exhaust gas temperature (EGT) in degrees Celsius, a total sea level static thrust output (Fn_{Total}) in pounds, and a corrected specific thrust. The corrected specific thrust is greater than or equal to forty-two (42) and less than or equal to ninety (90), the corrected specific thrust determined as follows: Fn_{Total}×EGT/(A_{HPCExit}²×1000).

In certain exemplary aspects, operating the gas turbine engine at the takeoff power level further includes reducing a temperature of a cooling airflow provided to a high-pressure turbine of the gas turbine engine with a cooled cooling air system. For example, in certain exemplary aspects, reducing the temperature of the cooling airflow provided to the high-pressure turbine of the gas turbine engine with the cooled cooling air system comprises providing a temperature reduction of the cooling airflow equal to at least fifteen percent (15%) of the EGT and up to forty-five percent (45%) of the EGT.

As will be appreciated from the description herein, various embodiments of a gas turbine engine are provided. Certain of these embodiments may be an unducted, single rotor gas turbine engine (see FIG. 4), a turboprop engine, or a ducted turbofan engine (see FIG. 1). Another example of a ducted turbofan engine can be found in U.S. patent application Ser. No. 16/811,368 (Published as U.S. Patent Application Publication No. 2021/0108597), filed Mar. 6, 2020 (FIG. 14, Paragraph [0062], et al., including an annular fan case 13 surrounding the airfoil blades 21 of rotating element 20 and surrounding vanes 31 of stationary element 30, and including a third stream/fan duct 73 (shown in FIG. 14, described extensively throughout the application)). Various additional aspects of one or more of these embodiments are discussed below. These exemplary aspects may be combined with one or more of the exemplary gas turbine engine(s) discussed above with respect to FIGS. 5, 12, and 17.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted, single rotor or primary forward fan) may range from twenty-five horsepower per square foot (25 hp/ft²) or greater at cruise altitude during a cruise operating mode. In particular embodiments of the engine, structures and methods provided herein generate power loading between eighty horsepower per square foot and one hundred sixty horsepower per square foot (80 hp/ft² and 160 hp/ft²) or higher at cruise altitude during a cruise operating mode, depending on whether the engine is an open rotor or ducted engine.

In various embodiments, an engine of the present disclosure is applied to a vehicle with a cruise altitude up to approximately sixty-five thousand feet (65,000 ft). In certain embodiments, cruise altitude is between approximately twenty-eight thousand feet (28,000 ft) and approximately forty-five thousand feet (45,000 ft). In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately four point eight five pounds per square inch absolute (4.85 psia) and approximately point eight two pounds per square inch absolute (0.82 psia) based on a sea level pressure of approximately fourteen point seven pounds per square inch absolute (14.70 psia) and sea level temperature at approximately fifty-nine degrees Fahrenheit (59° F.). In another embodiment, cruise altitude is between approximately four point eight five pounds per square inch absolute (4.85 psia) and approximately two point one four pounds per square inch absolute (2.14 psia). In certain embodiments, the ranges of cruise altitude defined by pressure may be adjusted based on a different reference sea level pressure and/or sea level temperature.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least ten feet (10 ft), such as at least eleven feet (11 ft), such as at least twelve feet (12 ft), such as at least thirteen feet (13 ft), such as at least fifteen feet (15 ft), such as at least seventeen feet (17 ft), such as up to twenty-eight feet (28 ft), such as up to twenty-six feet (26 ft), such as up to twenty-four feet (24 ft), such as up to eighteen feet (18 ft). In some embodiments, the fan has a fan diameter in a range of 84.0 inches to 180.0 inches. In embodiments for a ducted engine (e.g., the gas turbine engine 100 of FIG. 1), the fan diameter is in a range of 84.0 inches to 120.0 inches. In embodiments for an open fan engine (e.g., the gas turbine engine 100 of FIG. 4), the fan diameter is in a range of 120.0 inches to 180.0 inches.

In various embodiments, the gas turbine engine includes a ratio of a quantity of vanes to a quantity of blades that could be less than, equal to, or greater than 1:1. For example, in particular embodiments, the gas turbine engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the gas turbine engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the gas turbine engine includes the third stream and a mid-fan (a ducted fan aft of the primary, forward fan), a ratio R1/R2 may be between one and ten (1 and 100, or two and seven (2 and 7), or at least three point three (3.3), at least three point five (3.5), at least four (4) and less than or equal to seven (7), where R1 is the radius of the primary fan and R2 is the radius of the mid-fan.

Various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the gas turbine engine allows for normal aircraft operation between Mach 0.75 and Mach 0.85. In certain embodiments, the gas turbine engine allows for rotor blade tip speeds at or less than seven hundred fifty feet per second (750 fps). In other embodiments, the rotor blade tip speed at a cruise flight condition can be six hundred fifty feet per second to nine hundred feet per second (650 fps to 900 fps), or seven hundred feet per second to eight hundred feet per second (700 fps to 800 fps). Alternatively, in certain suitable embodiments, the gas turbine engine allows for normal aircraft operation of at least Mach 0.3, such as with turboprop engines.

A fan pressure ratio (FPR) for the primary fan of the fan assembly can be one point zero four to two point two (1.04 to 2.20), or in some embodiments one point zero five to one point two (1.05 to 1.2), or in some embodiments less than one point zero eight (1.08), as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low-pressure shaft coupled to a low-pressure turbine). In some embodiments, a gear ratio of the input rotational speed to the output rotational speed is between three and four (3.0 and 4.0), between three point two and three point five (3.2 and 3.5), or between three point five and four point five (3.5 and 4.5). In some embodiments, a gear ratio of the input rotational speed to the output rotational speed is greater than four point one (4.1). For example, in particular embodiments, the gear ratio is within a range of four point one to fourteen (4.1 to 14.0), within a range of four point five to fourteen (4.5 to 14.0), or within a range of six to fourteen (6.0 to 14.0). In certain embodiments, the gear ratio is within a range of three point two to twelve (3.2 to 12) or within a range of four point five to eleven (4.5 to 11.0).

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low-pressure compressor may include one to eight (1 to 8) stages, a high-pressure compressor may include four to fifteen (4 to 15) stages, a high-pressure turbine may include one to two (1 to 2) stages, and/or a low-pressure turbine (LPT) may include one to seven (1 to 7) stages. In particular, the LPT may have four (4) stages, or between four and six (4 and 6) stages. For example, in certain embodiments, an engine may include a one (1) stage low-pressure compressor, an eleven (11) stage high-pressure compressor, a two (2) stage high-pressure turbine, and four (4) stages, or between four and seven (4 and 7) stages for the LPT. As another example, an engine can include a three (3) stage low-pressure compressor, a ten (10) stage high-pressure compressor, a two (2) stage high-pressure turbine, and a seven (7) stage low-pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least two (2). In another embodiment, L/Dcore is at least two point five (2.5). In some embodiments, the L/Dcore is less than five (5), less than four (4), and less than three (3). In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, ranges of power loading and/or rotor blade tip speed may correspond to certain structures, core sizes, thrust outputs, etc., or other structures of the core engine. However, as previously stated, to the extent one or more structures provided herein may be known in the art, the present disclosure may include combinations of structures not previously known to combine, at least for reasons based in part on conflicting benefits versus losses, desired modes of operation, or other forms of teaching away in the art.

Although depicted above as an unshrouded or open rotor engine, aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, certain aspects of the disclosure may address issues that may be particular to unshrouded or open rotor engines, such as, but not limited to, issues related to gear ratios, fan diameter, fan speed, length (L) of the engine, maximum diameter of the core engine (D_{CORE}) of the engine, L/Dcore of the engine, desired cruise altitude, and/or desired operating cruise speed, or combinations thereof.

A turbomachine shaft coupled to the power turbine and fan (either directly or through a gearbox) can experience vibrations during operation of the engine (e.g., during rotation of the shaft). For example, when the shaft rotates at its critical speed, the shaft will vibrate excessively. The excessive vibration is due primarily to excitation of a first-order beam bending mode of the shaft. Thus, the shaft may be characterized by its first order bending mode, the fundamental resonance frequency (fundamental frequency) of this mode, and the shaft's critical speed of rotation. If the first order bending mode may be excited by a low-pressure shaft rate occurring during a standard operating range of the engine, undetected vibration as well as an increased risk of whirl instability, may result. There is a continuing need to address vibrations induced by rotating shafts in turbomachinery engines.

As mentioned above, the engines disclosed herein provide for higher EGTs, provided for, for example, faster shaft speeds for the low-pressure turbine (LPT), and longer shafts to accommodate a longer engine core (e.g., the high-pressure compressor, the combustor, and the high-pressure turbine). Additionally, it is desirable to house the engine core within a smaller space. These trends can result in reductions in stiffness-to-weight ratio for the shaft and structure that influence dynamics of the LP shaft, which may have the effect of lowering the critical speed and/or limiting the available options for increasing the critical speed for the LPT's shaft (referred to as the low-pressure shaft or the low-pressure (LP) shaft). Accordingly, different approaches for engine types, midshaft geometry, bearing support, and material compositions are required for next-generation turbomachine engines, to permit high-speed operation without resulting in an unstable bending mode during regular operation. The present disclosure provides for a wide variety of shafts having different combinations of stiffness, material, bearing type and location, shaft length, and diameter in order to determine which embodiment(s) were most promising for a variety of contemplated engine designs. The various embodiments, as described herein and as shown in the figures, include turbomachine shafts that employ one or more of these techniques to increase the critical speed of the first order bending mode.

The aforementioned shaft structure and features also, however, directly affect other components in the engine and the operation of the engine itself. For example, shortening the length of the low-pressure turbine's shaft reduces the available space for the high-pressure compressor stages, the combustor, the low-pressure turbine stages, the low-pressure compressor stages, ducts, mounts, and other engine components etc. This, in turn, has a negative impact on engine operation by reducing the power output of the engine and reducing combustor efficiency. Indeed, there is a desire to have a lengthened high-pressure compressor or more high-pressure compressor stages to improve combustor efficiency. Likewise, increasing the diameter and/or mass of the low-speed shaft can have a similar effect, reducing available space for the remaining engine components and increasing weight of the engine, thus, again, negatively impacting engine performance. Thus, a balance is ultimately struck (penalties vs. benefits) to maintain or enhance engine performance, while also enabling an increase in the critical speed of the low-pressure turbine shaft, or not lowering the critical speed, e.g., add 1 or 2 additional stages to a compressor to increase efficiency, to allow for faster speeds for the power turbine while avoiding sustained operations at or near the critical speed. To achieve this balance, tradeoffs are made to 1) allow for a lengthened high-pressure compressor, shortened overall length of the engine for aero-performance, or reduced nacelle length or size, or any combination thereof, while 2) shortening the low-pressure turbine shaft length, in particular, the midshaft length and increasing the shaft diameter of the low-pressure turbine shaft to increase the critical speed of the low-pressure/low speed turbine shaft (LP shaft).

Different materials for the engine core (rotor disks, airfoils) and changes in size of the core have an impact on the dynamics of the high speed shaft, the low speed shaft, and the interaction between these two shafts as can occur through dynamic excitation transmitted through shaft bearings. Next generation engines will operate with a higher power density (power/weight), which can mean lengthening the core by adding additional compression stages to the high speed compressor. Additionally, or alternatively, a core operating at a higher power density is expected to operate at higher temperatures at the compressor exit stage and the downstream turbine stages (e.g., higher EGTs as discussed above). In this regard, higher-temperature-tolerant material can be used to enable operating at higher temperatures, such as, a ceramic matrix composite (CMC) material. The use of such higher temperature-tolerant material is expected to bring about changes in weight and component size and volume, which is expected to influence the behavior of both the high-speed shaft and mid-shaft. Thus, the present disclosure also considers how the dynamics of the midshaft and high speed shaft might change when the engine core changes in size and weight, in response to a need to operate at higher power densities enabled by use of higher temperature-tolerant material.

Different approaches for engine types, midshaft geometry, bearing support, and material compositions are needed for next-generation turbomachine engines, to permit high-speed operation without resulting in an unstable bending mode, and, therefore, vibrations during regular operation. The present disclosure provides for a suitable design to meet these requirements while lowering vibrations, or at least maintaining a tolerable vibration environment during flight conditions (e.g., takeoff or max thrust), including a wide variety of shafts having different combinations of stiffness, material, bearing type and location, shaft length, and diameter in order to determine which embodiment(s) were most promising for a variety of contemplated engine designs, including different engine core sizes for different sized high-pressure compressors and high-pressure turbines. The various embodiments, as described herein including illustrated examples for both a ducted and open fan configuration of a gas turbine engine, include turbomachine shafts that employ one or more of the above-mentioned techniques to increase the critical speed of the LP shaft and/or maintain a design speed for improved efficiency while mitigating or avoiding a subcritical or critical speed situation during flight operations, or operating supercritical within a 5% to 10% margin of the redline speed.

Moreover, it will be appreciated that in addition to a gas turbine engine that integrates composite fan blades in a fan of a high-bypass gas turbine engine, leveraging the increased strength to weight ratio of composite materials to facilitate an increase in a diameter of the fan blades of the gas turbine engine, which, e.g., can further facilitate a reduction in a fan pressure ratio of the fan to improve overall engine efficiency. The present disclosure can further incorporate architecture characterized by a Midshaft Rating (MSR) that ensures the LP shaft remains subcritical or supercritical within a 5% to 10% margin of the redline speed during operation of the gas turbine engine. The present disclosure also incorporates a bearing and shaft stiffness architecture characterized by a Midshaft Effective Flexural Rigidity (MEFR) that ensures the LP shaft remains subcritical.

Referring to the description hereinabove, as will be appreciated, with the lower fan pressure ratio comes an increase in propulsion efficiency. When such a fan configuration is combined with a gas turbine engine in accordance with the description hereinabove, e.g., a gas turbine engine having a high total sea level static thrust output and redline exhaust gas temperature for a given high-pressure compressor exit area, a compounded improvement in gas turbine engine efficiency is provided.

In particular, in the description hereinabove, the emphasis was on fan design parameters, particularly how changes in, e.g., fan blade radius and hub radius (embodied in the FLTCF and FLTOR relationships) improve thrust and aerodynamic efficiency. By adding the shaft arrangements discussed below, the engine can simultaneously benefit from an MSR or a MEFR within the ranges defined below while still operating at reduced fan pressure ratios and high bypass ratios. This pairing allows the engine architecture to take advantage of lower fan rotor speeds—thereby supporting the lower solidity fan designs—while remaining subcritical or supercritical within a 5% to 10% margin.

Moreover, it will be appreciated that reducing the core size complements the larger-diameter fan or fewer blades described hereinabove by further increasing the bypass ratio. A reduced core size corresponding to an increased bypass ratio shifts the engine cycle toward a lower specific thrust configuration, in which a reduced fan pressure ratio provides improved propulsive efficiency and reduced exhaust velocity.

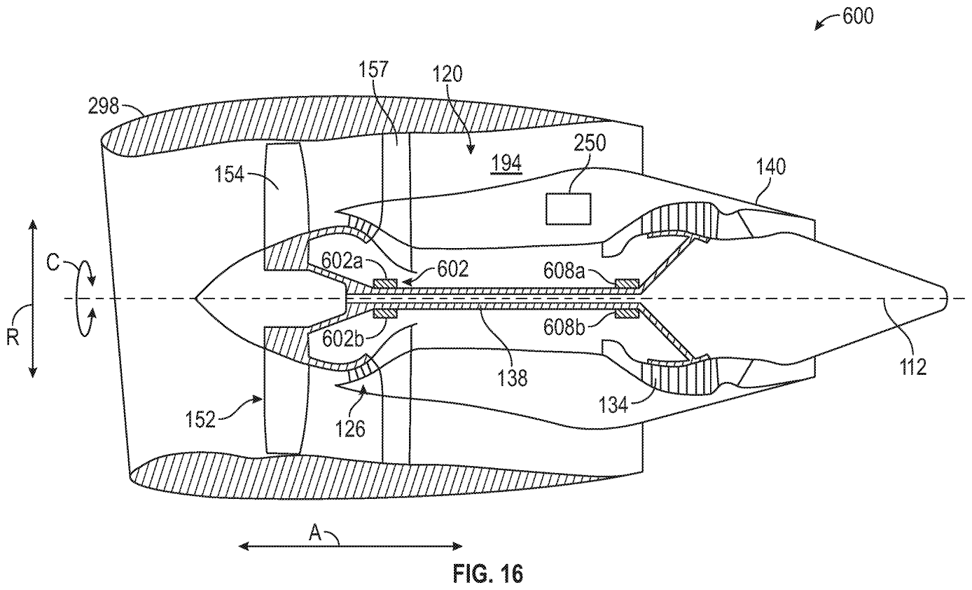

FIG. 16 shows a schematic, cross-sectional view of a gas turbine engine 600, taken along a longitudinal centerline axis 112 of the gas turbine engine 600, in accordance with another exemplary embodiment of the present disclosure. The exemplary embodiment of FIG. 16 may be configured in substantially the same manner as the gas turbine engine 100 described above with respect to FIG. 11, and the same or similar reference numerals may refer to the same or similar parts. In particular, the gas turbine engine 600 includes the nacelle 298. The components of the core engine (e.g., the high-pressure compressor, the combustor, the high-pressure turbine, and the high-pressure shaft) are not shown in FIG. 16 for clarity.

The low-pressure shaft 138 is supported on bearings 602a, 602b, 608a, 608b, which are mounted to support structures (not shown) of the gas turbine engine 600. At each position, only two bearings are shown in FIG. 16 for clarity, though more than two bearings, e.g., 3 or 4 bearings forward or aft of the respective illustrated locations, may be arranged to support the low-pressure shaft 138 at the respective positions, and may be evenly spaced or irregularly spaced depending on the geometry of the bearing supporting structure, and available space and clearances.

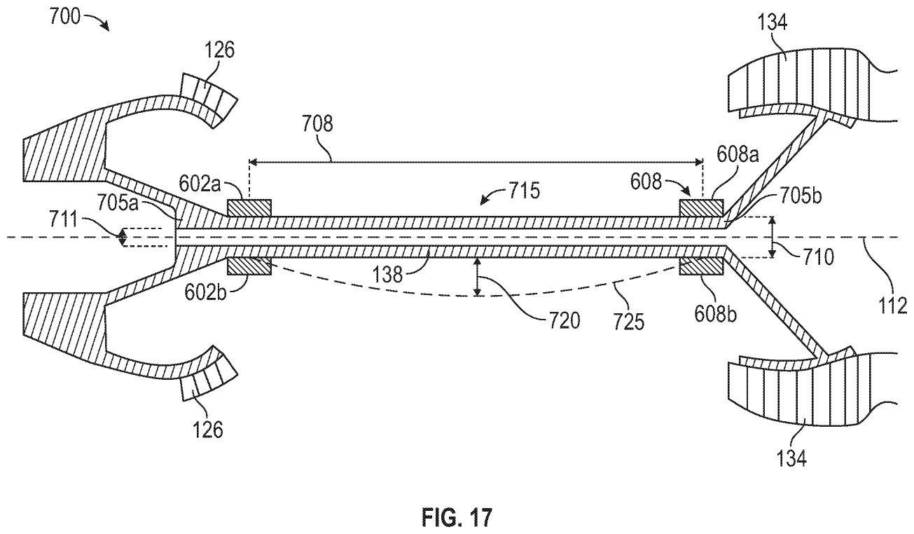

The low-pressure shaft 138, components of the low-pressure compressor 126, and components of the low-pressure turbine 134 all rotate around the longitudinal centerline axis 112 of the gas turbine engine 600, in either the same direction or a counter-rotating direction as that of the high-pressure spool. The low-pressure compressor 126 (or at least the rotating components thereof), the low-pressure turbine 134 (or at least the rotating components thereof), and the low-pressure shaft 138 may collectively be referred to as a low-pressure spool of the gas turbine engine 600 and is further described in FIG. 17.

As shown, the gas turbine engine 600 has a direct drive configuration in which the low-pressure shaft 138 is directly coupled to the fan 152 and thereby rotates the fan 152 at the same rotational speed as the low-pressure spool. Alternatively, in some embodiments, the gas turbine engine 600 includes a power gearbox (similar to the embodiment of FIG. 11), and the fan 152 is indirectly driven by the low-pressure spool across the power gearbox. The power gearbox may include a gearset for decreasing a rotational speed of the low-pressure spool relative to the low-pressure turbine 134, such that the fan 152 may rotate at a slower rotational speed than does the low-pressure spool.

FIG. 17 shows an enlarged view of a portion of the cross-sectional view of FIG. 16, that includes a low-pressure spool 700 according to some embodiments of the present disclosure. For example, a portion of the low-pressure compressor 126 and a portion of the low-pressure turbine 134 are shown mounted to the low-pressure shaft 138 of the gas turbine engine 600 (FIG. 16), which in this example is a two-spool engine. Alternatively, the low-pressure shaft 138 may be an intermediate shaft in a three-spool engine (not shown). The low-pressure shaft 138 is supported by at least bearings 602a to 608b, which are located at mounting points 705a, 705b associated with a low-pressure compressor 126 location and a low-pressure turbine 134 location, respectively, for providing shaft rotational support at these locations. In the example of FIG. 17, bearings 602a, 602b, 608a, and 608b are all positioned inside of the mounting points 705a and 705b, which is referred to as an inbound bearing layout, or alternatively referred to as an overhung configuration for the low-pressure compressor 126 and low-pressure turbine 134. If the bearings were positioned outside of the mounting point 705b, then that would be referred to as an outbound layout. The bearings 602a to 608b can, however, be positioned at any point along the low-pressure shaft 138, and may both be inbound, both be outbound, or one inbound and the other outbound.

The low-pressure shaft 138 has a length “L” (indicated by arrow 708) and an outer diameter “D” (indicated by arrow 710). The length L is also referred to as L_{MSR} and the outer diameter D is also referred to D_{MSR}, as detailed further below. The low-pressure shaft 138 can be hollow, with an inner diameter “d” indicated by arrow 711). In cases when the diameter of the low-pressure shaft 138 varies along the length L, the outer diameter “D” and the inner diameter “d” may be defined at a midpoint of the low-pressure shaft 138 (also referred to as the midshaft 715). The thickness may be defined as the thickness of the walls of the low-pressure shaft 138 in embodiments in which the low-pressure shaft 138 is hollow. A difference between a stated outer diameter D and inner diameter d of the low-pressure shaft 138 may be understood as the shaft's wall thickness. In cases when the wall thickness varies along the length of the low-pressure shaft 138, the thickness may be defined as the difference between the inner diameter and the outer diameter at the midshaft 715.

In some embodiments, the length L can be understood as the portion of the low-pressure shaft 138 between the bearings 602a to 608b and/or the mounting points 705a, 705b of engine components such as the low-pressure compressor 126 and the low-pressure turbine 134. For example, in the two-bearing arrangement of FIG. 17, the length L may be measured as the distance between midpoints of the bearings 602a to 608a, as indicated by the dashed vertical lines and arrow 708. For a four-bearing arrangement, there may be additional bearings along the shaft, in which case the length L may be measured as the distance between the midpoints of an innermost pair of bearings, or the distance between pairs or other groupings of bearings. In some embodiments, the length may be measured relative to specific bearings associated with specific engine components such as the low-pressure compressor 126 and the low-pressure turbine 134.

During operation, the low-pressure shaft 138 rotates with a rotational speed that can be expressed in either rotations per minute (RPM), or as an outer diameter (OD) speed expressed in units of linear velocity, such as feet per second (ft/sec). The rotational stability of the low-pressure shaft 138 relative to its operational range may be characterized by the resonance frequency of the fundamental or first order bending mode. When an operational speed is the same as this resonance frequency, the shaft is operating at its critical speed. The low-pressure shaft 138, when supported by bearings 602a to 608b, has a mode shape for this first order bending mode that may be generally described as a half-sinusoid, with a midshaft 715 location undergoing maximum displacement (indicated by arrow 720, which is exaggerated for clarity and is not to scale) and, therefore, having a maximum kinetic energy of displacement relative to other portions of the low-pressure shaft 138. The fundamental mode shape is illustrated by dashed line 725 extending from bearing 602b to bearing 608b in FIG. 17, though this is only half of the amplitude of oscillation. This unstable mode is a standing wave across the length L of the low-pressure shaft 138. The maximum deflection occurs when the excitation source has a periodicity or cyclic component near to the fundamental frequency. Since the bending mode is not active at the location of the innermost bearings 602a to 608b for the low-pressure shaft 138, the instability cannot be mitigated with the use of bearing dampers. When an engine is designed, the shaft speed expected to produce the highest deflection or instability at the midshaft is the shaft speed that equals the critical speed.

If the critical speed of the shaft critical speed falls within the standard operational range, i.e., if the critical speed is below the redline speed or the low-pressure shaft 138 is a supercritical shaft, then during routine operation, the low-pressure shaft 138 may at times operate at or pass through the critical speed, which induces an unstable condition. Even if the engine is operated at the critical speed temporarily, there is a possibility of undetected vibration, whirl instability, and some likelihood of damage. For low vibration and stability, it is preferable to have an operating range free of any intervening critical speeds.

There is a desire to pursue engines capable of operating at higher redline speeds. This pursuit of higher operating speeds requires that the low-pressure shaft 138 have a higher strength to weight characteristic if it is also desired that the shaft remain subcritical. The present disclosure provides this end result-higher speed shafts while remaining subcritical. To this end, a large number of engine designs were evaluated. Depending on the architecture, the positions and numbers of bearings relative to mounting points 705a, 705b were varied, and the resulting impact, not only on the critical speed but also the feasibility of such configurations given competing requirements (clearance, spacing, sump locations, oil supply lines), were taken into consideration, as will be readily apparent in view of the disclosure. A discussion of these embodiments follows. In the following discussion, strength to weight ratio is represented as E/rho, calculated as the ratio of Young's modulus E for the material (expressed, for example, in pounds per square foot) divided by the density rho (expressed, for example, in pounds per cubic inch). The shaft bending mode is represented as the critical rotational speed expressed in rotations per minute (RPM), though it could alternatively be expressed as the fundamental frequency of the bending mode in Hertz.

In some embodiments, high strength steel alloys, advanced materials, composite materials, and combinations thereof, were contemplated. For example, high strength-to-weight ratio materials such as titanium boride (TiB), a titanium metal matrix composite (TiMMC), provided 30% to 50% increased strength-to-weight ratio relative to steel or titanium alloys. In addition, coatings with materials such as graphene were found to improve strength by a factor of two in lab tests, without impacting weight. These types of changes in material composition may be characterized in some embodiments by the ratio of E/rho.

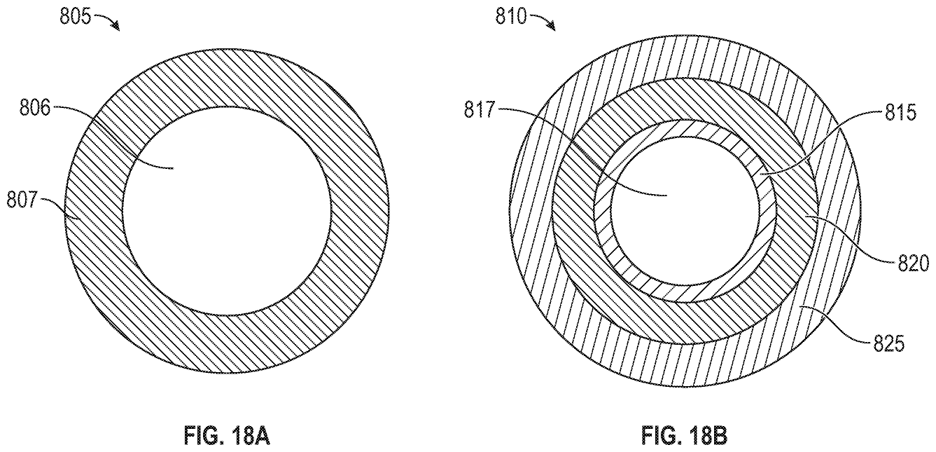

FIG. 18A shows a cross-sectional view of a steel shaft 805, with a standard hollow interior 806 surrounded by a steel layer 807, and geometry defined by a length L, outer diameter D, inner diameter d, etc.

FIG. 18B shows a cross-sectional view of an example of a composite shaft 810, with identical geometry to the steel shaft 805. Rather than being composed entirely of steel, the composite shaft 810 has an inner layer 815 surrounding a hollow interior 817, a middle layer 820, and an outer coating 825, all of different materials. The middle layer 820 in this example is also steel, though in other embodiments the composite shaft could use no steel at all, or have a different layer be steel.

For example, both the steel shaft 805 and the composite shaft 810 have length L of seventy-six inches and outer diameter of three inches, along with a standard inbound two-bearings configuration as depicted in FIG. 17. The fundamental frequency of the unstable mode for the steel shaft 805 is eighty Hertz (Hz), whereas the fundamental frequency for the composite shaft 810 is ninety Hz.

In other embodiments, more layers or fewer layers may be used. Some or all of these layers and coatings may be of numerous alternative materials to steel, including but not limited to TiB, TiMMC, other metals and metal matrix composites, silicon carbide (SiC), silicon carbide reinforced metals or alloys (e.g., SiC-MMC), aluminum alloys, graphene, or combinations thereof. The concepts of the present disclosure are not limited by the particular materials used for the layers and coatings. For the composite shaft 810, the critical speed corresponding to the unstable mode is increased relative to the (otherwise identical) steel shaft 805, which means that relative to the steel shaft 805, the composite shaft 810 can attain a higher rotational speed before reaching the critical speed.

Depending on the type of composite materials chosen and the relative thickness and arrangement of the layers, the ratio of stiffness to weight can be modified, and, therefore the critical speed can be increased. The present disclosure provides for a variety of embodiments resulting from the selection of different composite materials, thicknesses, and bearings configurations to allow for operation at higher speed. Two such embodiments are listed in TABLE 2. These embodiments were considered as possible designs that could increase the shaft stiffness to weight ratio in such a way to be compatible with engine architecture and without requiring modifications or limitations on the targeted operating range for a subcritical shaft.

TABLE 2

| | L | D | | E/rho | Teff | Mode |
|---|---|---|---|---|---|---|
| Embodiment | in | in | Bearing type | (in⁻¹) | (in) | (RPM) |
| 1 | 82.2 | 2.74 | 2-bearing | 1.00E+08 | 0.35 | 4181 |
| | | | outbound | | | |
| 2 | 60.6 | 2.75 | inbound OTM | 1.27E+08 | 0.35 | 10263 |
| 3 | 82.2 | 2.74 | outbound OTM | 1.27E+08 | 0.35 | 6915 |

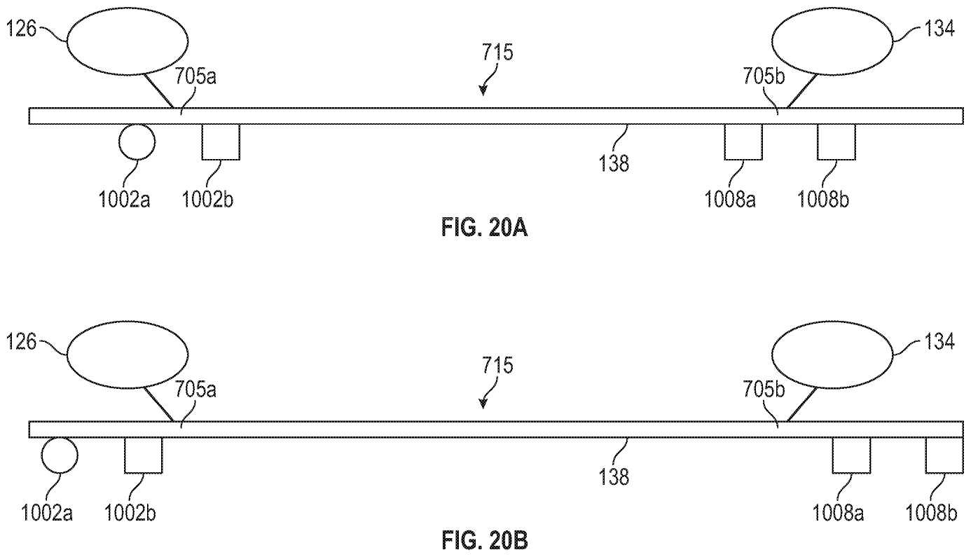

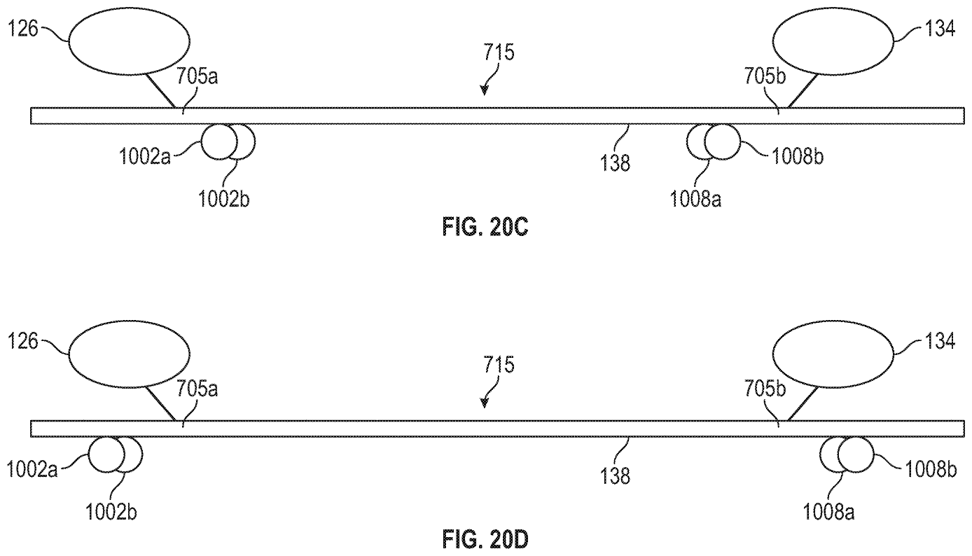

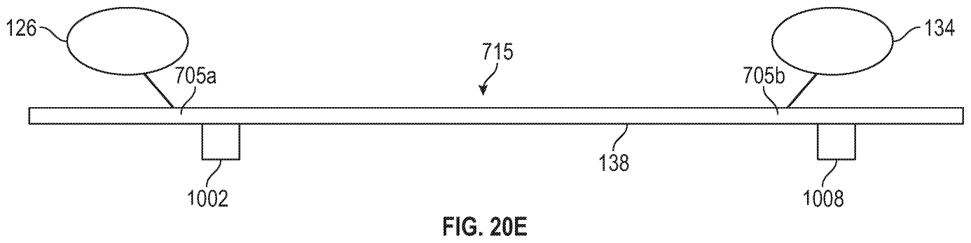

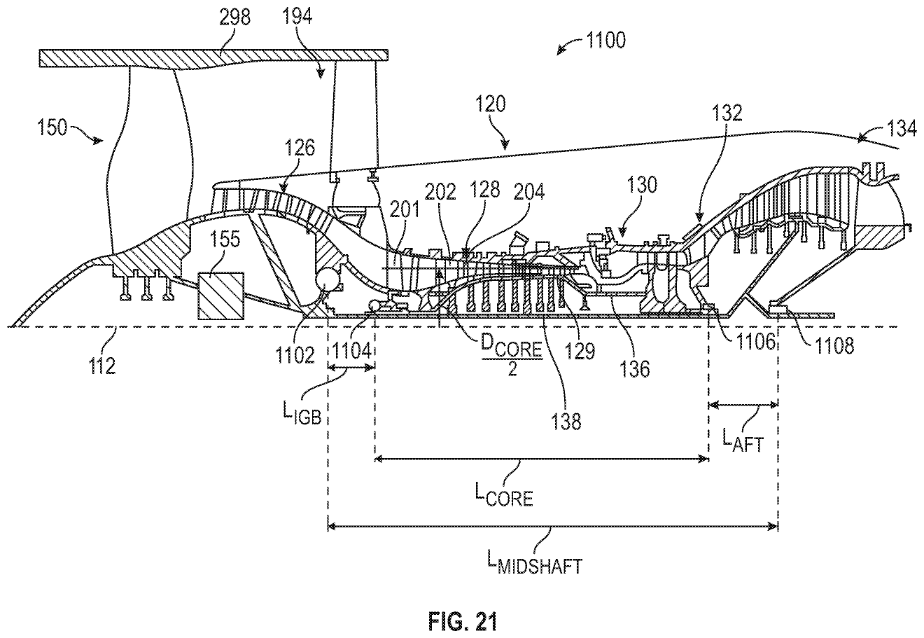

Embodiment 1 was evaluated using a high strength steel alloy and an outbound bearing layout. Embodiments 2 and 3 were evaluated with a composite material instead of steel alloy. Embodiment 2 uses overturning moment (OTM) bearings with an inbound bearing layout that is different from the layout used by Embodiment 1. Embodiment 3 uses OTM bearings with an outbound bearing layout that is similar to that used by Embodiment 1. These bearing types and layouts are described in further detail below with reference to FIG. 20A and TABLE 4. The values shown in TABLE 2 illustrate that Embodiments 2 and 3 achieve a higher strength-to-weight ratio (E/rho) when using a composite material, instead of the steel alloy used in Embodiment 1. As a result of these differences, the shaft mode critical speed occurs at 4181 RPM for Embodiment 1, at 10263 RPM for Embodiment 2 and at 6915 for Embodiment 3.

The present disclosure also modified the shaft thickness along its length, to evaluate the effect on critical speed for a strength to weight ratio of E/rho that is not constant along the length L, and for different suitable materials. An example of a shaft with a uniform E/rho along its length L is shown in FIG. 19A, and examples of shafts having variable E/rho are shown in FIG. 19B and FIG. 19C.

FIG. 19A conceptually shows a cross-sectional view of a uniform shaft 905 with a constant diameter and thickness. In this example, the uniform shaft 905 has a length L of seventy-six inches. The outer diameter D of the uniform shaft 905 is 3.0 inches. The uniform shaft 905 is hollow, with a constant wall thickness of 0.2 inches and corresponding constant inner radius of 1.3 inches along its length. For this example of a uniform shaft 905, and a two-bearing outbound configuration such as in FIG. 18, the fundamental frequency of the unstable mode is eighty Hz.

FIG. 19B conceptually shows a cross-sectional view of a concave shaft 910 with a constant outer diameter D and a variable thickness. For comparison, the uniform shaft 905 and the concave shaft 910 have the same material (e.g., hollow steel), bearings (outbound), and length (seventy-six inches), with a constant outer radius of 1.5 inches along its length. The outer diameter D of the concave shaft 910 is, therefore, 3.0 inches. Unlike the uniform shaft 905, however, the concave shaft 910 has a wall thickness of 0.3 inch at the ends 912, 914 (e.g., at the bearings, which are not shown in FIGS. 19A to 19C), and a thinner wall thickness of 0.15 inches in the midshaft region 915. This results in an inner radius of 1.35 inches in the midshaft region 915 and a smaller inner radius of 1.2 inches at the ends 912, 914. The concave shaft 910 therefore has a reduced mass density in the midshaft region 915. To achieve the resulting concave profile, various methods may be used to manufacture the concave shaft 910, such as a bottle boring technique.

FIG. 19C conceptually shows a cross-sectional of a convex shaft 920 with a variable outer diameter D and a variable thickness. For comparison, the uniform shaft 905 and the convex shaft 920 have the same material (e.g., hollow steel), bearings (outbound), and length (seventy-six inches), with a constant inner radius of 1.2 inches along its length. Unlike the uniform shaft 905, the convex shaft 920 has a wall thickness of 0.3 inch at the ends 922, 924, and a thinner wall thickness of 0.15 inches in the midshaft region 925, just like the concave shaft 910. Unlike the concave shaft 910, the convex shaft 920 has an outer radius of 1.5 inches at the ends 922, 924, and a smaller outer radius of 1.35 inches in the midshaft region 925. The convex shaft 920 also has a reduced mass density in the midshaft region 925.

Since the radius (and, therefore, the diameter) are variable over the length of the convex shaft 920, the diameter D is defined in some embodiments as the diameter at the midshaft region 925, since this has the most relevance to the bending mode and undergoes maximum deflection. In the example of the convex shaft 920, the shaft outer diameter D is 2.7 inches in the midshaft region 925. In other embodiments, for example, embodiments when the radius has multiple minima and/or maxima, the diameter D may be defined at any of those minima or maxima. To achieve the resulting convex profile, various methods may be used to manufacture the convex shaft 920, such as external machining.

For both convex and concave thickness profiles, as well as types of variable thickness profiles, the thickness may be described using an effective thickness value, Teff. For a uniform shaft the thickness would simply be the difference between the outer diameter and the inner diameter. When these values are variable over the length of the shaft, the effective thickness can be calculated as the difference between the effective outer diameter and effective inner diameter. For example, the effective thickness may be defined at the midshaft in some embodiments.

With variable thickness, in some embodiments the concave shaft 910 and the convex shaft 920 can have twenty-five to thirty percent less weight than the uniform shaft 905 in the midshaft region 915 and 925, respectively. Note that the variation in thickness need not be continuous, for example a stepped change in geometry could also be used. As a result, the fundamental frequency of the unstable mode for both the concave shaft 910 and the convex shaft 920 is increased to ninety Hz, which is higher than the eighty Hz fundamental frequency for the uniform shaft 905. In other words, the concave shaft 910 and the convex shaft 920 can both attain a higher rotational speed than that of uniform shaft 905, before reaching subcritical speeds.

The concave shaft 910 and the convex shaft 920 are examples of different thickness profiles that may be used in some embodiments. Other thickness profiles are also contemplated, which reduce or increase the mass density of the shaft in the midshaft region. The concepts of the current disclosure are not limited by the particular thickness profile used.

Depending on the thickness profile, the ratio of stiffness to weight can be modified to produce significant changes in the critical speed. embodiments are listed in TABLE 3. These embodiments were considered as possible designs that could modify the effective thickness in such a way to be compatible with engine architecture and without requiring modifications or limitations on the targeted operating range for a subcritical shaft.

TABLE 3

| | L | D | | E/rho | Teff | Mode |
|---|---|---|---|---|---|---|
| Embodiment | in | in | Bearing type | (in⁻¹) | (in) | (RPM) |
| 4 | 60.6 | 2.75 | inbound OTM | 1.00E+08 | 0.35 | 9001 |
| 5 | 82.2 | 2.74 | outbound OTM | 1.00E+08 | 0.35 | 6065 |
| 6 | 60.6 | 2.75 | inbound OTM | 1.00E+08 | 0.32 | 10039 |
| 7 | 82.2 | 2.74 | outbound OTM | 1.00E+08 | 0.32 | 6942 |

Embodiments 4, 5, 6, and 7 all use a steel alloy material composition. Embodiments 4 and 6 use an inbound bearing layout with OTM bearings, and Embodiments 5 and 7 use an outbound bearing layout with OTM bearings. Embodiments 4 and 5 are uniform shafts similar to the Example of FIG. 20A. Embodiments 6 and 7, however, have a convex thickness profile similar to the example of FIG. 19C, having been manufactured with a bottle boring manufacturing technique. The values shown in TABLE 3 illustrate that Embodiments 6 and 7 achieve a lower effective thickness Teff due to their convex profile, instead of the uniform profile for Embodiments 4 and 5. As a result of these differences, the shaft mode critical speed occurs at 9001 RPM for Embodiment 4, and at 10039 RPM for Embodiment 6. The shaft mode critical speed occurs at 6065 RPM for Embodiment 5, and at 6942 RPM for Embodiment 7.

The present disclosure also provides for a variety of shafts with modified bearing configurations. Bearings are used to provide transverse support to the shaft along its length. Bearings may be ball-type bearings, which have a very small contact area with the shaft to provide less friction, or roller-type bearings, which have a large contact area with the shaft to provide increased rigidity and load bearing. Different types of bearings may be mixed in various bearing layouts. According to additional embodiments, different bearing layouts were considered, for different combinations of uniform, convex, and concave shafts, or varying shaft thickness profiles and material composition in order to determine which combination would work best for a given architecture and need, as well as taking into account competing engineering requirements.

A variety of combinations of bearing configurations were contemplated, such as embodiments when the number of bearings in duplex and/or straddling position relative to engine components (e.g., the low-pressure compressor 126 or the low-pressure turbine 134) were changed. Either or both of the engine components mounted to the low-pressure shaft 138 may be straddled or overhung. It was found that these variations can improve the critical speed and/or be more suitable to accommodate space limitations, lubrication resources or other architecture-imposed limitations. The embodiments included locating bearings at different inbound or outbound positions relative to the mounting points 705a, 705b.

Specific bearing layouts were preferentially used in various embodiments. These are now described in more detail, though the concepts of the present disclosure are not limited by the particular number or arrangement of bearings described herein.

For example, FIG. 20A conceptually shows the low-pressure turbine 134 and the low-pressure compressor 126 mounted on the low-pressure shaft 138 (e.g., a low-pressure shaft) supported by a four-bearing straddle configuration. Additional bearings located around the circumference of the low-pressure shaft 138 are omitted from FIG. 20A for clarity. In this system, one pair of bearings 1002a, 1002b straddle (i.e., placed forward and aft of) the mounting point 705a of the low-pressure compressor 126, and a second pair of bearings 1008a, 1008b straddle a mounting point 705b of the low-pressure turbine 134. In this example, the bearings 1002b, 1008a, and 1008b are roller bearings, and the bearing 1002a is a ball bearing, though these bearing types may vary in other embodiments. The length L for low-pressure shaft 138 is represented in some embodiments as the distance between the midpoints or centers of the innermost bearings 1002b, 1008a. The four-bearing straddle layout is used in several embodiments described with reference to TABLE 4.

As another example, FIG. 20B conceptually shows the low-pressure turbine 134 and the low-pressure compressor 126 mounted on the low-pressure shaft 138 supported by a four-bearing outbound configuration. Additional bearings located around the circumference of the low-pressure shaft 138 are omitted from FIG. 20B for clarity. This system is similar to that of the straddle system shown in FIG. 20A, but differs in that the bearings 1002a, 1002b are both placed forward of mounting point 705a of the low-pressure compressor 126, and the bearings 1008a, 1008b are placed aft of mounting point 705b of the low-pressure turbine 134. The low-pressure shaft 138 may extend beyond the bearings 1008a, 1008b. As in the example of FIG. 20A, the bearings 1002b, 1008a, and 1008b are roller bearings, and the bearing 1002a is a ball bearing, though these bearing types may vary. The length L for low-pressure shaft 138 is represented in some embodiments as the distance between the midpoints or centers of the innermost bearings 1002b, 1008a.

As yet another example, FIG. 20C conceptually shows the low-pressure shaft 138 with an inbound duplex bearing configuration. Additional bearings located around the circumference of the low-pressure shaft 138 are omitted from FIG. 20C for clarity. According to some embodiments, the bearings 1002a, 1002b are ball bearings and arranged in a duplex configuration aft of the mounting point 705a for the low-pressure compressor 126. The bearings 1008a, 1008b are ball bearings and arranged in a duplex configuration forward of the mounting point 705b for the low-pressure turbine 134. Duplex bearing arrangements may also be referred to as double-row bearings, or overturning moment (OTM) bearings, since they provide moment stiffness to the shaft, i.e., provide resistance to rotation across the bearing locations. In some embodiments duplex bearing types may include tandem bearings, back-to-back bearings, face-to-face bearings, and/or tapered roller bearings.

In the example shown in FIG. 20C, both the bearings 1002a, 1002b and the bearings 1008a, 1008b are in an inbound position, i.e., located closer towards the midshaft 715 than the respective mounting points 705a, 705b. In this position, the low-pressure compressor 126 and the low-pressure turbine 134 are referred to as overhung. This inbound OTM layout is used in Embodiments 2, 4, and 6, for example, described above with reference to TABLES 2 and 3.

Alternatively, the bearings 1002a, 1002b and/or the bearings 1008a, 1008b may be in an outbound position, as shown in FIG. 20D, i.e., located farther from the midshaft 715 than the respective mounting points 705a, 705b of the low-pressure compressor 126 and the low-pressure turbine 134. The length L for the duplex bearing configurations shown in FIG. 20C and FIG. 20D may be represented in some embodiments as the distance between the midpoints or centers of the innermost bearings 1002b and 1008a, or alternatively, as the distance between the center of the first pair of bearings 1002a, 1002b and the center of the second pair of bearings 1008a, 1008b. The outbound OTM layout is used in Embodiments 3, 5, and 7, for example, described above with reference to TABLES 2 and 3.

As a further example, FIG. 20E conceptually shows the low-pressure shaft 138 with a two-bearing configuration. This configuration employs a first bearing 1002 positioned aft of the mounting point 705a for the low-pressure compressor 126, and a second bearing 1008 positioned aft of the mounting point 705b for the low-pressure turbine 134. The length L for this two-bearing configuration is represented in some embodiments as the distance between the midpoints or centers of the bearings 1002, 1008. Alternative two-bearing configurations may position the two bearings in either an outbound configuration or an inbound configuration. An example of a two-bearing layout in an inbound configuration is shown in FIG. 16, that shows bearings 602a, 602b, 608a, and 608b are all located inbound of the mounting points for the low-pressure compressor 126 and the low-pressure turbine 134. Note that in this context, two is the number of bearings along the low-pressure shaft 138 and does not include additional bearings along the circumference of the low-pressure shaft 138. Embodiment 1, described above with reference to TABLE 2, uses a two-bearing layout in an outbound configuration (not shown).

In FIGS. 20A to 20E, the lines connecting the low-pressure compressor 126 to the mounting point 705a and the low-pressure turbine 134 to the mounting point 705b are intended only to indicate schematically the general location of a net force of the core engine components (e.g., the low-pressure compressor 126 or the low-pressure turbine 134) acting on the low-pressure shaft 138 relative to the bearings, and is illustrated in this fashion only for purposes of illustrating a relationship between the nearest engine component relative to the bearing(s). The actual loading on a shaft is distributed and comes from not only the engine components represented by the low-pressure compressor 126 and the low-pressure turbine 134, but other nearby structures as well. In these embodiments, the primary loading for purposes of this disclosure may, however, be thought of simply in terms of engine components attached to the low-pressure shaft 138 (e.g., the low-pressure turbine 134 and the low-pressure compressor 126). The representation shown in FIGS. 20A to 20E is sufficient in defining the parts of the engine that mostly influence the low-pressure shaft 138 behavior.

As discussed, at least one bearing may have an overturning moment (OTM) capability, which can resist relative rotation across the bearing in at least a lateral plane or a vertical plane. These relative rotations may occur during bending of the shaft. The position along the shaft of such bearings with OTM capabilities may directly affect the critical speed, by providing constraints to the relative rotations of the shaft, in addition to the transverse support function of the bearings.

Examples of embodiments with different bearing arrangements are summarized in TABLE 4. Generally, the present disclosure found that the number of bearings, the position of the bearings and the OTM capability of the bearings can be selected to make a full range of operations subcritical for an engine. In other words, the selection of bearing layout can affect (either increase or decrease) the shaft's critical speed.

TABLE 4

| | L | D | Bearing | E/rho | Teff | Mode |
|---|---|---|---|---|---|---|
| Embodiment | in | in | type | (in⁻¹) | (in) | (RPM) |
| 8 | 60.6 | 2.75 | 4-bearing | 1.00E+08 | 0.35 | 7746 |
| | | | straddle | | | |
| 9 | 60.6 | 2.75 | 4-bearing | 1.00E+08 | 0.32 | 8555 |
| | | | straddle | | | |
| 10 | 60.6 | 2.75 | 4-bearing | 1.27E+08 | 0.35 | 8832 |
| | | | straddle | | | |
| 11 | 82.2 | 2.74 | 4-bearing | 1.27E+08 | 0.32 | 9703 |
| | | | straddle | | | |
| 12 | 60.6 | 2.75 | inbound | 1.27E+08 | 0.32 | 11386 |
| | | | OTM | | | |
| 13 | 82.2 | 2.74 | outbound | 1.27E+08 | 0.32 | 7873 |
| | | | OTM | | | |

Embodiments 8, 9, 10, and 11 use a four-bearing straddle layout. Embodiments 8 and 9 use steel alloy, while Embodiments 10 and 11 use composite materials. Embodiments 8 and 10 have a uniform thickness profile, while Embodiments 9 and 11 have a concave thickness profile, manufactured using a bottle boring method. As a result of these differences, the shaft mode critical speed occurs at 7746 RPM for Embodiment 8, 8555 RPM for Embodiment 9, 8832 RPM for Embodiment 10, and 9703 RPM for Embodiment 11.

Embodiments 11, 12, and 13 all use composite material and concave thickness profile via bottle boring. However, Embodiment 11 uses a four-bearing straddle layout, Embodiment 12 uses an inbound OTM bearing layout, and Embodiment 13 uses an outbound OTM bearing layout. As a result of these differences, the shaft mode critical speed occurs at 9703 RPM for Embodiment 11, 11386 RPM for Embodiment 12, and 7873 RPM for Embodiment 13.

Embodiment 11 can also be compared to Embodiments 8, 9, and 10 as described with reference to TABLE 4. This allows a comparison of the impact on critical speed of using composite material, variable thickness profile, and both, on a shaft with a four-bearing straddle layout.

Embodiment 12 can be compared to Embodiments 2, 4, and 6 described with reference to TABLE 3. This allows a comparison of the impact on critical speed of using composite material, variable thickness profile, and both, on a shaft with an inbound OTM layout.

Embodiment 13 can be compared to Embodiments 3, 5, and 7 described with reference to TABLE 3. This allows a comparison of the impact on critical speed of using composite material, variable thickness profile, and both, on a shaft with an outbound OTM layout.

Additionally, Embodiments 2 and 3 (in TABLE 2), and 10 (in TABLE 4) can be compared, to evaluate the impact on critical speed of using different bearing layouts on shafts using composite material. Embodiments 6 and 7 (in TABLE 3) and 9 (in TABLE 4) can be compared, to evaluate the impact on critical speed of using different bearing layouts on shafts using concave thickness profiles.

The embodiments of engines, and in particular the shafts associated with a power turbine described with reference to FIGS. 18A, 18B, 19A to 19C, 20A, and 20B, were found to provide an improvement in the performance of a shaft vis-à-vis its operating range. In addition to the mentioned embodiments and those provided in TABLES 2 to 4, the types of improvements to the critical speed of the shaft when these features were combined, taking into consideration the various benefits, as well as down-sides, to selecting a particular configuration for an engine architecture.

Examples of a subcritical shaft with a high redline speed include a shaft with a redline speed of, e.g., 70 ft/sec and adapted for a shaft mode of 5293 RPM, a shaft with a redline speed of, e.g., 75 ft/sec and adapted for a shaft mode of 6380 RPM, and a shaft with a redline speed of, e.g., 181 ft/sec and adapted for a shaft mode of 11410 RPM.

FIGS. 21 to 27 illustrate various gas turbine engines. In the embodiments of FIGS. 21 to 27, the low-pressure shaft is supported within the engine with different bearing arrangements. The gas turbine engines of FIGS. 21 to 27 may include structure that is the same as, or similar to, the gas turbine engines described with respect to FIGS. 4, 11, and 16 and the gas turbine engines may operate the same as, or similar, as the turbine engines described with respect to FIGS. 4, 11, and 16. Accordingly, reference numerals are omitted from FIGS. 21 to 27 for clarity, but it is understood that features of similar appearance are the same as or similar to the like features shown in FIGS. 5, 11, and 16. Although only one half of the gas turbine engine is shown in FIGS. 21 to 27, a mirror image of the depicted half exists on the other side of the centerline axis (e.g., similar to the gas turbine engine 100 shown in FIG. 1).

FIG. 21 is a cross-sectional view of a gas turbine engine 1100, taken along a longitudinal centerline axis 112 of the gas turbine engine 1100, in accordance with another exemplary embodiment of the present disclosure. The exemplary embodiment of FIG. 21 may be configured in substantially the same manner as the gas turbine engine 100 described above with respect to FIG. 11, and the same or similar reference numerals may refer to the same or similar parts. In particular, the gas turbine engine 1100 includes the nacelle 298. The HP compressor 128 includes an inlet guide vane (IGV) 201 upstream from a first stage of the HP compressor 128. In this way, the IGV 201 directs the core air into the HP compressor 128 at a particular angle.

The gas turbine engine 1100 includes one or more bearings that rotationally support the shafts (e.g., the low-pressure shaft 138 or the high-pressure shaft 136). In particular, the gas turbine engine 1100 includes a first bearing 1102, a second bearing 1104, a third bearing 1106, and a fourth bearing 1108. The first bearing 1102 rotationally supports the low-pressure shaft 138 on a forward side of the core engine and the fourth bearing 1108 rotationally supports the low-pressure shaft 138 on an aft side of the core engine. The second bearing 1104 supports the high-pressure shaft 136 on a forward side of the core engine and the third bearing 1106 supports the high-pressure shaft 136 on the aft side of the core engine. The first bearing 1102 and the second bearing 1104 are ball bearings and the third bearing 1106 and the fourth bearing 1108 are roller bearings. The first bearing 1102, the second bearing 1104, the third bearing 1106, and the fourth bearing 1108 can include any type of bearing or rotational support for rotationally supporting the low-pressure shaft 138 or the high-pressure shaft 136. In some embodiments, the bearings can include two axially spaced bearings at each location.

In FIG. 21, the length L_{MIDSHAFT} is a length of a portion of the low-pressure shaft 138, referred to as a midshaft. The length L_{MIDSHAFT} is defined from the first bearing 1102 (e.g., also referred to as an inboard low-pressure shaft forward bearing) to the fourth bearing 1108 (e.g., also referred to as an inboard low-pressure shaft aft bearing). The length L_{MIDSHAFT} is the lateral distance, parallel to the longitudinal centerline axis 112, defined between midpoints of the first bearing 1102 and the fourth bearing 1108.

The length L_{IGB} is the length from the first bearing 1102 (e.g., the inboard low-pressure shaft forward bearing) to the second bearing 1104 (e.g., also referred to as a core forward bearing). The length L_{IGB} is the lateral distance, parallel to the longitudinal centerline axis 112, defined between midpoints of the first bearing 1102 and the second bearing 1104.

The length L_{CORE} is the length of the engine core (e.g., the length including the high-pressure compressor 128, the combustion section 130, and the high-pressure turbine 132). The length L_{CORE} is defined between the second bearing 1104 (e.g., core forward bearing) and the core aft bearing (e.g., a core aft bearing). The length L_{CORE} is the lateral distance, parallel to the longitudinal centerline axis 112, defined between midpoints of the second bearing 1104 and the third bearing 1106. In this way, the length L_{CORE} is the length of the high-pressure shaft 136 from the second bearing 1104 to the third bearing 1106. In particular, the length L_{CORE} is defined as an axial distance between the core forward bearing and the core aft bearing with at least one stage of the high-pressure compressor 128 between the core forward bearing and the core aft bearing. In FIG. 21, the core forward bearing is positioned forward of a stage of the high-pressure compressor 128 and the core aft bearing is positioned aft of a stage of the high-pressure turbine 132. In some embodiments, one or more stages of the high-pressure compressor 128 can be positioned forward of the core forward bearing, while at least one stage of the high-pressure compressor 128 is positioned aft of the core forward bearing.

The length L_{AFT} is the length from aft of the core to the inboard low-pressure shaft aft bearing (e.g., the fourth bearing 1108). The length L_{AFT} is the lateral distance, parallel to the longitudinal centerline axis 112, defined between midpoints of the third bearing 1106 and the fourth bearing 1108.

The core diameter D_{CORE} represents the diameter of the engine core. The diameter D_{CORE} is defined by the outer diameter of the exit from a last stage 129 of the high-pressure compressor 128, also referred to as the exit stage diameter. In this way, the last stage 129 defines an exit of the high-pressure compressor 128. The radius of the core is shown in FIG. 21 as

$$\frac{{D}_{CORE}}{2} .$$

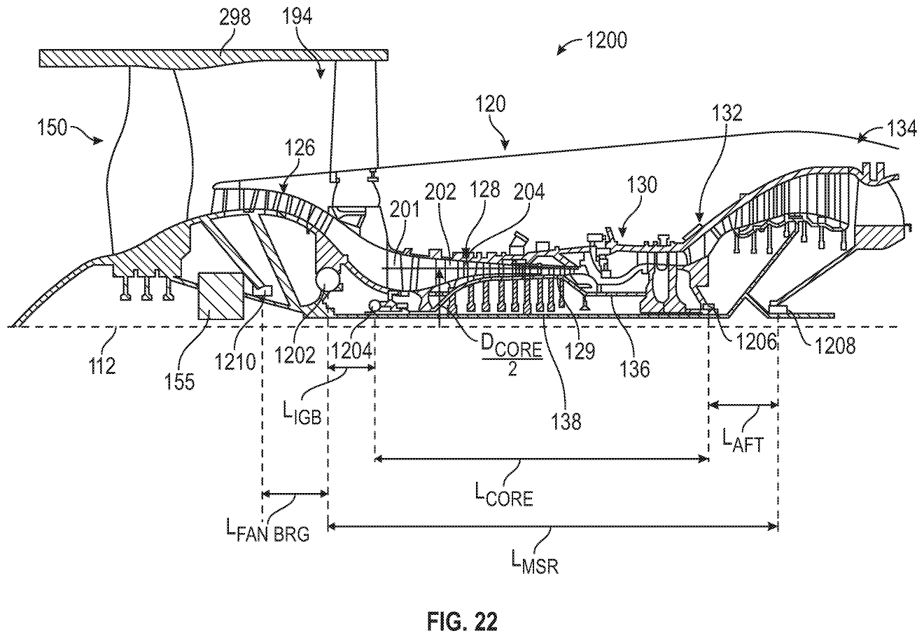

FIG. 22 shows a cross-sectional view of a gas turbine engine 1200, taken at the longitudinal centerline axis 112, according to another embodiment. The gas turbine engine 1200 includes a first bearing 1202, a second bearing 1204, a third bearing 1206, and a fourth bearing 1208. The gas turbine engine 1200 also includes a second forward bearing, also referred to as a fifth bearing 1210 on the low-pressure shaft 138. The fifth bearing 1210, also referred to as a fan bearing, may be a roller bearing (e.g., a tapered roller bearing or a plurality of tapered roller bearings) and the first bearing 1202 may be a ball bearing. In this arrangement, the low-pressure shaft 138 has two bearings forward of the core (e.g., the first bearing 1202 and the fifth bearing 1210) and one bearing aft of the core (e.g., the fourth bearing 1208).

The gas turbine engine 1200 also has a length L_{FAN BRG} that is the length from the fifth bearing 1210 (e.g., the fan bearing) to the first bearing 1202 (e.g., the inboard low-pressure shaft forward bearing). The length L_{FAN BRG} is the lateral distance, parallel to the longitudinal centerline axis 112, defined between midpoints of the fifth bearing 1210 and the first bearing 1202. Although not shown for clarity, any of the engines detailed herein can include the fifth bearing 1210.

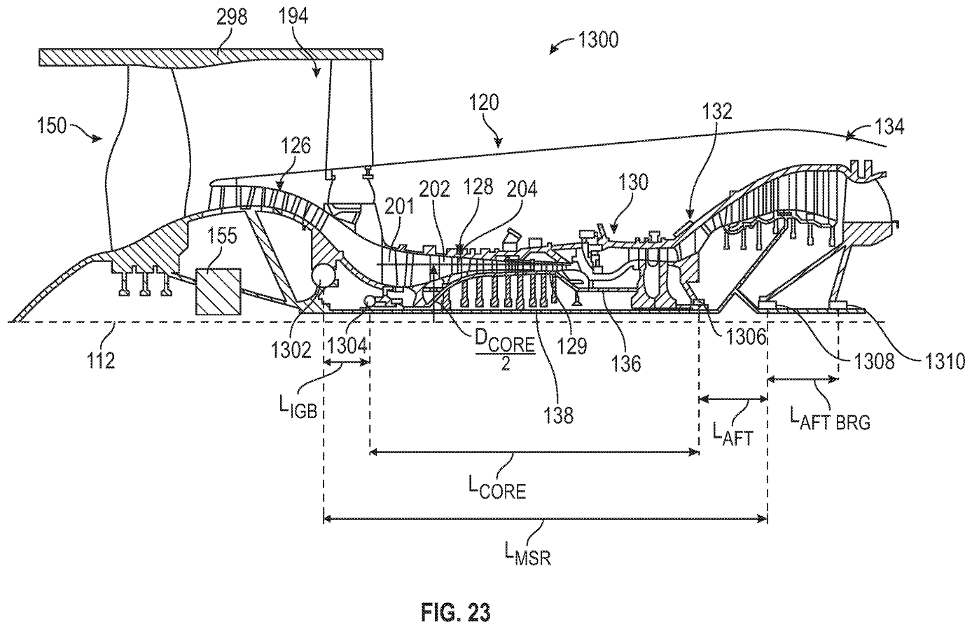

FIG. 23 shows a cross-sectional view of an gas turbine engine 1300, taken along the longitudinal centerline axis 112, according to another embodiment. The gas turbine engine 1300 includes a first bearing 1302, a second bearing 1304, a third bearing 1306, a fourth bearing 1308, and a fifth bearing 1310. The low-pressure shaft 138 is supported by one bearing on the forward side of the core (e.g., first bearing 1302) and two bearings on the aft side of the core (e.g., the fourth bearing 1308 and the fifth bearing 1310). The high-pressure shaft is supported by the second bearing 1304 on a forward side and the third bearing 1306 on the aft side. The first bearing 1302 and the second bearing 1304 may be ball bearings, although other types of bearings or rotational supports are contemplated. The third bearing 1306, the fourth bearing 1308, and the fifth bearing 1310 may be roller bearings, although other types of bearings or rotational supports are contemplated.

In FIG. 23, the length L_{MSR} is the length of the low-pressure shaft 138 employed in relationship (3) (below) to determine the midshaft rating of the low-pressure shaft 138. The length L_{MSR} is defined between the inboard low-pressure shaft forward bearing (e.g., the first bearing 1302) and the inboard low-pressure shaft aft bearing (e.g., the fourth bearing 1308). The length L_{MSR} is the lateral distance, parallel to the longitudinal centerline axis 112, defined between midpoints of the first bearing 1302 and the fourth bearing 1308.

The length L_{IGB} is the length from the inboard low-pressure shaft forward bearing (e.g., the first bearing 1302) to the core forward bearing (e.g., the second bearing 1304). The length L_{IGB} is the lateral distance, parallel to the longitudinal centerline axis 112, defined between midpoints of the first bearing 1302 and the second bearing 1304.

The length L_{CORE} is the length of the engine core (e.g., the length including the high-pressure compressor 128, the combustion section 130, and the high-pressure turbine 132). The length L_{CORE} is defined between the core forward bearing (e.g., the second bearing 1304) and the core aft bearing (e.g., the third bearing 1306). The length L_{CORE} is the lateral distance, parallel to the longitudinal centerline axis 112, defined between midpoints of the second bearing 1304 and the third bearing 1306.

The length L_{AFT} is the length from aft of the core to the inboard low-pressure shaft aft bearing (e.g., the fourth bearing 1308). The length L_{AFT} is the lateral distance, parallel to the longitudinal centerline axis 112, defined between midpoints of the third bearing 1306 and the fourth bearing 1308.

The length L_{AFT BRG} is the length from the inboard low-pressure shaft aft bearing (e.g., the fourth bearing 1308) to an aftmost bearing (e.g., the fifth bearing 1310). The length L_{AFT BRG} is the lateral distance, parallel to the longitudinal centerline axis 112, defined between midpoints of the fourth bearing 1308 and the fifth bearing 1310.

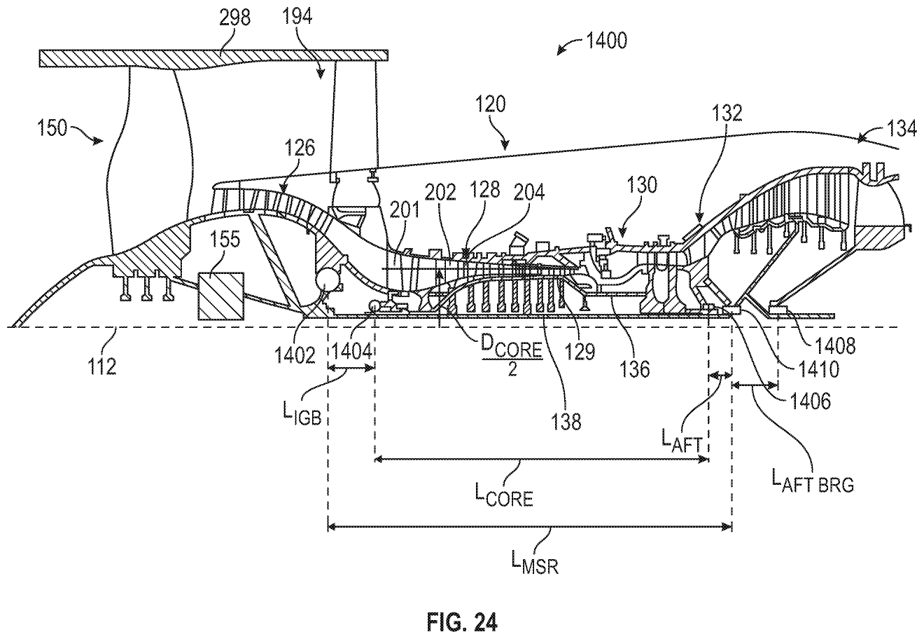

The core diameter D_{CORE} represents the diameter of the engine core. The diameter D_{CORE} is defined by the outer diameter of the exit from a last stage 129 of the high-pressure compressor 128. The radius of the core is shown in FIG. 24 as

$$\frac{{D}_{CORE}}{2} .$$

FIG. 24 shows a cross-sectional view of a gas turbine engine 1400, taken along the longitudinal centerline axis 112. The gas turbine engine 1400 includes a first bearing 1402, a second bearing 1404, a third bearing 1406, a fourth bearing 1408, and a fifth bearing 1410. The low-pressure shaft 138 is supported by one bearing on the forward side of the core (e.g., first bearing 1402) and two bearings on the aft side of the core (e.g., the fourth bearing 1408 and the fifth bearing 1410), where the two aft bearings are straddled as shown in FIG. 24. The high-pressure shaft 136 is supported by the second bearing 1404 on a forward side and the third bearing 1406 on the aft side. The first bearing 1402 and the second bearing 1404 may be ball bearings, although other types of bearings or rotational supports are contemplated. The third bearing 1406, the fourth bearing 1408, and the fifth bearing 1410 may be roller bearings, although other types of bearings or rotational supports are contemplated.

In FIG. 24, the length L_{MSR} is the length of the low-pressure shaft 138 defined between midpoints of the first bearing 1402 and the fourth bearing 1408. The length L_{IGB} is the length defined between midpoints of the first bearing 1402 and the second bearing 1404. The length L_{CORE} is the length of the engine core defined between midpoints of the second bearing 1404 and the third bearing 1406. The length L_{AFT} is the length defined between midpoints of the third bearing 1406 and the fifth bearing 1410. The length L_{AFT BRG} is the length defined between midpoints of the fifth bearing 1410 and the fourth bearing 1408.

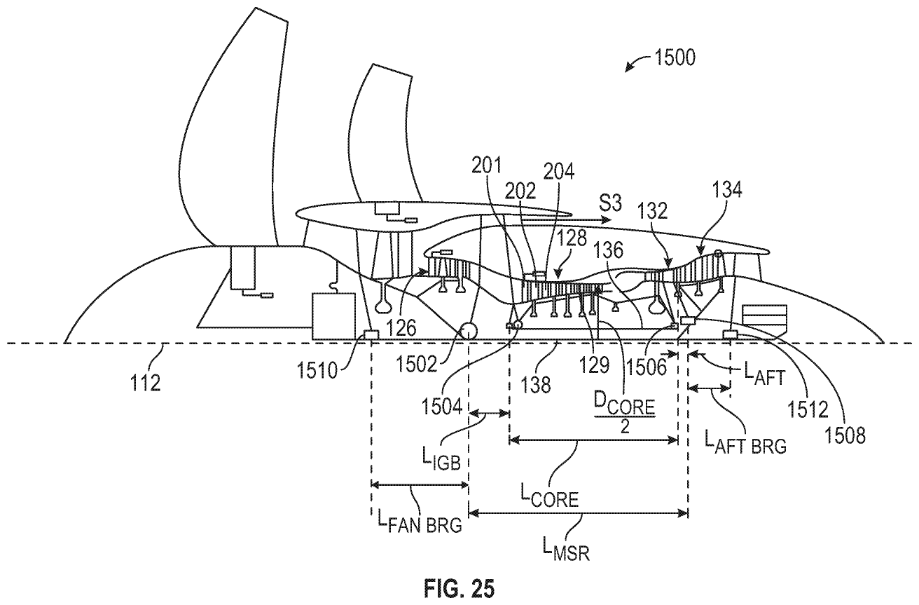

FIG. 25 shows a schematic view of a gas turbine engine 1500. In particular, the gas turbine engine 1500 is a three-stream, open fan engine, similar to the gas turbine engine of FIG. 4. The gas turbine engine 1500 includes a first bearing 1502, a second bearing 1504, a third bearing 1506, a fourth bearing 1508, a fifth bearing 1510, and a sixth bearing 1512. The first bearing 1502, the second bearing 1504, the third bearing 1506, and the fourth bearing 1508 are defined as above. The fifth bearing 1510 is positioned to support the low-pressure shaft 138 forward of the first bearing 1502, similar to the embodiment of FIG. 22. The sixth bearing 1512 is positioned to support the low-pressure shaft 138 aft of the fourth bearing 1508, similar to the embodiment of FIG. 24.

In FIG. 25, the length L_{MSR}, the length L_{IGB}, the length L_{CORE}, and the length L_{AFT} are defined as above. The length L_{AFT BRG} is defined as the length between the midpoint of the fourth bearing 1508 and the midpoint of the sixth bearing 1512.

The term “IGB” refers to the inlet gearbox to drive the core to start the engine, run pumps or other accessories. Referring to FIGS. 25 to 29, the location of the first bearing 1102, 1202, 1302, 1402, and 1502 relative to the second bearing 1104, 1204, 1304, 1404, and 1504 may also be chosen for reasons isolating, or reducing a dynamic coupling between vibration modes of the LP shaft (i.e., bending mode excited between the LP shaft rotates at its critical speed) and modes associated with other components supported by a separate frame from, or the same frame supporting the core. For example, referring to FIG. 25, coupling between a modal property of the frame supporting the mid-fan (located directly below the outlet guide vanes) and the modal property of the LP shaft may excite the LP shaft when the engine operates at certain speeds. The length L_{IGB} distance may also be affected when stages are added or removed from the booster (e.g., the low-pressure compressor 126) or when the outlet guide vanes are moved closer or further away from the primary fan. The L_{IGB} distance may also increase relative to the HPC front end in order to align the forward bearing (e.g., first bearing 1502) more closely with the axial center of gravity of the frame supporting the booster and OGV. The core is normally supported by a separate frame from the frames that supports the fan, gearbox and booster. In some embodiments the first bearing 1502 and the second bearing 1504 may be located so as to provide direct support for both a center frame (supporting the core) and a forward frame (supporting, e.g., the booster).

The bearing distances L_{AFT} and L_{AFT BRG} may be affected by the number of stages in the LPT. If a stage is added then the distances aft of L_{AFT} and/or L_{AFT BRG} from the HPT aft end may increase given the increased weight and support needed for additional stages, e.g., 3 to 4 stages, or 4 to 5 stages. Additionally, the bearings 1310, 1410 and 1512 in the embodiments of FIGS. 23 to 25 may be desired for higher speed LP shafts. The additional bearing can add a dampening effect to the LP shaft primary mode, or otherwise influence the mode shape so that its deflection at resonance is reduced. The bearing distances L_{AFT} and L_{AFT BRG} may be affected by the presence of an electric machine coupled to the low-pressure shaft. The electric machine may increase the weight on the low-pressure shaft and, thus, increase the load that the bearings on the low-pressure shaft need to support and may also affect the frequency of the low-pressure shaft. Thus, the bearing distances L_{AFT} and L_{AFT BRG} are affected by the additional load from the electric machine. For example, in embodiments with an electric machine near an aft portion of the core, the bearing distances may increase or decrease in a direction further aft or further forward compared to embodiments without an electric machine, depending on the particular location of the electric machine within the engine. That is, the location of the bearings may be moved to a location more forward or more aft as compared to embodiments without an electric machine.

FIG. 26 shows a partial cross-sectional view of a gas turbine engine 1600. As shown and previously described the high-pressure turbine 132 includes one or more stages, represented by high-pressure turbine stage 214.

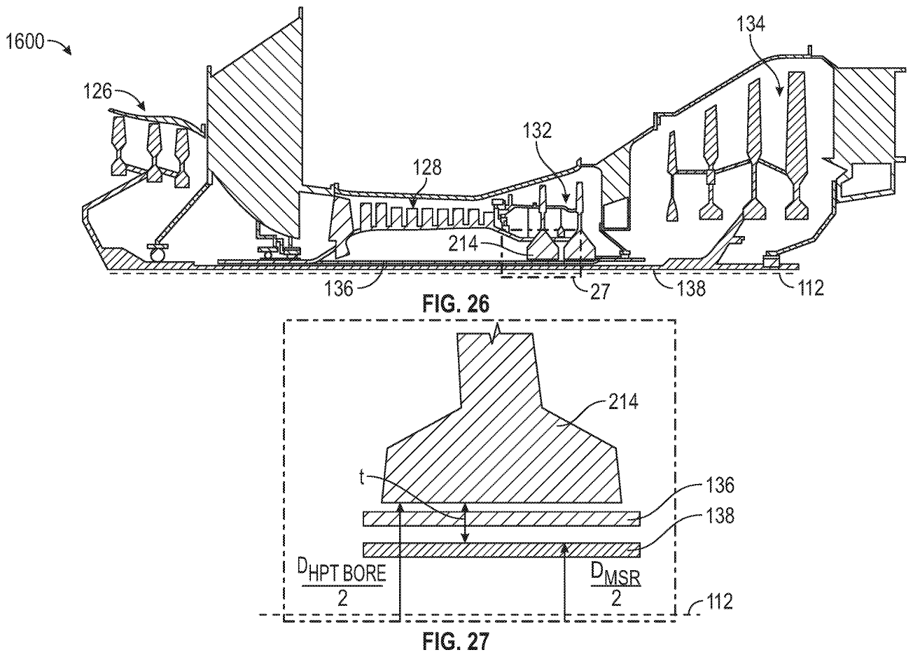

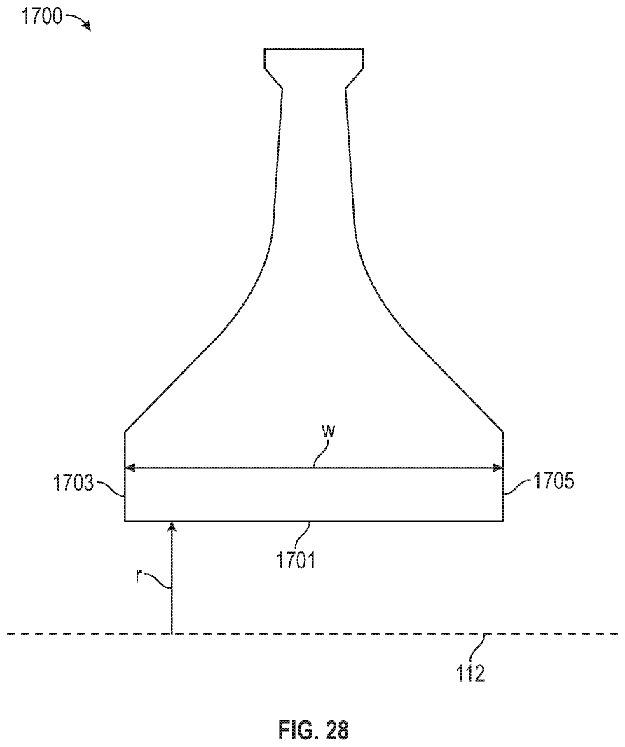

FIG. 27 illustrates a cross-sectional view of the high-pressure turbine stage 214, taken at detail 27 in FIG. 26. In the example of FIGS. 26 and 27, the high-pressure turbine 132 has a core diameter D_{HPT BORE} defined by an inner diameter of the high-pressure turbine stage 214. The radius of the high-pressure turbine stage 214 is illustrated in FIG. 28 from the longitudinal centerline axis 112 to the high-pressure turbine stage 214 and represented as

$$\frac{{D}_{HPT BORE}}{2} .$$

The low-pressure shaft 138 has a diameter D_{MSR} that is defined by an outer diameter of the low-pressure shaft 138. The radius of the low-pressure shaft 138 is illustrated in FIG. 27 from the longitudinal centerline axis 112 to the outer diameter of the low-pressure shaft 138, and represented as

$$\frac{{D}_{MSR}}{2} .$$

The diameter D_{MSR} is the diameter employed in relationship (3) to determine the midshaft rating of the low-pressure shaft 138. The difference between D_{HPT CORE} and D_{MSR} define an intershaft thickness t.

With regard to improving upon the speed of the low-speed shaft, consideration was given not simply to those factors affecting the low-pressure shaft, but also to factors considering the engine core of the engine, such as, the length of the engine core, the diameter of the engine core, the material of the components within the engine, the number of stages present in the high-pressure compressor, low-pressure compressor, high-pressure turbine, low-pressure turbine, and the location of bearings. In contrast to existing gas turbine engines requiring lower speeds, embodiments considered presented challenges in determining how the low-speed shaft speed could be increased without operating at or near a critical speed, for at least sustained periods of time or during standard flight periods (i.e., takeoff or max thrust).

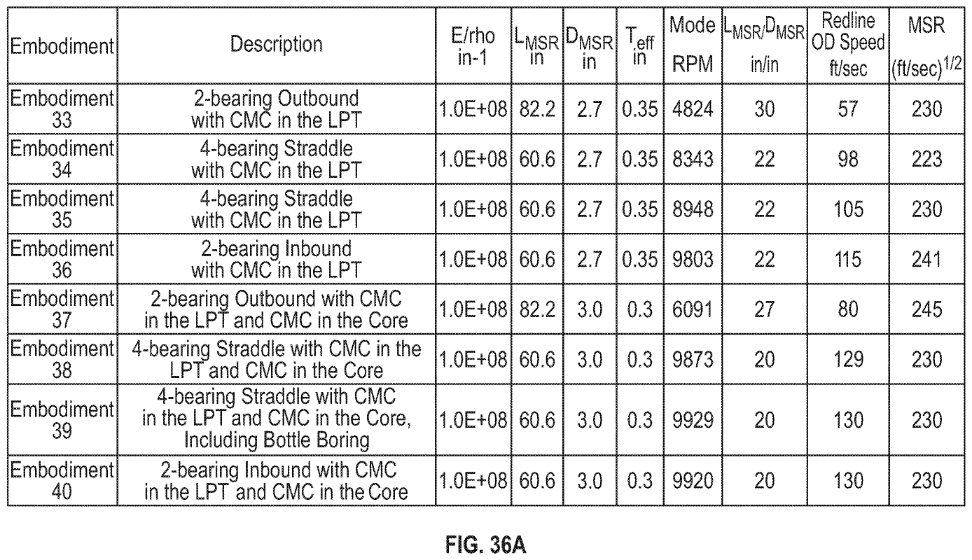

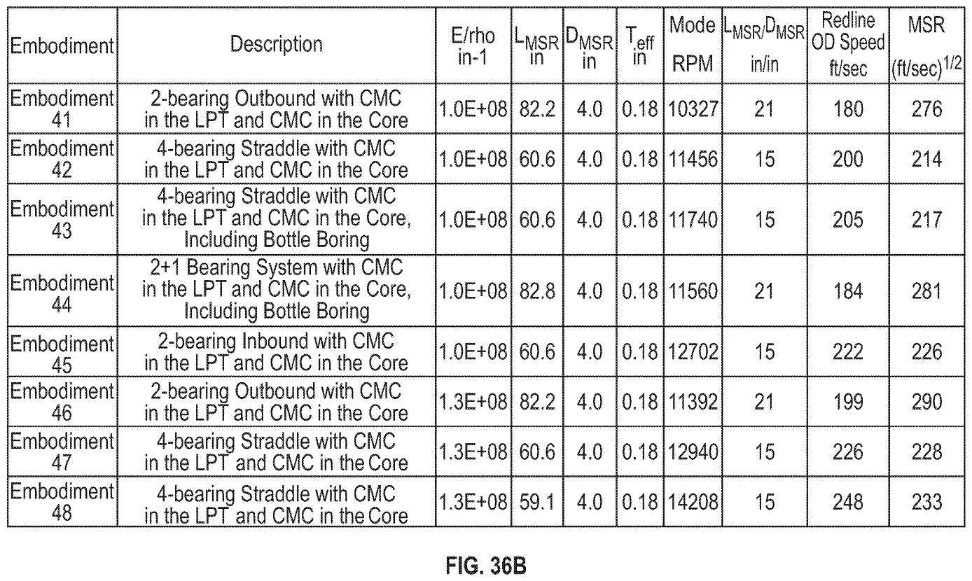

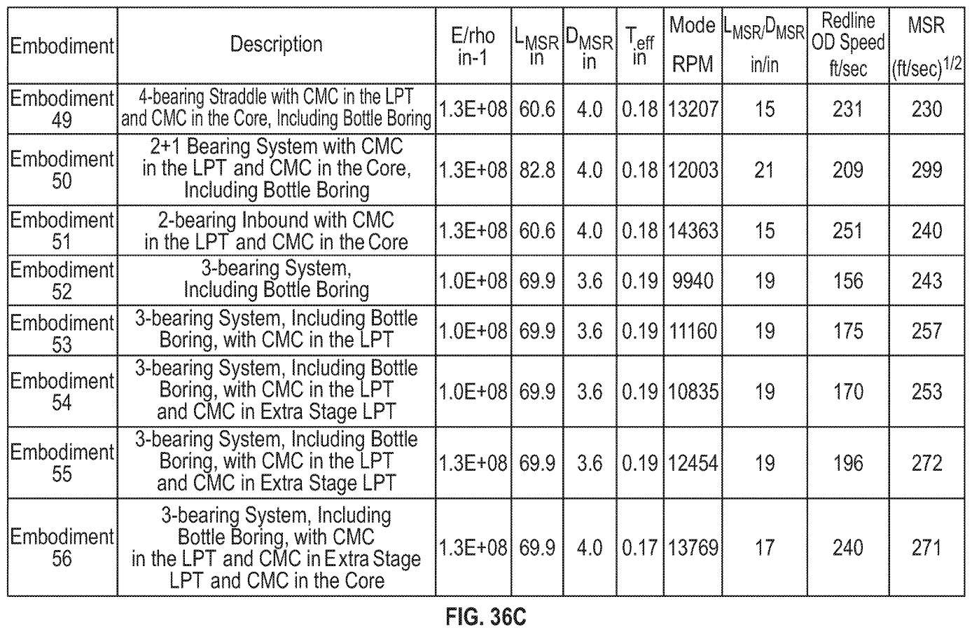

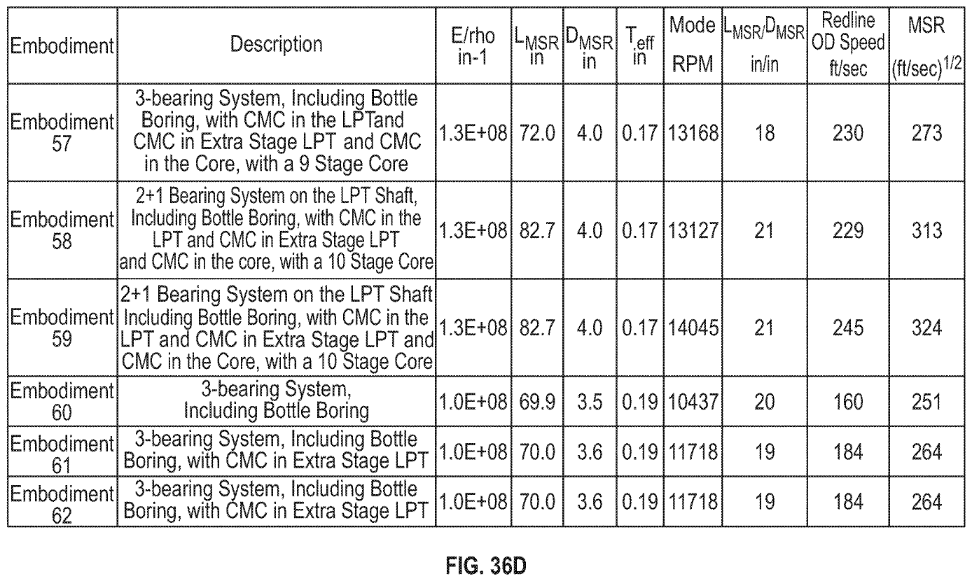

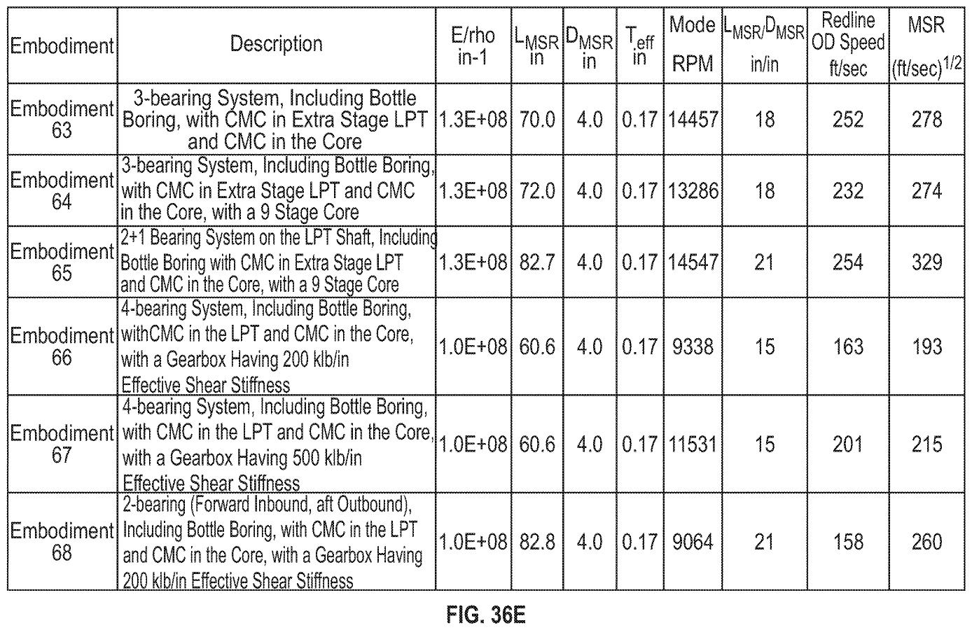

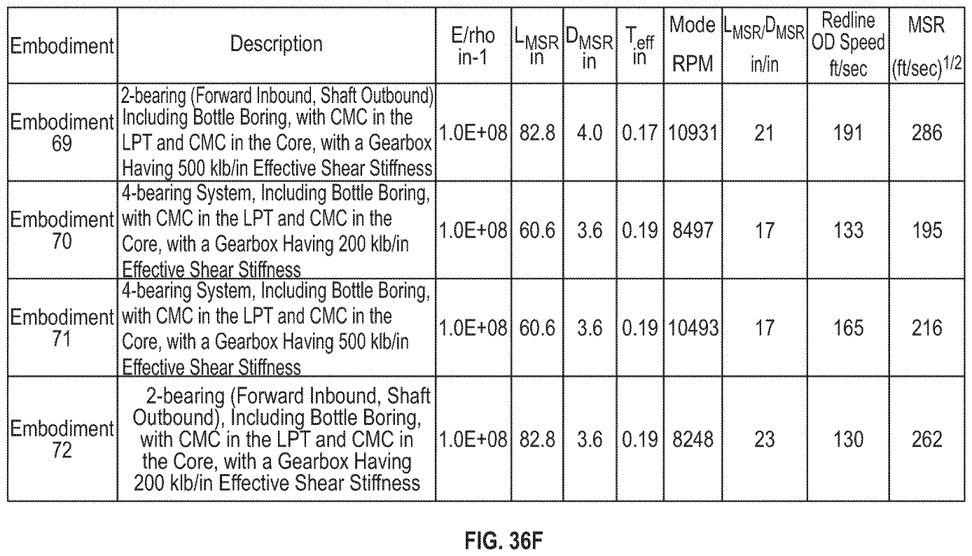

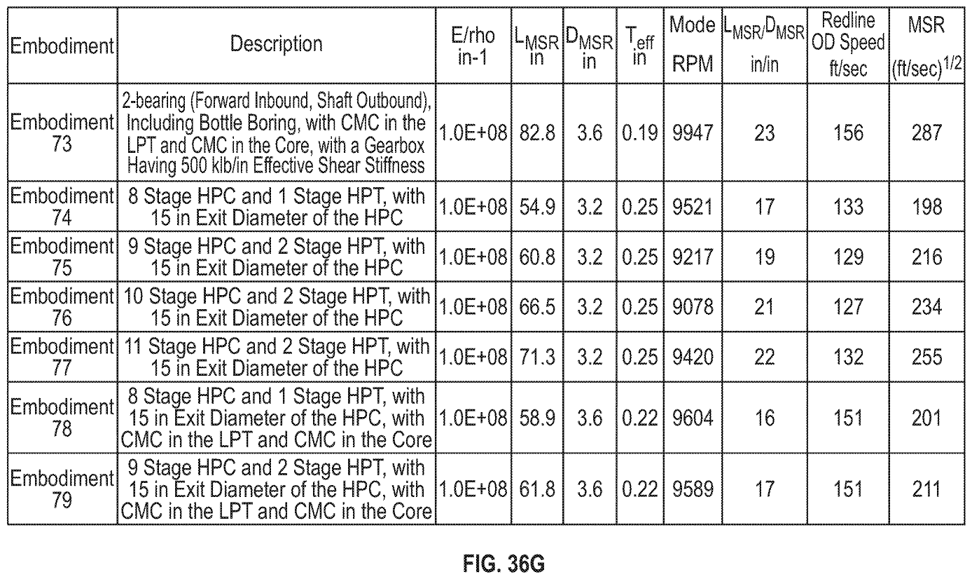

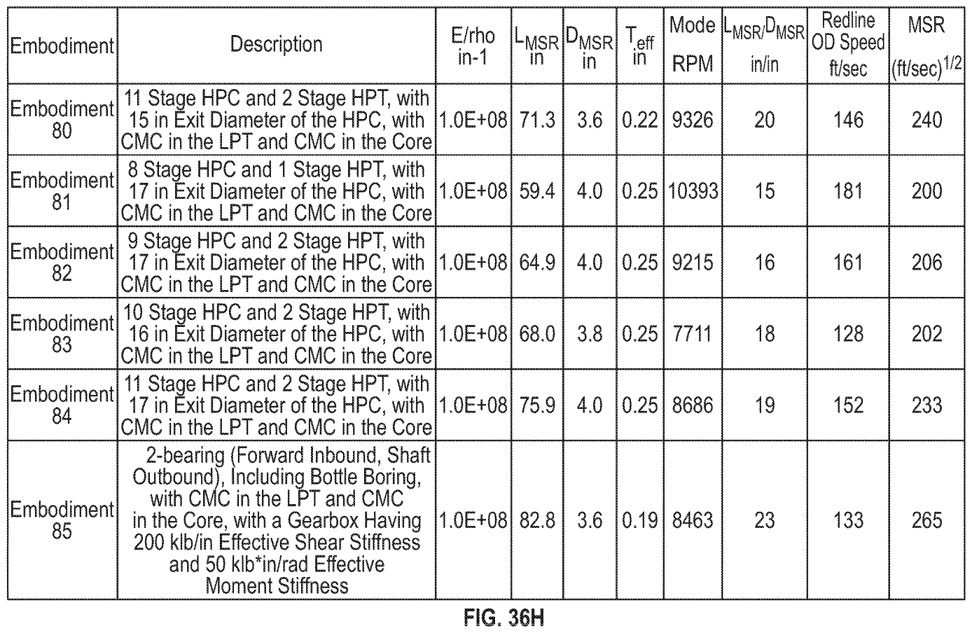

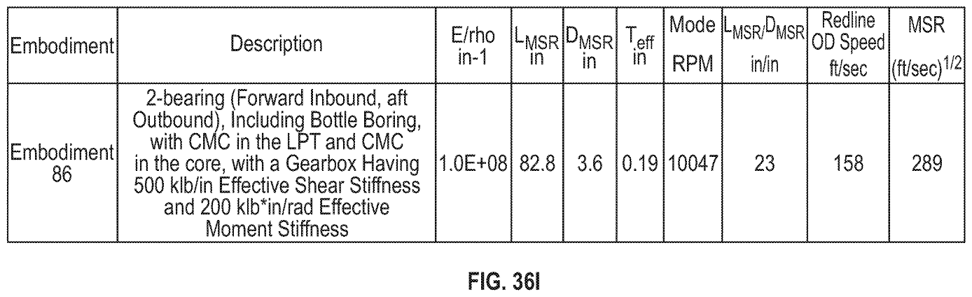

Further, a selection of power turbine shaft and bearing arrangements, and location of those bearings for a gas turbine engine takes into consideration other factors, some of which can limit the selection of a shaft. During the course of making the several embodiments referred to in the foregoing, however, there is a particular range of designs, constraints on feasible designs that provided an unexpected benefit. These are the embodiments provided in FIGS. 36A to 36I, Tables 5, 7 and 8 and the accompanying description further describe features of those embodiments providing unexpected benefits.

Even taken separately from the integration of a shaft design with the rest of an engine, modifying an existing shaft to increase its critical speed is challenging, and the impact of the different types of improvements and configurations on critical speed is not easily predictable without empirical experimentation and simulation, which can be enormously expensive and time-consuming. A modification to the engine architecture, e.g., modification to the core or rear frame, may result in lowering a critical speed.

The present disclosure provides for a relationship among the critical speed of the shaft, redline speed, bearing supports and shaft properties at the mid-shaft region and outside this region, and the ratio L/D (also referred to as L_{MSR}/D_{MSR}), which characterize benefits of implementing features of any of the embodiments disclosed in FIGS. 36A through 36I, and Tables 6, 8 and 9 and accompanying disclosure, and excluding those embodiments that were disfavored, and judged suitable for a narrow body engine architecture, or rated thrust between 20 kips and 40 kips, to avoid a supercritical or critical shaft situation during normal operation of an engine. In some instances, during normal operating conditions for the engine, the shaft can operate at speeds higher than the maximum operating speed but less than the redline speed (e.g., 1% to 2.5%, 3% to 5%, 3.6% to 5%, or 5% to 10% less than a rated redline speed for the shaft) depending on the thrust required from the engine, the environment (e.g., ambient temperature, extreme cold or heat), or the altitude.

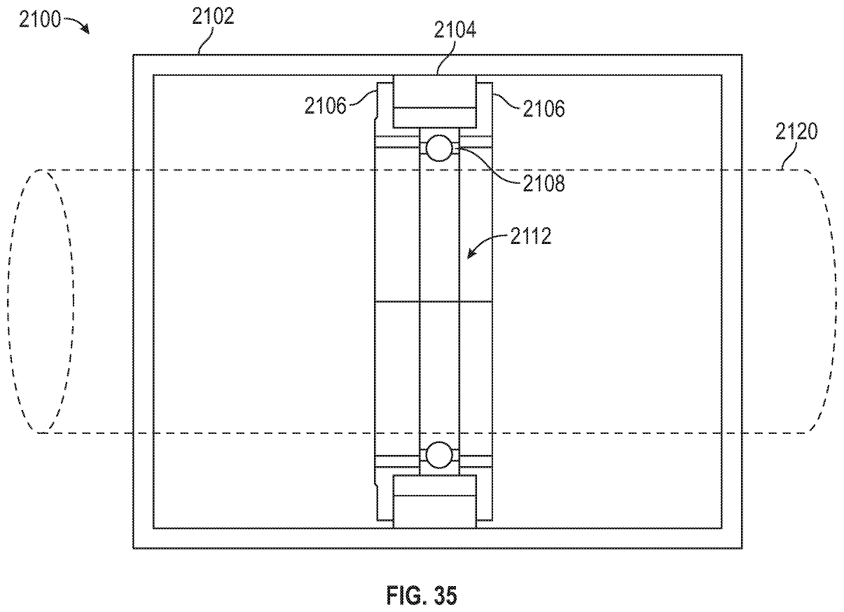

Given the comparative cost, complexity, or weight penalty, the fundamental mode should always be higher than the shaft redline speed and/or highest operating speed. Shaft flexural rigidity, and the number and types of bearings used to support the shaft, have the most influence on the fundamental mode compared to redline. Bearing dampers (e.g., the bearing damper assembly 2100 detailed below with respect to FIG. 35) affect the shaft fundamental mode shape (e.g., the first order bending mode). The bearing provides damping by circulating a layer of oil through the bearing to produce viscous damping at the bearing when under compression. Hot oil (e.g., oil temperature greater than an operational temperature range) to these dampers or no oil flow to the dampers reduces the effectiveness of bearing dampers (squeeze film dampers) in limiting deflection or lowering the shaft critical speed. Examples of operational ranges for oil are detailed below. Cold oil (e.g., oil temperature less than the operational temperature range) to the dampers increases the shaft fundamental mode with respect to the shaft fundamental mode during the normal operating conditions.

In the event that bearing dampers lose oil or the oil becomes too hot (e.g., the oil temperature is greater than the oil's effective operating temperature), a shaft's fundamental mode can drop below the shaft's redline speed and even below the shaft's normal operating speed, thereby presenting a supercritical shaft situation. To take this into account, a safety margin is designed into the shaft and bearing design. The safety margins (highest operating speed vs. critical speed) included in the embodiments utilizing a damper bearing (i.e., squeeze film damper) for the low-pressure shaft are critical speed above 1% to 2.5%, 3% to 5%, 3.6% to 5%, or 5% to 10% from the operating speed, and critical speed above 1% to 2.5%, 3% to 5%, 3.6% to 5%, or 5% to 10% above redline speed.

In one respect, the scope and number of embodiments in addressing the need for a subcritical shaft is characterized by a midshaft rating (MSR):

$$Midshaft Rating MSR = ( {L}_{MSR} / {D}_{MSR} ) {( Shaft OD Speed at redline )}^{1 / 2} \qquad ( 3 )$$

L_{MSR}/D_{MSR} is shaft length divided by effective shaft outer diameter. The ratio L_{MSR}/D_{MSR} is multiplied with the square root of the outer diameter (OD) rotation speed (OD Speed) at the redline speed for the engine architecture. Generally, the length L_{MSR} and diameter D_{MSR} are expressed in inches, and the shaft OD redline speed is the linear speed of the shaft surface. The OD redline speed in feet per second is calculated as the shaft mode speed (in RPM) multiplied by the outer circumference of the shaft (the outer diameter of the shaft multiplied by the number π), and with additional corrections to convert from inches to feet and from minutes to seconds. Accordingly, the midshaft rating has units of (velocity)^{1/2}.

The midshaft rating identifies embodiments for a turbomachine's power turbine that allow subcritical operation of the engine for a rated redline speed. TABLE 5 lists embodiments of the turbine shaft along with its associated MSR value. The midshaft rating also identifies the suitable operating margins for the power turbine to avoid a critical or supercritical condition in respect to the rated or redline speed and/or normal range of operating speeds, as provided above. FIGS. 36A to 36I list embodiments of the turbine shaft along with its associate MSR value for configurations that incorporate CMC. TABLE 9 lists embodiments of the turbine shaft along with its associated MSR value for critical or supercritical shafts. The embodiments can inform one of the dimensions or qualities of the shaft that are believed reasonable and practical for a shaft according to its basic features and the intended, rated critical speed. In other words, the midshaft rating, and, optionally, the L_{MSR}/D_{MSR} ratio and/or the OD speed at redline, indicates the operating ranges of interest, taking into account the constraints within which a turbomachine operates, e.g., size, dimensions, cost, mission requirements, airframe type, etc. and based on the embodiments listed in the Tables, which showed favorable results compared to embodiments that were less favored.

In other embodiments, the midshaft rating may also, or alternatively, be used to define the propulsive system operating at a relatively high redline speed. Such things as the requirements of a propulsive system, the requirements of its subsystem(s), airframe integration needs and limitations, and performance capabilities may, therefore, be summarized or defined by the midshaft rating when considered for an engine core that is more compact, higher power density, higher OPR.

As mentioned earlier, next generation gas turbine engine cores are expected to operate at higher power densities, which can include a same level of power output as exists in current engines, but using a lighter weight core. A reduced weight core includes components coupled through the high-pressure shaft, which are the high-pressure compressor (HPC) and the high-pressure turbine (HPT). A higher power density will also mean higher engine operating temperatures (e.g., higher EGT as mentioned above), particularly at the HPC exit stage, combustor exit, HPT nozzle exit, and LPT. These changes in power density also result in changes in core size (length, width, bore heights, etc.) and in some cases significant changes in core weight, such as when a CMC material is used for core components. As such, it is desirable to assess the impact that next generation cores operating at higher power density can have on engine dynamics (e.g., dynamics of the LP shaft, the HP shaft, and/or a gearbox of the engine).

These changes in engine core size and weight effects not only the dynamic behavior of the HP shaft, but also can influence the dynamic behavior of the LP shaft, e.g., the critical speed, that results in undesired vibrations. Likewise, the dynamic behavior of the LP shaft can influence the dynamics of the HP shaft. Dynamic excitation of natural modes/frequencies of these two shafts, while decoupled in rotation from each other, nonetheless can interact and amplify each other's natural modes of vibration via load paths through their respective supporting bearings.

Acceptable dynamic behavior at redline, cruise and maximum thrust operating conditions depends also on interaction between a high and low-pressure shaft. When a higher power density core is installed in the engine with concomitant lengths and sizes changing for the core, these changes influence not only the behavior of the LP shaft mode in isolation, but also dynamic interaction between the HP and LP shafts. Without proper consideration of the effects that the LP shaft dynamics have on the HP shaft dynamics (and HP shaft dynamics have on the LP shaft dynamics), intolerable vibrations may occur resulting from primary or higher frequency modal interaction between the shafts. To address these concerns, engine architectures were evaluated to determine the structural and/or inertial changes reflected in a higher power density core would cause unacceptable vibration in either or both of the HP shaft and the LP shaft. The core weights and sizes reflect improved performance from the general perspective of a reduced Specific Fuel Consumption (SFC), overall compactness of the engine, but could also create unanticipated or unmanageable dynamic excitation when the LP shaft and the HP shaft are operated at high speeds. The MSR and related critical dynamics are impacted by variations in such things as HPC stages to raise the overall pressure ratio of the gas entering the combustion chamber, and/or an increased number of stages for the HPT, the overall length of the LP shaft accounting for other changes in the engine cross-section affected by changes in the HPC and/or HPT, and the impact on stiffness and weight when advanced material such as CMC material is used in the core.

Changes to these aspects of the core influence, not only an overall length, weight, and size of the HPC and HPT, but also placement of shaft-supporting bearings and accessories. Changes in the core affect placement of other engine components encased within a core cowl. Thus, examining the effects of, e.g., adding an additional HPC stage, require an understanding of adjacent engine components that need to accommodate an increased length of the core. To date, acceptable designs vs. unacceptable core design practice (from the perspective of structural dynamics) have often involved an iterative process involving design on experiment studies where many variations on architecture design are considered, with the hope that one of the variations might provide the desired configuration satisfying both core performance and dynamic stability for both the HP shaft and LP shaft. After consideration of several embodiments of a next generation engine core having between 8 and 11 stages for an HPC and 1 to 2 stages for an HPT, as well as different material (e.g., CMC material, Ni superalloys) each requiring different bearing placements relative to the core, it was found there are relationships between the length of the core, bearing supports at each end and L_{MSR} for each of the foregoing modifications to a core that produces a good approximation for the dynamic behavior of the engine. These relationships define the dynamic behaviors of the HP shaft and LP shaft in terms of factors attributable to a higher power density core, enabling an improved engine design, one that took into account the often competing interests between dynamic stability and achieving a more compact and higher power density core.

With reference back to FIGS. 21 to 25, the LP shaft 138 length from the forward bearing (e.g., the first bearing 1102) to the aft bearing (e.g., the fourth bearing 1108), i.e., L_{MSR}, can be broken down into three portions: a length forward of the core (L_{IGB}), a length aft of the core (L_{AFT}), and the portion of the LP shaft that extends from the aft portion of the HPT to the forward end of the HPC (L_{CORE}). The flexural rigidity of the LP shaft portion (mid-shaft) extending along the engine core (HPC-combustor-HPT), between the nearest forward and aft bearings supporting the mid-shaft, is lower than portions outside the core due to the limited space available for a higher outer diameter for the LP shaft.

L_{MSR} is defined according to the relationship:

$${L}_{MSR} = {L}_{IGB} + {L}_{CORE} + {L}_{AFT} \qquad ( 4 )$$

L_{IGB} represents a minimum distance from core forward end and forward inboard low-pressure shaft bearing (e.g., the first bearing 1102 in FIG. 21) to the forward core bearing (e.g., the second bearing 1104 in FIG. 21). The length from the bearing supporting the input to the gearbox (e.g., 1102) to the core forward bearing (e.g. 1104) represented as L_{IGB} can range from four inches to twelve inches (the minimum length of four inches accommodates an accessary gearbox). The distance may be increased or decreased depending on factors such as, location of other components supported by a common frame, the location of the axial center of gravity for a frame, etc. as discussed earlier. Taking these factors into consideration, the length L_{IGB} may be estimated based on D_{CORE} using (5):

$${L}_{IGB} = 0.16 \times {D}_{CORE} + 1.7 \qquad ( 5 )$$

Wherein D_{CORE} is the diameter (measured from the engine centerline) of the last stage of the high-pressure compressor, measured as the tip-to-tip diameter of the rotor of the exit or aft-most/last stage of the high-pressure compressor. D_{CORE} varies from ten inches to thirty inches depending on whether there are 8, 9, 10, or 11 stages in the HPC. Examples are provided below in TABLE 5. Relation (5) is valid only for an HPC having 8, 9, 10 or 11 stages.

The length of the engine core from the core forward bearing (e.g., bearing 1404) to core aft bearing (e.g., 1406), L_{CORE1}, may be related to the number of HPC and HPT stages of the core, and the exit diameter as follows:

$${L}_{CORE 1} = {[ {m}^{( 20 + m )} \times {n}^{( 10 + n )} ]}^{( \frac{1}{100} )} \times {D}_{CORE} + CIS \qquad ( 6 )$$

Expression (6) reflects the influence on core length changes impacted by adding additional HPC or HPT stages, leading to in an improved engine design that balances dynamics needs against a higher pressure ratio core choice for higher power density. The symbol m is the number of stages in the high-pressure compressor and n is the number of stages in the high-pressure turbine. The CIS accounts for changes in core supporting structure, seals, nozzle sizes, and changes to the combustor length associated with a change in the HPC and/or HPT stages. CIS can be from twenty inches up to thirty inches for HPC stages ranging between 8 to 11 and 1 to 2 HPT stages. The relation in (6) for L_{CORE1} is valid only for m being eight, nine, ten, or eleven, and n being one or two.

The aft length L_{AFT} is the length from the aft core bearing (e.g., the third bearing 1106 in FIG. 21) to the aft inboard low-pressure shaft bearing (e.g., the fourth bearing 1108 in FIG. 21). L_{AFT} can be from two inches to twenty-four inches, depending on the specific spacing needs/preferences aft of the HPT and turbine rear frame integration with the rotor. Also, placement of this bearing can be influenced by whether additional LPT stages are added, dynamics of the LP shaft and turbine rear frame. In some cases, an additional bearing L_{AFT BRG} as discussed earlier. The furthest aft bearing (e.g. 1108) supporting the turbine rear frame can include a bearing housing that includes a viscous damping system (e.g., squeeze-film damper whereby oil viscosity is used to dampen vibrations transmitted to/from the bearing).

TABLE 5 provides embodiments found to produce an acceptable dynamics environment, in terms of L_{MSR} according to relationships (4) to (6). The embodiments shown in TABLE 5 align with the like embodiment numbers in FIGS. 36A to 36I.

TABLE 5

| | L_{MSR} | L_{IGB} | L_{CORE} | L_{AFT} | D_{CORE} | CIS | HPC | HPT |
|---|---|---|---|---|---|---|---|---|
| Embodiment | in | in | in | in | in | in | stages | stages |
| 74 | 54.9 | 4 | 47 | 4 | 15 | 20 | 8 | 1 |
| 75 | 60.8 | 4 | 54 | 3 | 15 | 23 | 9 | 2 |
| 76 | 66.5 | 4 | 59 | 4 | 15 | 26 | 10 | 2 |
| 77 | 71.3 | 4 | 64 | 3 | 15 | 30 | 11 | 2 |
| 78 | 58.9 | 4 | 48 | 7 | 15 | 21 | 8 | 1 |
| 79 | 61.8 | 4 | 54 | 4 | 15 | 23 | 9 | 2 |
| 80 | 71.3 | 4 | 64 | 3 | 15 | 30 | 11 | 2 |
| 81 | 60.4 | 4 | 52 | 4 | 17 | 22 | 8 | 1 |
| 82 | 64.9 | 4 | 58 | 3 | 17 | 23 | 9 | 2 |
| 83 | 68 | 6 | 58 | 4 | 16 | 24 | 10 | 2 |
| 84 | 75.9 | 4 | 69 | 3 | 17 | 30 | 11 | 2 |

D_{MSR} is defined according to the relationship:

$${D}_{MSR} = {D}_{HPT BORE} - 2 t \qquad ( 7 )$$

D_{HPT BORE} is the rotor bore diameter for the first stage of the high-pressure turbine. Its size may be approximated according to the relationship:

$${D}_{HPT BORE} = 0.26 {D}_{CORE} + 0.6 \qquad ( 8 )$$

The thickness t is the intershaft thickness between the low-pressure shaft and the high-pressure turbine bore (e.g., as shown in FIG. 28). The thickness t can vary from 450 mils and 650 mils (from 0.45 in to 0.65 in).

CMC material may be used in the HPT, LPT, and/or HPC parts of a core engine as this type of material can withstand higher temperatures than more traditional metal alloys. Given the differences in material properties for a CMC material, particularly the higher strength to weight ratio (or higher specific modulus) of CMC versus a metal alloy used in existing gas turbine engines in use currently, there is a need to ascertain the expected effects on HP shaft dynamics and LP shaft dynamics. Use of a CMC material introduces opportunities to increase a critical speed of the LP shaft, not only due to a weight reduction but also in making more space available for increasing the LP shaft diameter extending through the core given the materials higher strength. The components made, at least in-part, from CMC material may include the HP compressor rotors and disks, the HP turbine nozzles and/or rotors and rotor disks, and the LP turbine nozzles and/or rotors and disks. CMC allows for components to be made more stiff or reduced in size while having the same strength properties as metal alloys, thereby having equivalent capability for sustaining high stresses associated with centrifugal forces at high temperatures and operating speeds, in addition to reducing the weight of the core, as compared to metals. CMC also introduces new and untested structural dynamics, which can introduce tradeoffs or compromise between a desired aero-performance (temperatures, rotation rates, pressure ratios) and stable dynamics at cruise, takeoff/max thrust and redline speeds for both the HP shaft and LP shaft.

CMC provided in the low-pressure turbine, which drives the LP shaft, can enable an increased critical speed due to a reduced weight, thereby affecting MSR of the midshaft. For example, and referring back to FIGS. 4 to 7 and 11 to 28, rotors, blades, or blades and discs in the low-pressure turbine module can be formed partially or wholly of CMC. Additionally, the nozzles in the low-pressure turbine module can be formed partially or wholly of CMC, for example, the static vanes, the shrouds or both can be formed of CMC. Such components can be formed from CMC materials in a single stage, or multiple stages (e.g., the turbine stages 214). In some embodiments, a first, second, third, fourth or fifth stage of a LPT may have airfoils made from a CMC material. LPT nozzles may be made from CMC material. Or both the LPT airfoils on rotor and nozzle airfoils may be made from CMC material. When CMC is used in the LPT, the critical speed at which the low-pressure shaft can operate is increased significantly while also taking into account for the relatively brittle nature and temperature-dependent strength properties of CMC that goes along with the reduced weight (or increase in specific strength) benefits that the material provides. That is, with strength and toughness needs across different environments and operating conditions realized, the present disclosure provides a relation between CMC material used in the core for a resulting comparatively higher critical speed for the LP shaft, for maintaining a critical speed for increases in core length when used in the LPT, and for higher critical speeds without an associated un-acceptable MSR value indicating that the design using CMC material could have an LP shaft operating in a critical or supercritical range, or operating within 5% to 10% of the redline speed. In this way, the CMC material is used to increase the power density of the gas turbine engine, while taking into account the effects on MSR and the engine dynamics. For example, and referring back to FIGS. 4 to 7 and 11 to 28, CMC used for the HPT and/or the HPC airfoils, HPT nozzle, and rotor disks supporting airfoils that influence the length of the core can influence the LP shaft design for other reasons as well, as explained in greater detail below. Example embodiments showing effect on LP shaft MSR values and critical speed for CMC used in the LPT are included in the Tables of FIGS. 36A to 36I. It was found that for an LPT made at least partially from CMC material the effective reduction in mass, i.e., the mass reduction can influence the MSR and critical speed by an amount that provides more opportunities for increased efficiency by enabling a higher rotation speed. FIGS. 36A to 36I provide examples.

Use of CMC material in the HPT rotor blades also affects the size of the HPT bore radius, because the higher strength to weight ratio of CMC material (when used for the rotor blades) reduces the strength requirements for the disk supporting the blades, thereby permitting the bore radius to increase. The bore radius limits the outer diameter of the LP shaft. It is desirable to increase the bore radius of the high-pressure turbine (first stage) to allow an increase in the low-pressure shaft diameter (e.g., D_{MSR}). Referring to FIG. 28, a cross-sectional view of a first stage HPT airfoil disk 1700 is shown. The blade disk 1700 has a bore radius r defined from the longitudinal centerline axis 112 to an inner surface 1701 of the disk bore. Use of CMC material for the rotor blade permits an increase in the radius r to enable a larger D_{MSR} for the LP shaft, thereby affecting the critical speed and MSR of the midshaft. CMC material for the bore disk may also be desired. Each blade disk 1700 has a width w measured from a forward edge 1703 to an aft edge 1705. For a disk made from CMC material, the increased specific modulus (strength/weight) may allow for a meaningful reduction in the width w of the disk and therefore a reduction in L_{CORE}, which can enable an increased critical speed and higher MSR value, which is desired. Even if a metal alloy is used for the disk, a reduced width can be realized because of the lighter weight airfoil it needs to support.

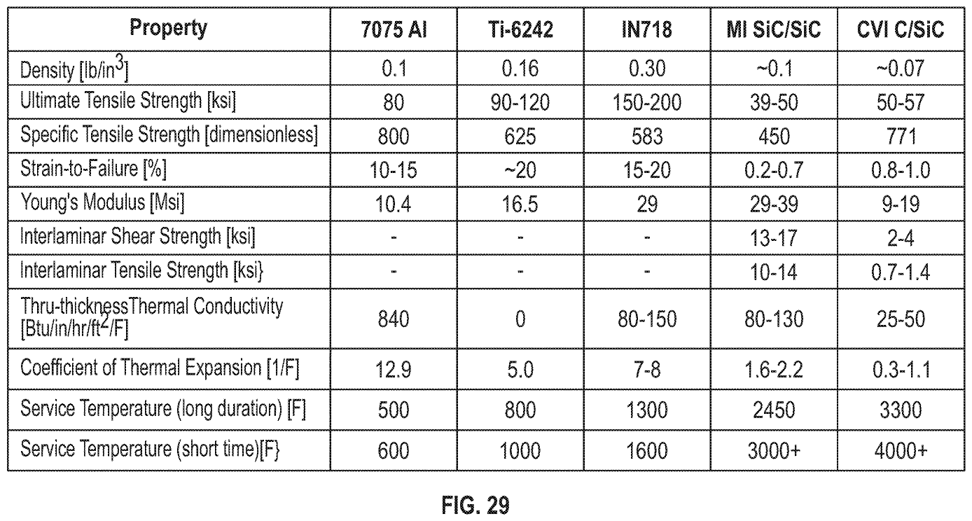

FIG. 29 compares the properties of MI and CVI type CMC material compared to conventional metal alloys. The HPT may be made from CVI or MI types of CMC material, or a hybrid of MI and CVI. In some embodiments the HPT is made from CVI type CMC material, such as the airfoil, while the disk is made from a metal alloy (separate parts coupled through a dovetail slot), or both the disk and airfoil is made from the CVI material (blisk). In some embodiments the surface of an airfoil (LPT, HPT either on nozzles or rotors) facing the hot gas may be made from CVI material while the surface facing away from the hot gas is made from the MI material. The consideration of material to use includes not only high temperature resistance but also the strength and toughness of the material.

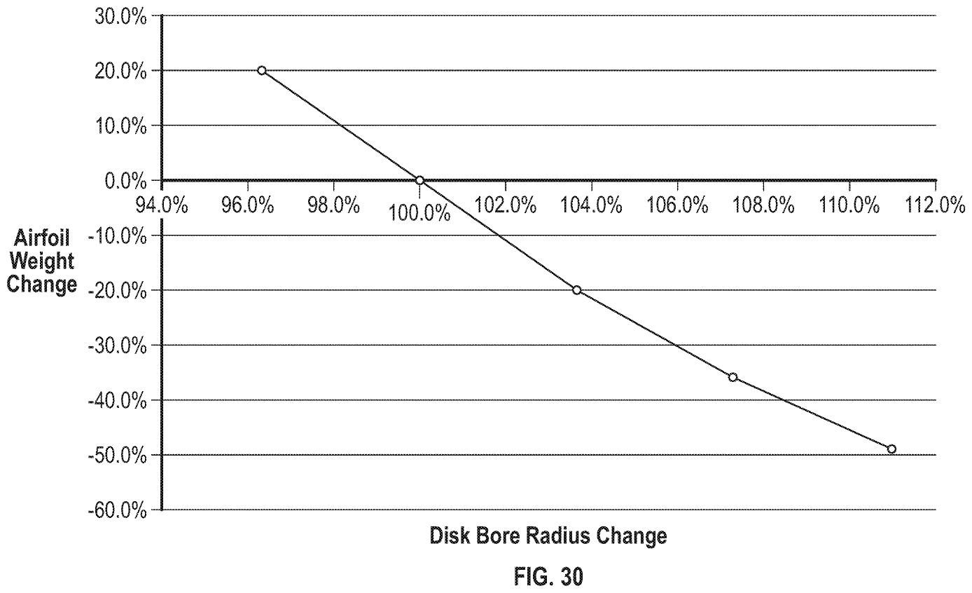

Referring to FIG. 30, the effects of using a CMC material in the HPT are shown. As more CMC material is used, the strength requirements needed to react the airfoil inertial loading reduces. As shown when the airfoil weight is reduced to 50% using CMC material, the radius of the bore increases by approximating 11%. This translates into a stiffer LP shaft (higher D_{MSR}), thereby providing a higher critical speed and a higher MSR value. FIGS. 36A to 36I include embodiments of an engine where the MSR and/or critical speed may increase as a result of an increased HPT disk bore radius.

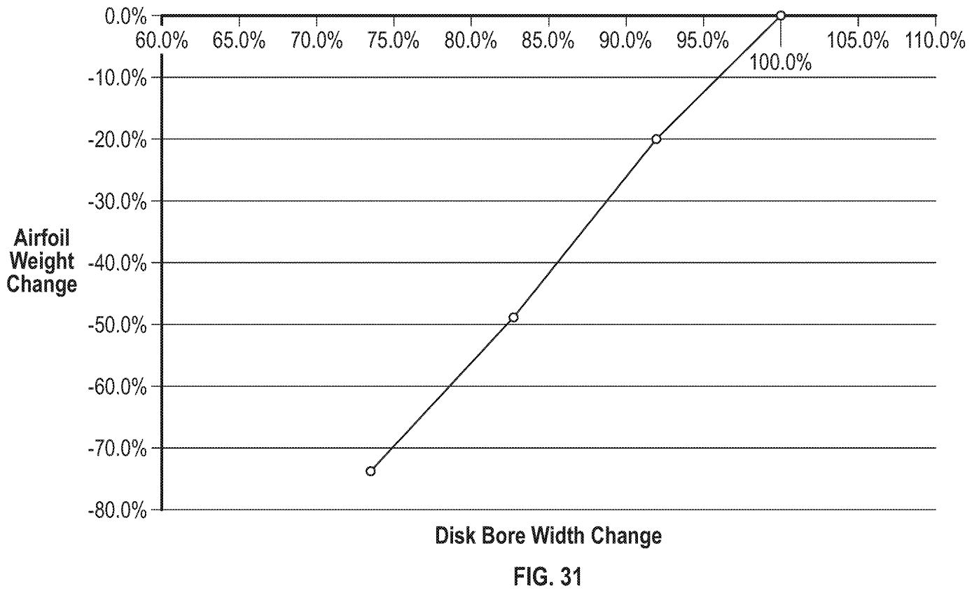

Referring to FIG. 31, further effects of using a CMC material in the HPT are shown. As more material is used, the strength requirements needed to react the airfoil inertial loading reduces. As shown when the airfoil weight is reduced to 50% using CMC material, the width of the bore decreases by approximately 17%. This translates into a stiffer HP and LP shaft (lower L_{CORE} and L_{MSR}), enabling higher critical speeds, mitigating against lower critical speeds as a result of adding additional stages to the HPC and/or HPT. FIGS. 36A to 36I include embodiments of an engine where the MSR and/or critical speed increase when the HPT disk width is decreased, enabling a decrease in L_{MSR}.

In addition to the aforementioned dimensional and weight changes in the core attributed to use of CMC material and affecting the LP shaft dynamics, using CMC material will also affect vibrational response for the HP shaft, also referred to as HP shaft dynamics.

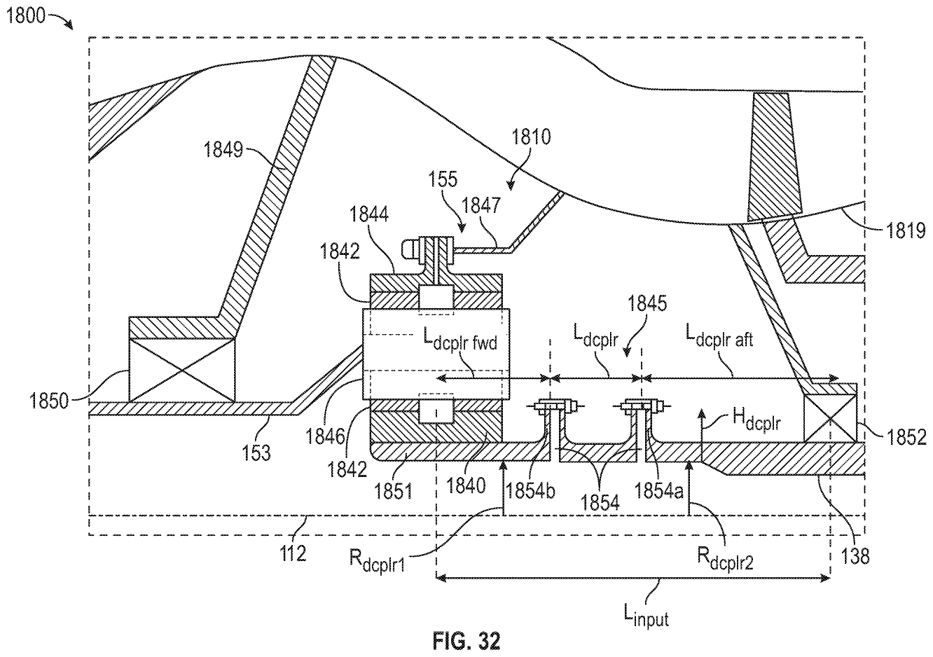

FIG. 32 illustrates an enlarged, schematic side cross-sectional view of the gearbox assembly 155 with a mounting assembly 1810 for an engine 1800, taken at the longitudinal centerline axis 112 of the engine 1800. The engine 1800 can be any of the engines detailed herein. The gearbox assembly 155 is in a planetary configuration. For example, the gearbox assembly 155 includes a sun gear 1840, a plurality of planet gears 1842, and a ring gear 1844. The low-pressure shaft 138 coupled to the sun gear 1840. The sun gear 1840 is coupled via a flex coupling 1845 to the low-pressure shaft 138. The plurality of planet gears 1842 are coupled together by a planet carrier 1846. In the embodiment of FIG. 32, the planet carrier 1846 is coupled, via a fan shaft 153, to a fan (e.g., any of the fans or fan assemblies detailed herein) to drive rotation of the fan about the longitudinal centerline axis 112. The fan shaft 153 is coupled to a fan frame 1849 via a fan bearing 1850. The ring gear 1844 is coupled via a flex mount 1847 to an engine static structure 1819. The flex coupling 1845, the flex mount 1847, and the fan frame 1849 define the mounting assembly 1810 for the gearbox assembly 155. As described herein, the flex coupling 1845, the flex mount 1847, and the fan frame 1849 may be referred to as mounting members.

In FIG. 32, the flex coupling 1845 is part of an input shaft portion 1851 of the low-pressure shaft 138 that extends from a forward bearing 1852 of the low-pressure shaft 138 to the sun gear 1840 (e.g., to an axially center of the sun gear 1840). The flex coupling 1845 is also referred to as a decoupler and includes one or more flex plates 1854 that absorb and reduce deflections and vibrations from propagating from the gearbox assembly 155 to the low-pressure shaft 138 or from the low-pressure shaft 138 to the gearbox assembly 155. In the embodiment shown in FIG. 32, the one or more flex plates 1854 include a first flex plate 1854a and a second flex plate 1854b spaced axially from each other along the input. The one or more flex plates 1854 can include any number of flex plates located at any axial position along the input, as desired. The flex plates 1854 are integral with the flex coupling 1845 and include axial gaps that absorb the deflections in an axial direction so that propagation of the deflections through the flex coupling 1845 is reduced. Accordingly, the flex coupling 1845 can be tuned or can be changed to achieve a particular desired vibrational frequency response such that vibrations of the gearbox assembly 155 do not excite the low-pressure shaft 138 when the redline speed is subcritical.

The input shaft portion 1851 includes an input shaft length Lᵢₙₚᵤₜ that extends axially from the forward bearing 1852 to the sun gear 1840 (e.g., an axial center of the sun gear 1840). The input shaft length Lᵢₙₚᵤₜ is equal to an aft decoupler length L_{dplr_aft}, a decoupler length L_{dcplr}, and a forward decoupler length L_{dcplr_fwd}, added together. The aft decoupler length L_{aplr_aft} extends from the forward bearing 1852 to the first flex plate 1854a, the decoupler length L_{dcplr} extends from the first flex plate 1854a to the second flex plate 1854b, and the forward flex length L_{dcplr_fwd} extends from the second flex plate 1854b to the sun gear 1840 (e.g., to an axially center of the sun gear 1840). The flex coupling 1845 also includes a decoupler height H_{dcplr} and one or more decoupler radii. The decoupler height is a height of the flex plates 1854 in the radial direction from the input shaft portion 1851. The one or more decoupler radii is an inner radius of the input shaft portion 1851. The one or more decoupler radii include a first decoupler radius R_{deplr1} and a second decoupler radius R_{dcplr2}. In the embodiment of FIG. 32, the first decoupler radius R_{dcplr1} is equal to the second decoupler radius R_{dcplr2} such that the input shaft portion 1851 has a constant inner radius. In some embodiments the first decoupler radius R_{dcplr1} is different than the second decoupler radius R_{dcplr2} such that the input shaft portion 1851 has a variable inner radius (e.g., the inner radius of the input shaft portion 1851 changes along the axial direction).

In consideration of midshaft operating speeds, whether during an aircraft maximum thrust at takeoff, redline or cruise operating condition, it is desirable to have any anticipated dynamic loading of the gearbox caused by midshaft motion to not act as to amplify or to excite fundamental or principal mode(s) of the gearbox through the sun gear-midshaft coupling. It is also desirable to avoid a dynamic excitation communicated through the sun gear/midshaft coupling and influenced by modal characteristics of the gearbox assembly to act as to excite fundamental mode(s) of the midshaft. To achieve this end result, it is desirable to have a decoupler moment stiffness KM_{deplr} of the flex coupling 1845 and a decoupler shear stiffness KS_{deplr} of the flex coupling 1845 (e.g., a moment stiffness and a shear stiffness at the sun gear-midshaft coupling) being such as to neither cause significant excitation of a fundamental midshaft mode, nor a dynamic excitation from the midshaft communicated at this coupling to cause significant excitation of a fundamental mode of the gearbox assembly. The decoupler moment stiffness KM_{deplr} is an overturning moment stiffness of the flex coupling 1845 (e.g., a torque of the flex coupling 1845 applied radially on the flex coupling 1845), including the decoupler moment stiffness of the first flex plate 1854a and the decoupler moment stiffness of the second flex plate 1854b. The decoupler shear stiffness KS_{deplr} is a stiffness of the flex coupling 1845 (e.g., between the first flex plate 1854a and the second flex plate 1854b) in the axial direction. The stiffness of the flex coupling 1845 (e.g., the decoupler moment stiffness KM_{deplr} and the decoupler shear stiffness KS_{dcplr}) should be selected so as to not amplify midshaft properties or so as not excite the gearbox assembly 155 by midshaft dynamic behavior during engine operation.

Various rig tests and measurements taken to simulate engine operational conditions, accounting for any differences between a dynamic response for a recently fielded engine and an engine after several operational cycles, revealed common patterns in dynamic behavior for midshaft-gearbox interactions to inform the design of the flex coupling 1845 to avoid the modal coupling between gearbox and midshaft explained above. It was found that a decoupler moment stiffness KM_{dcplr} of the flex coupling 1845 in a range of 50 klb×in/rad to 200 klb×in/rad, and a decoupler shear stiffness KS_{deplr} of the flex coupling 1845 in a range of 100 klb/in to 500 klb/in, should substantially avoid intolerable or sustained dynamic amplification of the gearbox assembly 155 or the midshaft (e.g., the low-pressure shaft) when there is excitation of either the gearbox assembly 155 or the midshaft during engine operations. In this way, the flex coupling 1845 prevents the gearbox assembly 155 from dynamically exciting the midshaft and prevents the midshaft from dynamically exciting the gearbox assembly 155. In this way, the gearbox and its couplings are designed to prevent the gearbox dynamics from affecting the midshaft dynamics at subcritical speeds of the LP shaft, and vice versa. The decoupler moment stiffness KM_{dcplr} of the flex coupling 1845 is expressed in klb×in/rad, and the decoupler shear stiffness KS_{dcplr} of the flex coupling 1845 is expressed in klb/in. In view of the foregoing, the decoupler moment stiffness KM_{deplr} of the flex coupling 1845 and the decoupler shear stiffness KS_{dcplr} of the flex coupling 1845 are desired to satisfy the relationships (9) and (10), respectively:

$${KM}_{dcplr} = \frac{E \times {K}_{m} \times {R}_{dcplr}^{4}}{{H}_{dcplr}} \qquad ( 9 )$$

$${KS}_{dcplr} = \frac{E \times {K}_{s} \times {R}_{dcplr}^{4}}{{L}_{dcplr}^{2}} \qquad ( 10 )$$

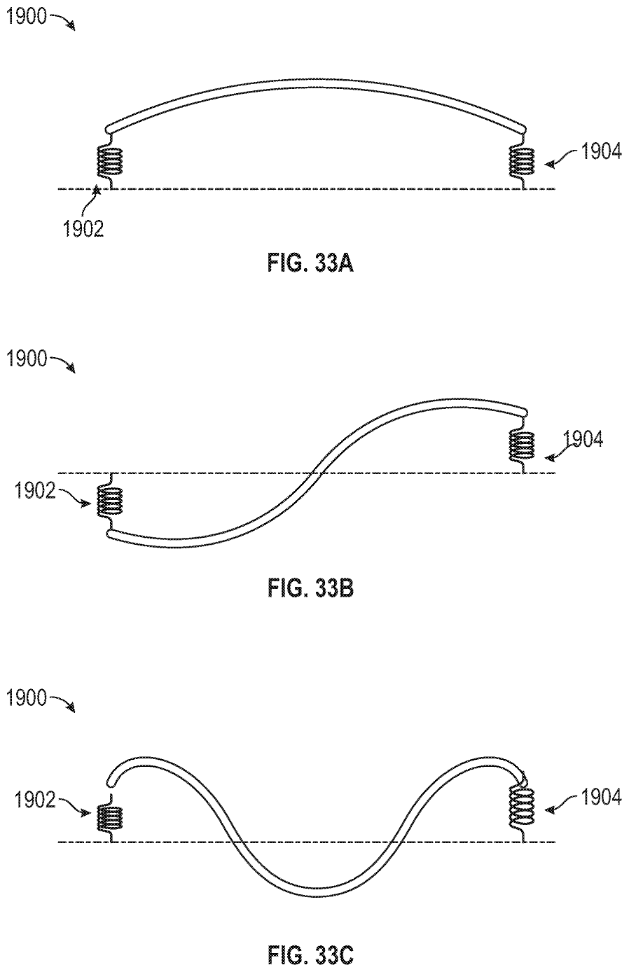

As discussed earlier, HP shaft excitation can influence LP shaft dynamics; and LP shaft excitation can influence HP shaft dynamics. Referring to FIGS. 33A to 33C, there is shown a schematic view of a high-pressure shaft (HP shaft) corresponding to the predominate three typical mode shapes of the HP shaft that need to be taken into consideration when designing an engine core and avoiding dynamic instability not only in the HP shaft, but also in the LP shaft. The deformed HP shaft is supported at its ends by the HP shaft forward and aft bearings 1902 and 1904, respectively. The bearings are represented by their stiffnesses (shown as springs). FIG. 33A illustrates a first mode, also referred to as a fundamental bounce mode, also known as a bow rotor mode, of the high-pressure shaft 1900. The first mode can occur at sub-idle speeds of the high-pressure shaft, which are about twenty percent to thirty percent below a redline speeds of the low-pressure rotor (e.g., about ten percent below cruise speeds). In FIG. 33B, the high-pressure shaft 1900 has a second order bending mode, also known as the pitch mode. The second order bending mode occurs at near to cruise speeds of the high-pressure shaft, which are about twenty percent to thirty percent below the high-pressure shaft redline speeds. In FIG. 33C, the high-pressure shaft 1900 has a third order bending mode, also known as a S-shaped mode. The third order bending mode occurs near redline speeds of the high-pressure shaft.

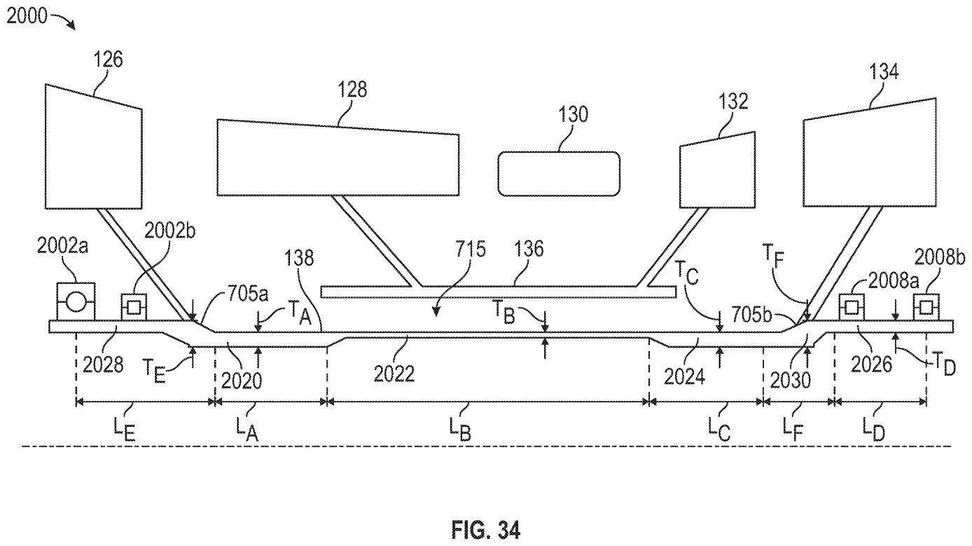

FIG. 34 shows a schematic view of a gas turbine engine 2000, according to the present disclosure. This figure illustrates a design for the LP shaft that increases the critical and/or available redline speed while avoiding a supercritical shaft condition, and associated margins between operating and critical speeds, by varying the relative stiffness between shaft sections while taking into account the limited space available for the shaft in different sections of engine. The exemplary embodiment of FIG. 34 may be configured in substantially the same manner as the gas turbine engine 100 described above with respect to FIGS. 4 through 7 and the same or similar reference numerals may refer to the same or similar parts. The gas turbine engine 2000 includes the low-pressure compressor 126, the high-pressure compressor 128, the combustion section 130, the high-pressure turbine 132, the low-pressure turbine 134, the high-pressure shaft 136, and the low-pressure shaft 138. The low-pressure compressor 126 is coupled to the low-pressure shaft 138 at the mounting point 705a and the low-pressure turbine 134 is coupled to the low-pressure shaft 138 at the mounting point 705b. The low-pressure shaft 138 has the midshaft 715. In FIG. 34, the HP shaft bearings have been omitted for clarity, but the high-pressure shaft 175 can be supported by any of the HP shaft bearings detailed herein.

The low-pressure shaft 138 is supported on bearings 2002a, 2002b, 2008a, 2008b, which are mounted to support structures (not shown) of the gas turbine engine 2000. The bearings 2002a, 2002b and the bearings 2008a, 2008b are in an outbound position, similar to the embodiment of FIG. 20D, i.e., located farther from the midshaft 715 than the respective mounting points 705a, 705b of the low-pressure compressor 126 and the low-pressure turbine 134. The bearing 2002a is a ball bearing. The bearings 2002b, 2008a, and 2008b are roller bearings. In one embodiment, the low-pressure shaft 138 includes the bearing 2002a (e.g., ball bearing) and the bearings 2008a, 2008b (e.g., roller bearings). The bearing 2002a (and the bearing 2002b) is positioned axially forward of the mounting point 705a. The bearings 2008a, 2008b are positioned axially aft of the mounting point 705b. The bearing 2002b (e.g., roller bearing) provides additional support and can be positioned axially forward of the mounting point 705a or axially aft of the mounting point 705b.

Referring to FIG. 34, the low-pressure shaft 138 of the gas turbine engine 2000 is illustrated to show differently sized shaft outer diameters between bearing 2008b and bearing 2002a reflecting differing dynamic properties between the bearings. As shown, the mid-shaft portion (L_{B}) has the smallest diameter, given the limited space through which it can extend across the engine core. The low-pressure shaft 138 in this embodiment has a varying stiffness between bearings, both in the shaft length and outer diameter along an axial length of the low-pressure shaft 138, the shaft stiffness being dependent on the lengthwise and bearings supporting the shaft.

In an alternative embodiment, the wall thickness of the shaft sections differs between shaft sections when space limitations prevent or limit the outer diameter shaft size, particularly for the mid-shaft. For example, the wall thickness of section L_{A}, L_{C}, L_{F}, L_{D}, L_{E}, and/or L_{A} may be increased relative to its length to produce similar shaft section stiffness properties without a significant change in the shaft outer diameter compared to adjacent sections.

The plurality of sections 2020 to 2030 include a first section 2020, a second section 2022, a third section 2024, a fourth section 2026, a fifth section 2028, and a sixth section 2030. The first section 2020 extends axially from a forward end that is aft of the mounting point 705a to an aft end at the second section 2022. The second section 2022 extends axially from a forward end at the aft end of the first section 2020 to an aft end at the third section 2024. The second section 2022 defines the midshaft 715. The third section 2024 extends axially from a forward end at the second section 2022 to an aft end at a forward end of the sixth section 2030. The fourth section extends from a forward end at an aft end of the sixth section 2030 to an aft end. The aft end of the fourth section 2026 defines an aft end of the low-pressure shaft 138 and is a free end of the low-pressure shaft 138. The fifth section 2028 extends from a forward end to an aft end at the forward end of the first section 2020. In this way, the fifth section 2028 includes the mounting point 705a. The forward end of the fifth section 2028 defines a forward end of the low-pressure shaft 138 and is a free end of the low-pressure shaft 138. The sixth section 2030 extends from a forward end at the aft end of the third section 2024 to an aft end at the forward end of the fourth section 2026. In this way, the sixth section 2030 includes the mounting point 705b.

The first section 2020 has a first section length L_{A} defined in the axial direction from the forward end of the first section 2020 to the aft end of the first section 2020. The second section 2022 has a second section length L_{B} defined in the axial direction from the forward end of the second section 2022 to the aft end of the second section 2022. The third section 2024 has a third section length L_{C} defined in the axial direction from the forward end of the third section 2024 to the aft end of the third section 2024. The fourth section 2026 has a fourth section length L_{D} defined in the axial direction from the forward end of the fourth section 2026 to the aft end of the fourth section 2026. The fifth section 2028 has a fifth section length LE defined in the axial direction from the forward end of the fifth section 2028 to the aft end of the fifth section 2028. The sixth section 2030 has a sixth section length LF defined in the axial direction from the forward end of the sixth section 2030 to the aft end of the sixth section 2030.

The first section 2020 has a first section thickness T_{A} defined as a maximum thickness in the radial direction of the first section 2020. The second section 2022 has a second section thickness T_{B} defined as a maximum thickness in the radial direction of the second section 2022. The third section 2024 has a third section thickness T_{C} defined as a maximum thickness in the radial direction of the third section 2024. The fourth section 2026 has a fourth section thickness T_{D} defined as a maximum thickness in the radial direction of the fourth section 2026. The fifth section 2028 has a fifth section thickness T_{E} defined as a maximum thickness in the radial direction of the fifth section 2028. The sixth section 2030 has a sixth section thickness TF defined as a maximum thickness in the radial direction of the sixth section 2030.

The first section thickness T_{A} is in a range of 0.16 in to 0.78 in. In some embodiments, the first section thickness T_{A} is in a range of 0.232 in to 0.606 in. The second section thickness T_{B} is in a range of 0.16 in to 0.83 in. In some embodiments, the second section thickness T_{B} is in a range of 0.232 in to 0.488 in. The third section thickness T_{C} is in a range of 0.16 in to 0.78 in. In some embodiments, the third section thickness T_{C} is in a range of 0.232 in to 0.606 in. The fourth section thickness T_{D} is in a range of 0.16 in to 0.83 in. In some embodiments, the fourth section thickness T_{D} is in a range of 0.232 in to 0.488 in. The fifth section thickness T_{E} is in a range of 0.16 in to 1.17 in. In some embodiments, the fifth section thickness T_{E} is in a range of 0.232 in to 0.900 in. The sixth section thickness TF is in a range of 0.16 in to 0.24 in. In some embodiments, the sixth section thickness TF is in a range of 0.232 in to 1.818 in.

A ratio of the second section thickness T_{B} to the first section thickness T_{A} (T_{B}/T_{A}) is in a range of 0.3 to 1.0. A ratio of the second section thickness T_{B} to the third section thickness T_{C} (T_{B}/T_{C}) is in a range of 0.3 to 1.0. A ratio of the second section thickness T_{B} to the fourth section thickness T_{D} (T_{B}/T_{D}) is in a range of 0.4 to 1.0. A ratio of the second section thickness T_{B} to the fifth section thickness T_{E} (T_{B}/T_{E}) is in a range of 0.2 to 1.0. A ratio of the second section thickness T_{B} to the sixth section thickness T_{F} (T_{B}/T_{F}) is in a range of 0.1 to 1.0.

The lengths and thicknesses of the various sections 2020 to 2030 define a stiffness of each of the sections 2020 to 2030. The first section 2022 wall thickness and length (L_{A}, T_{A}), and the third section 2024 length and thickness (L_{C}, T_{C}) have a shaft stiffness greater than the stiffness for the midshaft 715. The effect of this arrangement is that the midshaft 715 has bending properties more similar to a midshaft having fixed end supporting bearings, as opposed to pinned bearing supports for the midshaft region. The first section thickness T_{A} and the third section thickness T_{C} and lengths are equal so that the stiffness of the first section 2020 and the stiffness of the third section 2024 are equal. The thickness of the LP shaft 138 increases at the mounting points 705a, 705b to provide additional support for mounting the LP compressor 126 and the LP turbine 134 to the LP shaft 138, thereby preventing lower frequency excitation from passing between the HP and LP shafts, in addition to raising the critical frequency for the LP shaft.

The first section length L_{A} and the third section length L_{C} are less than the second section length L_{B}. In some embodiments, the second section length L_{B} is equal to L_{CORE}, described above. The first section length L_{A} is equal to the third section length L_{C}. The fourth section length L_{D}, the fifth section length L_{E}, and the sixth section length L_{F} are less than the second section length L_{B}.

The first section length L_{A} is in a range of 8.8 in to 13.2 in. The second section length L_{B} is in a range of 29.7 in to 44.7 in. The third section length L_{C} is in a range of 8.8 in to 13.2 in. The fourth section length L_{D} is in a range of 10.6 in to 16.0 in. The fifth section length LE is in a range of 5.7 in to 8.6 in. The sixth section length is in a range of 10.4 in to 15.8 in. The total length of the LP shaft 138 is in a range of 74.1 to 111.3 in.

A ratio of the first section length L_{A} to the second section length L_{B} of (L_{A}/L_{B}) is in a range of 0.16 to 0.3. A ratio of the third section length L_{C} to the second section length L_{B} (L_{C}/L_{B}) is in a range of 0.16 to 0.3. A ratio of the fourth section length L_{D} to the second section length L_{B} (L_{D}/L_{B}) is in a range of 0.07 to 0.36. A ratio of the fifth section length L_{E} to the second section length L_{B} (L_{E}/L_{B}) is in a range of 0.05 to 0.2. A ratio of the sixth section length L_{F} of to the second section length L_{B} (L_{F}/L_{B}) is in a range of 0.08 to 0.35.

The fourth section 2026 and the fifth section 2028 define bearing support sections of the low-pressure shaft 138. The thickness and the diameter of the fourth section 2026 and the fifth section 2028 are greater than the second section thickness T_{B} and the diameter of the second section 2022. In this way, the fourth section 2026 and the fifth section 2028 have a greater stiffness than the second section 2022. Such a configuration of the fourth section 2026 and the fifth section 2028 provides for the low-pressure shaft 138 to act as a fixed-fixed beam (e.g., two fixed ends) rather than a pinned end beam, resulting in a higher frequency for the midshaft fundamental mode. In particular, given that the second section 2026 is the dominant stiffness making the fourth section 2026 and the fifth section 2028 with a greater stiffness than the second section 2022 means that the second section 2022 will behave more like a fixed beam (rather than a pinned beam). The low-pressure shaft 138 is a non-uniform cross section having a minimum wall thickness or outer diameter (or both) at the second section 2022 (e.g., at the midshaft 715).

The stiffness of the low-pressure shaft 138 may be characterized by stiffness-to-weight ratios, as compared to the second section 2022:

$$\frac{[ \frac{{K}_{A}}{{m}_{A}} ]}{[ \frac{{K}_{B}}{{m}_{B}} ]} \qquad ( 11 )$$

$$\frac{[ \frac{{K}_{C}}{{m}_{C}} ]}{[ \frac{{K}_{B}}{{m}_{B}} ]} \qquad ( 12 )$$

$$\frac{[ \frac{{K}_{D}}{{m}_{D}} ]}{[ \frac{{K}_{B}}{{m}_{B}} ]} \qquad ( 13 )$$

$$\frac{[ \frac{{K}_{E}}{{m}_{E}} ]}{[ \frac{{K}_{B}}{{m}_{B}} ]} \qquad ( 14 )$$

$$\frac{[ \frac{{K}_{F}}{{m}_{F}} ]}{[ \frac{{K}_{B}}{{m}_{B}} ]} \qquad ( 15 )$$

K_{A}/m_{A} is the stiffness to mass ratio of the first section 2020, where K_{A} is the bending stiffness of the first section 2020 and m_{A} is the mass of the first section 2020. K_{A}/m_{A} is in a range of 4.85×10⁻⁹ rad/in to 2.00×10⁻⁸ rad/in. K_{B}/m_{B} is the stiffness to mass ratio of the second section 2022, where K_{B} is the bending stiffness of the second section 2022 and m_{B} is the mass of the second section 2022. K_{B}/m_{B} is in a range of 1.4×10⁻⁸ rad/in to 2.60×10⁻⁸ rad/in. K_{C}/m_{C} is the stiffness to mass ratio of the third section 2024, where K_{C} is the bending stiffness of the third section 2024 and m_{C} is the mass of the third section 2024. K_{C}/m_{C} is in a range of 4.85×10⁻⁹ rad/in to 2.00×10⁻⁸ rad/in. K_{D}/m_{D} is the stiffness to mass ratio of the fourth section 2026, where K_{D} is the bending stiffness of the fourth section 2026 and m_{D} is the mass of the fourth section 2026. K_{D}/m_{D} is in a range of 1.42×10⁻⁹ rad/in to 2.00×10⁻⁸ rad/in. K_{E}/M_{E} is the stiffness to mass ratio of the fifth section 2028, where K_{E} is the bending stiffness of the fifth section 2028 and m_{E} is the mass of the fifth section 2028. K_{E}/m_{E} is in a range of 1.37×10⁻⁹ rad/in to 2.00×10⁻⁸ rad/in. K_{F}/m_{F} is the stiffness to mass ratio of the sixth section 2030, where K_{F} is the bending stiffness of the sixth section 2030 and m_{F} is the mass of the sixth section 2030. K_{F}/m_{F} is in a range of 7.30×10⁻¹⁰ rad/in to 2.00×10⁻⁸ rad/in.

K is the bending stiffness of each of the sections 2020 to 2030. K is represented by relationship (16) for each section:

$$K = \frac{EI}{{L}^{3}} \qquad ( 16 )$$

Relationship (16) assumes a constant section thickness (or average wall thickness) and disregards tapering within a particular section. In relationship (14), E is the modulus of elasticity, or Young's modulus, for the material of the respective section of the LP shaft 138, L is the length of the respective section, and I is the area moment of inertia of the respective section. I is given by relationship (17):

$$I = \frac{π ( {D}_{o}^{4} - {D}_{i}^{4} )}{64} \qquad ( 17 )$$

Dₒ is an outer diameter of the respective shaft section and Dᵢ is an inner diameter of the respective shaft section. The outer diameter Dₒ is the diameter of the respective shaft section at the outer surface of the respective shaft section. The inner diameter Dᵢ is the diameter of the respective shaft section at the inner surface of the respective shaft section.

The area moment of inertia (I_{A}) of the first section 2020 is in a range of 2.0 in⁴ to 7.15 in⁴. In some embodiments, the area moment of inertia (I_{A}) of the first section 2020 is in a range of 2.9 in⁴ to 5.5 in⁴. The area moment of inertia (I_{B}) of the second section 2022 is in a range of 2.0 in⁴ to 7.8 in⁴. In some embodiments, the area moment of inertia (I_{B}) of the second section 2022 is in a range of 2.9 in⁴ to 6.0 in⁴. The area moment of inertia (I_{C}) of the third section 2024 is in a range of 2.0 in⁴ to 7.15 in⁴. In some embodiments, the area moment of inertia (I_{C}) of the third section 2024 is in a range of 2.9 in⁴ to 5.5 in⁴. The area moment of inertia (I_{D}) of the fourth section 2026 is in a range of 2.0 in⁴ to 19.0 in⁴. In some embodiments, the area moment of inertia (I_{D}) of the fourth section 2026 is in a range of 2.9 in⁴ to 14.6 in⁴. The area moment of inertia (I_{E}) of the fifth section 2028 is in a range of 2.0 in⁴ to 15.0 in⁴. In some embodiments, the area moment of inertia (I_{E}) of the fifth section 2028 is in a range of 2.9 in⁴ to 11.5 in⁴. The area moment of inertia (IF) of the sixth section 2030 is in a range of 2.0 in⁴ to 81.4 in⁴. In some embodiments, the area moment of inertia (IF) of the sixth section 2030 is in a range of 2.9 in⁴ to 62.6 in⁴.

A ratio of the area moment of inertia of the second section 2022 to the area moment of inertia of the first section 2020 (I_{B}/I_{A}) is in a range of 0.53 to 1. A ratio of the area moment of inertia of the second section 2022 to the area moment of inertia of the third section 2024 (I_{B}/I_{C}) is in a range of 0.53 to 1. A ratio of the area moment of inertia of the second section 2022 to the area moment of inertia of the fourth section 2026 (I_{B}/I_{D}) is in a range of 0.19 to 1. A ratio of the area moment of inertia of the second section 2022 to the area moment of inertia of the fifth section 2028 (I_{B}/I_{E}) is in a range of 0.25 to 1. A ratio of the area moment of inertia of the second section 2022 to the area moment of inertia of the sixth section 2030 (I_{B}/IF) is in a range of 0.04 to 1.

The mass of each of the shaft sections 2020 to 2030 is given by relationship (18):

$$m = ρ π ( {D}_{o}^{2} - {D}_{i}^{2} ) * L \qquad ( 18 )$$

The symbol ρ is the density of the respective shaft section. The mass m_{A} of the first section 2020 is in a range of 4.8 lbf to 20.8 lbf. In some embodiments, the mass m_{A} of the first section 2020 is in a range of 7.1 lbf to 16.0 lbf. The mass m_{B} of the second section 2022 is in a range of 6.0 lbf to 31.2 lbf. In some embodiments, the mass m_{B} of the second section 2022 is in a range of 8.6 lbf to 24.0 lbf. The mass m_{C} of the third section 2024 is in a range of 4.8 lbf to 20.8 lbf. In some embodiments, the mass m_{C} of the third section 2024 is in a range of 7.1 lbf to 16.0 lbf. The mass m_{B} of the fourth section 2026 is in a range of 6.0 lbf to 31.2 lbf. In some embodiments, the mass m_{B} of the fourth section 2026 is in a range of 8.6 lbf to 24.0 lbf. The mass m_{E} of the fifth section 2028 is in a range of 3.2 lbf to 22.5 lbf. In some embodiments, the mass m_{E} of the fifth section 2028 is in a range of 4.6 lbf to 17.3 lbf. The mass m_{F} of the sixth section 2030 is in a range of 5.9 lbf to 65.2 lbf. In some embodiments, the mass m_{F} of the sixth section 2030 is in a range of 8.5 lbf to 50.1 lbf. The total mass mₜₒₜₐₗ of the LP shaft 138 is in a range of 42.0 lbf to 192.0 lbf. In some embodiments, the total mass mₜₒₜₐₗ of the LP shaft 138 is in a range of 60.0 lbf to 147.6 lbf.

Accordingly, the stiffness ratios for each section are given by relationships (19) to (23):

$$\frac{[ \frac{{K}_{A}}{{m}_{A}} ]}{[ \frac{{K}_{B}}{{m}_{B}} ]} = \frac{( {D}_{oA}^{4} - {D}_{iB}^{4} ) {L}_{B}^{4} ( {D}_{oB}^{2} - {D}_{iB}^{2} )}{( {D}_{oA}^{2} - {D}_{iA}^{2} ) {L}_{A}^{4} ( {D}_{oB}^{4} - {D}_{iB}^{4} )} \qquad ( 19 )$$

$$\frac{[ \frac{{K}_{C}}{{m}_{C}} ]}{[ \frac{{K}_{B}}{{m}_{B}} ]} = \frac{( {D}_{oC}^{4} - {D}_{iB}^{4} ) {L}_{B}^{4} ( {D}_{oB}^{2} - {D}_{iB}^{2} )}{( {D}_{oC}^{2} - {D}_{iC}^{2} ) {L}_{C}^{4} ( {D}_{oB}^{4} - {D}_{iB}^{4} )} \qquad ( 20 )$$

$$\frac{[ \frac{{K}_{D}}{{m}_{D}} ]}{[ \frac{{K}_{B}}{{m}_{B}} ]} = \frac{( {D}_{oD}^{4} - {D}_{iB}^{4} ) {L}_{B}^{4} ( {D}_{oB}^{2} - {D}_{iB}^{2} )}{( {D}_{oD}^{2} - {D}_{iD}^{2} ) {L}_{C}^{4} ( {D}_{oB}^{4} - {D}_{iB}^{4} )} \qquad ( 21 )$$

$$\frac{[ \frac{{K}_{E}}{{m}_{E}} ]}{[ \frac{{K}_{B}}{{m}_{B}} ]} = \frac{( {D}_{oE}^{4} - {D}_{iB}^{4} ) {L}_{B}^{4} ( {D}_{oB}^{2} - {D}_{iB}^{2} )}{( {D}_{oE}^{2} - {D}_{iE}^{2} ) {L}_{E}^{4} ( {D}_{oB}^{4} - {D}_{iB}^{4} )} \qquad ( 22 )$$

$$\frac{[ \frac{{K}_{F}}{{m}_{F}} ]}{[ \frac{{K}_{B}}{{m}_{B}} ]} = \frac{( {D}_{oE}^{4} - {D}_{iB}^{4} ) {L}_{B}^{4} ( {D}_{oB}^{2} - {D}_{iB}^{2} )}{( {D}_{oF}^{2} - {D}_{iF}^{2} ) {L}_{C}^{4} ( {D}_{oB}^{4} - {D}_{iB}^{4} )} \qquad ( 23 )$$

In relationships (19) to (23), L is the section length of the respective section, Dₒ is the outer diameter of the respective section, and Dᵢ is the inner diameter of the respective section.

The outer diameter Do of each section is in a range of 2.9 in to 9.1 in. In some embodiments, the outer diameter Do of each section is in a range of 3.0 in to 7.0 in. In some embodiments, the outer diameter Do of each section is the same. In some embodiments, the outer diameter Do varies among the various sections. In particular, in some embodiments, at least one of the outer diameter D_{oD} of the fourth section 2026, the outer diameter D_{oE} of the fifth section 2028, or the outer diameter Dor of the sixth section 2030 is different than the outer diameter Dₒ of the first section 2020, the second section 2022, and the third section 2024. A ratio of the outer diameter D_{oB} of the second section 2022 to the outer diameter D_{oA} of the first section 2020 is in a range of 1.0 to 1.5. A ratio of the outer diameter D_{oB} of the second section 2022 to the outer diameter Doc of the third section 2024 is in a range of 1.0 to 1.5. A ratio of the outer diameter D_{oB} of the second section 2022 to the outer diameter D_{oD} of the fourth section 2026 is in a range of 0.7 to 1.5. A ratio of the outer diameter D_{oB} of the second section 2022 to the outer diameter D_{oE} of the fifth section 2028 is in a range of 0.8 to 1.5. A ratio of the outer diameter D_{oB} of the second section 2022 to the outer diameter D_{oF} of the sixth section 2030 is in a range of 0.5 to 1.5.

The inner diameter Di of each section varies among the various sections. In general, the inner diameter Di of each section is in a range of 1.4 in to 3.9 in. In some embodiments, the inner diameter Di of each section is in a range of 2.1 in to 3.0 in. In some embodiments, the inner diameter D_{iB} of the second section 2022 is equal to or greater than the inner diameter Dₒ of the first section 2020, the third section 2024, the fifth section 2028, and the sixth section 2030. A ratio of the inner diameter D_{iB} of the second section 2022 to the inner diameter D_{iA} of the first section 2020 is in a range of 1.0 to 1.5. A ratio of the inner diameter D_{iB} of the second section 2022 to the inner diameter D_{iC} of the third section 2024 is in a range of 1.0 to 1.5. A ratio of the inner diameter D_{iB} of the second section 2022 to the inner diameter D_{iD} of the fourth section 2026 is in a range of 0.7 to 1.5. A ratio of the inner diameter D_{iB} of the second section 2022 to the inner diameter D_{iE} of the fifth section 2028 is in a range of 1.0 to 1.5. A ratio of the inner diameter D_{iB} of the second section 2022 to the inner diameter Dir of the sixth section 2030 is in a range of 1.0 to 1.5.

The total bending stiffness Kₜₒₜₐₗ of the low-pressure shaft 138 is given by relationship (24):

$${K}_{total} = {K}_{A} + {K}_{B} + {K}_{C} + {K}_{D} + {K}_{E} + {K}_{F} \qquad ( 24 )$$

In relationship (24), K_{A} is the bending stiffness of the first section 2020, K_{B} is the bending stiffness of the second section 2022, K_{C} is the bending stiffness of the third section 2024, K_{D} is the bending stiffness of the fourth section 2026, K_{E} is the bending stiffness of the fifth section 2028, and Kr is the bending stiffness of the sixth section 2030. The bending stiffness K of each section is given by relationship (16) above.

K_{A} is in a range of 5.43×10⁻⁸ rad/lbf*in to 1.85×10⁻⁷ rad/lbf*in. In some embodiments, K_{A} is in a range of 7.76×10⁻⁸ rad/lbf*in to 1.42×10⁻⁷ rad/lbf*in. K_{B} is in a range of 3.36×10⁻⁷ rad/lbf*in to 6.24×10⁻⁷ rad/lbf*in. K_{C} is in a range of 5.43×10⁻⁸ rad/lbf*in to 1.85×10⁻⁷ rad/lbf*in. In some embodiments, K_{C} is in a range of 7.76×10⁻⁸ rad/lbf*in to 1.42×10⁻⁷ rad/lbf*in. K_{D} is in a range of 2.4×10⁻⁸ rad/lbf*in to 2.24×10⁻⁷ rad/lbf*in. In some embodiments, K_{D} is in a range of 3.43×10⁻⁸ rad/lbf*in to 1.72×10⁻⁷ rad/lbf*in. K_{E} is in a range of 1.65×10⁻⁸ rad/lbf*in to 11.98×10⁻⁸ rad/lbf*in. In some embodiments, K_{E} is in a range of 2.36×10⁻⁸ rad/lbf*in to 9.21×10⁻⁸ rad/lbf*in. K_{F} is in a range of 2.56×10⁻⁸ rad/lbf*in to 2.20×10⁻⁷ rad/lbf*in. In some embodiments, K_{F} is in a range of 3.66×10⁻⁸ rad/lbf*in to 1.69×10⁻⁷ rad/lbf*in. Kₜₒₜₐₗ is in a range of 5.11×10⁻⁷ rad/lbf*in to 1.56×10⁻⁶ rad/lbf*in. In some embodiments, Kₜₒₜₐₗ is in a range of 7.30×10⁻⁷ rad/lbf*in to 1.2×10⁻⁶ rad/lbf*in.

A ratio of the stiffness K_{A} of the first section 2020 to the stiffness K_{B} of the second section 2022 (K_{A}/K_{B}) is in a range of 0.16 to 0.3. A ratio of the stiffness K_{C} of the third section 2024 to the stiffness K_{B} of the second section 2022 (K_{C}/K_{B}) is in a range of 0.16 to 0.3. A ratio of the stiffness K_{D} of the fourth section 2026 to the stiffness K_{B} of the second section 2022 (K_{D}/K_{B}) is in a range of 0.07 to 0.36. A ratio of the stiffness K_{E} of the fifth section 2028 to the stiffness K_{B} of the second section 2022 (K_{E}/K_{B}) is in a range of 0.05 to 0.19. A ratio of the stiffness K_{F} of the sixth section 2030 to the stiffness K_{B} of the second section 2022 (K_{F}/K_{B}) is in a range of 0.08 to 0.35.

A ratio of the stiffness K_{B} of the second section 2022 to the total stiffness Kₜₒₜₐₗ is greater than or equal to 0.4. In particular, K_{B}/Kₜₒₜₐₗ is in a range of 0.4 to 0.7. A ratio of the stiffness to mass ratio of the second section 2022 to the total stiffness to mass ratio ((K_{B}/m_{B})/(Kₜₒₜₐₗ/mₜₒₜₐₗ) is greater than one. In some embodiments, the ratio of the stiffness to mass ratio of the second section 2022 to the total stiffness to mass ratio ((K_{B}/m_{B})/(Kₜₒₜₐₗ/mₜₒₜₐₗ) is 1.2 to 5. In some embodiments, the ratio of the stiffness to mass ratio of the second section 2022 to the total stiffness to mass ratio ((K_{B}/m_{B})/(Kₜₒₜₐₗ/mₜₒₜₐₗ) is 1.3 to 5. Such a configuration of the stiffness of the low-pressure shaft 138 provides for the bending modes (e.g., the first order bending mode, the second order bending mode, or the third order bending mode) of the low-pressure shaft 138 to be greater than the redline speed of the low-pressure shaft 138. In particular, the bending modes (e.g., the first order bending mode, the second order bending mode, or the third order bending mode) are at least 5% greater than the redline speed.

The embodiments of shaft length changes as effected by changes in the core size was previously expressed in expression (6). With respect to FIG. 34, the relationship among HPC and HPT stages to core length, core exit radius the core inlet radius, and the compressor stages and the turbine stages is expressed by relationship (25), which was found to characterize the embodiments that provided desired results in terms of core properties:

$${L}_{CORE} = {[ {m}^{( 20 + m )} \times {n}^{( 10 + n )} ]}^{( \frac{1}{100} )} \times {( \frac{Core Exit Radius}{Core Inlet Radius} )}^{\frac{\sqrt{{M}^{2} + {N}^{2}}}{10}} + C \qquad ( 25 )$$

Due to relationship (25), the influence of core length changes impacted by adding additional HPC or HPT stages from the embodiments evaluated, are more directly related to engine dynamics associated with a higher power density core. The symbol m is the number of stages in the high-pressure compressor and n is the number of stages in the high-pressure turbine. The symbol C is a constant that represents an axial distance from the IGV 201 (FIG. 22) of the HP compressor 128 to a leading edge of the HP compressor rotor blade 202 (FIG. 22) of the first stage of the HP compressor 128. C is in a range of 11.9 in to 23.5 in. The relation in (25) for L_{CORE} is valid only for m being eight, nine, ten, or eleven, and n being one or two. The core exit radius is a radius of the HP turbine 132 at an exit stage (last stage) of the HP turbine 132. In particular, the core exit radius is an average radius of the exit stage and is given by (26):

$$\frac{{R}_{exit \_ blade \_ tip} + {R}_{exit \_ blade \_ hub}}{2} \qquad ( 26 )$$

In (26), R_{exit_blade_tip} is the radius from the longitudinal centerline axis 12 to the tip of the HP turbine rotor blade 206 of the exit stage at the leading edge of the HP turbine rotor blade 206 and R_{exit_blade_hub} is the radius from the longitudinal centerline axis 12 to the hub (e.g., the root) of the HP turbine rotor blade 206 of the exit stage 129 at the leading edge of the HP turbine rotor blade 206.

The core inlet radius is a radius of the HP compressor 128 at inlet stage (e.g., the first stage) of the HP compressor 128. In particular, the core inlet radius is an average radius of the inlet stage and is given by (27):

$$\frac{{R}_{inlet \_ blade \_ tip} + {R}_{inlet \_ blade \_ hub}}{2} \qquad ( 27 )$$

In (27), R_{inlet_blade_tip} is the radius from the longitudinal centerline axis 12 to the tip of the HP compressor rotor blade 202 of the first stage at the leading edge of the HP compressor rotor blade 202 and R_{inlet_blade_hub} is the radius from the longitudinal centerline axis 12 to the hub (e.g., the root) of the HP compressor rotor blade 202 of the first stage at the leading edge of the HP compressor rotor blade 202.

The embodiments evaluated and tested for varying shaft distances and bearing placements to produce an effective fixed-fixed midshaft support (FIG. 35) are disclosed in TABLE 11, below. The problem addressed was both accommodating a stiffer shaft within a reduced space associated with a more compact core and raising the critical frequency of the midshaft section. The present disclosure found, unexpectedly, that certain dimensions and placement of bearings, wall thicknesses, and shaft lengths, as described earlier, produced the unexpected result of higher mid-shaft critical frequencies needed for a high speed LP turbine associated with next generation, geared engines. By way of testing various engine architectures, the present disclosure provides for different configurations of the low-pressure shaft, bearing placement and type, including different thicknesses, moments of inertia, and lengths, and different bearing configurations for the bearings that support the low-pressure shaft.

During the course of evaluating the different embodiments set forth herein, with the goal of providing a low-pressure shaft that rotates at higher speeds while remaining sub-critical during normal operation of the turbine engine, the present disclosure determined that varying the thickness of the low-pressure shaft along the length of the low-pressure shaft, and arranging the bearings axially forward of the low-pressure compressor mounting point and aft of the low-pressure turbine mounting point, provided for an increased natural frequency of the low-pressure shaft without overly increasing the diameter of the low-pressure shaft to fit within the bore of the high-pressure shaft and without exciting a bending mode of the high-pressure shaft.

The present disclosure provides for several different architectures of the low-pressure shaft and the bearings, and, unexpectedly, favorable results that provided a favorable balance between limited space, higher mass-stiffness properties, and avoided cross-coupling with the HP shaft. The embodiments, provided below, were found to be capable of characterization by specifying a combination of the area moment of inertia, the average wall thickness of the second section 2022, the average wall thickness of the fourth section 2026 and the fifth section 2028, the length (L_{MIDSHAFT}) of the low-pressure shaft from the forward low-pressure shaft bearing (e.g., the bearing 2002a) to the aft low-pressure shaft bearing (e.g., the bearing 2008a), the length of the second section 2022, and the modulus of elasticity (E) of the material of the second section 2022. With this characterization, the architectures that satisfy operational requirements (e.g., low-pressure shafts have a natural frequency that is at least 10% greater than the redline speed) and the packaging requirements (e.g., low-pressure shafts having a length and a diameter that fit within the limited space of the turbine engine) could be distinguished from architectures that do not satisfy these requirements. As such, a finite and readily ascertainable number of embodiments that accounts of the operational requirement and the packaging requirements without exciting the first-order bending mode of the low-pressure shaft. The present disclosure provides a set of novel designs that meet these requirements. The novel designs can be characterized by a Midshaft Effective Flexural Rigidity (MEFR), as set forth in relationship (28):

$$MEFR = E \times {I}_{B} \times ( \frac{( 1.3 \times {T}_{E} ) + {T}_{D}}{2 \times {T}_{B}} ) \times ( \frac{{L}_{B}}{{L}_{T ota} l} ) \times 1 {0}^{- 6} \qquad ( 28 )$$

In MEFR, E is the modulus of elasticity of the material of the second section 2022, I_{B} is the average area moment of inertia of the second section 2022 osf the low-pressure shaft, T_{D} is the thickness of the fourth section 2026, T_{E} the thickness of the fifth section 2028, T_{B} is the thickness of the second section 2022 (also referred to as the midshaft), L_{B} is the length of the second section 2022 (the midshaft), and L_{Total} is the total length of the low-pressure shaft 138 (L_{Total}=L_{E}+L_{A}+L_{B}+L_{C}+L_{F}+L_{D}).

As discussed further below and mentioned above, the present disclosures provides low-pressure shaft designs for different turbine engine architectures that account for the higher rotational speeds, while increasing the natural frequency of the low-pressure shaft to avoid exciting the first-order bending mode of the shaft. These improved low-pressure shaft designs can be characterized according to a defined range for the MEFR. Table 11 below represents exemplary embodiments 129 to 134 and their corresponding MEFR values for various low-pressure shafts.

FIG. 35 is a schematic view of a bearing damper assembly 2100 for the gas turbine engine 1100 (FIG. 21), taken along the longitudinal centerline axis 112 (FIG. 21) of the gas turbine engine 1100, according to the present disclosure. The bearing damper assembly 2100 can be utilized in any of the engines disclosed herein, provided, in the case of a squeeze film damper housing for the bearing, the oil sump and circuit is suitable for the bearing load requirements and accommodated in engine's thermal management system for the oil. The bearing damper assembly 2100 can be utilized to engage and to support a rotating component 2120 of the gas turbine engine 1100. The bearing damper assembly 2100, however, can be used to support any rotating component of the gas turbine engine 1100, or between any rotating component of other gas turbine engines. Particularly, the rotating component 2120 may be any rotating component of the turbomachine 120 (e.g., the LP shaft 138 or the HP shaft 136) of the gas turbine engine 1100 (FIG. 21). For example, the bearing damper assembly 2100 of the present disclosure may be associated with any of the bearings discussed herein. In some embodiments, the gas turbine engine 1100 may include one or more bearing damper assemblies 2100 at various bearing locations. For example, one or more of the bearings 1102 to 1108 can include a respective bearing damper assembly 2100.

As shown in FIG. 35, the bearing damper assembly 2100 includes a damper frame 2102, a bearing housing 2104, end seals 2106, and one or more bearings 2108. In the illustrated embodiment, an outer surface (e.g., an outer rim) of the bearing housing 2104 is coupled to an inner surface of the damper frame 2102. In some embodiments, the bearing housing 2104 may be fixedly coupled to the damper frame 2102 (e.g., via screws, nuts, or other suitable fastening mechanisms). In such embodiments, movement of the outer rim of the bearing housing 2104 relative to the damper frame 2102 may be limited.

The bearings 2108 are coupled to an inner surface of the bearing housing 2104 and define an annular region 2112, that supports the rotating component 2120. As described above, the bearings 2108 may facilitate rotation of the rotating component 2120, for example, by reducing friction that resists rotation. In the illustrated embodiment, the bearings 2108 are ball bearings. The bearings 2108 may be, any type of bearings, such as, for example, ball bearings, roller bearings, or the like. The bearings 2108 are coupled between the bearing housing 2104 and the rotating component 2120. As such, the rotating component 2120 may exert a force through the bearings 2108 onto the bearing housing 2104. For example, gravity may pull downward on the rotating component 2120, thus causing the rotating component 2120 to exert a radial force on the bearing housing 2104. Additionally, thrust from movement of the gas turbine engine 1100 (FIG. 21) may cause the rotating component 2120 to exert an axial force on the bearing housing 2104.

Furthermore, during operation of the gas turbine engine 1100 (FIG. 21), vibrations may be produced on the rotating component 2120 (e.g., due to mass imbalance or operation of the gas turbine engine 1100 (FIG. 21)) that may propagate into the bearing housing 2104. In some instances, vibrations of the rotating component 2120 may affect operation of the gas turbine engine 1100 (FIG. 21), for example, by disturbing or displacing other components. In particular, the vibrations can excite the first order bending mode of the low-pressure shaft 138, as detailed above. As such, the bearing housing 2104 may be used to damp (e.g., dissipate) vibrations of the rotating component 2120, thus, reducing likelihood of vibrations affecting operation of the gas turbine engine 1100.

Various types of dampers may be utilized in the bearing damper assembly 2100 to damp vibrations of the rotating component 2120. In the illustrated embodiment of FIG. 35, the bearing housing 2104 of the bearing damper assembly 2100 is a squeeze film damper that utilizes fluid (e.g., oil) in one or more annular gaps formed between an inner diameter and an outer diameter of the bearing housing 2104. In some embodiments, the damper may be a segmented damper, although other types of bearings or rotational supports are contemplated in this way, damping characteristics (e.g., targeted frequencies or a targeted damping value) of the bearing housing 2104 may be dependent at least in part on the fluid in the one or more annular gaps. The bearing damper assembly 2100 depicted in FIG. 35 is by way of example only. In other embodiments, the bearing damper assembly 2100 may have any other suitable configuration.

In operation, oil is supplied to the bearing housing 2104 between the end seals 2106 to damp the vibrations. The oil is supplied within an operating temperature range to achieve a particular viscosity of the oil that corresponds to a particular damping coefficient to damp the vibrations in the rotating component 2120. In one embodiment, the operating temperature range of the oil is between one hundred eighty degrees Fahrenheit (180° F.) and two hundred twenty degrees Fahrenheit (220° F.).

The present disclosure provides the following relationships that represent evaluation of several different core designs (designs that provide higher power densities, as discussed earlier) from the perspective of maintaining dynamic stability between and among the HP shaft and LP shaft. These relationships take into account the trade-offs that need to be made, so that the design accounts not only for features of the core length, size and weight, and representative of a higher overall pressure ratio and increased operating temperatures (including use of CMC material), but also the effects that these changes in the core can have on both the HP shaft and the LP shaft.

A first relationship concerns the high-pressure shaft redline speed, or high speed shaft rating HSR given by (26):

$$HSR = 1 {0}^{- 6} * N {2}_{r / l} * {D}_{CO RE} * {( \frac{{L}_{CORE}}{{D}_{CORE}} )}^{2} \qquad ( 26 )$$

L_{CORE} and D_{CORE} are defined as described previously. N2_{r/l} is the redline speed for the HP shaft. The redline speed N2_{r/l} is from 11000 RPM to 25000 RPM. L_{CORE} is from forty-three inches to eighty inches. D_{CORE} is from 13.8 inches to 30.6 inches. HSR is from 1.9 to 4.3.

For stable operating conditions the high-pressure shaft third order bending mode should be placed above the redline speed of the HP shaft and satisfying (27):

$$- 0.1822 * HSR + HST > 0 \qquad ( 27 )$$

HST accounts for the effects that the HPC pressure ratio and the HPC exit temperature can have on the third order bending mode. T25 is the temperature in Rankine (R) at the high-pressure compressor (HPC) inlet. A good approximation for HST can be made in terms of only the T25, using (28):

$$HST = - 0.0014 * T 25 + 1.61 \qquad ( 28 )$$

where T25 is from 615 R to 855 R and HST is from 0.46 to 0.78.

For stable operating conditions the high-pressure shaft second order bending mode should be placed 20% below the redline speed of the HP shaft satisfying (29):

$$- 0.1215 * HSR + ( \frac{2 * HST - 1}{3} ) < - 0.2 \qquad ( 29 )$$

A second relationship concerns the low-pressure shaft redline speed, or high-speed shaft rating HSR_{LP} given by (30):

$$H S {R}_{L P} = 1 {0}^{- 6} * N {1}_{r / l} * {D}_{C O R E} * {( \frac{{L}_{C O R E}}{{D}_{C O R E}} )}^{2} \qquad ( 30 )$$

L_{CORE} and D_{CORE} are defined as described previously. N1_{r/l} is the redline speed for the LP shaft. For stable operating conditions the high-pressure shaft first mode should be placed either 20% below or above the redline speed of the LP shaft satisfying (31):

$$\frac{0.55}{{( H S {R}_{L P} )}^{2}} + LST < - 0.2 OR \frac{0.55}{{( H S {R}_{L P} )}^{2}} + LST > 0 \qquad ( 31 )$$

LST accounts for the effects that the HPC pressure ratio and the HPC exit temperature can have on the first mode. T25 is the temperature in Rankine (R) at the high-pressure compressor (HPC) inlet. A good approximation for LST can be made in terms of only the T25, using (32):

$$LST = - 0.0023 * T 25 + 1.18 \qquad ( 32 )$$

where T25 is from 615 R to 855 R and LST is from −0.2 to −0.74.

Relationships (26) through (32) when used together individually or together (depending on application or changes made to a design) can identify an improved core accounting for characteristics associated with a higher power density (use of CMC material, increased number of HPC and/or HPT stages, increased bore height or length of the LP shaft) and bounding those features within constraints to avoid dynamic instability by interaction between one or more vibration modes of the LP shaft and HP shaft.

The foregoing indicates that employing CMC in the high-pressure turbine and/or the high-pressure compressor can benefit both the low-pressure shaft critical speed and the high-pressure shaft dynamics (e.g., the third order bending mode of the high-pressure shaft), or it can introduce unanticipated dynamic instability such as at a cruise condition. As explained earlier, CMC material used in the high-pressure turbine can provide favorable reductions in disk width (e.g., FIG. 28, width w) and increased disk bore radius (e.g., FIG. 28, radius r) which may both reduce L_{MSR} and increase D_{MSR}. The changes in core length can also benefit the third order bending mode of the high-pressure shaft.

Additionally, CMC material used in high-pressure compressor (particularly the aft-most stages) can produce a noticeable increase in the natural frequency of the HP shaft first and third order bending mode because this location corresponds to the maximum deflection points for the first mode and the third order bending mode (FIGS. 33A, 33C). Finally, as discussed earlier, CMC material used for the HPT rotor blades (first stage) can result in a width reduction of the HPT disk (e.g., FIG. 28, width w), as well as an increased bore radius for the HPT first stage disk bore (e.g., FIG. 28, radius r). These later changes to the HPT can improve the dynamics of the high-pressure shaft, including the third order bending mode of the high-pressure shaft and the MSR because of the weight reduction and reduced L_{MSR} (reduces length of HP shaft correspondingly, thereby moving the third order bending mode to a higher frequency), and D_{MSR} increase, respectively. Accordingly, the use of CMC material in the HPC, LPC, HPT, and/or the LPT provides for higher critical speeds and lower weights, thereby increasing the MSR, and, thus, providing a higher power density engine.

Furthermore, the present disclosure considered the effects that gearbox dynamics have on LP shaft dynamics. Based on the studies done, it was found unexpectedly that there are certain relationships between gearbox dynamics and LP shaft dynamics that influence the design of the coupling between the gearbox and the LP shaft. Embodiments taking into account gearbox dynamics in combination with CMC are found in FIGS. 36A to 36I (e.g., embodiments 66 to 73, 85, and 86).

TABLE 6 lists the bearing layout, the strength-to-weight ratio E/rho in inches⁻¹, the effective thickness Teff in inches, the critical speed corresponding to the shaft's fundamental mode in RPM, the OD linear speed at redline in ft/sec, the length-to-diameter ratio L_{MSR}/D_{MSR} (dimensionless), and MSR in (ft/sec)^{1/2} for all the embodiments (1 to 13) of Tables 2 to 4, as well as a number of additional embodiments (14 to 32). As noted above, L_{MSR}/D_{MSR} represents the ratio of the length over the outer diameter of the low-pressure/low-speed shaft. When the shaft has a variable diameter over its length, the outer diameter may be the diameter at the midshaft. E/rho represents the material composition of the shaft, and Teff represents an effective wall thickness of the shaft. For shafts with variable thickness over their length, the wall thickness may be the thickness at the midshaft.

TABLE 6

| | | | | | | Redline | |
|---|---|---|---|---|---|---|---|
| | | | | | L_{MSR}/ | OD | |
| | Bearing | E/rho | T_{eff} | Mode | D_{MSR} | Speed | MSR |
| Embodiment | Layout | in⁻¹ | in | RPM | in/in | ft/sec | (ft/sec)^{1/2} |
| 1 | 2-bearing | 1.00E+8 | 0.35 | 4181 | 30 | 50 | 214 |
| | outbound | | | | | | |
| 2 | inbound | 1.27E+8 | 0.35 | 10263 | 22 | 123 | 247 |
| | OTM | | | | | | |
| 3 | outbound | 1.27E+8 | 0.35 | 6915 | 30 | 83 | 275 |
| | OTM | | | | | | |
| 4 | inbound | 1.00E+8 | 0.35 | 9001 | 22 | 108 | 231 |
| | OTM | | | | | | |
| 5 | outbound | 1.00E+8 | 0.35 | 6065 | 30 | 73 | 257 |
| | OTM | | | | | | |
| 6 | inbound | 1.00E+8 | 0.32 | 10039 | 22 | 121 | 242 |
| | OTM | | | | | | |
| 7 | outbound | 1.00E+8 | 0.32 | 6942 | 30 | 83 | 272 |
| | OTM | | | | | | |
| 8 | 4-bearing | 1.00E+8 | 0.35 | 7746 | 22 | 93 | 214 |
| | straddle | | | | | | |
| 9 | 4-bearing | 1.00E+8 | 0.32 | 8555 | 22 | 103 | 223 |
| | straddle | | | | | | |
| 10 | 4-bearing | 1.27E+8 | 0.35 | 8832 | 22 | 106 | 229 |
| | straddle | | | | | | |
| 11 | 4-bearing | 1.27E+8 | 0.32 | 9703 | 30 | 116 | 322 |
| | straddle | | | | | | |
| 12 | inbound | 1.27E+8 | 0.32 | 11386 | 22 | 137 | 257 |
| | OTM | | | | | | |
| 13 | outbound | 1.27E+8 | 0.32 | 7873 | 30 | 94 | 290 |
| | OTM | | | | | | |
| 14 | 4-bearing | 1.00E+8 | 0.35 | 6262 | 26 | 72 | 219 |
| | outbound | | | | | | |
| 15 | 2-bearing aft | 1.27E+8 | 0.29 | 8255 | 21 | 109 | 215 |
| 16 | 2-bearing aft | 1.27E+8 | 0.31 | 13323 | 14 | 233 | 216 |
| 17 | 2-bearing aft | 1.27E+8 | 0.47 | 5667 | 23 | 83 | 210 |
| 18 | 2-bearing aft | 1.27E+8 | 0.29 | 6380 | 24 | 83 | 215 |
| 19 | 2-bearing aft | 1.27E+8 | 0.31 | 9821 | 17 | 154 | 216 |
| 20 | 2-bearing aft | 1.27E+8 | 0.47 | 4586 | 26 | 67 | 211 |
| 21 | 2-bearing aft | 1.00E+8 | 0.23 | 6380 | 24 | 84 | 217 |
| 22 | 2-bearing aft | 1.00E+8 | 0.25 | 13493 | 14 | 235 | 218 |
| 23 | 2-bearing aft | 1.00E+8 | 0.38 | 4586 | 27 | 62 | 210 |
| 24 | 2-bearing aft | 1.27E+8 | 0.29 | 6619 | 25 | 87 | 231 |
| 25 | 2-bearing aft | 1.27E+8 | 0.31 | 11065 | 17 | 176 | 232 |
| 26 | 2-bearing aft | 1.27E+8 | 0.47 | 4852 | 28 | 64 | 224 |
| 27 | 4-bearing | 1.00E+8 | 0.29 | 6380 | 28 | 75 | 245 |
| | straddle | | | | | | |
| 28 | inbound | 1.00E+8 | 0.31 | 10666 | 19 | 165 | 247 |
| | OTM | | | | | | |
| 29 | outbound | 1.00E+8 | 0.47 | 4586 | 31 | 59 | 239 |
| | OTM | | | | | | |
| 30 | 4-bearing | 1.27E+8 | 0.23 | 6380 | 35 | 70 | 289 |
| | straddle | | | | | | |
| 31 | inbound | 1.27E+8 | 0.25 | 11410 | 22 | 181 | 294 |
| | OTM | | | | | | |
| 32 | outbound | 1.27E+8 | 0.38 | 5293 | 33 | 70 | 276 |
| | OTM | | | | | | |

Embodiments 15 to 26 use a two-bearing aft layout. These embodiments differ in using composite materials, different shaft geometries, and variable thickness profiles.

Embodiments 15 to 17 use a composite material instead of steel alloy. These embodiments differ in shaft geometry, with different L_{MSR}/D_{MSR} ratios ranging from 14 to 23.

Embodiments 18 to 20 use a composite material instead of a steel alloy. These embodiments also differ from each other in shaft geometry (e.g., L_{MSR}/D_{MSR} ratio). These also differ from Embodiments 15 to 17, in being longer and thinner, resulting in a higher range of L_{MSR}/D_{MSR} ratio, from 17 to 26.

Embodiments 21 to 23 use a steel alloy, vary the shaft geometry (length and/or diameter), and have a concave thickness profile. These differ from each other in terms of their effective thickness. These embodiments may be compared to Embodiments 24 to 26, which use composite materials, vary the shaft geometry (length and/or diameter), and have a concave thickness profile.

Embodiments 27 to 32 use different bearing layouts. Embodiments 27 to 29 use steel alloy and have varying geometry. Embodiments 30 to 32 use composite material and a concave thickness profile, in addition to varying geometry.

FIGS. 36A to 36I, illustrate additional embodiments 33 to 86 taking into account the effects of the change in core dimensions (e.g., stages, lengths, diameters, etc.) and use of CMC described previously. The comparisons described below are in relation to the embodiments 1 to 32 described in TABLE 6.

Embodiments 33 to 36 use CMC for various components in the low-pressure turbine to help reduce the weight. These embodiments differ from each other in terms of bearing arrangements, and maintain the same stiffness as comparable embodiments 1, 2, and 8 (described above in TABLE 6) without CMC components. The use of CMC provides a reduced overhung weight, which has the effect of increasing the allowable OD speed at redline and/or enabling a higher MSR.

Embodiments 37 to 40 use CMC for various components in both the low-pressure turbine and the core (e.g., the high-pressure turbine). The use of CMC in the low-pressure turbine reduces the weight. The use of CMC in the core increases the bore radius of the core, thus allowing for an increase in diameter of the low-pressure shaft. That is, embodiments 37 to 40, have a larger radius for the low-speed shaft (3 inches) relative to embodiments without CMC in the core, for example, embodiments 1, 2, 8, and 33 to 36, which employ CMC only in the LPT (having a low-speed shaft diameter of 2.7 inches). Embodiment 39 further includes the addition of using bottle boring for a variable low-speed shaft thickness. The increased bore radius generally provides a lower L_{MSR}/D_{MSR} ratio (see for example, a comparison with embodiments 1, 2, 8, and 33 to 36) and/or enabling an increased MSR.

Embodiments 41 to 45 use different combinations of bottle boring and CMC for various components in both the LPT and the HPT. These embodiments have an even larger radius (4 inches) for the low-speed shaft, as well as a lower effective thickness (see, for example, a comparison with embodiments 1, 4, 8, and 37 to 40) generally resulting in a higher redline speeds and/or higher MSR. Embodiments 43 and 44 further including bottle boring. Embodiment 44 includes a 2+1 bearing system arrangement, such as described with respect to FIG. 22.

Embodiments 46 to 51 use different combinations of bottle boring and CMC for various components in both the LPT and the HPT. These embodiments have an even larger radius (4 inches) for the low-speed shaft, as well as a lower effective thickness (see, for example, a comparison with embodiments 1, 4, 8, and 37 to 40). Embodiments 46 to 51 further include a composite material shaft. Embodiments 46 to 51 include CMC in the HPT a manner that increases the bore radius (e.g., as described with respect to FIG. 28). Embodiment 48 further includes CMC in the HPT in a manner that decreases the core length (e.g., as described with respect to FIG. 17). This results in increased strength to weight ratio (1.3E+8 in). The combination of CMC in the LPT, CMC in the HPT, and a composite material shaft facilitates higher redline speeds and/or higher MSR.

Embodiment 52 used a three-bearing system, including bottling boring. Embodiments 53 to 59 begin with this as a baseline and adjust various factors. Each additional embodiment from embodiments 53 to 59 builds on the prior embodiment. Embodiment 53 adds CMC in the LPT to embodiment 52. Embodiment 54 adds CMC in another stage of the LPT to embodiment 53. Embodiment 55 includes a composite material in the low-speed shaft added to the embodiment 54. Embodiment 56 adds the core increase benefits of CMC in the HPT to embodiment 55. Embodiment 57 is based on embodiment 56 but with a 9 stage core. Embodiment 58 is based on embodiment 57, but with two bearings in the forward position and one bearing in the aft position on the LPT (e.g., the arrangement described with respect to FIG. 11B). Embodiment 59 adds another core stage to embodiment 58. These variations resulted in increased redline speed and/or higher MSR.

Embodiment 60 used a three-bearing system, including bottling boring. Embodiments 61 to 65 begin with this as a baseline and adjust various factors. Each additional embodiment from embodiments 61 to 65 builds on the prior embodiment. Embodiment 61 adds CMC in the LPT to embodiment 60. Embodiment 62 includes a composite material in the low-speed shaft added to the embodiment 61. Embodiment 63 adds the core increase benefits of CMC in the HPT to embodiment 62.

Embodiment 64 is based on embodiment 63 but with a 9-stage core. Embodiment 65 is based on embodiment 64, but with two bearings in the forward position and one bearing in the aft position on the LPT (e.g., the arrangement described with respect to FIG. 23). These variations resulted in increased redline speed and/or higher MSR.

Embodiments 66 to 69 all use CMC in the LPT and CMC in the HPT to take advantage of the core increase benefits. Embodiments 66 and 67 use a four-bearing system and include bottle boring. Embodiments 68 and 69 include a two-bearing system having a forward inbound bearing and an aft outbound bearing and include bottle boring. The embodiments of 66 to 69 further have differences in terms of stiffness (e.g., decoupler shear stiffness and/or decoupler moment stiffness). As shown, embodiments 67 and 69 achieve a greater shear stiffness than embodiments 66 and 68, respectively, generally resulting in substantially higher redline speeds and/or higher MSR.

Embodiments 70 to 73 all use CMC in the LPT and CMC in the HPT to take advantage of the core increase benefits. Embodiments 70 and 71 use a four-bearing system and include bottle boring. Embodiments 72 and 73 include a two-bearing system having a forward inbound bearing and an aft outbound bearing and include bottle boring. The embodiments of 70 to 73 further have differences in terms of stiffness (e.g., decoupler shear stiffness). As shown, embodiments 71 and 73 achieve a greater shear stiffness than embodiments 70 and 72, respectively, generally resulting in substantially higher redline speeds and/or higher MSR. Embodiments 70 to 73 differ from embodiments 66 to 69 in that the embodiments have a smaller LP shaft diameter.

In each of the embodiments 74 to 84, L_{MSR} is determined based on the relationship (4) described previously. In embodiments 74 to 77 CMC is not used. In embodiments 78 to 84, CMC is used in the LPT and the HPT. In embodiments 78 to 80, the CMC is used in the HPT to increase the core radius. In the embodiments 81 to 84 the CMC is used in the HPT to decrease the core length and increase the core radius. As shown in embodiments 74 to 84, this allows increase in redline speeds and/or MSR.

Embodiments 85 and 86 both use CMC in the LPT and CMC in the HPT to take advantage of the core increase benefits. Embodiments 85 and 86 both include a two-bearing system having a forward inbound bearing and an aft outbound bearing and include bottle boring. The embodiments differ in terms of stiffness (e.g., decoupler shear stiffness and/or decoupler moment stiffness). As shown, embodiment 86 achieves a greater shear stiffness and greater moment stiffness than embodiment 85, generally resulting in a substantially higher redline speed and/or higher MSR.

Based on the experimentation described above, the present disclosure identified embodiments with MSR between two hundred and three thirty hundred (ft/sec)⁻¹ and OD redline speeds ranging from fifty to two hundred sixty ft/sec and with L_{MSR}/D_{MSR} ratio ranging from twelve to thirty-seven were possible and indicated noticeable improvements in subcritical range when the power turbine shaft incorporates the various aspects of the disclosure.

TABLE 7 summarizes examples of different operating ranges for embodiments, such as the embodiments listed in TABLE 6. For example, an embodiment can be configured with a L_{MSR}/D_{MSR} ranging between twelve and twenty may have an OD speed between one hundred and fifty and two hundred and fifty ft/sec, and a corresponding range of MSR between one hundred ninety and two hundred forty-five (ft/sec)^{1/2}. As another example, an embodiment can be configured with a L_{MSR}/D_{MSR} ranging between sixteen and thirty may have an OD speed between seventy-five and one hundred seventy-five ft/sec, and a corresponding range of MSR between two hundred twelve and two hundred sixty (ft/sec)^{1/2}. As still another example, an embodiment can be configured with a L_{MSR}/D_{MSR} ranging between twenty-six and thirty-seven may have an OD speed between sixty and ninety ft/sec, and a corresponding range of MSR between two hundred forty-seven and two hundred eighty-seven ft/sec)^{1/2}. These low, nominal, and high ranges as summarized in TABLE 7 are general examples, and individual embodiments may exceed these values.

TABLE 7

| | L_{MSR}/ | Redline OD | |
|---|---|---|---|
| Example Limits | D_{MSR} | Speed | MSR |
| and Ranges | (in/in) | (ft/sec) | (ft/sec)^{1/2} |
| Low limit | 12 | 250 | 190 |
| | 20 | 150 | 245 |
| Nominal limit | 16 | 175 | 212 |
| | 30 | 75 | 260 |
| High Limit | 26 | 90 | 247 |
| | 37 | 60 | 287 |

According to additional embodiments, CMCs were evaluated in the low-pressure turbine and high-pressure turbine, in combination with different bearing configurations, different effective shaft thicknesses, different shaft diameters, different shaft materials (e.g., composites), and a variety of combinations thereof, in order to determine which combinations would work best for a given architecture and need, as well as taking the competing engineering requirements into account. Some of these embodiments are summarized in FIGS. 36A to 36I.

FIGS. 36A to 36I list the bearing layout, the strength-to-weight ratio E/rho in inches⁻¹, the effective thickness Teff in inches, the critical speed corresponding to the shaft's fundamental mode in RPM, the OD linear speed at redline in ft/sec, the length-to-diameter ratio L_{MSR}/D_{MSR} (dimensionless), and MSR in (ft/sec)^{1/2} for a number of additional embodiments (33 to 59). As noted above, L_{MSR}/D_{MSR} represents the ratio of the length over the outer diameter. When the shaft has a variable diameter over its length, the outer diameter may be the diameter at the midshaft. E/rho represents the material composition of the shaft, and Teff represents an effective wall thickness of the shaft. For shafts with variable thickness over their length, the wall thickness may be the thickness at the midshaft.

Additional embodiments of engine architectures utilizing CMC are detailed in Table 8. As discussed above, CMC materials are currently being considered for use various in higher temperature sections of gas turbine engines, such as airfoils (e.g., turbines, and vanes), combustors, shrouds and other like components, that would benefit from the lighter-weight and higher temperature capability these materials can offer. The additional embodiments summarized in Table 8 include CMC materials in certain components of gas turbine engine. For example, and referring to FIG. 7 above, embodiment 87 includes the combustor 262 with the outer combustion chamber liner 264 and the inner combustion chamber liner 266 both formed from CMC materials and defining the combustion chamber 268. In some embodiments, at least one of the outer combustion chamber liner 264 or the inner combustion chamber liner 266 is formed from the CMC material. In some embodiments (e.g., embodiments 88 to 92), CMC components are static components of the HPT, such as the HP turbine stator vanes 208 (FIG. 7), the shroud 209 (FIG. 7), or both the HP turbine stator vane 208 and the shroud 209. In some embodiments (e.g., embodiments 93 to 97), CMC components are static components of the LPT, such as the LP turbine stator vanes 212 (FIG. 12), the shroud 213 (FIG. 12), or both the LP turbine stator vane 212 and the shroud 213. In some embodiments (e.g., embodiments 92, 97, 98, 99, 100, and 101), CMC components are rotating components, such as the HP turbine rotor blades 206 (FIGS. 7 and 12), the shroud 207 (FIG. 12), the LP turbine rotor blades 210 (FIG. 12), or the shroud 211 (FIG. 12). In embodiments (e.g., embodiments 88, 90, 92, and 98), the CMC materials are used in the first stage of the HPT, with the downstream stages being formed from non-CMC materials such as metal alloys. In other embodiments (e.g., embodiments 89, 91, and 99), the CMC materials are used in the first stage of the HPT and downstream stages, such as the second stage of the HPT. Similarly, in embodiments (e.g., embodiments 93, 95, 97, and 100), the CMC materials are used in the first stage of the LPT, with the downstream stages being formed from non-CMC materials such as metal alloys. In other embodiments (e.g., embodiments 94, 96, and 101), the CMC materials are used in the first stage of the LPT and one or more downstream stages, such as the second stage of the LPT.

Each of the embodiments in Table 8 are based on embodiment 52 in FIG. 36C and discussed above but include components that are formed from CMC materials as indicated in the description of the embodiment in Table 8. In the embodiments below, the other components can be made from non-ceramic matrix composite materials, such as a metal alloys, including but not limited to titanium, nickel, and/or cobalt based superalloys (e.g., those available under the name Inconel® available from Special Metals Corporation).

TABLE 8

| Embodiment | Description |
|---|---|
| 87 | Combustor with CMC inner combustion |
| | chamber liner and CMC outer combustion |
| | chamber liner |
| 88 | HPT with the stage 1 nozzle having a CMC |
| | stator vanes |
| 89 | HPT with the stage 1 nozzle having CMC stator |
| | vanes and the stage 2 nozzle having CMC stator |
| | vanes |
| 90 | HPT with the stage 1 nozzle having a CMC |
| | shroud |
| 91 | HPT with the stage 1 nozzle having a CMC |
| | shroud and the stage 2 nozzle having a CMC |
| | shroud |
| 92 | HPT with the stage 1 nozzle having a CMC |
| | shroud and CMC stator vanes and with the stage |
| | 1 turbine having CMC rotor blades |
| 93 | LPT with the stage 1 nozzle having a CMC |
| | stator vanes |
| 94 | HPT with the stage 1 nozzle having CMC stator |
| | vanes and the stage 2 nozzle having CMC stator |
| | vanes |
| 95 | LPT with the stage 1 nozzle having a CMC |
| | shroud |
| 96 | LPT with the stage 1 nozzle having a CMC |
| | shroud and the stage 2 nozzle having a CMC |
| | shroud |
| 97 | LPT with the stage 1 nozzle having a CMC |
| | shroud and CMC stator vanes and with the stage |
| | 1 turbine having CMC rotor blades |
| 98 | HPT with stage 1 turbine blades having CMC |
| | shroud |
| 99 | HPT with the stage 1 turbine blades having |
| | CMC shroud and the stage 2 turbine blades |
| | having CMC shroud |
| 100 | LPT with stage 1 turbine blades having CMC |
| | shroud |
| 101 | LPT with the stage 1 turbine blades having |
| | CMC shroud and the stage 2 turbine blades |
| | having CMC shroud |

As mentioned above, during normal operation of an engine, the shaft can become critical or supercritical due to conditions in which the shaft operates at speeds greater than the maximum operating speed and less than the redline speed (e.g., 5% to 10% less than the redline speed) and the bearing damper assembly 2100 (FIG. 35) loses oil or the oil becomes too hot (e.g., the oil temperature is greater than the operating temperature range). In such instances, the shaft mode, and, thus, the margin to redline and the MSR for a particular shaft configuration changes as compared to the shaft mode and the MSR during normal conditions for that particular shaft configuration. Table 9 lists embodiments in which the shaft may become critical or supercritical and the shaft mode is within 5% to 10% of the redline speed.

TABLE 9

| | | | | | | Redline | |
|---|---|---|---|---|---|---|---|
| | | | | | L_{MSR}/ | OD | |
| | Bearing | E/rho | T_{eff} | Mode | D_{MSR} | Speed | MSR |
| Embodiment | Layout | in⁻¹ | in | RPM | in/in | ft/sec | (ft/sec)^{1/2} |
| 102 | 2-bearing | 1.00E+8 | 0.29 | 6619 | 25 | 87 | 231 |
| | outbound | | | | | | |
| 103 | 2-bearing | 1.27E+8 | 0.31 | 11065 | 16 | 176 | 207 |
| | outbound | | | | | | |
| 104 | 2-bearing | 1.27E+8 | 0.47 | 4852 | 28 | 64 | 224 |
| | outbound | | | | | | |
| 105 | 4-bearing | 1.27E+8 | 0.23 | 6380 | 35 | 70 | 289 |
| | straddle | | | | | | |
| 106 | inbound | 1.27E+8 | 0.25 | 10666 | 22 | 169 | 284 |
| | OTM | | | | | | |
| 107 | inbound | 1.27E+8 | 0.38 | 4586 | 33 | 61 | 257 |
| | OTM | | | | | | |
| 108 | 2-bearing | 1.00E+8 | 0.29 | 7083 | 25 | 93 | 238 |
| | outbound | | | | | | |
| 109 | 2-bearing | 1.27E+8 | 0.31 | 11839 | 16 | 188 | 214 |
| | outbound | | | | | | |
| 110 | 2-bearing | 1.27E+8 | 0.47 | 5191 | 28 | 69 | 232 |
| | outbound | | | | | | |
| 111 | 4-bearing | 1.27E+8 | 0.23 | 6827 | 35 | 75 | 299 |
| | straddle | | | | | | |
| 112 | inbound | 1.27E+8 | 0.25 | 11412 | 22 | 181 | 294 |
| | OTM | | | | | | |
| 113 | inbound | 1.27E+8 | 0.38 | 4907 | 33 | 65 | 266 |
| | OTM | | | | | | |
| 114 | 2-bearing | 1.00E+8 | 0.29 | 6255 | 25 | 83 | 224 |
| | outbound | | | | | | |
| 115 | 2-bearing | 1.27E+8 | 0.31 | 10456 | 16 | 166 | 201 |
| | outbound | | | | | | |
| 116 | 2-bearing | 1.27E+8 | 0.47 | 4585 | 28 | 61 | 218 |
| | outbound | | | | | | |
| 117 | 4-bearing | 1.27E+8 | 0.23 | 6029 | 35 | 66 | 281 |
| | straddle | | | | | | |
| 118 | inbound | 1.27E+8 | 0.25 | 10079 | 22 | 160 | 276 |
| | OTM | | | | | | |
| 119 | inbound | 1.27E+8 | 0.38 | 4334 | 33 | 58 | 250 |
| | OTM | | | | | | |

Embodiments 102 to 107 show embodiments in which the oil to the bearing dampers has an oil temperature within the operating temperature range (e.g., within 180° F. to 220° F.).

Embodiments 108 to 113 correspond to embodiments 102 to 107, respectively, and show embodiments in which the oil to the bearing dampers is cold, particularly, in which the oil temperature is between ninety degrees Fahrenheit) (90° and one hundred fifty degrees Fahrenheit (150° F.). The oil can fall into this range, for example, at locations with low ambient temperatures (e.g., less than 32° F.) such that the oil temperature does not increase into the operating temperature range during high power (e.g., takeoff) conditions. In particular, such a condition can occur if there is an insufficient amount of time between the turbine engine powering on and takeoff such that the oil does not warm up into the operating temperature range prior to takeoff. As shown in Table 8, the shaft mode and the MSR increase for embodiments 108 to 113 as compared to the shaft mode and the MSR of the respective embodiments 102 to 107. Thus, the cold oil increases the shaft mode and the MSR, while MSR remains within the acceptable range of two hundred (ft/sec)^{1/2} to three hundred (ft/sec)^{1/2}.

Embodiments 114 to 119 correspond to embodiments 102 to 1027, respectively, and show embodiments in which the oil to the bearing dampers is hot, particularly, in which the oil temperature is greater than three hundred degrees Fahrenheit) (300°. The oil can increase greater than the operating temperature range (e.g., greater than 300° F.), for example, at locations with relatively high ambient temperatures. In particular, such a condition can occur if there is insufficient cooling for the oil (e.g., an insufficient amount of oil, an insufficient amount of fuel, or an insufficient amount of air is routed through the heat exchanger to cool the oil to the operating temperature range). As shown in Table 9, the shaft mode and the MSR decrease for embodiments 114 to 119 as compared to the shaft mode and the MSR of the respective embodiments 102 to 107. Thus, the hot oil decreases the shaft mode and the MSR, while MSR remains within the acceptable range of two hundred (ft/sec)^{1/2} to three hundred (ft/sec)^{1/2}.

Accordingly, the ranges disclosed herein for the MSR relationship accounts for such instances when the shaft becomes critical or supercritical during operation of the engine by placing the shaft mode in a range of 5% to 10% less than the redline speed of the shaft.

Table 10 lists embodiments showing the effects of particular ratios of the length L_{FAN BRG} to the length L_{MSR} and the ratio of the length L_{AFT BRG} to the length L_{MSR} (FIGS. 22, 23, and 25).

TABLE 10

| | | | | | Redline | | L_{FAN} | L_{AFT} |
|---|---|---|---|---|---|---|---|---|
| | | | | L_{MSR}/ | OD | | B_{RG}/ | B_{RG}/ |
| | LMSR | DMSR | Mode | D_{MSR} | Speed | MSR | L_{MSR} | L_{MSR} |
| Embodiment | in | in | RPM | in/in | ft/sec | (ft/sec)^{1/2} | in/in | in/in |
| 120 | 74.6 | 3.03 | 6619 | 25 | 87 | 231 | 0.15 | 0 |
| 121 | 56.8 | 3.64 | 11065 | 16 | 176 | 207 | 0.2 | 0 |
| 122 | 84.9 | 3.04 | 4852 | 28 | 64 | 224 | 0.25 | 0 |
| 123 | 75.9 | 3.03 | 6380 | 25 | 84 | 230 | 0.35 | 0.1 |
| 124 | 62.2 | 3.03 | 10380 | 21 | 137 | 241 | 0.4 | 0.1 |
| 125 | 87.0 | 2.52 | 4586 | 35 | 50 | 245 | 0.5 | 0.2 |
| 126 | 75.9 | 3.03 | 6780 | 25 | 89 | 237 | 0.35 | 0.2 |
| 127 | 62.2 | 3.03 | 10840 | 21 | 143 | 246 | 0.4 | 0.2 |
| 128 | 87.0 | 2.52 | 5293 | 35 | 58 | 263 | 0.5 | 0.3 |

In Table 10, embodiments 120 to 128 correspond to a direct drive engine (e.g., no power gearbox). In particular, embodiments 120 to 122 correspond to embodiments 24 to 26 in Table 6. In embodiments 120 to 122, the engine is a three bearing configuration that includes a fan bearing (e.g., the fifth bearing 1210 in FIG. 22), a forward LP shaft bearing (e.g., the first bearing 1202 in FIG. 22), and an aft LP shaft bearing (e.g., the fourth bearing 1208 in FIG. 22). In this way, there is no aft bearing (e.g., the fifth bearing 1310 in FIG. 23) aft of the aft LP shaft bearing such that L_{AFT BRG}/L_{MSR} is zero. In embodiments 120 to 122, L_{FAN BRG}/L_{MSR} is in a range of 0.15 to 0.30 and L_{MSR}/D_{MSR} in a range of fifteen (15) to twenty-eight (28).

Embodiments 123 to 125 correspond to embodiments 120 to 122, but include a gearbox assembly (e.g., the gearbox assembly 155) and an aft bearing (e.g., the fifth bearing 1310 in FIG. 23) in addition to the fan bearing. In embodiments 123 to 125, L_{MSR}/D_{MSR} is in a range of fifteen (15) to thirty-five (35) such that the LP shaft is more slender than the LP shaft of embodiments 120 to 122. Further, in embodiments 123 to 125, L_{FAN BRG}/L_{MSR} is in a range of 0.35 to 0.50. In this way, the section of the LP shaft from the fan bearing to the forward LP shaft bearing has little effect on the shaft mode. L_{AFT BRG}/L_{MSR} is in a range of 0.10 to 0.20.

Embodiments 126 to 128 also correspond to embodiments 120 to 122, and include a gearbox assembly (e.g., the gearbox assembly 155) and an aft bearing (e.g., the fifth bearing 1310 in FIG. 23) in addition to the fan bearing. In embodiments 126 to 128, L_{MSR}/D_{MSR} is in a range of fifteen (15) to thirty-five (35) such that the LP shaft is more slender than the LP shaft of embodiments 120 to 122. Further, in embodiments 126 to 128, L_{FAN BRG}/L_{MSR} is in a range of 0.35 to 0.50. In this way, the section of the LP shaft from the fan bearing to the forward LP shaft bearing has little effect on the shaft mode. L_{AFT BRG}/L_{MSR} is in a range of 0.20 to 0.30.

As shown in Table 10, increasing L_{AFT BRG} increases the shaft mode, and, thus, increases the MSR (e.g., in embodiments 123 to 125 and 126 to 128), as compared to embodiments (e.g., embodiments 120 to 122) without a gearbox assembly (e.g., such that the fan bearing is closer to the forward LP shaft bearing) and without an aft bearing.

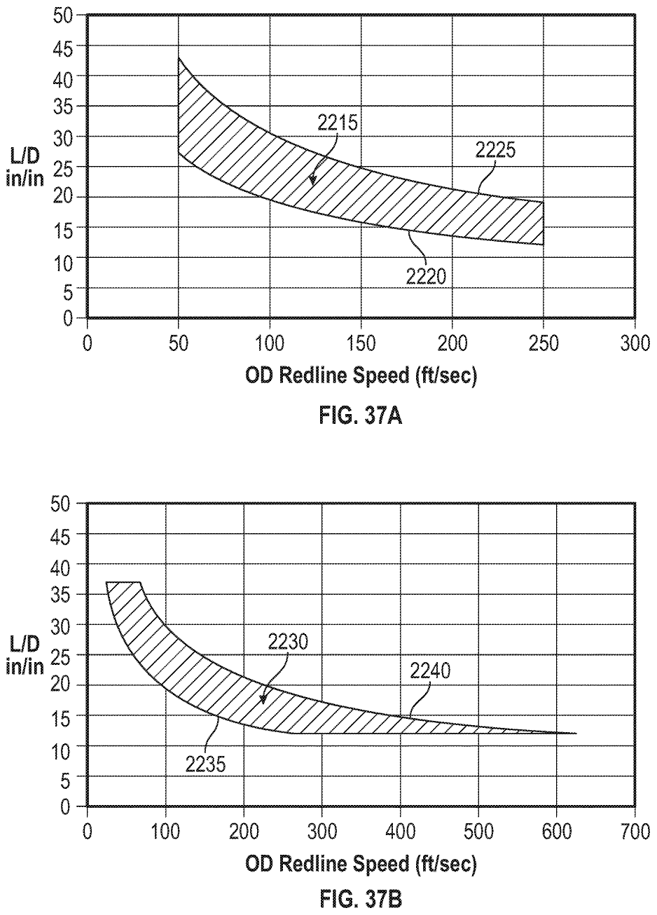

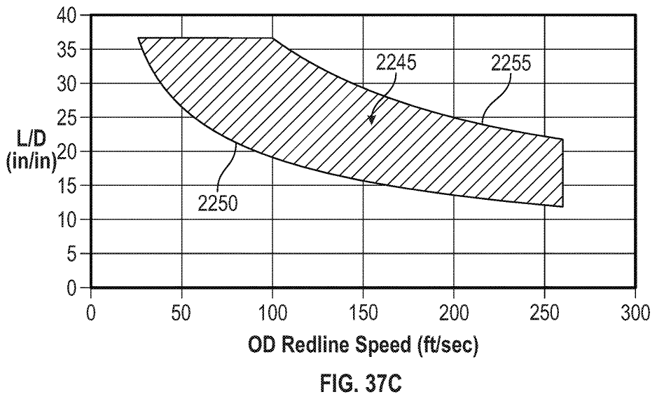

FIG. 37A illustrates acceptable ranges for LP shaft redline speeds for a MSR region 2215, ranging from 200 (ft/sec)⁻¹ (curve 2220) to 300 (ft/sec)⁻¹ (curve 2225), for redline speeds from fifty to two hundred and fifty feet per second and shafts having an L_{MSR}/D_{MSR} from twelve to forty-three.

FIG. 37B illustrates acceptable ranges for LP shaft redline speeds for a MSR region 2230, ranging from 200 (ft/sec)⁻¹ (curve 2235) to 300 (ft/sec)⁻¹ (curve 2240), for L_{MSR}/D_{MSR} ratios from twelve to thirty-seven and redline speeds from thirty to six hundred thirty feet per second.

FIG. 37C illustrates acceptable ranges for LP shaft redline speeds for a MSR region 2245, ranging from one hundred ninety (ft/sec)⁻¹ (curve 2250) to three hundred thirty (ft/sec)⁻¹ (curve 2255), for L_{MSR}/D_{MSR} between twelve and thirty-seven. Examples are provided in TABLE 6 and FIGS. 36A to 36I. FIG. 37C shows an MSR ranging from one hundred ninety (ft/sec)⁻¹ (curve 2250) to three hundred thirty (ft/sec)⁻¹ (curve 2255), for L_{MSR}/D_{MSR} ratios from twelve to thirty-seven and redline speeds from fifty to two hundred and sixty feet per second.

In view of the foregoing objectives, in at least certain embodiments, a propulsion system is configured to define an MSR greater than one hundred ninety (ft/sec)^{1/2}, such as greater than two hundred (ft/sec)^{1/2}, such as at least two hundred thirty-five (ft/sec)^{1/2}, up to at least three hundred thirty (ft/sec)^{1/2}.

In view of the foregoing objectives, in at least certain embodiments, a propulsion system is configured to define an L_{MSR}/D_{MSR} ratio greater than twelve, such as greater than sixteen, such as at least twenty-six, up to at least thirty-seven.

In view of the foregoing objectives, in at least certain embodiments, a propulsion system is configured to define an OD redline speed greater than sixty ft/sec, such as greater than seventy-five ft/sec, such as at least one hundred and fifty ft/sec, up to at least two hundred and sixty ft/sec.

Based on the teachings in this disclosure, and without limiting the disclosure to only those embodiments explicitly shown, it will be understood how both the manner and the degree to which a modification of shaft length, diameter, material composition, bearings configuration, and thickness profile affects the MSR, and, additionally, the competing requirements, or requirements for a turbomachine architecture (e.g., available spacing/packaging, clearance, sump location, lubrication, etc.) for a given MSR.

Referring to Table 11, embodiments 129 to 134 may represent any of the turbine engines detailed herein. In Table 11, the MEFR values were determined on relationship (28) described above and using units of inches for the lengths and thicknesses, inches to the fourth power for the area moment of inertia, and pounds per square inch (psi) for the modulus of elasticity.

TABLE 11

| | I_{B} | T_{D} | T_{E} | T_{B} | L_{B} | L_{Total} | E | MEFR |
|---|---|---|---|---|---|---|---|---|
| Emb. | (in⁴) | (in) | (in) | (in) | (in) | (in) | (psi) | (lbf-in²) |
| 129 | 2.91 | 0.48 | 0.90 | 0.23 | 37.20 | 92.74 | 2.9E+07 | 121.42 |
| 130 | 6.00 | 0.83 | 1.17 | 0.83 | 44.70 | 111.30 | 3.1E+07 | 104.09 |
| 131 | 3.49 | 0.83 | 0.90 | 0.53 | 37.20 | 92.74 | 1.5E+07 | 39.64 |
| 132 | 2.33 | 0.48 | 1.17 | 0.16 | 44.70 | 111.30 | 3.6E+07 | 210.47 |
| 133 | 2.91 | 0.58 | 1.08 | 0.28 | 44.64 | 111.29 | 3.1E+07 | 127.70 |
| 134 | 4.46 | 0.38 | 0.72 | 0.18 | 29.76 | 74.19 | 2.9E+07 | 185.89 |
| 135 | 2.91 | 0.48 | 0.90 | 0.23 | 37.20 | 92.74 | 3.0E+07 | 124.35 |
| 136 | 5.44 | 0.61 | 0.90 | 0.61 | 40.00 | 95.00 | 2.9E+07 | 97.25 |
| 137 | 3.49 | 0.83 | 0.90 | 0.42 | 37.20 | 92.74 | 3.1E+07 | 102.21 |
| 138 | 6.00 | 0.83 | 1.17 | 0.83 | 44.70 | 101.20 | 3.6E+07 | 135.12 |
| 139 | 2.91 | 0.48 | 0.90 | 0.23 | 37.20 | 92.74 | 1.5E+07 | 62.80 |
| 140 | 2.91 | 0.23 | 0.90 | 0.23 | 37.2 | 92.74 | 2.9E+07 | 103.02 |
| 141 | 2.91 | 0.37 | 1.50 | 0.23 | 41.00 | 94.00 | 3.0E+07 | 192.04 |
| 142 | 1.53 | 0.34 | 0.97 | 0.15 | 39.3 | 86.00 | 3.0E+07 | 111.94 |
| 143 | 2.00 | 0.36 | 1.37 | 0.17 | 40.03 | 92.50 | 3.0E+07 | 163.51 |
| 144 | 2.25 | 0.37 | 1.46 | 0.19 | 39.79 | 94.00 | 3.0E+07 | 170.53 |

The designs herein provide the aforementioned benefits including achieving an increased natural frequency of the low-pressure shaft. The present disclosure provides ranges that would be suitable to achieve the desired results, while taking into account the operational requirements and the packaging requirements for the low-pressure shaft. The values for terms used to compute the MEFR value are strictly limited to certain ranges based on the various designs evaluated where those values had varied. Otherwise, the engine made will not produce favorable results.

The shaft redline speeds provided herein are in a range of 5,000 RPM to 13,000 RPM. In particular, the shaft redline speeds are in a range of 10,000 RPM to 13,000 RPM for a three-stage low-pressure turbine. The shaft redline speeds are in a range of 9,000 RPM to 10,200 RPM for a four-stage low-pressure turbine.

The MEFR is only valid for an area moment of inertia of the second section 2022 (I_{B}) in a range of 1.5 in⁴ to 6.0 in⁴. Values of Ip that fall within this range provide for a shaft that has a balance between reducing the overall weight of the shaft by having less material and increasing the stiffness and the resistance to bending of the shaft. Values of I_{B} less than 1.5 in⁴ account for the second section 2022 having less material, and therefore, less weight, but a lesser resistance to bending. Values of I_{B} greater than 6.0 in⁴ account for the second section 2022 having a greater stiffness and resistance to bending, but more material and a greater weight.

The MEFR is only valid for a thickness of the fourth section 2026 (T_{D}) in a range of 0.23 in to 0.83 in. Values of T_{D} that fall within this range provide for a fourth section 2026 that reduces overall weight of the shaft and increases stiffness and resistance to bending such that the shaft, in combination with the bearing configuration, acts as a fixed-fixed beam. Values of T_{D} less than 0.23 in reduce material and weight, but also have a lesser stiffness. Value of T_{D} greater than 0.83 have a greater stiffness, but increased material and weight.

The MEFR is only valid for a thickness of the fifth section 2028 (T_{E}) in a range of 0.72 in to 1.17 in. Values of T_{D} that fall within this range provide for a fifth section 2028 that reduces overall weight of the shaft and increases stiffness and resistance to bending such that the shaft, in combination with the bearing configuration, acts as a fixed-fixed beam. Values of T_{E} less than 0.72 in reduce material and weight, but also have a lesser stiffness. Value of T_{E} greater than 1.17 in have a greater stiffness, but increased material and weight.

The MEFR is only valid for a thickness of the second section 2022 (T_{B}) in a range of 0.15 in to 0.83 in. Values of T_{B} that fall within this range provide for a second section 2022 that reduces overall weight of the shaft and increases stiffness and resistance to bending such that the shaft has an increased natural frequency (e.g., the first order bending mode). Values of T_{B} less than 0.15 in reduce material and weight, but also have a lesser stiffness. Value of T_{B} greater than 0.83 have a greater stiffness, but increased material and weight.

The MEFR is only valid for a length of the second section 2022 (L_{B}) in a range of 29.7 in to 44.7 in. Values of L_{B} that fall within this range provide for a balance between increasing the natural frequency, having a shaft length that accommodates the LPT stages, and reduces material and weight. Values of L_{B} less than 29.7 in provide for an increased natural frequency, but require other, thicker sections of the shaft to be longer, and, therefore, increases the overall weight of the shaft. Value of L_{B} greater than 44.7 in have less overall shaft weight but reduced natural frequency.

The MEFR is only valid for a total length of the low-pressure shaft (L_{Total}) in a range of 74.1 in to 111.3 in. Values of L_{Total} that fall within this range provide for a balance between increasing the natural frequency, having a shaft length that accommodates the LPT stages, and reduces material and weight. Values of L_{Total} less than 74.1 in provide for an increased natural frequency, but cannot accommodate the LPT stages. Value of L_{Total} greater than 111.3 in have less overall shaft weight but reduced natural frequency.

The MEFR is only valid for a modulus of elasticity (E) in a range of 1.5E+07 psi to 3.6E+07 psi. The modulus of elasticity (E) is given based on the material of the low-pressure shaft. Materials considered herein include steel, nickel, titanium, cobalt, and metal alloys, as detailed above.

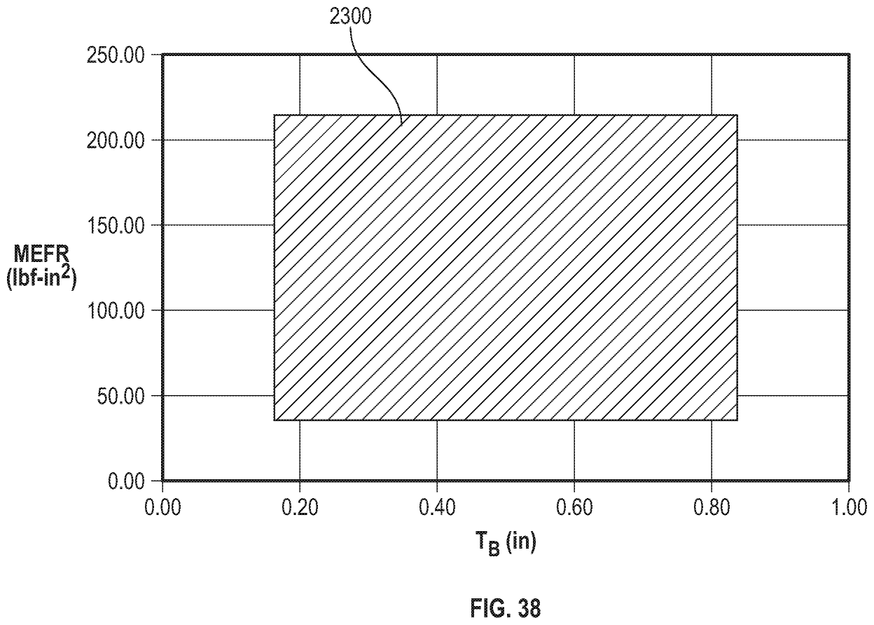

FIG. 38 represents, in graph form, MEFR as a function of T_{B}, according to the present disclosure. An area 2300 represents the boundaries of the MEFR. The MEFR is in a range of 39 lbf-in² to 211 lbf-in² for a second section thickness T_{B} of the second section 2022 in a range of 0.15 in to 0.83 in. The range of the MEFR identifies the specific architectures (section thicknesses and bearing configuration) that avoid exciting the first-order bending mode of the low-pressure shaft, while accounting for higher shaft speeds and fitting the low-pressure shaft within the limited space of smaller core engines. In particular, if the MEFR is within the area 2300, then the low-pressure shaft satisfies the operational requirements (e.g., the low-pressure shaft has a natural frequency that is at least 10% greater than the redline speed) and the packaging requirements (e.g., the low-pressure shaft has a length and a diameter that fit within the limited space of the turbine engine) could be distinguished from architectures that do not satisfy these requirements. As such, low-pressure shafts having a MEFR that falls within the area 2300 account for the operational requirements and the packaging requirements without exciting the first-order bending mode of the low-pressure shaft. If the MEFR is outside of the area 2300, then the low-pressure shaft either will not rotate at the required speed, will not fit within the limited space within the HP shaft without exciting the HP shaft dynamics, or will have a natural frequency that is less than 10% greater than the redline speed such that the first-order bending mode will be excited during operation. Thus, the low-pressure shaft having a MEFR within the area 2300 provides for an improved low-pressure shaft architecture that is capable of rotating at the greater speeds of next generation engines, while accounting for the limited space of such engines and without exciting the first-order bending mode of the low-pressure shaft during operation.

Further aspects are provided by the subject matter of the following clauses:

A gas turbine engine defining a radial direction, the gas turbine engine including: a turbomachine including a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan\_LE} \times {R}_{Hub\_TE}}{{R}_{Fan\_TE} \times {R}_{Hub\_LE}} .$$

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine includes a compressor section having a low-pressure compressor and a high-pressure compressor, wherein the low-pressure compressor is rotatable with the drive turbine.

The gas turbine engine of any preceding clause, further including: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan\_LE} \times {R}_{Hub\_LE}}{{R}_{Fan\_TE} \times {R}_{Hub\_TE}} .$$

A gas turbine engine defining a radial direction, the gas turbine engine including: a turbomachine including a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan\_LE} \times {R}_{Hub\_LE}}{{R}_{Fan\_TE} \times {R}_{Hub\_TE}} .$$

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further including: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan\_LE} \times {R}_{Hub\_TE}}{{R}_{Fan\_TE} \times {R}_{Hub\_LE}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the fan is a ducted fan, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio greater than 2 and less than 4, wherein a thrust rating for the gas turbine engine is between 20,000 pounds and 45,000 pounds, wherein the FLTCF is greater than or equal to 1.12 and less than or equal to 1.35, and wherein the FLTOR is greater than or equal to 1.06 and less than or equal to 1.19.

The gas turbine engine of any preceding clause, wherein the fan is a ducted fan, wherein the leading edge fan radius R_{Fan_LE} is greater than or equal to 51 inches and less than or equal to 66 inches, wherein the fan defines a fan blade count greater than or equal to 17 and less than or equal to 23, wherein a thrust rating for the gas turbine engine is between 60,000 pounds and 118,000 pounds, wherein the FLTCF is greater than or equal to 1.27 and less than or equal to 1.5, and wherein the FLTOR is greater than or equal to 1.18 and less than or equal to 1.5.

The gas turbine engine of any preceding clause, wherein the fan is a ducted fan, wherein the leading edge fan radius R_{Fan_LE} is greater than or equal to 55 inches and less than or equal to 70 inches, wherein the fan defines a fan blade count greater than or equal to 12 and less than or equal to 22, wherein a thrust rating for the gas turbine engine is between 100,000 pounds and 150,000 pounds, wherein the FLTCF is greater than or equal to 1.46 and less than or equal to 1.65, and wherein the FLTOR is greater than or equal to 1.2 and less than or equal to 1.5.

A gas turbine engine including a turbomachine including a compressor section, a combustion section, and a turbine section arranged in serial flow order, the compressor section having a high-pressure compressor defining a high-pressure compressor exit area (A_{HPCExit}) in square inches, wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}×EGT/(A_{HPCExit}²×1000).

The gas turbine engine of the preceding clause, wherein the corrected specific thrust is from 42 to 90, such as from 45 to 80, such as from 50 to 80.

The gas turbine engine of any preceding clause, wherein the EGT is greater than 1000 degrees Celsius and less than 1300 degrees Celsius.

The gas turbine engine of any preceding clause, wherein the EGT is greater than 1100 degree Celsius and less than 1250 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, wherein the turbine section includes a high-pressure turbine having a first stage of high-pressure turbine rotor blades, and wherein the gas turbine engine further includes: a cooled cooling air system in fluid communication with the first stage of high-pressure turbine rotor blades.

The gas turbine engine of one or more of the preceding clause, wherein the cooled cooling air system is further in fluid communication with the high-pressure compressor for receiving an airflow from the high-pressure compressor, and wherein the cooled cooling air system further includes a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, wherein when the gas turbine engine is operated at a takeoff power level, the cooled cooling air system is configured to receive between 2.5% and 35% of an airflow through a working gas flowpath of the turbomachine at an inlet to a compressor of the compressor section.

The gas turbine engine of any preceding clause, further including a primary fan driven by the turbomachine.

The gas turbine engine of any preceding clause, further including an inlet duct downstream of the primary fan and upstream of the compressor section of the turbomachine; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

The gas turbine engine of any preceding clause, wherein the cooled cooling air systems includes a thermal bus cooled cooling air system (see, e.g., FIGS. 8 and 9).

The gas turbine engine of any preceding clause, wherein the cooled cooling air systems includes a dedicated heat exchanger cooled cooling air system (i.e., a cooled cooling air system including a heat exchanger dedicated to the cooled cooling air system).

The gas turbine engine of any preceding clause, wherein the cooled cooling air systems includes a bypass heat exchanger cooled cooling air system having a heat sink heat exchanger thermally coupled to an airflow through a bypass passage (see, e.g., FIG. 13).

The gas turbine engine of any preceding clause, wherein the cooled cooling air systems includes an air-to-air cooled cooling air system (a cooled cooling air system having a heat sink heat exchanger configured to transfer heat to an airflow. See, e.g., FIG. 13).

The gas turbine engine of any preceding clause, wherein the cooled cooling air systems includes an oil-to-air cooled cooling air system (a cooled cooling air system having a heat sink heat exchanger configured to transfer heat to an oil flow).

The gas turbine engine of any preceding clause, wherein the cooled cooling air systems includes a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc. See, e.g., FIG. 8). or a combination thereof. In one or more of the exemplary cooled cooling air systems described herein, the

The gas turbine engine of any preceding clause, wherein the cooled cooling air systems is configured to receive the cooling air from a downstream end of a high-pressure compressor.

The gas turbine engine of any preceding clause, wherein the cooled cooling air systems is configured to receive the cooling air from an upstream end of the high-pressure compressor.

The gas turbine engine of any preceding clause, wherein the cooled cooling air systems is configured to receive the cooling air from a downstream end of a low-pressure compressor.

The gas turbine engine of any preceding clause, wherein the cooled cooling air systems is configured to receive the cooling air from an upstream end of the low-pressure compressor.

The gas turbine engine of any preceding clause, wherein the cooled cooling air systems is configured to receive the cooling air from a location between compressors.

The gas turbine engine of any preceding clause, wherein the cooled cooling air systems is configured to receive the cooling air from a bypass passage.

A method of operating a gas turbine engine, including: operating the gas turbine engine at a takeoff power level, the gas turbine engine having a turbomachine with a high-pressure compressor defining a high-pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; wherein the corrected specific thrust is greater than or equal to 42 and less than or equal to 90, the corrected specific determined as follows: Fn_{Total}×EGT/(A_{HPCExit}²×1000).

The method of the preceding clause, wherein the EGT defined by the gas turbine engine is greater than 1000 degree Celsius and less than 1300 degrees Celsius.

The method of any preceding clause, wherein the EGT defined by the gas turbine engine is greater than 1100 degree Celsius and less than 1300 degrees Celsius.

The method of any preceding clause, wherein the EGT defined by the gas turbine engine is greater than 1000 degree Celsius and less than 1300 degrees Celsius, and wherein the corrected specific thrust defined by the gas turbine engine is greater than or equal to 45.

The method of any preceding clause, wherein operating the gas turbine engine at the takeoff power level further includes reducing a temperature of a cooling airflow provided to a high-pressure turbine of the gas turbine engine with a cooled cooling air system.

The method of any preceding clause, wherein reducing the temperature of the cooling airflow provided to the high-pressure turbine of the gas turbine engine with the cooled cooling air system includes providing a temperature reduction of the cooling airflow equal to at least 15% of the EGT and up to 45% of the EGT.

A gas turbine engine includes a core engine having one or more compressor sections, one or more turbine sections that includes a power turbine, and a combustion chamber in flow communication with the compressor sections and turbine sections.

The gas turbine engine also includes a shaft that is coupled to the power turbine and that is characterized by a midshaft rating (MSR) between two hundred (ft/sec)^{1/2} and three hundred (ft/sec)^{1/2}, and a redline speed between fifty and two hundred fifty feet per second (ft/sec).

A gas turbine engine includes a core engine having one or more compressor sections, one or more turbine sections that includes a power turbine, and a combustion chamber in flow communication with the compressor sections and turbine sections. The gas turbine engine also includes a shaft that is coupled to the power turbine and that is characterized by a midshaft rating (MSR) between two hundred (ft/sec)^{1/2} and three hundred (ft/sec)^{1/2}, a length L_{MSR}, an outer diameter D_{MSR}, and a ratio of L_{MSR}/D_{MSR} between twelve and thirty-seven.

The gas turbine engine of any preceding clause, wherein the gas turbine engine is configured to operate up to a redline speed without passing through a critical speed associated with a first order bending mode of the shaft.

The gas turbine engine of any preceding clause, wherein the gas turbine engine is configured to operate up to the redline speed without passing through a critical speed associated with a first order bending mode of the shaft.

The gas turbine engine of any preceding clause, wherein the MSR is between one hundred ninety (ft/sec)^{1/2} and two hundred forty-five (ft/sec)^{1/2}.

The gas turbine engine of any preceding clause, wherein the MSR is between two hundred twelve (ft/sec)^{1/2} and two hundred sixty (ft/sec)^{1/2}.

The gas turbine engine of any preceding clause, wherein the MSR is between two hundred forty-seven (ft/sec)^{1/2} and two hundred ninety (ft/sec)^{1/2}.

The gas turbine engine of any preceding clause, wherein the redline speed is between sixty and ninety ft/sec.

The gas turbine engine of any preceding clause, wherein the redline speed is between seventy-five and one hundred seventy-five ft/sec.

The gas turbine engine of any preceding clause, wherein the redline speed is between one hundred fifty and two hundred fifty ft/sec.

The gas turbine engine of any preceding clause, wherein the ratio of L_{MSR}/D_{MSR} is between twelve and twenty.

The gas turbine engine of any preceding clause, wherein the ratio of L_{MSR}/D_{MSR} is between sixteen and thirty.

The gas turbine engine of any preceding clause, wherein the ratio of L_{MSR}/D_{MSR} is between twenty-six and thirty-seven.

The gas turbine engine of any preceding clause, wherein the shaft is a composite shaft made of at least two different materials.

The gas turbine engine of any preceding clause, wherein the shaft has a length L_{MSR} and a reduced mass density at a midpoint along the length L_{MSR}.

The gas turbine engine of any preceding clause, wherein the shaft has a reduced mass density at a midpoint along the length L_{MSR}.

The gas turbine engine of any preceding clause, wherein the shaft is a hollow convex shaft with a reduced wall thickness at the midpoint, a variable inner diameter, and a constant outer diameter.

The gas turbine engine of any preceding clause, wherein the shaft is a hollow convex shaft with a reduced wall thickness at the midpoint, a constant inner diameter, and a variable outer diameter.

The gas turbine engine of any preceding clause, wherein the shaft is coupled to the power turbine at a first mounting point, and wherein the shaft is also coupled to one of the compressor sections at a second mounting point.

The gas turbine engine of any preceding clause, wherein the shaft is supported by at least a first bearing and a second bearing.

The gas turbine engine of any preceding clause, wherein the shaft has a length L that is measured as the distance between the first bearing and the second bearing.

The gas turbine engine of any preceding clause, wherein the length L is measured as the distance between the first bearing and the second bearing.

The gas turbine engine of any preceding clause, wherein at least one bearing is a duplex bearing that has an overturning moment capability.

The gas turbine engine of any preceding clause, wherein each bearing is one of a ball bearing and a roller bearing.

The gas turbine engine of any preceding clause, wherein the first bearing is positioned between the first mounting point and the second mounting point, and wherein the second mounting point is positioned between the first bearing and the second bearing.

The gas turbine engine of any preceding clause, wherein the first bearing and the second bearing support the shaft in an inbound configuration in which the first bearing and the second bearing are positioned between the first mounting point and the second mounting point.

The gas turbine engine of any preceding clause, wherein the first bearing and the second bearing support the shaft in an outbound configuration in which the first mounting point and the second mounting point are positioned between the first bearing and the second bearing.

The gas turbine engine of any preceding clause, wherein the shaft is further supported by a third bearing and a fourth bearing.

The gas turbine engine of any preceding clause, wherein the first bearing and the second bearing are a first pair of duplex bearings, and the third bearing and the fourth bearing are a second pair of duplex bearings, wherein the first pair of duplex bearings and the second pair of duplex bearings support the shaft in an inbound overturning moment configuration in which the first pair of duplex bearings and the second pair of duplex bearings are positioned between the first mounting point and the second mounting point.

The gas turbine engine of any preceding clause, wherein the first bearing and the second bearing are a first pair of duplex bearings, and the third bearing and the fourth bearing are a second pair of duplex bearings, wherein the first pair of duplex bearings and the second pair of duplex bearings support the shaft in an outbound overturning moment configuration in which the first mounting point and the second mounting point are positioned between the first pair of duplex bearings and the second pair of duplex bearings.

The gas turbine engine of any preceding clause, wherein the first bearing, the second bearing, the third bearing, and the fourth bearing support the shaft in a four-bearing straddle configuration in which the first bearing and the second bearing are positioned between the first mounting point and the second mounting point, and the first mounting point and the second mounting point are positioned between the third bearing and the fourth bearing.

The gas turbine engine of any preceding clause, wherein the first bearing, the second bearing, the third bearing, and the fourth bearing support the shaft in a four-bearing outbound configuration in which the first mounting point and the second mounting point are positioned between a first group of bearings including the first bearing and the second bearing, and a second group of bearings including the third bearing and the fourth bearing.

In another aspect, a method includes using a gas turbine engine with a core having one or more compressor sections, one or more turbine sections that includes a power turbine, and a combustion chamber in flow communication with the compressor sections and turbine sections. The method also includes driving a shaft that is coupled to the power turbine and that is characterized by a midshaft rating (MSR) between two hundred (ft/sec)^{1/2} and three hundred (ft/sec)^{1/2}, and a redline speed between fifty and two hundred fifty feet per second (ft/sec).

In another aspect, a method includes using a gas turbine engine with a core having one or more compressor sections, one or more turbine sections that includes a power turbine, and a combustion chamber in flow communication with the compressor sections and turbine sections. The method also includes driving a shaft that is coupled to the power turbine and that is characterized by a midshaft rating (MSR) between two hundred (ft/sec)^{1/2} and three hundred (ft/sec)^{1/2}, a length L_{MSR}, an outer diameter D_{MSR}, and a ratio of L_{MSR}/D_{MSR} between twelve and thirty-seven.

The method of any preceding clause, wherein the gas turbine engine is configured to operate up to a redline speed without passing through a critical speed associated with a first order bending mode of the shaft.

The method of any preceding clause, wherein the gas turbine engine is configured to operate up to the redline speed without passing through a critical speed associated with a first order bending mode of the shaft.

The method of any preceding clause, wherein the MSR is between one hundred ninety (ft/sec)^{1/2} and two hundred forty-five (ft/sec)^{1/2}.

The method of any preceding clause, wherein the MSR is between two hundred twelve (ft/sec)^{1/2} and two hundred sixty (ft/sec)^{1/2}.

The method of any preceding clause, wherein the MSR is between two hundred forty-seven (ft/sec)^{1/2} and two hundred ninety (ft/sec)^{1/2}.

The method of any preceding clause, wherein the redline speed is between sixty and ninety ft/sec.

The method of any preceding clause, wherein the redline speed is between seventy-five and one hundred seventy-five ft/sec.

The method of any preceding clause, wherein the redline speed is between one hundred fifty and two hundred fifty ft/sec.

The method of any preceding clause, wherein the ratio of L_{MSR}/D_{MSR} is between twelve and twenty.

The method of any preceding clause, wherein the ratio of L_{MSR}/D_{MSR} is between sixteen and thirty.

The method of any preceding clause, wherein the ratio of L_{MSR}/D_{MSR} is between twenty-six and thirty-seven.

The method of any preceding clause, wherein the shaft is a composite shaft made of at least two different materials.

The method of any preceding clause, wherein the shaft has a length L_{MSR} and a reduced mass density at a midpoint along the length L_{MSR}.

The method of any preceding clause, wherein the shaft has a reduced mass density at a midpoint along the length L.

The method of any preceding clause, wherein the shaft is a hollow convex shaft with a reduced wall thickness at the midpoint, a variable inner diameter, and a constant outer diameter.

The method of any preceding clause, wherein the shaft is a hollow convex shaft with a reduced wall thickness at the midpoint, a constant inner diameter, and a variable outer diameter.

The method of any preceding clause, wherein the shaft is coupled to the power turbine at a first mounting point, and wherein the shaft is also coupled to one of the compressor sections at a second mounting point.

The method of any preceding clause, wherein the shaft is supported by at least a first bearing and a second bearing.

The method of any preceding clause, wherein the shaft has a length L_{MSR} that is measured as the distance between the first bearing and the second bearing.

The method of any preceding clause, wherein the length L_{MSR} is measured as the distance between the first bearing and the second bearing.

The method of any preceding clause, wherein at least one bearing is a duplex bearing that has an overturning moment capability.

The method of any preceding clause, wherein each bearing is one of a ball bearing and a roller bearing.

The method of any preceding clause, wherein the first bearing is positioned between the first mounting point and the second mounting point, and wherein the second mounting point is positioned between the first bearing and the second bearing.

The method of any preceding clause, wherein the first bearing and the second bearing support the shaft in an inbound configuration in which the first bearing and the second bearing are positioned between the first mounting point and the second mounting point.

The method of any preceding clause, wherein the first bearing and the second bearing support the shaft in an outbound configuration in which the first mounting point and the second mounting point are positioned between the first bearing and the second bearing.

The method of any preceding clause, wherein the shaft is further supported by a third bearing and a fourth bearing.

The method of any preceding clause, wherein the first bearing and the second bearing are a first pair of duplex bearings, and the third bearing and the fourth bearing are a second pair of duplex bearings, wherein the first pair of duplex bearings and the second pair of duplex bearings support the shaft in an inbound overturning moment configuration in which the first pair of duplex bearings and the second pair of duplex bearings are positioned between the first mounting point and the second mounting point.

The method of any preceding clause, wherein the first bearing and the second bearing are a first pair of duplex bearings, and the third bearing and the fourth bearing are a second pair of duplex bearings, wherein the first pair of duplex bearings and the second pair of duplex bearings support the shaft in an outbound overturning moment configuration in which the first mounting point and the second mounting point are positioned between the first pair of duplex bearings and the second pair of duplex bearings.

The method of any preceding clause, wherein the first bearing, the second bearing, the third bearing, and the fourth bearing support the shaft in a four-bearing straddle configuration in which the first bearing and the second bearing are positioned between the first mounting point and the second mounting point, and the first mounting point and the second mounting point are positioned between the third bearing and the fourth bearing.

The method of any preceding clause, wherein the first bearing, the second bearing, the third bearing, and the fourth bearing support the shaft in a four-bearing outbound configuration in which the first mounting point and the second mounting point are positioned between a first group of bearings including the first bearing and the second bearing, and a second group of bearings including the third bearing and the fourth bearing.

A gas turbine engine including a high-pressure compressor, a high-pressure turbine, a combustion chamber in flow communication with the high-pressure compressor and the high-pressure turbine. The gas turbine engine including a power turbine in flow communication with the high-pressure turbine, wherein at least one of the high-pressure compressor, the high-pressure turbine, or the power turbine includes a ceramic matrix composite (CMC) material. The gas turbine engine includes a low-pressure shaft coupled to the power turbine and characterized by a midshaft rating (MSR) between two hundred (ft/sec)^{1/2} and three hundred (ft/sec)^{1/2}. The low-pressure shaft has a redline speed between fifty and two hundred fifty feet per second (ft/sec). The gas turbine engine is configured to operate up to the redline speed without passing through a critical speed associated with a first order bending mode of the low-pressure shaft.

A gas turbine engine includes a high-pressure compressor, a high-pressure turbine, a combustion chamber in flow communication with the high-pressure compressor and the high-pressure turbine, a power turbine in flow communication with the high-pressure turbine, wherein at least one of the high-pressure compressor, the high-pressure turbine, and the power turbine including a ceramic matrix composite (CMC) material. The gas turbine engine includes a low-pressure shaft coupled to the power turbine. The low-pressure shaft configured to operate at a linear speed that does not exceed three hundred feet per second.

The gas turbine engine of any preceding clause, wherein the power turbine includes the CMC material.

The gas turbine engine of any preceding clause, wherein the power turbine includes at least one nozzle and at least one airfoil, wherein the at least one nozzle, the at least one airfoil, or both the at least one nozzle and the at least one airfoil include the CMC material.

The gas turbine engine of any preceding clause, wherein the power turbine has three stages, four stages, five stages, or six stages, and wherein at least one stage includes the CMC material.

The gas turbine engine of any preceding clause, wherein the power turbine has four stages and at least one stage of the four stages includes the CMC material.

The gas turbine engine of any preceding clause, wherein the CMC material is a first CMC material, and wherein the high-pressure turbine includes the first CMC material or a second CMC material.

The gas turbine engine of any preceding clause, wherein the high-pressure compressor includes the first CMC material or the second CMC material or a third CMC material.

The gas turbine engine of any preceding clause, wherein the high-pressure turbine includes the CMC material.

The gas turbine engine of any preceding clause, wherein the high-pressure turbine includes at least one nozzle and at least one airfoil, wherein the at least one nozzle, the at least one airfoil, or both the at least one nozzle and the at least one airfoil include the CMC material.

The gas turbine engine of any preceding clause, wherein the high-pressure turbine has one stage or two stages, and wherein at least one stage includes the CMC material.

The gas turbine engine of any preceding clause, wherein the CMC material is a first CMC material, and wherein the power turbine includes the first CMC material or a second CMC material.

The gas turbine engine of any preceding clause, wherein the high-pressure compressor includes the first CMC material or the second CMC material or a third CMC material.

The gas turbine engine of any preceding clause, wherein the high-pressure compressor includes the CMC material.

The gas turbine engine of any preceding clause, wherein the high-pressure compressor has eight stages, nine stages, ten stages, or eleven stages, and wherein at least one stage includes the CMC material.

The gas turbine engine of any preceding clause, wherein the high-pressure compressor has nine stages and at least one stage of the nine stages includes the CMC material.

The gas turbine engine of any preceding clause, wherein the CMC material is a first CMC material, and the high-pressure turbine includes the first CMC material or a second CMC material.

The gas turbine engine of any preceding clause, wherein the power turbine includes the first CMC material, the second CMC material, or a third CMC material.

The gas turbine engine of any preceding clause, wherein the first CMC material and the second CMC material are the same materials.

The gas turbine engine of any preceding clause, wherein the first CMC material and the second CMC material are different materials.

The gas turbine engine of any preceding clause, wherein the third CMC material is the same material as the first CMC material, the second CMC material, or both the first CMC material and the second CMC material.

The gas turbine engine of any preceding clause, wherein the third CMC material is a different material than the first CMC material, the second CMC material, or both the first CMC material and the second CMC material.

The gas turbine engine of any preceding clause, further including an engine core including the high-pressure turbine, the high-pressure compressor, and the combustion chamber, wherein the engine core has a core length (L_{CORE}) given by:

$${L}_{CORE} = {[ {m}^{( 20 + m )} \times {n}^{( 10 + n )} ]}^{( \frac{1}{100} )} \times {D}_{CORE} + CIS ,$$

where m is a number of stages of the high-pressure compressor, n is a number of stages of the high-pressure turbine, and CIS is a constant.

The gas turbine engine of any preceding clause, further including a high-pressure shaft coupled between the high-pressure turbine and the high-pressure compressor and an engine core including the high-pressure turbine, the high-pressure compressor, and the combustion chamber, wherein the high-pressure shaft is

$$HSR = {10}^{- 6} \times {N2}_{r / l} \times {D}_{C O R E} \times {( \frac{{L}_{C O R E}}{{D}_{C O R E}} )}^{2} ,$$

where N2_{r/l} is a redline speed of the high-pressure shaft, D_{CORE} is the diameter of an exit stage of the high-pressure compressor, and L_{CORE} is a core length of the engine core.

The gas turbine engine of any preceding clause, wherein the high-pressure shaft is characterized by a second high-pressure shaft rating (HSR_{LP}) given by:

$$H S {R}_{L P} = 1 {0}^{- 6} \times N {1}_{r / l} \times {D}_{CORE} \times {( \frac{{L}_{C O R E}}{{D}_{C O R E}} )}^{2} ,$$

where N1_{r/l} is the redline speed of the low-pressure shaft.

The gas turbine engine of any preceding clause, wherein the high-pressure turbine includes an airfoil configured with a forward surface facing towards a hot gas stream and a rearward surface facing away from the hot gas stream, wherein the forward surface includes a CVI type CMC material and the rearward surface includes an MI type CMC material.

The gas turbine engine of any preceding clause, wherein the high-pressure turbine includes a CVI type CMC material and the power turbine includes a MI type CMC material.

The gas turbine engine of any preceding clause, wherein the CMC material includes a ceramic matrix material.

The gas turbine engine of any preceding clause, wherein the ceramic matrix material includes a non-oxide silicon-based material.

The gas turbine engine of any preceding clause, wherein the non-oxide silicon-based material is selected from the group consisting of silicon carbide, silicon nitride, and mixtures thereof.

The gas turbine engine of any preceding clause, wherein the ceramic matrix material includes an oxide ceramic material.

The gas turbine engine of any preceding clause, wherein the oxide ceramic material is selected from the group consisting of silicon oxycarbides, silicon oxynitrides, aluminum oxide (Al₂O₃), silicon dioxide (SiO₂), aluminosilicates, and mixtures thereof.

The gas turbine engine of any preceding clause, wherein the oxide ceramic material includes oxides of element X, wherein X is selected from the group consisting of silicon (Si), aluminum (Al), zirconium (Zr), yttrium (Y), and combinations thereof.

The gas turbine engine of any preceding clause, wherein the ceramic matrix includes a non-oxide silicon-based material, an oxide ceramic material, or mixtures thereof.

The gas turbine engine of any preceding clause, wherein the CMC material includes a plurality of reinforcing fibers.

The gas turbine engine of any preceding clause, further including a flex coupling that couples the gearbox assembly to the low-speed shaft.

The gas turbine engine of any preceding clause, wherein the flex coupling is characterized by a decoupler moment stiffness in a range of 50 klb×in/rad to 200 klb×in/rad.

The gas turbine engine of any preceding clause, wherein the flex coupling is characterized by a decoupler shear stiffness in a range of 100 klb/in to 500 klb/in.

The gas turbine engine of any preceding clause, the decoupler moment stiffness being equal to

$$\frac{E \times {K}_{m} \times {R}_{d c p l r}^{4}}{{H}_{d c p l r}} ,$$

E being a Young's modulus of a material of the flex coupling, Kₘ being a correction factor, R_{dcplr} being a decoupler radius of the flex coupling, and H_{dcplr} being a decoupler height of the flex coupling.

The gas turbine engine of any preceding clause, Kₘ being in a range of 0.13×10⁻³ to 0.27×10⁻³.

The gas turbine engine of any preceding clause, the decoupler shear stiffness being equal to

$$\frac{E \times {K}_{m} \times {R}_{d c p l r}^{4}}{{L}_{d c p l r}^{2}} ,$$

wherein E being a Young's modulus of a material of the flex coupling, Kₘ being a correction factor, R_{dcplr} being a decoupler radius of the flex coupling, and L_{dcplr} being a decoupler length of the flex coupling.

The gas turbine engine of any preceding clause, Kₘ being in a range of 0.13×10⁻³ to 0.27×10⁻³.

The gas turbine engine of any preceding clause, wherein the MSR is between one hundred ninety (ft/sec)^{1/2} and two hundred forty-five (ft/sec)^{1/2}.

The gas turbine engine of any preceding clause, wherein the MSR is between two hundred twelve (ft/sec)^{1/2} and two hundred sixty (ft/sec)^{1/2}.

The gas turbine engine of any preceding clause, wherein the MSR is between two hundred forty-seven (ft/sec)^{1/2} and two hundred ninety (ft/sec)^{1/2}.

The gas turbine engine of any preceding clause, wherein HSR is from 1.9 to 4.3.

The gas turbine engine of any preceding clause, wherein D_{CORE} is from 13 inches to 41 inches.

The gas turbine engine of any preceding clause, wherein L_{CORE} is from 43 inches to 80 inches.

The gas turbine engine of any preceding clause, wherein N2_{r/l} is from 11000 RPM to 25000 RPM.

The gas turbine engine of any preceding clause, wherein m is eight, nine, ten, or eleven.

The gas turbine engine of any preceding clause, wherein n is one or two.

The gas turbine engine of any preceding clause, wherein CIS is from twenty inches to thirty inches.

The gas turbine engine of any preceding clause, wherein HSR_{LP} is from 1.1 to 1.6.

The gas turbine engine of any preceding clause, wherein the high-pressure shaft first mode margin with respect to the low-pressure shaft redline speed is given by:

$$0 < \frac{0.55}{{( H S {R}_{L P} )}^{2}} + LST < - 0.2 ,$$

wherein LST accounts for the effects that the HPC pressure ratio and the HPC exit temperature can have on the first mode.

The gas turbine engine of any preceding clause, wherein LST is from −0.2 to −0.74.

The gas turbine engine of any preceding clause, wherein the high-pressure shaft second order bending mode margin with respect to the high-pressure shaft redline speed is given by:

$$- 0.1215 \times H S R + ( \frac{2 \times H S T - 1}{3} ) < - 0.2 ,$$

wherein HST accounts for the effects that the HPC pressure ratio and the HPC exit temperature have on the third order bending mode.

The gas turbine engine of any preceding clause, wherein HST is from 0.46 to 0.78.

The gas turbine engine of any preceding clause, wherein the low-pressure shaft has a length (L_{MSR}) that extends from a forward bearing to an aft bearing, and a mid-shaft diameter (D_{MSR}), and wherein the length (L_{MSR}) is given by: L_{MSR}=L_{IGB}+L_{CORE}+L_{AFT}, where L_{IGB} is a length forward of the core engine to the forward bearing, L_{CORE} is a length of the core engine, and L_{AFT} is a length from aft of the core engine to the aft bearing.

The gas turbine engine of any preceding clause, wherein L_{MSR} is given by:

$${L}_{M S R} = [ 0.16 \times {D}_{CORE} + 1.7 ] + [ {[ {m}^{( 20 + m )} \times {n}^{( 10 + n )} ]}^{( \frac{1}{100} )} \times {D}_{C O R E} + CIS ] + {L}_{AFT} ,$$

where m is a number of stages of the high-pressure compressor, n is a number of stages of the high-pressure turbine, and CIS is a constant.

The gas turbine engine of any preceding clause, wherein L_{IGB} is from four inches to twelve inches.

The gas turbine engine of any preceding clause, wherein L_{AFT} is from two inches to twenty-four inches.

The gas turbine engine of any preceding clause, wherein the high-pressure compressor includes an exit stage having an exit stage diameter (D_{CORE}).

The gas turbine engine of any preceding clause, wherein L_{IGB} is given by:

$${L}_{IGB} = 0.16 \times {D}_{CORE} + 1.7 ] .$$

The gas turbine engine of any preceding clause, wherein D_{MSR} is given by: D_{MSR}=D_{HPT BORE}−2×t, where D_{HPT BORE} is a diameter of a bore of the high-pressure turbine and t is an intershaft thickness between the shaft and the bore of the high-pressure turbine.

The gas turbine engine of any preceding clause, wherein the thickness is from 450 mils to 650 mils.

The gas turbine engine of any preceding clause, further including a core forward bearing and a core aft bearing.

The gas turbine engine of any preceding clause, wherein the length L_{IGB} extends from the forward bearing to the core forward bearing.

The gas turbine engine of any preceding clause, wherein the length L_{AFT} extends from the aft bearing to the core aft bearing.

The gas turbine engine of any preceding clause, wherein the length L_{CORE} extends from the core forward bearing to the core aft bearing.

The gas turbine engine of any preceding clause, wherein the engine is an unducted engine.

The gas turbine engine of any preceding clause, wherein the engine is a ducted engine.

The gas turbine engine of any preceding clause, further including a second aft bearing.

The gas turbine engine of any preceding clause, further including a second forward bearing and a second aft bearing.

The gas turbine engine of any preceding clause, wherein the forward bearing is forward of the high-pressure compressor.

The gas turbine engine of any preceding clause, wherein the aft bearing is aft of the high-pressure turbine.

The gas turbine engine of any preceding clause, wherein the low-pressure turbine has five stages and at least one stage of the five stages includes the CMC material.

The gas turbine engine of any preceding clause, wherein the low-pressure turbine has six stages and at least one stage of the six stages includes the CMC material.

The gas turbine engine of any preceding clause, wherein the low-pressure turbine has three stages and at least one stage of the three stages includes the CMC material.

The gas turbine engine of any preceding clause, wherein the low-pressure turbine and the high-pressure compressor each includes a CMC material.

The gas turbine engine of any preceding clause, wherein the low-pressure turbine and the high-pressure turbine each includes a CMC material.

The gas turbine engine of any preceding clause, wherein the high-pressure compressor and the high-pressure turbine each includes a CMC material.

The gas turbine engine of any preceding clause, wherein the high-pressure turbine has one stage, and wherein the stage includes the CMC material.

The gas turbine engine of any preceding clause, wherein the high-pressure turbine has two stages, and wherein at least one stage of the two stages includes the CMC material.

The gas turbine engine of any preceding clause, wherein the high-pressure compressor has eight stages and at least one stage of the eight stages includes the CMC material.

The gas turbine engine of any preceding clause, wherein the high-pressure compressor has ten stages and at least one stage of the ten stages includes the CMC material.

The gas turbine engine of any preceding clause, wherein the high-pressure compressor has eleven stages and at least one stage of the eleven stages includes the CMC material.

The gas turbine engine of any preceding clause, wherein the engine is an open fan engine having a first second and third stream, and wherein a ratio of a primary fan to a mid-fan blade spans is between 2:1 to 10:1.

The gas turbine engine of any preceding clause, wherein the engine is an open fan engine having a first second and third stream, and wherein a ratio of a primary fan to a mid-fan blade spans is between 3:1 to 7:1.

The gas turbine engine of any preceding clause, wherein the engine is an open fan or ducted engine.

The gas turbine engine of any preceding clause, wherein the linear speed of the low-pressure shaft is greater than thirty feet per second.

The gas turbine engine of any preceding clause, wherein the ceramic matrix includes an inorganic filler.

The gas turbine engine of any preceding clause, wherein the inorganic filler is selected from the group consisting of pyrophyllite, wollastonite, mica, talc, kyanite, montmorillonite, and mixtures thereof.

The gas turbine engine of any preceding clause, wherein the ceramic matrix includes a non-oxide silicon-based material, an oxide ceramic material, or mixtures thereof.

The gas turbine engine of any preceding clause, wherein the CMC material includes a plurality of reinforcing fibers.

The gas turbine engine of any preceding clause, wherein the plurality of reinforcing fibers includes a non-oxide silicon-based material.

The gas turbine engine of any preceding clause, wherein the non-oxide silicon-based material is selected from the group consisting of silicon carbide, silicon nitride, and mixtures thereof.

The gas turbine engine of any preceding clause, wherein the plurality of reinforcing fibers includes an oxide ceramic material.

The gas turbine engine of any preceding clause, wherein the oxide ceramic is selected from the group consisting of silicon oxycarbides, silicon oxynitrides, aluminum oxide (Al₂O₃), silicon dioxide (SiO₂), aluminosilicates, and mixtures thereof.

The gas turbine engine of any preceding clause, wherein the plurality of reinforcing fibers includes a non-oxide carbon-based material.

The gas turbine engine of any preceding clause, wherein the ceramic matrix includes a non-oxide silicon-based material, an oxide ceramic material, a non-oxide carbon-based material, or mixtures thereof.

The gas turbine engine of any preceding clause, further including an electric machine coupled to the low-pressure shaft.

The gas turbine engine of any preceding clause, wherein the electric machine is located aft of the power turbine.

The gas turbine engine of any preceding clause, wherein the electric machine is an electric motor.

The gas turbine engine of any preceding clause, wherein the electric machine is an electric generator.

The gas turbine engine of any preceding clause, wherein the electric machine includes a rotor and a stator, wherein the rotor rotates with respect to the stator.

The gas turbine engine of any preceding clause, wherein the rotor is coupled to the low-pressure shaft.

The gas turbine engine of any preceding clause, wherein the rotor is configured to rotate with the low-pressure shaft.

The gas turbine engine of any preceding clause, wherein the electric machine is a motor-generator.

A method of operating the gas turbine engine of any preceding clause, the method including operating the gas turbine engine to generate an engine thrust wherein a linear speed of the low-pressure shaft does not exceed three hundred feet per second.

A method of operating a gas turbine engine having a high-pressure compressor, a high-pressure turbine, a combustion chamber in flow communication with the high-pressure compressor and the high-pressure turbine, a power turbine, at least one of the high-pressure compressor, the high-pressure turbine, and the power turbine having a ceramic matric composite (CMC) material, and a low-pressure shaft coupled to the power turbine and characterized by a midshaft rating (MSR) between two hundred (ft/sec)^{1/2} and three hundred (ft/sec)^{1/2}. The method including operating the low-pressure shaft up to the redline speed between fifty and two hundred fifty feet per second (ft/sec) without passing through a critical speed associated with a first order bending mode of the low-pressure shaft.

A method of operating a gas turbine engine having a high-pressure compressor, a high-pressure turbine, a combustion chamber in flow communication with the high-pressure compressor and the high-pressure turbine, a power turbine in flow communication with the high-pressure turbine, at least one of the high-pressure compressor, the high-pressure turbine, or the power turbine having a ceramic matrix composite (CMC) material, and a low-pressure shaft coupled to the power turbine. The method including operating the low-pressure shaft at a linear speed that does not exceed three hundred feet per second.

The method of any preceding clause, wherein the gas turbine engine is the gas turbine engine according to any preceding clause.

A gas turbine engine including an engine core including a high-pressure compressor, which has an exit stage having an exit stage diameter (D_{CORE}), a high-pressure turbine, and a combustion chamber in flow communication with the high-pressure compressor and the high-pressure turbine; a power turbine in flow communication with the high-pressure turbine; and a low-pressure shaft coupled to the power turbine and characterized by a midshaft rating (MSR) between two hundred (ft/sec)^{1/2} and three hundred (ft/sec)^{1/2}. The low-pressure shaft has a redline speed between fifty and two hundred fifty feet per second (ft/sec). The gas turbine engine is configured to operate up to the redline speed without passing through a critical speed associated with a first order bending mode of the low-pressure shaft. The low-pressure shaft has a length (L_{MSR}) defined by an engine core length (L_{CORE}) given by:

$${L}_{CORE} = {[ {m}^{( 20 + m )} \times {n}^{( 10 + n )} ]}^{( \frac{1}{100} )} \times {D}_{CORE} + CIS ,$$

where m is a number of stages of the high-pressure compressor, n is a number of stages of the high-pressure turbine, and CIS is a constant.

A gas turbine engine having an engine core including a high-pressure compressor, which has an exit stage having an exit stage diameter (D_{CORE}), having from eight stages to eleven stages, a high-pressure turbine, and a combustion chamber in flow communication with the high-pressure compressor and the high-pressure turbine, wherein the high-pressure compressor and higher pressure turbine are connected through a high-pressure shaft; and wherein the high-pressure compressor and high-pressure turbine are related to a core length (L_{CORE}) by

$${L}_{CORE} = {[ {m}^{( 20 + m )} \times {n}^{( 10 + n )} ]}^{( \frac{1}{100} )} \times {D}_{C O R E} + CIS ,$$

where m is a number of stages of the high-pressure compressor, n is a number of stages of the high-pressure turbine, and CIS is a constant. The gas turbine engine further including a power turbine in flow communication with the high-pressure turbine and a low-pressure shaft coupling the power turbine to a low-pressure compressor and fan assembly, wherein the low-pressure shaft has a redline speed of between 50 feet per second and 300 feet per second.

The gas turbine engine of any preceding clause, wherein CIS is from twenty inches to thirty inches.

The gas turbine engine of any preceding clause, wherein L_{CORE} is from forty-three inches to eighty inches.

The gas turbine engine of any preceding clause, wherein D_{CORE} is from 13 inches to 41 inches.

The gas turbine engine of any preceding clause, wherein the power turbine has four stages, five stages, or six stages.

The gas turbine engine of any preceding clause, wherein n is one stage or two stages.

The gas turbine engine of any preceding clause, wherein m is eight stages, nine stages, ten stages, or eleven stages.

The gas turbine engine of any preceding clause, wherein m is nine stages.

The gas turbine engine of any preceding clause, wherein the high-pressure turbine and the high-pressure compressor are connected to each other through a high-pressure shaft, and wherein the high-pressure shaft is characterized by a high-pressure shaft rating (HSR) given by:

$$HSR = {10}^{- 6} \times N {2}_{r / l} \times {D}_{C O R E} \times {( \frac{{L}_{C O R E}}{{D}_{C O R E}} )}^{2} ,$$

where N2_{r/l} is a redline speed of the high-pressure shaft.

The gas turbine engine of any preceding clause, wherein HSR is from 1.9 to 4.3.

The gas turbine engine of any preceding clause, wherein N2_{r/l} is from 11000 RPM to 25000 RPM.

The gas turbine engine of any preceding clause, wherein the high-pressure shaft is characterized by a second high-pressure shaft rating (HSRLP) given by:

$${HSR}_{L P} = 1 {0}^{- 6} * N {1}_{r / l} \times {D}_{C O R E} \times {( \frac{{L}_{C O R E}}{{D}_{C O R E}} )}^{2} ,$$

where N1_{r/l} is the redline speed of the low-pressure shaft.

The gas turbine engine of any preceding clause, wherein HSR_{LP} is from 1.1 to 1.6.

The gas turbine engine of any preceding clause, wherein the power turbine includes a ceramic matrix composite (CMC) material.

The gas turbine engine of any preceding clause, further including an electric machine coupled to the low-pressure shaft.

The gas turbine engine of any preceding clause, wherein the electric machine is located aft of the power turbine.

The gas turbine engine of any preceding clause, further including a primary fan driven by the power turbine through a gearbox assembly and a flex coupling that couples the gearbox assembly to the low-pressure shaft.

The gas turbine engine of any preceding clause, wherein the flex coupling is characterized by a decoupler moment stiffness in a range of 50 klb*in/rad to 200 klb*in/rad and a decoupler shear stiffness in a range of 100 klb/in to 500 klb/in.

The gas turbine engine of any preceding clause, wherein the length (L_{MSR}) is given by: L_{MSR}=L_{IGB}+L_{CORE}+L_{AFT}, where L_{IGB} is a length forward of the core engine to the forward bearing and is from four inches to twelve inches and L_{AFT} is a length from aft of the core engine to the aft bearing and is from two inches to twenty-four inches.

The gas turbine engine of any preceding clause, wherein the electric machine is an electric motor.

The gas turbine engine of any preceding clause, wherein the electric machine is an electric generator.

The gas turbine engine of any preceding clause, wherein the electric machine includes a rotor and a stator, wherein the rotor rotates with respect to the stator.

The gas turbine engine of any preceding clause, wherein the rotor is coupled to the low-pressure shaft.

The gas turbine engine of any preceding clause, wherein the rotor is configured to rotate with the low-pressure shaft.

The gas turbine engine of any preceding clause, wherein the electric machine is a motor-generator.

The method of any preceding clause, wherein the gas turbine engine is an open fan or ducted engine.

The gas turbine engine of any preceding clause, wherein the flex coupling is characterized by a decoupler moment stiffness in a range of 50 klb×in/rad to 200 klb×in/rad.

The gas turbine engine of any preceding clause, wherein the flex coupling is characterized by a decoupler shear stiffness in a range of 100 klb/in to 500 klb/in.

The gas turbine engine of any preceding clause, the decoupler moment stiffness being equal to

$$\frac{E \times {K}_{m} \times {R}_{dcplr}^{4}}{{H}_{dcplr}} ,$$

E being a Young's modulus of a material of the flex coupling, Kₘ being a correction factor, R_{dcplr} being a decoupler radius of the flex coupling, and H_{dcplr} being a decoupler height of the flex coupling.

The gas turbine engine of any preceding clause, Kₘ being in a range of 0.13×10⁻³ to 0.27×10⁻³.

The gas turbine engine of any preceding clause, the decoupler shear stiffness being equal to

$$\frac{E \times {K}_{m} \times {R}_{dcplr}^{4}}{{L}_{dcplr}^{2}} ,$$

wherein E being a Young's modulus of a material of the flex coupling, Kₘ being a correction factor, R_{dcplr} being a decoupler radius of the flex coupling, and L_{dcplr} being a decoupler length of the flex coupling.

The gas turbine engine of any preceding clause, Kₘ being in a range of 0.13×10⁻³ to 0.27×10⁻³.

The gas turbine of any preceding clause, wherein the MSR is between one hundred ninety (ft/sec)^{1/2} and two hundred forty-five (ft/sec)^{1/2}.

The gas turbine of any preceding clause, wherein the MSR is between two hundred twelve (ft/sec)^{1/2} and two hundred sixty (ft/sec)^{1/2}.

The turbomachine of any preceding clause, wherein the MSR is between two hundred forty-seven (ft/sec)^{1/2} and two hundred ninety (ft/sec)^{1/2}.

The gas turbine engine of any preceding clause, wherein the high-pressure shaft first mode margin with respect to the low-pressure shaft redline speed is given by:

$$0 < \frac{0.55}{{( {HSR}_{LP} )}^{2}} + LST < - 0.2 ,$$

wherein LST accounts for the effects that the HPC pressure ratio and the HPC exit temperature can have on the first mode.

The gas turbine engine of any preceding clause, wherein LST is from −0.2 to −0.74.

The gas turbine engine of any preceding clause, wherein the high-pressure shaft second order bending mode margin with respect to the high-pressure shaft redline speed is given by:

$$- 0.12 \; 15 \times HSR + ( \frac{2 * HST - 1}{3} ) < - 0.2 ,$$

wherein HST accounts for the effects that the HPC pressure ratio and the HPC exit temperature have on the third order bending mode.

The gas turbine engine of any preceding clause, wherein HST is from 0.46 to 0.78.

The gas turbine engine of any preceding clause, wherein the engine is an open fan engine having a first second and third stream, and wherein a ratio of a primary fan to a mid-fan blade spans is between 2:1 to 10:1.

The gas turbine engine of any preceding clause, wherein the engine is an open fan engine having a first second and third stream, and wherein a ratio of a primary fan to a mid-fan blade spans is between 3:1 to 7:1.

The gas turbine of any preceding clause, wherein L_{IGB} is from four inches to twelve inches.

The gas turbine of any preceding clause, wherein L_{AFT} is between two inches and twenty-four inches, inclusive of the endpoints.

The gas turbine of any preceding clause, wherein L_{IGB} is given by L_{IGB}=0.16×D_{CORE}+1.7.

The gas turbine of any preceding clause, wherein D_{MSR} is given by: D_{MSR}=D_{HPT BORE}−2×t, where D_{HPT BORE} is a diameter of a bore of the high-pressure turbine and t is an intershaft thickness between the shaft and the bore of the high-pressure turbine.

The gas turbine of any preceding clause, wherein the thickness is between 450 mils and 650 mils, inclusive of the endpoints.

The gas turbine of any preceding clause, wherein at least one of the power turbine, the high-pressure compressor, and the high-pressure turbine includes a ceramic matrix composite (CMC).

The gas turbine engine of any preceding clause, further including a core forward bearing and a core aft bearing.

The gas turbine engine of any preceding clause, wherein the length L_{IGB} extends from the forward bearing to the core forward bearing.

The gas turbine engine of any preceding clause, wherein the length L_{AFT} extends from the aft bearing to the core aft bearing.

The gas turbine engine of any preceding clause, wherein the length L_{CORE} extends from the core forward bearing to the core aft bearing.

The gas turbine engine of any preceding clause, wherein the gas turbine engine is an unducted engine.

The gas turbine engine of any preceding clause, wherein the gas turbine engine is a ducted engine.

The gas turbine engine of any preceding clause, further including a second aft bearing.

The gas turbine engine of any preceding clause, further including a second forward bearing.

The gas turbine engine of any preceding clause, wherein the forward bearing is forward of the high-pressure compressor.

The gas turbine engine of any preceding clause, wherein the aft bearing is aft of the high-pressure turbine.

A method of operating the gas turbine engine of any preceding clause, the method including operating the gas turbine engine to generate an engine thrust wherein a linear speed of the low-pressure shaft does not exceed three hundred feet per second.

A method of operating a gas turbine engine including an engine core including a high-pressure compressor, which has an exit stage having an exit stage diameter (D_{CORE}), a high-pressure turbine, a combustion chamber in flow communication with the high-pressure compressor and the high-pressure turbine, a power turbine in flow communication with the high-pressure turbine, and a low-pressure shaft coupled to the power turbine and characterized by a midshaft rating (MSR) between two hundred (ft/sec)^{1/2} and three hundred (ft/sec)^{1/2} and having a length (L_{MSR}) defined by an engine core length (L_{CORE}) given by:

$${L}_{CORE} = {[ {m}^{( 20 + m )} \times {n}^{( 10 + n )} ]}^{( \frac{1}{100} )} \times {D}_{CORE} + CIS ,$$

where m is a number of stages of the high-pressure compressor, n is a number of stages of the high-pressure turbine, and CIS is a constant. The method including operating the low-pressure shaft at a redline speed between fifty and two hundred fifty feet per second (ft/sec). The method including operating the low-pressure shaft up to the redline speed without passing through a critical speed associated with a first order bending mode of the low-pressure shaft.

A method of operating a gas turbine engine, including the steps of using an engine core including a high-pressure compressor, which has an exit stage having an exit stage diameter (D_{CORE}), a high-pressure turbine, and a combustion chamber in flow communication with the high-pressure compressor and the high-pressure turbine, a power turbine in flow communication with the high-pressure turbine, and a low-pressure shaft coupled to the power turbine and characterized by a midshaft rating (MSR) between two hundred (ft/sec)^{1/2} and three hundred (ft/sec)^{1/2}. The method includes operating the gas turbine engine to generate an engine thrust wherein the low-pressure shaft linear speed does not exceed three hundred feet per second.

A method of operating a gas turbine engine, including using an engine core including a high-pressure compressor, which has an exit stage having an exit stage diameter (D_{CORE}), a high-pressure turbine, a combustion chamber in flow communication with the high-pressure compressor and the high-pressure turbine, a power turbine in flow communication with the high-pressure turbine, and a low-pressure shaft coupled to the power turbine having a length (L_{MSR}) defined by an engine core length (L_{CORE}) given by:

$${L}_{CORE} = {[ {m}^{( 20 + m )} \times {n}^{( 10 + n )} ]}^{( \frac{1}{100} )} \times {D}_{CORE} + CIS ,$$

where m is a number of stages of the high-pressure compressor, n is a number of stages of the high-pressure turbine, and CIS is a constant. The method including operating the gas turbine engine to generate an engine thrust wherein a linear speed of the low-pressure shaft does not exceed three hundred feet per second.

The method of any preceding clause, wherein the gas turbine engine is the gas turbine engine according to any preceding clause.

A gas turbine engine including a turbomachine including a compressor section, a combustion section, and a turbine section arranged in serial flow order, the compressor section having a high-pressure compressor defining a high-pressure compressor exit area (A_{HPCExit}) in square inches and an exit stage diameter (D_{CORE}) in inches, and the turbine section having a high-pressure turbine, wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust is determined as follows: Fn_{Total}×EGT/(A_{HPCExit}²×1000), and a low-pressure shaft coupled to the turbine section and characterized by a midshaft rating (MSR) between two hundred (ft/sec)^{1/2} and three hundred (ft/sec)^{1/2}, wherein the low-pressure shaft has a length (L_{MSR}) defined by an engine core length (L_{CORE}), and wherein the engine core length (L_{CORE}) is from forty-three inches to eighty inches and is given by

$${L}_{CORE} = {[ {m}^{( 20 + m )} \times {n}^{( 10 + n )} ]}^{( \frac{1}{100} )} \times {D}_{CORE} + CIS ,$$

where m is a number of stages of the high-pressure compressor, n is a number of stages of the high-pressure turbine, and CIS is a constant.

The gas turbine engine the preceding clause, wherein a first order bending mode of the low-pressure shaft is greater than a redline speed of the low-pressure shaft.

The gas turbine engine of any preceding clause, wherein a first order bending mode of the low-pressure shaft is less than a redline speed of the low-pressure shaft and within 5% to 10% of the redline speed.

The gas turbine engine of any preceding clause, wherein CIS is from twenty inches to thirty inches.

The gas turbine engine of any preceding clause, wherein D_{CORE} is from 13 inches to 41 inches.

The gas turbine engine of any preceding clause, wherein the turbine section includes a power turbine that has four stages, five stages, or six stages.

The gas turbine engine of any preceding clause, wherein n is one stage or two stages.

The gas turbine engine of any preceding clause, wherein the length (L_{MSR}) is given by: L_{MSR}=L_{IGB}+L_{CORE}+L_{AFT}, where L_{IGB} is a length forward of the high-pressure compressor to a forward bearing and is from four inches to twelve inches and L_{AFT} is a length from aft of the high-pressure turbine to an aft bearing and is from two inches to twenty-four inches.

The gas turbine engine of any preceding clause, wherein m is eight stages, nine stages, ten stages, or eleven stages.

The gas turbine engine of any preceding clause, wherein m is nine stages.

The gas turbine engine of any preceding clause, further including one or more bearings that support the low-pressure shaft.

The gas turbine engine of any preceding clause, wherein the one or more bearings include at least two bearings aft of the high-pressure turbine.

The gas turbine engine of any preceding clause, wherein the low-pressure shaft has a varying stiffness along an axial length of the low-pressure shaft such that a center axial section of the low-pressure shaft has a stiffness that is less than axial end sections of the low-pressure shaft.

The gas turbine engine of any preceding clause, wherein a ratio of the stiffness of the center axial section of the low-pressure shaft to a total stiffness of the low-pressure shaft is greater than or equal to 0.4.

The gas turbine engine of any preceding clause, wherein a ratio of the stiffness to a mass of the center axial section to a total stiffness to a total mass of the low-pressure shaft is greater than 1.

The gas turbine engine of any preceding clause, further including a bearing damper assembly including the one or more bearings and a bearing housing that receives oil to damp vibrations of the one or more bearings from the low-pressure shaft.

The gas turbine engine of any preceding clause, wherein the MSR is greater when the oil has an oil temperature greater than an operating temperature range as compared to the MSR when the oil has an oil temperature within the operating temperature range.

The gas turbine engine of any preceding clause, wherein the MSR is less when the oil has an oil temperature less than an operating temperature range as compared to the MSR when the oil has an oil temperature within the operating temperature range.

The gas turbine engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range.

The gas turbine engine of any preceding clause, wherein a first order bending mode of the low-pressure shaft is less when the oil has an oil temperature less than an operating temperature range as compared to the first order bending mode of the low-pressure shaft when the oil has an oil temperature within the operating temperature range.

A gas turbine engine including a turbomachine including a compressor section, a combustion section, and a turbine section arranged in serial flow order, the compressor section having a high-pressure compressor defining a high-pressure compressor exit area (A_{HPCExit}) in square inches, wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust is determined as follows: Fn_{Total}×EGT/(A_{HPCExit}²×1000), and a low-pressure shaft coupled to the turbine section and characterized by a midshaft rating (MSR) between two hundred (ft/sec)^{1/2} and three hundred (ft/sec)^{1/2}, wherein at least one of the compressor section, the combustion section, or the turbine section includes a ceramic matrix composite (CMC) material.

The gas turbine engine of the preceding clause, wherein a first order bending mode of the low-pressure shaft is greater than a redline speed of the low-pressure shaft.

The gas turbine engine of any preceding clause, wherein a first order bending mode of the low-pressure shaft is less than a redline speed of the low-pressure shaft and within 5% to 10% of the redline speed.

The gas turbine engine of any preceding clause, wherein the CMC material includes a plurality of reinforcing fibers.

The gas turbine engine of any preceding clause, wherein the CMC material includes a ceramic matrix material including a non-oxide silicon-based material, an oxide ceramic material, or mixtures thereof.

The gas turbine engine of any preceding clause, wherein the non-oxide silicon-based material is selected from the group consisting of silicon carbide, silicon nitride, and mixtures thereof, and the oxide ceramic material is selected from the group consisting of silicon oxycarbides, silicon oxynitrides, aluminum oxide (Al₂O₃), silicon dioxide (SiO₂), aluminosilicates, and mixtures thereof.

The gas turbine engine of any preceding clause, wherein turbine section includes a high-pressure turbine that includes the CMC material.

The gas turbine engine of any preceding clause, wherein the high-pressure turbine includes at least one nozzle and at least one airfoil, wherein the at least one nozzle, the at least one airfoil, or both the at least one nozzle and the at least one airfoil include the CMC material.

The gas turbine engine of any preceding clause, wherein the high-pressure turbine has one stage or two stages, and wherein the one stage or at least one stage of the two stages includes the CMC material.

The gas turbine engine of any preceding clause, wherein turbine section includes a power turbine that includes the CMC material.

The gas turbine engine of any preceding clause, wherein the power turbine includes at least one nozzle and at least one airfoil, wherein the at least one nozzle, the at least one airfoil, or both the at least one nozzle and the at least one airfoil include the CMC material.

The gas turbine engine of any preceding clause, wherein the power turbine has three stages, four stages, five stages, or six stages, and wherein at least one stage of the three stages, the four stages, the five stages, or the six stages includes the CMC material.

The gas turbine engine of any preceding clause, wherein the power turbine has four stages and at least one stage of the four stages includes the CMC material.

The gas turbine engine of any preceding clause, wherein the turbine section includes a high-pressure turbine, the CMC material is a first CMC material, and the high-pressure turbine includes the first CMC material or a second CMC material.

The gas turbine engine of any preceding clause, further including one or more bearings that support the low-pressure shaft.

The gas turbine engine of any preceding clause, further including a bearing damper assembly including the one or more bearings and a bearing housing that receives oil to damp vibrations of the one or more bearings from the low-pressure shaft.

The gas turbine engine of any preceding clause, wherein the MSR is greater when the oil has an oil temperature greater than an operating temperature range as compared to the MSR when the oil has an oil temperature within the operating temperature range.

The gas turbine engine of any preceding clause, wherein the MSR is less when the oil has an oil temperature less than an operating temperature range as compared to the MSR when the oil has an oil temperature within the operating temperature range.

The gas turbine engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range.

The gas turbine engine of any preceding clause, wherein a first order bending mode of the low-pressure shaft is less when the oil has an oil temperature less than an operating temperature range as compared to the first order bending mode of the low-pressure shaft when the oil has an oil temperature within the operating temperature range.

A gas turbine engine including a turbomachine including a compressor section, a combustion section, and a turbine section arranged in serial flow order, the turbine section having a low-pressure turbine, and a low-pressure shaft coupled to the low-pressure turbine and characterized by a midshaft effective flexural rigidity (MEFR) in a range of 39 lbf-in² to 211 lbf-in² and given by:

$$MEFR = E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L′Total is a total length of the low-pressure shaft.

The gas turbine engine of the preceding clause, wherein E is in a range of 1.5E+07 psi to 3.6E+07 psi.

The gas turbine engine of any preceding clause, wherein I_{B} is in a range of 1.5 in⁴ to 6.0 in⁴.

The gas turbine engine of any preceding clause, wherein T_{D} is in a range of 0.23 in to 0.83 in.

The gas turbine engine of any preceding clause, wherein T_{E} is in a range of 0.72 in to 1.50 in.

The gas turbine engine of any preceding clause, wherein T_{B} is in a range of 0.15 in to 0.83 in.

The gas turbine engine of any preceding clause, wherein L_{B} is in a range of 29.7 in to 44.7 in.

The gas turbine engine of any preceding clause, wherein L_{Total} is in a range of 74.1 inches to 111.3 in.

The gas turbine engine of any preceding clause, wherein the low-pressure shaft has a redline speed in a range of 10,000 RPM to 13,000 RPM for a three-stage low-pressure turbine.

The gas turbine engine of any preceding clause, wherein the low-pressure shaft has a redline speed in a range of 9,000 RPM to 10,200 RPM for a four-stage low-pressure turbine.

A gas turbine engine including a turbomachine including a compressor section, a combustion section, and a turbine section arranged in serial flow order, the compressor section having a high-pressure compressor defining a high-pressure compressor exit area (A_{HPCExit}) in square inches and an exit stage diameter (D_{CORE}) in inches, and the turbine section having a high-pressure turbine, wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust is determined as follows: Fn_{Total}×EGT/(A_{HPCExit}²×1000), and a low-pressure shaft coupled to the turbine section and characterized by a midshaft effective flexural rigidity (MEFR) in a range of 39 lbf-in² to 211 lbf-in² and given by:

$$MEFR = E \times {I}_{B} \times ( \frac{( 1.3 \times {T}_{E} ) + {T}_{D}}{2 \times {T}_{B}} ) \times ( \frac{{L}_{B}}{{L}_{Total}} ) \times 1 {0}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

The gas turbine engine of the preceding clause, wherein E is in a range of 1.5E+07 psi to 3.6E+07 psi.

The gas turbine engine of any preceding clause, wherein I_{B} is in a range of 1.5 in⁴ to 6.0 in⁴.

The gas turbine engine of any preceding clause, wherein T_{D} is in a range of 0.23 in to 0.83 in.

The gas turbine engine of any preceding clause, wherein T_{E} is in a range of 0.72 in to 1.50 in.

The gas turbine engine of any preceding clause, wherein T_{B} is in a range of 0.15 in to 0.83 in.

The gas turbine engine of any preceding clause, wherein L_{B} is in a range of 29.7 in to 44.7 in.

The gas turbine engine of any preceding clause, wherein L_{Total} is in a range of 74.1 inches to 111.3 in

The gas turbine engine of any preceding clause, wherein the low-pressure shaft has a redline speed in a range of 10,000 RPM to 13,000 RPM for a three-stage low-pressure turbine.

The gas turbine engine of any preceding clause, wherein the low-pressure shaft has a redline speed in a range of 9,000 RPM to 10,200 RPM for a four-stage low-pressure turbine.

A gas turbine engine defining a radial direction, the gas turbine engine including a turbomachine comprising a drive turbine and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100, and a reduction gearbox mechanically coupling the drive turbine of the turbomachine to the fan, wherein the gas turbine engine defines a Fan Leading Edge to Trailing Edge

Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} ,$$

and wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

The gas turbine engine of the preceding clause, wherein the bypass ratio is greater than or equal to 13 and less than or equal to 25.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

The gas turbine engine of any preceding clause, wherein the EGT is greater than 1000 degrees Celsius and less than 1300 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, further comprising a high pressure turbine having a first stage of high pressure turbine rotor blades, and wherein the gas turbine engine further comprises: a cooled cooling air system in fluid communication with the first stage of high pressure turbine rotor blades.

The gas turbine engine of any preceding clause, further comprising a high pressure compressor, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, further comprising a compressor, wherein when the gas turbine engine is operated at a takeoff power level, the cooled cooling air system is configured to receive between 2.5% and 35% of an airflow through a working gas flowpath of the turbomachine at an inlet to the compressor.

The gas turbine engine of any preceding clause, further comprising a high-pressure turbine having a first stage of high-pressure turbine rotor blades, and a cooled cooling air system in fluid communication with the first stage of high-pressure turbine rotor blades.

The gas turbine engine of any preceding clause, further comprising a primary fan driven by the turbomachine.

The gas turbine engine of any preceding clause, further comprising an inlet duct downstream of the primary fan; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

The gas turbine engine of any preceding clause, further comprising a cooled cooling air system that includes a dedicated heat exchanger cooled cooling air system.

The gas turbine engine of any preceding clause, further comprising a cooled cooling air system that includes a bypass heat exchanger cooled cooling air system having a heat sink heat exchanger thermally coupled to an airflow through a bypass passage of the gas turbine engine.

The gas turbine engine of any preceding clause, further comprising a cooled cooling air system that includes an air-to-air cooled cooling air system.

The gas turbine engine of any preceding clause, further comprising a cooled cooling air system that includes an oil-to-air cooled cooling air system or a fuel-to-air cooled cooling air system.

A gas turbine engine defining a radial direction, the gas turbine engine including a turbomachine comprising a drive turbine and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30, and a reduction gearbox mechanically coupling the drive turbine of the turbomachine to the fan, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} ,$$

and wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

The gas turbine engine of the preceding clause, wherein the bypass ratio is greater than or equal to 13 and less than or equal to 25.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of any preceding clause, wherein the EGT is greater than 1000 degrees Celsius and less than 1300 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, further comprising a high pressure turbine having a first stage of high pressure turbine rotor blades, and wherein the gas turbine engine further comprises: a cooled cooling air system in fluid communication with the first stage of high pressure turbine rotor blades.

The gas turbine engine of any preceding clause, further comprising a high pressure compressor, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, further comprising a compressor, wherein when the gas turbine engine is operated at a takeoff power level, the cooled cooling air system is configured to receive between 2.5% and 35% of an airflow through a working gas flowpath of the turbomachine at an inlet to the compressor.

The gas turbine engine of any preceding clause, further comprising a high-pressure turbine having a first stage of high-pressure turbine rotor blades, and a cooled cooling air system in fluid communication with the first stage of high-pressure turbine rotor blades.

The gas turbine engine of any preceding clause, further comprising a primary fan driven by the turbomachine.

The gas turbine engine of any preceding clause, further comprising an inlet duct downstream of the primary fan; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

The gas turbine engine of any preceding clause, further comprising a cooled cooling air system that includes a dedicated heat exchanger cooled cooling air system.

The gas turbine engine of any preceding clause, further comprising a cooled cooling air system that includes a bypass heat exchanger cooled cooling air system having a heat sink heat exchanger thermally coupled to an airflow through a bypass passage of the gas turbine engine.

The gas turbine engine of any preceding clause, further comprising a cooled cooling air system that includes an air-to-air cooled cooling air system.

The gas turbine engine of any preceding clause, further comprising a cooled cooling air system that includes an oil-to-air cooled cooling air system or a fuel-to-air cooled cooling air system.

A gas turbine engine defining a radial direction, the gas turbine engine including a turbomachine comprising a drive turbine including a low-pressure shaft and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100, and a reduction gearbox mechanically coupling the drive turbine of the turbomachine to the fan, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} ,$$

and wherein the low-pressure shaft is characterized by a midshaft rating (MSR) between two hundred (ft/sec)^{1/2} and three hundred thirty (ft/sec)^{1/2}.

The gas turbine engine of any preceding clause, wherein the low-pressure shaft has a redline speed between fifty and two hundred fifty-five feet per second (ft/sec).

The gas turbine engine of any preceding clause, wherein a first order bending mode of the low-pressure shaft is greater than a redline speed of the low-pressure shaft.

The gas turbine engine of any preceding clause, wherein the low-pressure shaft has a length L, an outer diameter D, and a ratio of L/D between twelve and thirty-seven.

The gas turbine engine of any preceding clause, wherein the low-pressure shaft is a composite shaft made of at least two different materials.

The gas turbine engine of any preceding clause, wherein the reduction gearbox has a gear ratio between 2:1 and 14:1.

The gas turbine engine of any preceding clause, wherein a first order bending mode of the low-pressure shaft is less than a redline speed of the low-pressure shaft and within 5% to 10% of the redline speed.

The gas turbine engine of any preceding clause, further comprising one or more bearings that support the low-pressure shaft.

The gas turbine engine of any preceding clause, further comprising a bearing damper assembly including the one or more bearings and a bearing housing that receives oil to damp vibrations of the one or more bearings from the low-pressure shaft.

The gas turbine engine of any preceding clause, wherein the MSR is greater when the oil has an oil temperature greater than an operating temperature range as compared to the MSR when the oil has an oil temperature within the operating temperature range.

The gas turbine engine of any preceding clause, wherein the MSR is less when the oil has an oil temperature less than an operating temperature range as compared to the MSR when the oil has an oil temperature within the operating temperature range.

The gas turbine engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range.

The gas turbine engine of any preceding clause, wherein a first order bending mode of the low-pressure shaft is less when the oil has an oil temperature less than an operating temperature range as compared to the first order bending mode of the low-pressure shaft when the oil has an oil temperature within the operating temperature range.

The gas turbine engine of any preceding clause, wherein the MSR is between one hundred ninety (ft/sec)^{1/2} and two hundred forty-five (ft/sec)^{1/2}.

The gas turbine engine of any preceding clause, wherein the MSR is between two hundred twelve (ft/sec)^{1/2} and two hundred sixty (ft/sec)^{1/2}.

The gas turbine engine of any preceding clause, wherein the MSR is between two hundred forty-seven (ft/sec)^{1/2} and two hundred ninety (ft/sec)^{1/2}.

The gas turbine engine of any preceding clause, wherein the low-pressure shaft has a length L and a reduced mass density at a midpoint along the length L.

The gas turbine engine of any preceding clause, wherein the low-pressure shaft has a redline speed between sixty and ninety ft/sec, between seventy-five and one hundred seventy-five ft/sec, or between one hundred fifty and two hundred fifty ft/sec.

The gas turbine engine of any preceding clause, wherein the low-pressure shaft has a length L, an outer diameter D, and a ratio of L/D between twelve and twenty, between sixteen and thirty, or between twenty-six and thirty-seven.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

A gas turbine engine defining a radial direction, the gas turbine engine including a turbomachine comprising a drive turbine including a low-pressure shaft and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30, and a reduction gearbox mechanically coupling the drive turbine of the turbomachine to the fan, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} ,$$

and wherein the low-pressure shaft is characterized by a midshaft rating (MSR) between two hundred (ft/sec)^{1/2} and three hundred thirty (ft/sec)^{1/2}.

The gas turbine engine of any preceding clause, wherein the reduction gearbox has a gear ratio between 2:1 and 14:1.

The gas turbine engine of any preceding clause, wherein a first order bending mode of the low-pressure shaft is greater than a redline speed of the low-pressure shaft.

The gas turbine engine of any preceding clause, wherein a first order bending mode of the low-pressure shaft is less than a redline speed of the low-pressure shaft and within 5% to 10% of the redline speed.

The gas turbine engine of any preceding clause, further comprising one or more bearings that support the low-pressure shaft.

The gas turbine engine of any preceding clause, further comprising a bearing damper assembly including the one or more bearings and a bearing housing that receives oil to damp vibrations of the one or more bearings from the low-pressure shaft.

The gas turbine engine of any preceding clause, wherein the MSR is greater when the oil has an oil temperature greater than an operating temperature range as compared to the MSR when the oil has an oil temperature within the operating temperature range.

The gas turbine engine of any preceding clause, wherein the MSR is less when the oil has an oil temperature less than an operating temperature range as compared to the MSR when the oil has an oil temperature within the operating temperature range.

The gas turbine engine of any preceding clause, wherein a first order bending mode of the low-pressure shaft is greater when the oil has an oil temperature greater than an operating temperature range as compared to the first order bending mode of the low-pressure shaft when the oil has an oil temperature within the operating temperature range.

The gas turbine engine of any preceding clause, wherein a first order bending mode of the low-pressure shaft is less when the oil has an oil temperature less than an operating temperature range as compared to the first order bending mode of the low-pressure shaft when the oil has an oil temperature within the operating temperature range.

The gas turbine engine of any preceding clause, wherein the MSR is between one hundred ninety (ft/sec)^{1/2} and two hundred forty-five (ft/sec)^{1/2}.

The gas turbine engine of any preceding clause, wherein the MSR is between two hundred twelve (ft/sec)^{1/2} and two hundred sixty (ft/sec)^{1/2}.

The gas turbine engine of any preceding clause, wherein the MSR is between two hundred forty-seven (ft/sec)^{1/2} and two hundred ninety (ft/sec)^{1/2}.

The gas turbine engine of any preceding clause, wherein the low-pressure shaft has a length L and a reduced mass density at a midpoint along the length L.

The gas turbine engine of any preceding clause, wherein the low-pressure shaft has a redline speed between sixty and ninety ft/sec, between seventy-five and one hundred seventy-five ft/sec, or between one hundred fifty and two hundred fifty ft/sec.

The gas turbine engine of any preceding clause, wherein the low-pressure shaft has a length L, an outer diameter D, and a ratio of L/D between twelve and twenty, between sixteen and thirty, or between twenty-six and thirty-seven.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

A gas turbine engine defining a radial direction, the gas turbine engine including a turbomachine comprising a drive turbine including a low-pressure shaft and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100, and a reduction gearbox mechanically coupling the drive turbine of the turbomachine to the fan, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} ,$$

and wherein the low-pressure shaft is characterized by a midshaft effective flexural rigidity (MEFR) in a range of 39 lbf-in² to 211 lbf-in² and given by:

$$MEFR = E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

The gas turbine engine of any preceding clause, wherein E is in a range of 1.5E+07 psi to 3.6E+07 psi.

The gas turbine engine of any preceding clause, wherein I_{B} is in a range of 1.5 in⁴ to 6.0 in⁴.

The gas turbine engine of any preceding clause, wherein T_{D} is in a range of 0.23 in to 0.83 in.

The gas turbine engine of any preceding clause, wherein T_{E} is in a range of 0.72 in to 1.50 in.

The gas turbine engine of any preceding clause, wherein T_{B} is in a range of 0.15 in to 0.83 in.

The gas turbine engine of any preceding clause, wherein L_{B} is in a range of 29.7 in to 44.7 in.

The gas turbine engine of any preceding clause, wherein L_{Total} is in a range of 74.1 inches to 111.3 in.

The gas turbine engine of any preceding clause, wherein the low-pressure shaft has a redline speed in a range of 5,000 RPM to 13,000 RPM.

The gas turbine engine of any preceding clause, wherein the low-pressure shaft has a redline speed in a range of 10,000 RPM to 13,000 RPM for a three-stage low-pressure turbine.

The gas turbine engine of any preceding clause, wherein the low-pressure shaft has a redline speed in a range of 9,000 RPM to 10,200 RPM for a four-stage low-pressure turbine.

The gas turbine engine of any preceding clause, further comprising a plurality of bearings that support the low-pressure shaft.

The gas turbine engine of any preceding clause, wherein the plurality of bearings are arranged in an outbound position.

The gas turbine engine of any preceding clause, wherein at least one of the plurality of bearings is a roller bearing.

The gas turbine engine of any preceding clause, wherein at least one of the plurality of bearings is a ball bearing.

The gas turbine engine of any preceding clause, wherein the plurality of bearings includes one or more forward bearings and one or more aft bearings.

The gas turbine engine of any preceding clause, wherein the low-pressure shaft has a varying outer diameter between the one or more forward bearings and the one or more aft bearings.

The gas turbine engine of any preceding clause, wherein the low-pressure shaft has a varying thickness between the one or more forward bearings and the one or more aft bearings.

The gas turbine engine of any preceding clause, wherein the low-pressure shaft has a varying stiffness between the one or more forward bearings and the one or more aft bearings.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

A gas turbine engine defining a radial direction, the gas turbine engine including a turbomachine comprising a drive turbine including a low-pressure shaft and defining a working gas flowpath and an inlet to the working gas flowpath, a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30, and a reduction gearbox mechanically coupling the drive turbine of the turbomachine to the fan, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

and wherein the low-pressure shaft is characterized by a midshaft effective flexural rigidity (MEFR) in a range of 39 lbf-in² to 211 lbf-in² and given by:

$$MEFR = E \times {I}_{B} \times ( \frac{( 1.3 \times {T}_{E} ) + {T}_{D}}{2 \times {T}_{B}} ) \times ( \frac{{L}_{B}}{{L}_{Total}} ) \times {10}^{- 6} ,$$

where E is a modulus of elasticity of the low-pressure shaft, I_{B} is an area moment of inertia of a midshaft section of the low-pressure shaft, T_{E} is an average thickness of an axially forward-most section of the low-pressure shaft, T_{D} is an average thickness of an axially aft-most section of the low-pressure shaft, T_{B} is an average thickness of the midshaft section, L_{B} is an axial length of the midshaft section, and L_{Total} is a total length of the low-pressure shaft.

The gas turbine engine of the preceding clause, wherein E is in a range of 1.5E+07 psi to 3.6E+07 psi.

The gas turbine engine of any preceding clause, wherein Ip is in a range of 1.5 in⁴ to 6.0 in⁴.

The gas turbine engine of any preceding clause, wherein T_{D} is in a range of 0.23 in to 0.83 in.

The gas turbine engine of any preceding clause, wherein T_{E} is in a range of 0.72 in to 1.50 in.

The gas turbine engine of any preceding clause, wherein T_{B} is in a range of 0.15 in to 0.83 in.

The gas turbine engine of any preceding clause, wherein L_{B} is in a range of 29.7 in to 44.7 in.

The gas turbine engine of any preceding clause, wherein L_{Total} is in a range of 74.1 inches to 111.3 in.

The gas turbine engine of any preceding clause, wherein the low-pressure shaft has a redline speed in a range of 5,000 RPM to 13,000 RPM.

The gas turbine engine of any preceding clause, wherein the low-pressure shaft has a redline speed in a range of 10,000 RPM to 13,000 RPM for a three-stage low-pressure turbine.

The gas turbine engine of any preceding clause, wherein the low-pressure shaft has a redline speed in a range of 9,000 RPM to 10,200 RPM for a four-stage low-pressure turbine.

The gas turbine engine of any preceding clause, further comprising a plurality of bearings that support the low-pressure shaft.

The gas turbine engine of any preceding clause, wherein the plurality of bearings are arranged in an outbound position.

The gas turbine engine of any preceding clause, wherein at least one of the plurality of bearings is a roller bearing.

The gas turbine engine of any preceding clause, wherein at least one of the plurality of bearings is a ball bearing.

The gas turbine engine of any preceding clause, wherein the plurality of bearings includes one or more forward bearings and one or more aft bearings.

The gas turbine engine of any preceding clause, wherein the low-pressure shaft has a varying outer diameter between the one or more forward bearings and the one or more aft bearings.

The gas turbine engine of any preceding clause, wherein the low-pressure shaft has a varying thickness between the one or more forward bearings and the one or more aft bearings.

The gas turbine engine of any preceding clause, wherein the low-pressure shaft has a varying stiffness between the one or more forward bearings and the one or more aft bearings.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine defining a radial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan,
wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{LE}} \times {R}_{{Hub}_{TE}}}{{R}_{{Fan}_{TE}} \times {R}_{{Hub}_{LE}}} ,$$
and
wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

2. The gas turbine engine of claim 1, wherein the bypass ratio is greater than or equal to 13 and less than or equal to 25.

3. The gas turbine engine of claim 1, wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} .$$

4. The gas turbine engine of claim 1, wherein the EGT is greater than 1000 degrees Celsius and less than 1300 degrees Celsius.

5. The gas turbine engine of claim 1, wherein the EGT is greater than 1150 degree Celsius and less than 1250 degrees Celsius.

6. The gas turbine engine of claim 1, wherein the EGT is greater than 1000 degree Celsius and less than 1300 degrees Celsius, and wherein the corrected specific thrust is greater than or equal to 45.

7. The gas turbine engine of claim 1, wherein the EGT is greater than 1000 degree Celsius and less than 1300 degrees Celsius, and wherein the corrected specific thrust is greater than or equal to 50.

8. The gas turbine engine of claim 1, further comprising a high pressure turbine having a first stage of high pressure turbine rotor blades, and wherein the gas turbine engine further comprises:
a cooled cooling air system in fluid communication with the first stage of high pressure turbine rotor blades.

9. The gas turbine engine of claim 8, further comprising a high pressure compressor, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

10. The gas turbine engine of claim 8, wherein when the gas turbine engine is operated at a takeoff power level, the cooled cooling air system is configured to provide a temperature reduction of a cooling airflow equal to at least 15% of the EGT and up to 45% of the EGT.

11. The gas turbine engine of claim 8, further comprising a compressor, wherein when the gas turbine engine is operated at a takeoff power level, the cooled cooling air system is configured to receive between 2.5% and 35% of an airflow through a working gas flowpath of the turbomachine at an inlet to the compressor.

12. The gas turbine engine of claim 1, further comprising a high-pressure turbine having a first stage of high-pressure turbine rotor blades, and a cooled cooling air system in fluid communication with the first stage of high-pressure turbine rotor blades.

13. The gas turbine engine of claim 1, further comprising a primary fan driven by the turbomachine.

14. The gas turbine engine of claim 13, further comprising:
an inlet duct downstream of the primary fan; and
a secondary fan located within the inlet duct.

15. The gas turbine engine of claim 14, wherein the gas turbine engine defines a bypass passage over the turbomachine, and wherein the gas turbine engine defines a third stream extending from a location downstream of the secondary fan to the bypass passage.

16. The gas turbine engine of claim 14, wherein the secondary fan is a single stage secondary fan.

17. The gas turbine engine of claim 1, further comprising a cooled cooling air system that includes a dedicated heat exchanger cooled cooling air system.

18. The gas turbine engine of claim 1, further comprising a cooled cooling air system that includes a bypass heat exchanger cooled cooling air system having a heat sink heat exchanger thermally coupled to an airflow through a bypass passage of the gas turbine engine.

19. The gas turbine engine of claim 1, further comprising a cooled cooling air system that includes an air-to-air cooled cooling air system.

20. The gas turbine engine of claim 1, further comprising a cooled cooling air system that includes an oil-to-air cooled cooling air system or a fuel-to-air cooled cooling air system.
